(19) United States
(12) Patent Application Publication
(10) Pub. No.: US 2026/0205763 A1
(43) Pub. Date: Jul. 16, 2026

(54) SYSTEM FOR MEASURING THE ACOUSTIC PROPERTIES OF A ROOM AND GENERATING A ROOM SYSTEM LOCATION SCORE FOR EACH MEASUREMENT LOCATION IN THE ROOM AND GENERATING A 3D ROOM SYSTEM PERFORMANCE MAP

(71) Applicant: NUREVA, INC., Calgary (CA)

(72) Inventors: Paul Anthony Ferry, Calgary (CA); Erica Patricia Yorga, Calgary (CA); Boyi Ma, Calgary (CA); Chang Hyeon Lee, Calgary (CA); Yaohan Xing, Cochrane (CA)

(21) Appl. No.: 19/449,540

(22) Filed: Jan. 15, 2026

Related U.S. Application Data
(60) Provisional application No. 63/745,976, filed on Jan. 16, 2025.

(51) Int. Cl. H04S 7/00; H04R 29/00

(52) U.S. Cl. CPC H04S 7/40; H04R 29/001; H04S 7/305; H04S 2420/01

(57) ABSTRACT

A system is provided to measure and generate at least one multiscale room system performance map of a 3D space. The system is configured to measure the room acoustical properties at one or more locations at specific times in the 3D space to form an acoustic, system and room measurement map that is location accurate to a known room model which is used in conjunction with a user selected audio conference equipment model and a room use case scenario model, and then to derive a room system performance location score 3D map based on the room using a layout and geometry that is coordinate correct. The system also generates a Room System Performance Map over time such that room system performance can be collected, evaluated and scored over a temporal dimension, allowing for alerts and changes in equipment and the room environment which can be tracked and analyzed.

### CROSS REFERENCE TO RELATED APPLICATIONS

This application claims priority to U.S. Provisional Patent Application No. 63/745,976, filed on Jan. 16, 2025, the entire contents of which are incorporated herein by reference.

### BACKGROUND OF THE INVENTION

### Field of the Invention

The present invention generally relates to combining the measuring for one or more room acoustic parameters with one or more room locations on a 2D and/or 3D grid taking into account specific room usage scenario and audio equipment parameters to derive a combined 3D location based scoring metrics for audio conferencing and/or voice amp capability equipment in a particular room, which may be obtained by using combined parameters of room parameters, measured and calculated acoustic room parameters, selected audio equipment and use case type. More particularly, the system of the disclosed invention is configured to combine the measuring for one or more room locations, with one or more time periods, with one or more specific acoustic parameters, with a user configured room use case, with defined equipment parameters to generate a geometrically accurate combined room and system performance 3D scoring map that shows a derived room system performance location (region) based score for the room which can be then utilized for predicting and evaluating potential equipment recommendations, performance and placement options in the room for the purpose of optimizing the overall audio quality performance of the conference and/or voice lift systems full room microphone audio pickup and speaker output in the room and for remote participates connected via a Unified Communication Client (UCC) session.

### Description of Related Art

Obtaining high quality audio at both ends of a conference call is difficult to manage due to, but not limited to, variable room dimensions, room materials, room furnishings, dynamic seating plans, roaming participants, unknown number of microphones and locations, unknown speaker system locations, known steady state and unknown dynamic noise, variable desired sound source levels, and unknown room characteristics, as well as improper equipment selection and installation. This may result in conference call audio having a combination of desired sound sources (participants) and undesired sound sources (return speaker echo signals, HVAC ingress, feedback issues, room reverberation and high noise and varied gain levels across all sound sources, etc.). If the equipment is poorly chosen and/or is installed in poor acoustic locations the overall audio end-to-end performance will suffer accordingly.

To provide an audio conference system that addresses dynamic room usage scenarios, including the audio performance variables discussed above, microphone systems need to be thoughtfully installed, configured, and calibrated to perform satisfactorily in the environment. The process starts by placing an audio conference system in the room utilizing one or more microphones. The placement of microphone(s) is critical for obtaining adequate room coverage which must then be balanced with proximity of the microphone(s) to the participants to maximize desired vocal audio pickup while reducing the pickup of the audio speakers and undesired sound sources. Installers can be mindful of known noise sources such as HVAC vents but room acoustic issues such as location specific echo and reverb beyond the standard overall room measurement can be hidden from the installer and are typically found post installation when the conference system performs below expectations. In a small space where participants are collocated around a table, simple audio conference systems can be placed on the table to provide adequate performance and participant audio room coverage. Larger spaces require multiple microphones of various form factors which may be mounted in any combination of, but not limited to, the ceiling, tables, walls, etc., making for increasingly complex and difficult installations. To optimize performance of the audio conference system, various compromises are typically required based on, but not limited to, limited available microphone mounting locations, inability to run connecting cables, room use changes requiring a different microphone layout, seated vs. agile and walking participants, location of undesired noise sources and other equipment in the room, etc., all affecting where and what type of microphones can be placed in the room. The same goes for the audio speakers which need to be placed in sufficient quality to provide room coverage but far enough away from the microphone system to prevent audio feedback.

Compounding the problem of equipment installation is the room shape, construction and decorative materials and furnishings which all have a very large influence on the acoustical properties and artifacts the room presents to the audio conference and voice lift systems. Most rooms are prioritized for the functional use such as conference rooms and education spaces while decorative looks and subjective room feel take priority with little attention paid to acoustic properties and the influence those choices have on the in-room and remote user audio quality. An example of this is the use of glass walls to allow for natural lighting but are notoriously horrible for acoustic room sound quality. Hard surfaces, big tables and chairs with little padding all contribute to an overly lively acoustic environment creating high reverb and echo artifacts than is undesirable and can cause significant issues that the audio conference system needs to deal with which compounds the problem of where to install the equipment and predicting how it will perform in the room. A room with too many soft surfaces can also be a problem as more microphones and speakers may be required to obtain adequate in-room participant pickup from the microphones and remote participant volume levels out of the in-room speaker system.

To further add to the challenges, unwanted noise sources such as computer and monitor fans, HVAC ducts, adjacent room and external sound ingress all contribute to the factors that make the background noise potentially unpredictable, time based and varied in level making selecting and installing conference audio equipment even more problematic, resulting in an unpredictable and potentially poor level of audio performance. For the most part the noise sources in the room are at fixed locations, however it may be difficult to quantify and assess their impact on the room system as acoustical properties such as background noise and frequency spectral contributions (distortions) as those acoustic contributions are time specific and not a fixed or continuous static property like the RT60 measurement would be. Noise sources may not be accounted for in single or limited manual measurement windows undertaken by an acoustician.

The current art offers a few approaches to try and deal with the above issues of room acoustics, undesired sound pollution and equipment selection and installation. For room acoustics an acoustician would typically be hired to come in and analyze the room for reverb (RT60) aka impulse measurements which result in time domain measurement properties. This can be complemented with standard noise, SPL, and spectrum measurements. The nature of this type of approach means that the measurements are taken at a few locations, maybe even only one location, and it is up to the experience and technical skill level of the acoustician, which is typically time boxed meaning, at a certain time of day only. It is very expensive to hire a specialist to come in and take measurements and if the room changes in any way the measurements may need to be redone such as in the case of divisible rooms and multi-function rooms where the furnishings and people compliment are influx. Even in the best-case scenario an acoustical expert or acoustician in the field is most likely not a specialist in all the equipment types, performance behaviors, installation requirements and use cases that are to be potentially used in the space, so the acoustical measurement summary is a room only acoustic study with little to no consideration given to impact on the equipment used and performance. The acoustician can recommend room treatments to bring the space in-line with industry acceptable norms, however this is a limiting approach. For rooms with a single purpose this approach can work, such as concert halls, churches and other similar venues where natural acoustic source voices and sound reinforcement systems are used for specific situations. The room's acoustic measurements and analysis looks at the overall problem from a single perspective and does not have the whole picture of the room acoustics, impact on equipment selection and performance overtime even in the same day or week and the potential room use cases.

Acousticians use specialized tools for measurements which are typically standalone and specialized to the single task of measuring the room standalone acoustic properties at a specific time of day at a few locations. The depth of the measurement is based on the level and quality of measurement gear utilized by the acoustician, for example whether direct (single channel) or indirect (dual channel) are undertaken as both have their merits and complexities. The locations of the measurements are typically up to the discretion of the acoustician and most likely any two acousticians will measure differently and at different locations, if the exact location is even recorded, thus not allowing for repeatable measurements (dimension 1) at various locations (dimension 2) and time of day and year (dimension 3) to build up a basic room specific acoustic profile.

An IT/Systems Integrator/technical specialist would typically take the acoustic report, and recommendations from the acoustician and attempt to implement an equipment selection and installation strategy. This requires specialized knowledge and skill. Due to the cost of hiring an acoustician, installers, system integrators or technical specialists often forgo a detailed acoustic measurement process and instead install equipment where they think it makes sense and end up looking at the system install from a narrow perspective based on visual location assessment and perhaps undesired sound source (HVAC vents) locations and the often broad-based room size equipment manufacture recommendations. System integrators typically install equipment based on manufacture recommendations and their own experience level, which is highly variable. The location of known undesired sound sources and other visual aspects usually take a high priority without fully appreciating or understanding the room distortions such as RT60, and the impact on equipment performance.

It is difficult to ensure that the multiple disciplines involved work collaboratively and effectively with knowledge of the overall system requirements, room use cases and product knowledge; however, the conference audio system is expected to perform at optimal levels.

In addition the current art insufficiently solves for a complete integrated process and application solution that takes into account all of the impacting variables such as room properties and acoustics, noise sources, and time of day room impacts, audio conference system selection and installation, room usage scenarios, in combination or in part that are then used to predict and optimize for end-to-end audio conference and/or voice lift audio performance in a specific room. Thus, removing uncertainty, and the requirement for highly skilled industry specialists that can be costly and difficult to communicate clear requirements getting results that may or may not be useful and in context resulting in unpredictable results in the short term and long term. This leaves uncertainty and guess work as to the audio equipment's ability to work in a given room of shape, size and acoustic properties let alone that it is installed at the best locations in the room to optimize audio talker microphone pickup performance and speaker output level and quality in the room and ensure the remote participants to the conference call are hearing the best audio performance possible.

### SUMMARY OF THE INVENTION

An object of the embodiments of the present invention is, to measure the room acoustical properties at one or more locations at specific times in 3D space to form an acoustic, system and room measurement map that is location accurate to a known room model which is used in conjunction with a user selected audio conference equipment model and a room use case scenario model, to then to derive a room system performance location score 3D map based on the room using a layout and geometry that is coordinate correct.

More specifically, it is an object of the invention to preferably make equipment type and/or placement recommendations based on the Room System Performance. If a user selects a different audio conference equipment model, the Room System Performance Map will be adjusted accordingly to reflect the predicted in-room performance of that total integrated system.

Even more specifically, it is an object of the invention to support standalone and embedded application instantiations into various form factors and conference systems or similar devices, meaning that the conference system can generate a Room System Performance Map at any time the system is configured to do so allowing for a complete evaluation and system adjustment cycle.

Even more specifically, it is an object of the invention to generate a Room System Performance Map over time such that room system performance can be collected, evaluated and scored over a temporal dimension, allowing for alerts and changes in equipment and the room environment which can be tracked and analyzed.

Even more specifically, it is an object of the invention to generate a Room System Performance Map which is made available through application programing interface (API) and database interfaces to allow 3^{rd} party usage of the performance map data and for conference audio equipment to use the performance map data for real-time adjustments to the microphone targeting system, audio processing and speaker output performance.

The preferred embodiments comprise both algorithms, audio devices, measurement devices and hardware accelerators to implement the structures and functions described herein.

### BRIEF DESCRIPTION OF THE DRAWINGS

The preferred embodiments described herein and illustrated by the drawings hereinafter are to illustrate and not to limit the invention, where like designations denote like elements.

FIGS. 1a, 1b, 1c, 1d, 1e, and 1f are diagrammatic examples of a typical audio conference setup across multiple device and room types.

FIGS. 2a, 2b, 2c, 2d, 2e, 2f, and 2g are graphical structural examples of microphone array and speaker layouts supported in the embodiment of the present invention.

FIGS. 3a, 3b, 3c and 3d are prior art examples of acoustic room measurement technics.

FIGS. 4a, 4b, 4c. 4d, and 4e are prior art diagrammatic examples of acoustic measurement room analysis results.

FIGS. 5a, 5b, 5c, 5d, 5e, and 5f are exemplary diagrammatic illustrations showing a reference room geometry in relation to various specific microphone or sensor locations and orientations in the room in a 3D space supported in the embodiment of the invention.

FIGS. 6a, 6b, 6c, 6d, 6e, 6f, 6g, 6h, 6i, 6j, 6k, 6l, 6m, 6n, 6o, 6p, 6q, and or are exemplary examples of various room system acoustic measurement configurations, techniques and iterations supported in the embodiment of the invention.

FIGS. 7a, 7b, 7c, 7d, 7e, 7f, 7g, and 7h are exemplary illustrations of the overall measurement and room system performance map measurement, analysis and display output process supported in the embodiment of the invention.

FIGS. 8a, 8b, 8c, 8d, 8e, 8f, 8g, 8h, 8i and 8j are exemplary example workflow illustrations of the overall measurement and room system performance map measurement, analysis and display output process to then make recommendations based on room and equipment specifics supported in the embodiment of the invention.

FIGS. 9a, 9b, 9c, 9d, 9e, 9f, 9g and 9h are functional and structural diagrams of an exemplary embodiment of the Room System Performance Map Processor and its sub-systems.

FIGS. 10a, 10b, 10c, 10d, 10e, 10f, 10g, 10h, 10i, 10j, 10k, 10l, 10m, 10n, 10o, 10p, 10q, 10r, 10s, 10t, 10u. 10v, 10w, and 10x are exemplary embodiments of the logic flowcharts of the Room System Score Performance Processor and its sub systems in the generation of room system performance location scores.

FIGS. 11a, 11b, 11c, and 11d are exemplary illustrations of the present invention rendering and mapping room systems performance scores across various spatial and temporal dimensions as output from the Room System Performance Map Analytics Processor.

FIGS. 12a, 12b, 12c, and 12d are exemplary embodiments of the logic flowcharts of the Room System Performance Map Analytics Processor generating a Multiscale Room System Performance Map.

FIGS. 13a, 13b, 13c, 13d, 13e, 13f, 13g and 13h are exemplary embodiments of the logic flowcharts of the Room System Performance Map Analytics Processor outlining specific process and features of the Multiscale Room System Performance Map.

### DETAILED DESCRIPTION OF THE PRESENT INVENTION

The present invention is directed to systems, apparatus and methods that enable IT/Technical specialists, sales personnel, acousticians and equipment installers and similar groups of people to utilize a combined room and audio system performance scoring solution that can be run as an application standalone on a computer and/or smartphone like device and/or embedded in to an audio conference system or similar device for the purpose of forming a temporal and location based Room System Performance Map by measuring the room acoustics, analyzing the room system use case, in combination of all or a subset of, for equipment suitability and installation including general room suitability for acoustic and audio optimization of in-room microphone pickup and placement, speaker placement, room and equipment health over time for audio conference and voice lift applications (and other sound sources, for example, recordings, broadcast music, Internet sound, etc.), known as “participants”, to join together over a network, such as the Internet or similar electronic channel(s), in a remotely-distributed real-time fashion employing personal computers, network workstations, and/or other similarly connected appliances, often without face-to-face contact, to engage in effective audio conference meetings and voice lift applications that utilize large multi-user rooms (spaces) with distributed participants.

Advantageously, embodiments of the apparatus and methods of the present invention afford an ability for corporate departments and individuals to have a complete solution for understanding the complexities of measured room acoustics and audio equipment interactions using room parameters, audio equipment parameters and use case analysis to significantly improve the success of selection of equipment, installation, and configuration of the equipment knowing the locations in the room which are characterized and optimal resulting in the best performance of the audio equipment for all participants in the room and remotely. Bringing a common reference grid, with specialized expert knowledge and data collection in combination with acoustic measurements to infer a robust and meaningful scoring method by combining measurements with equipment data, room data and use case data to come up with a usable and meaningful simple room score solution that can be used for room analysis, selection and use cases.

A notable challenge to combining acoustic room measurements, room parameters and use case parameters to calculate and infer an overall room system performance location score that measures a room is being able to put into context standalone room acoustic measurements, with appropriate audio conference and voice lift system selection and requirements while also understanding the use case application, the room and the system are to be used in without requiring multiple specialized and skilled personnel to coordinate and work together efficiently. The costs in dollars and time are typically prohibitive to undertake this effort on all but the highest profile and important rooms. Preferably a fresh approach is used that is based on a room reference 3D geometry framework to establish the room dimensional parameters in the context of the measurement locations in 3D space and in the temporal dimension, the current and potential audio equipment locations and noise source locations and active times. This is in addition to preferably using a room properties parameter model, equipment model and use case model that a processing engine can utilize to infer and weight the acoustic measurements against, to form an accurate 3D room system performance location score output outlining the expected overall performance of the system in context of the acoustics, room, equipment and use case and thus removing the need for multiple specialists, the guess work of the type and quality of equipment required and the optimum locations for the audio equipment microphone and speakers. This results in a cost-effective solution that can be used in all rooms that utilize audio conference and/or voice lift equipment to optimize the end-to-end audio experience.

A “microphone” in this specification may include, but is not limited to, one or more of, any combination of transducer device(s) such as, microphone element, condenser mics, dynamic mics, ribbon mics, USB mics, stereo mics, mono mics, shotgun mics, boundary mic, small diaphragm mics, large diaphragm mics, multi-pattern mics, strip microphones, digital microphones, fixed microphone arrays, dynamic microphone arrays, beam forming microphone arrays, and/or any transducer device capable of receiving acoustic signals and converting to electrical signals, and or digital signals.

A “virtual microphone” in this specification represents a point in space that has been focused on by the combined microphone array by time-aligning and combining a set of physical microphone signals according to the time delays based on the speed of sound and the time to propagate from the sound source each to physical microphone. A virtual microphone emulates performance of a single, physical, omnidirectional microphone at that point in space.

A “Coverage Zone Dimension” in the specification may include physical boundaries such as wall, ceiling and floors that contain a space with regards to the establishment of installing and configuring a microphone system coverage patterns and dimensions. The coverage zone dimension can be known ahead of time or derived with a number of sufficiently placed microphone arrays also known as boundary devices placed on or offset from physical room boundaries.

A “combined array” in this specification can be defined as the combining of two more individual microphone elements, groups of microphone elements and other combined microphone elements into a single combined microphone array system that is aware of the relative distance between each microphone element to a reference microphone element, determined in configuration, and is aware of the relative orientation of the microphone elements such as an m-axis, m-plane and m-hyperplane sub arrangements of the combined array. A combined array will integrate all microphone elements into a single array and will be able to form coverage pattern configurations as a combined array.

In this specification, “generators” refer to output mechanisms in which a sound (test signal) can be output and/or transmitted and/or generated. This may include, but is not limited to, one or more of, or any combination of, balloons, hand claps, starter pistols, digital audio files such as wav, or mp3, and speakers, both embedded in and external to conference systems. Speakers May include, but are not limited to conference systems, USB speakers, Bluetooth speakers, studio monitors, sub-woofers, home audio systems, smart speakers, or any device capable of converting digital or electrical signals to acoustic signals.

A “conference enabled system” in this specification may include, but is not limited to, one or more of, any combination of device(s) such as, UC (unified communications) compliant devices and software, computers, dedicated software, audio devices, cell phones, a laptop, tablets, smart watches, a cloud-access device, and/or any device capable of sending and receiving audio signals to/from a local area network or a wide area network (e.g. the Internet), containing integrated or attached microphones, amplifiers, speakers and network adapters. PSTN, Phone networks etc.

A “communication connection” in this specification may include, but is not limited to, one or more of or any combination of network interface(s) and devices(s) such as, Wi-Fi modems and cards, internet routers, internet switches, LAN cards, local area network devices, wide area network devices, PSTN, Phone networks, etc.

A “device” in this specification may include, but is not limited to, one or more of, or any combination of processing device(s) such as, a cell phone, a Personal Digital Assistant, a smart watch or other body-borne device (e.g., glasses, pendants, rings, etc.), a personal computer, a laptop, a tablet, a cloud-access device, a white board, and/or any device capable of sending/receiving messages to/from a local area network or a wide area network (e.g., the Internet), such as devices embedded in cars, trucks, aircraft, household appliances (refrigerators, stoves, thermostats, lights, electrical control circuits, the Internet of Things, etc.).

A “participant” in this specification may include, but is not limited to, one or more of, any combination of persons such as students, employees, users, attendees, or any other general groups of people that can be interchanged throughout the specification and construed to mean the same thing. Participants gather into a room or space for the purpose of listening to and or being a part of a classroom, conference, presentation, panel discussion or any event that requires a public address system and a UCC connection for remote participants to join and be a part of the session taking place. Throughout this specification a participant is a desired sound source, and the two words can be construed to mean the same thing.

A “desired sound source” in this specification may include, but is not limited to, one or more of a combination of audio source signals of interest such as: sound sources that have frequency and time domain attributes, specific spectral signatures, and/or any audio sounds that have amplitude, power, phase, frequency and time, and/or voice characteristics that can be measured and/or identified such that a microphone can be focused on the desired sound source and said signals processed to optimize audio quality before delivery to an audio conferencing system. Examples include one or more speaking participants, one or more audio speakers providing input from a remote location, combined video/audio sources, multiple persons, or a combination of these. A desired sound source can radiate sound in an omni-polar pattern and/or in any one or combination of directions from the center of origin of the sound source.

An “undesired sound source” in this specification may include, but is not limited to, one or more of a combination of persistent or semi-persistent audio sources such as: sound sources that may be measured to be constant over a configurable specified period of time, have a predetermined amplitude response, have configurable frequency and time domain attributes, specific spectral signatures, and/or any audio sounds that have amplitude, power, phase, frequency and time characteristics that can be measured and/or identified such that a microphone might be erroneously focused on the undesired sound source. These undesired sources encompass, but are not limited to, Heating, Ventilation, Air Conditioning (HVAC) fans and vents; projector and display fans and electronic components; white noise generators; any other types of persistent or semi-persistent electronic or mechanical sound sources; external sound source such as traffic, trains, trucks, etc.; and any combination of these. An undesired sound source can radiate sound in an omni-polar pattern and/or in any one or combination of directions from the center of origin of the sound source.

A “system processor” or “processor” is preferably a computing platform composed of standard or proprietary hardware and associated software or firmware processing audio and control signals. An example of a standard hardware/software system processor would be a Windows-based computer. An example of a proprietary hardware/software/firmware system processor would be a Digital Signal Processor (DSP).

A “communication connection interface” is preferably a standard networking hardware and software processing stack for providing connectivity between physically separated audio-conferencing systems. A primary example would be a physical Ethernet connection providing TCP/IP network protocol connections.

A “UCC or Unified Communication Client” is preferably a program that performs the functions of but not limited to messaging, voice and video calling, team collaboration, video conferencing and file sharing between teams and or individuals using devices deployed at each remote end to support the session. Sessions can be in the same building and/or they can be located anywhere in the world that a connection can be established through a communications framework such as but not limited to Wi-Fi, LAN, Intranet, telephony, wireless or other standard forms of communication protocols. The term “Unified Communications” may refer to systems that allow companies to access the tools they need for communication through a single application or service (e.g., a single user interface). Increasingly, Unified Communications have been offered as a service, which is a category of “as a service” or “cloud” delivery mechanisms for enterprise communications (“UCaaS”). Examples of prominent UCaaS providers include Dialpad, Cisco, Mitel, RingCentral, Twilio, Voxbone, 8×8, and Zoom Video Communications.

An “engine” is preferably a program that performs a core function for other programs. An engine can be a central or focal program in an operating system, subsystem, or application program that coordinates the overall operation of other programs. It is also used to describe a special-purpose program containing an algorithm that can sometimes be changed. The best-known usage is the term search engine which uses an algorithm to search an index of topics given a search argument. An engine is preferably designed so that its approach to searching an index, for example, can be changed to reflect new rules for finding and prioritizing matches in the index. In artificial intelligence, for another example, the program that uses rules of logic to derive output from a knowledge base is called an inference engine.

In this specification, “inference engine” is a software component that contains an algorithm that processes known facts, for example input values such as raw measurement values, environment, system configuration, or outputs of other inference engines, to infer new facts or conclusions about the raw measurement values, environment, or system configuration, that can be consumed by other inference engines or downstream processes. Specifically, “Sensor Score Inference Engines” are used to consume raw measurement values such as, but not limited to, background noise values in dB (A) or dB (C), or RT60 values in milliseconds, to generate a uniform Sensor Score based on the environment and system configurations. Likewise, “Location Score Inference Engines” consume Sensor Scores to produce a Location Score based on the environment and system configurations.

“Environment”, in this specification, refers to the aggregation of the room, its use case, and a conferencing system and/or voice lift system currently installed in, or to be installed into, the room.

“Geometry”, in this specification, refers to the spatial and temporal coordinate frame of a room. This may include, but is not limited to, height, width, depth of a room, as well as the time at which measurements are taken within the room.

In this specification “volume”, “region”, “area” may include not only the notion of space but also the notion of a volume, region, or area in the space including time dimensions.

A “structured grid” refers to a type of grid where the data points are arranged in a regular, predictable pattern. This means that each point in the grid can be indexed using a multi-dimensional array, making it easier to locate and manipulate data. The grid is typically composed of cells but not limited (such as squares or cubes, or any geometric pattern) that are aligned in a consistent manner.

As used herein, a “server” may comprise one or more processors, one or more Random Access Memories (RAM), one or more Read Only Memories (ROM), one or more user interfaces, such as display(s), keyboard(s), mouse/mice, etc. A server is preferably apparatus that provides functionality for other computer programs or devices, called “clients.” This architecture is called the client-server model, and a single overall computation is typically distributed across multiple processes or devices. Servers can provide various functionalities, often called “services”, such as sharing data or resources among multiple clients, or performing computation for a client. A single server can serve multiple clients, and a single client can use multiple servers. A client process may run on the same device or may connect over a network to a server on a different device. Typical servers are database servers, file servers, mail servers, print servers, web servers, game servers, application servers, and chat servers. The servers discussed in this specification may include one or more of the above, sharing functionality as appropriate. Client-server systems are most frequently implemented by (and often identified with) the request-response model: a client sends a request to the server, which performs some action and sends a response back to the client, typically with a result or acknowledgement. Designating a computer as “server-class hardware” implies that it is specialized for running servers on it. This often implies that it is more powerful and reliable than standard personal computers, but alternatively, large computing clusters may be composed of many relatively simple, replaceable server components.

The servers and devices in this specification typically use one or more processors to run one or more stored “computer programs” and/or non-transitory “computer-readable media” to cause the device and/or server(s) to perform the functions recited herein. The media may include Compact Discs, DVDs, ROM, RAM, solid-state memory, or any other storage device capable of storing the one or more computer programs.

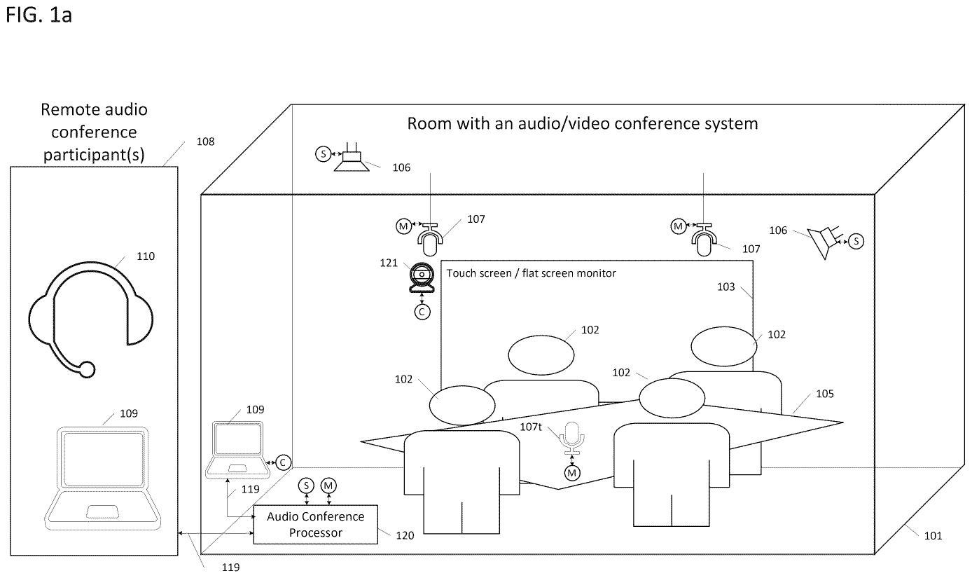

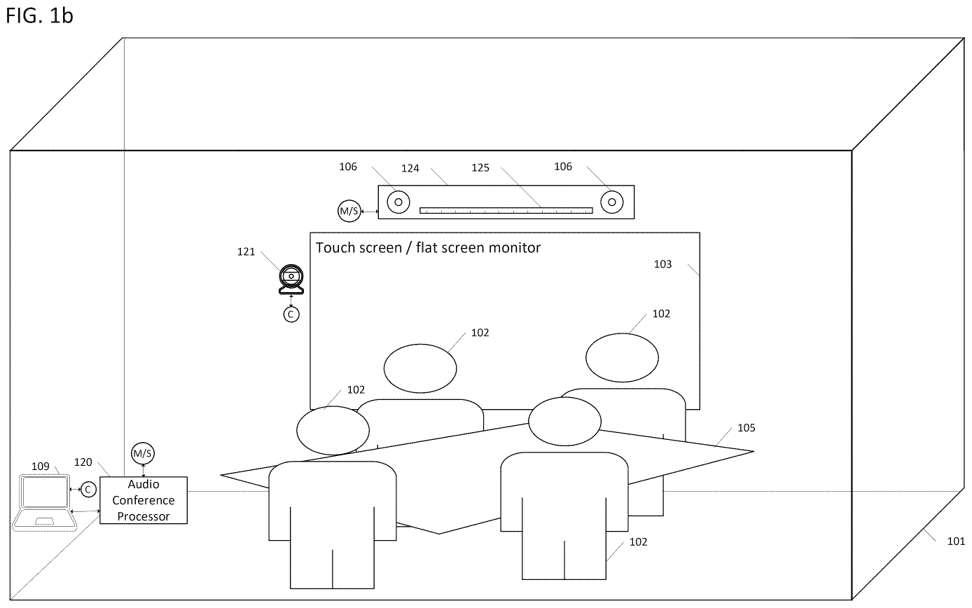

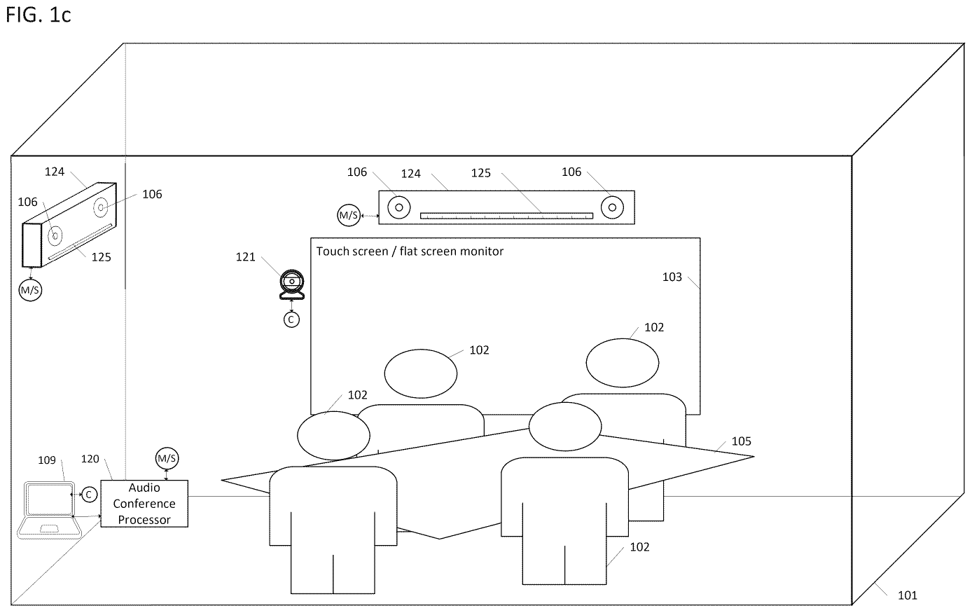

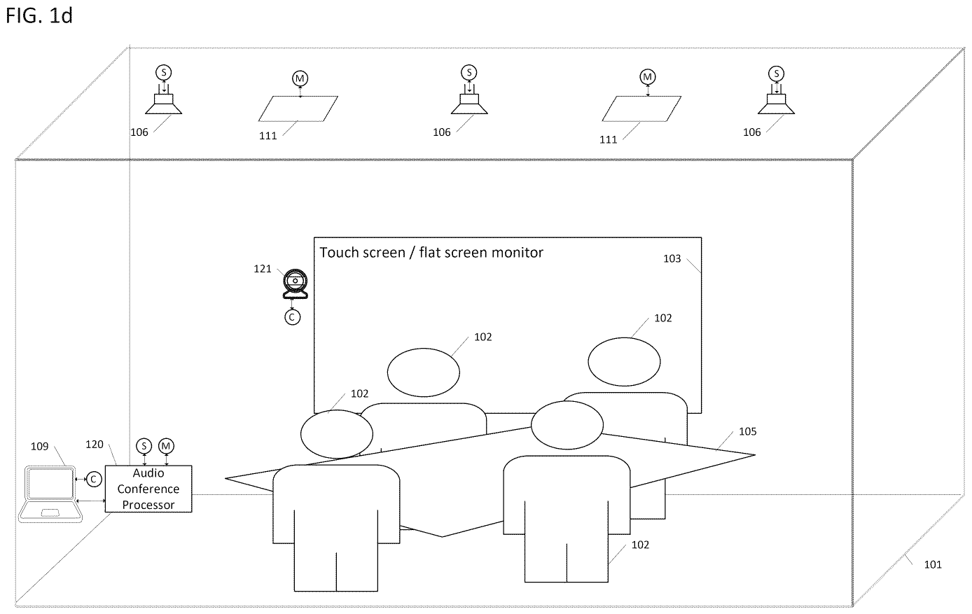

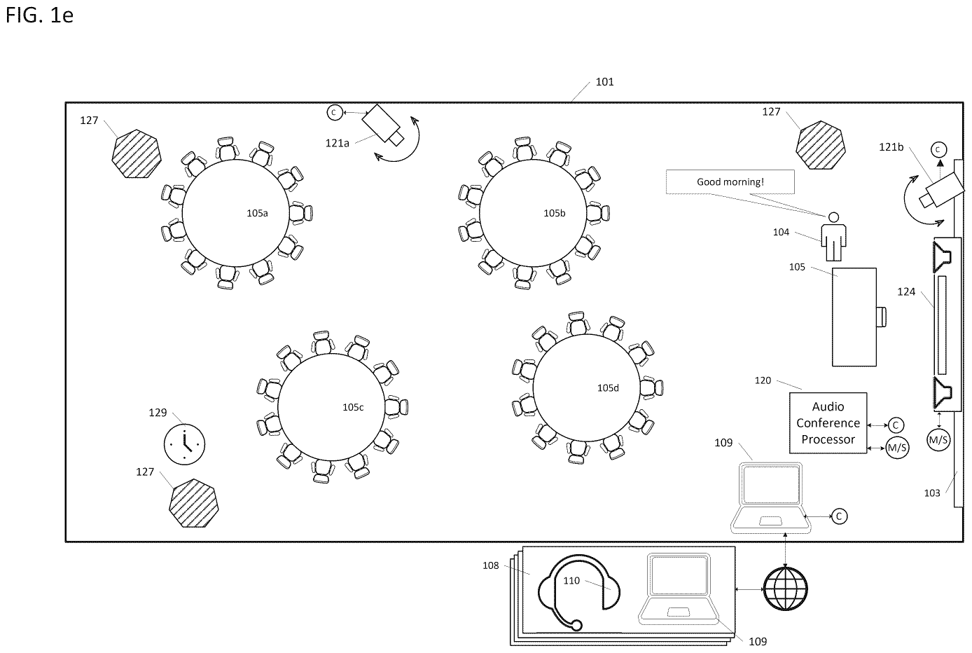

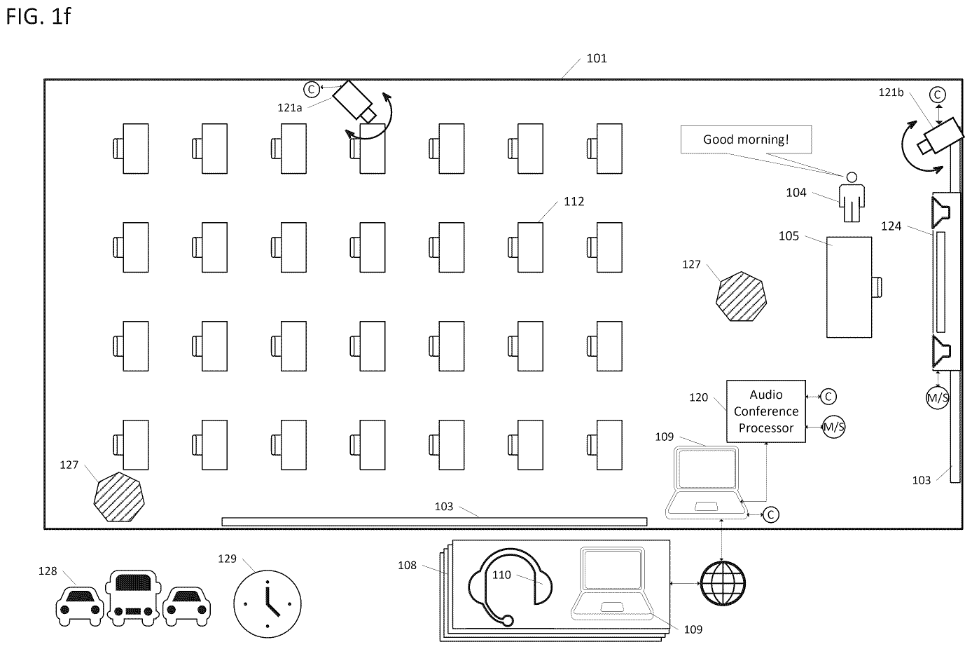

With reference to FIGS. 1a, 1b, 1c, 1d, 1e, 1f shown are illustrations of typical room 101 types such as for example but not limited to conference, presentation, collaboration and a classroom, with various audio equipment form factors that can be used to provide a typical audio conference to connect remote participants 108 and/or a voice lift system within the room 101 in the current art. It should be noted that the remote participant 108 is illustrated in a subset for clarity of the FIGS. 1a, 1b, 1c, 1d, 1e, 1f and should be considered to be within scope of the invention for all room 101 types illustrated. Room audio optimization meaning acoustic room measurements and analysis in the various room types some of which are illustrated in FIGS. 1a, 1b, 1c, 1d, 1e, 1f are often not considered or even realistically possible due to the sheer number of rooms in any one organization, which could measure into the 10 s, 100 s and possibly the 1000 s because the costs to undertake a thorough acoustic study by a acoustician with the appropriate tools becomes cost prohibitive except for the most important rooms in the business. If an acoustic study is completed the information needs to be interpreted by a specialist/installer to try and determine the correct locations to install the audio conference system and its peripherals adding to the cost and workload of an already busy individual who may be a specialist and most likely an IT/IS person, in which case this skill set is typically not their specialty. The IT/IS person does their best to install the conference system usually based on visual cues and the general product recommendations. Room acoustics is a specialized field of expertise, and it is easy to place audio conference peripherals such as microphones and speakers into spots that are poor acoustic choices resulting in a degraded audio conference performance that is sub-optimal. The audio conference system gets the brunt of the blame with excuses such a poor “communication bandwidth” and so on. When the real issue is the room acoustics were not properly understood and accounted for, in conjunction with equipment parameters and requirements. Complexity continues to increase with how the room is being used, which is critical and needs to be considered to ensure the correct audio conference equipment is chosen and is installed in the most appropriate locations in the room. A fully active collaboration space with mobile participants is completely different from a static boardroom scenario. It gets even more complicated when the room is expected to have multiple functions and is divisible for example.

The purpose of the invention is to provide a complete and easy to use solution that an IT/IS or other similar group of people can use to provide an all-in-one solution to measure the room acoustic parameters while using one or more in combination of input parameters if enabled the equipment parameters, room property parameters and the use case parameters which are input and/or measured into the application processor to formulate an 2D and/or 3D spatial acoustic room score map containing location based acoustic room scores as an output to score and understand the room acoustically which can include if enabled and entered the impact on the expected use case and/or the suggested recommendations for the equipment type and placement to optimize the audio performance of the audio equipment in context of the room acoustic properties and use cases. The invention can run standalone and in embedded applications to further expand its capabilities and usefulness to the company, which will be explained in detail later in the specification.

FIG. 1a illustrates a basic audio conference room 101 setup, where a remote participant 108 is communicating with a shared space conference room 101 via headphone (or speaker and microphone) 110 and computer 109. Room, shared space, free space, conference room, presentation room, education space, lecture hall, hybrid space, hybrid room and classroom and 3D space can be construed to mean the same thing and will be used interchangeably throughout the specification. The preferred body of the invention takes room 101 type and the associated parameters as an input through system configuration and/or manually through user input, accounting for a plurality of room 101 types beyond the example types illustrated and should be considered a within the scope of the invention. The purpose of the illustration is to portray a typical audio conference system 120 in the current art with sufficient system complexity that would benefit from an acoustic measurement assessment and recommendations to optimize the in room 101 audio performance, due to one or more of room 101 size, multiple installed microphones 107 and speakers 106, complex noise sources known as undesired sound sources 127 and additional potential acoustical concerns such as time domain properties such as but not limited to high reverberation, echo, overall damped, or undamped responses and frequency and power domain issues such as but not limited to spurious noise and spectral issues that can lead to sub-optimal performance of audio conference and voice lift systems. The cost and complexity of dealing with the above-mentioned acoustic issues and factors can be prohibitive for single use rooms 101 let alone rooms 101 that support various hybrid usage scenarios and/or for companies that need to support and manage numerous rooms 101 in the same building and across many buildings which could be located internationally

For clarity purposes, a single remote user 108 is illustrated. However, it should be noted that there may be a plurality of remote users 108 connected to the conference system 120 which can be located anywhere a communication connection 119 is available. The number of remote users 108 is not germane to the preferred embodiment of the invention and is included for the purpose of illustrating the context of how the audio conference system 120 is intended to be used once it has been installed and operating. The room 101 is configured with examples of, but not limited to, ceiling, and desk mounted microphones 107, 107t and examples of, but not limited to, ceiling and wall mounted speakers 106 which are connected to the audio conference system 120 via standard audio interface connections. In-room participants 102 may be located around a table 105 or moving about the room 101 to interact with various devices such as the touch screen monitor 103 located on the long wall and room computer 109 situated in the room 101. A microphone 107 enabled webcam 121 is located on the wall beside the touch screen 103 aiming towards the in-room participants 102. The microphone 107 enabled web cam 121 is connected to the audio conference system 120 through common industry standard audio/video interfaces. The complete audio conference system 120 as shown is sufficiently complex so that selection of the proper equipment 120 and installation can be difficult to achieve and even more difficult to optimize if the room 101 acoustics are ignored. Equipment 120 selection, placement and configuration should be based on room 101 acoustics to provide the optimum audio microphone 107, 107t pickup and loudspeaker 106 performance for the audio conference system 120. Typically, conference systems 120 are installed and operate independent of any knowledge of their location relative to the acoustics of the room 101 and thus cannot adjust their operating parameters in a predictive and/or intelligent manner. Installers and technicians will locate the microphones 107 and speakers 106 where they may be easy to hook up, install out of sight or where they think it may work and sound best. As installers gain experience, they may become more skilled with regard to their choices however installer to installer inconsistency will still exist. A robust, consistent and high confidence solution for determining the right complement of audio conference system 120 equipment, installation location and configuration for optimized audio performance to benefit the in-room 101 participants 102 and the remote participants 108 remains elusive and difficult to achieve.

Room 101 acoustics can be difficult to predict and usually takes an expert in the field known as an acoustician to understand the complexities of the room 101 acoustics, the measurements and how to interpret and deal with the acoustic issues in the context of the measured room 101. The result of not having the acoustic information and the expert analysis of the room 101 to install the audio conference systems 120 optimally is that most audio conference systems 120 attempt to compensate for poor room 101 acoustics and equipment installation in a reactive manner through post processing algorithms and adaptive microphone 107, 107t pickup techniques. As such the audio conference system 120 performance is negatively impacted in ways that result in poor in-room 101 participant 102 audio pickup and streamed audio quality to the remote participant 108 due to the misunderstood room 101 acoustic issues that were not handled in a productive manner during the equipment selection, install and post-install phases. To further complicate matters, the size, shape, construction materials and the usage scenario of the room 101 dictates situations in which audio conference equipment 120, microphones 107 and speakers 106 can or cannot be installed in the room 101 and compromises must be made. To further complicate the system 120 installation, as room 101 size increases, the room acoustic issues can become unpredictable and difficult to manage around. With an increase in room 101 size an increase in the number of speakers 106 and microphones 107 is required to ensure adequate participant 102 audio pickup and even sound coverage throughout the room 101 thus increasing the complexity of the installation, setup, and calibration of the audio conference system 120. The number of audio peripherals speakers 106 and microphones 107 required is dictated by the size and/or shape of the room 101, specific layout requirements of the room 101 and becomes even more complicated to support single, hybrid usage and/or divisible rooms 101. Trying to optimize all speakers 106 and specifically the microphones 107 for all potential room scenarios can be problematic and difficult to achieve, especially without an in depth acoustic analysis to outline the room 101 acoustic properties.

FIG. 1b illustrates an audio conference peripheral variant known as a microphone array 125 and speaker 106 bar (M/S bar) combination unit 124. M/S bar 124 systems can be contained in numerous product enclosure formats that support integration into the same device such as tabletop devices and/or wall mounted enclosures or any combination thereof and is considered within the scope of this disclosure, as illustrated in FIG. 1b. It is common for M/S bars 124 to contain multiple microphone 107 elements in what is known as a microphone array 125. A microphone array 125 is a method of organizing more than one microphone 107 into an array 125 of microphones 107 which consists of two or more and most likely five (5) or more physical microphones 107 grouped together to form a microphone array 125 element in the same enclosure 124. The microphone array 125 acts like a single microphone 107 but typically has more gain, wider coverage, fixed or configurable directional coverage patterns to optimize audio pickup in the room 101. It should be noted that a microphone array 125 is not limited to a single enclosure and can be formed out of separate enclosures that are combined into a single combined array 125. M/S bars 124 may be similar or can require more consideration depending on the array 125 and speaker 106 topology utilized than standalone microphone 107 and speaker 106 systems for selection, installation and configuration and thus they also benefit from a proper room 101 acoustic study for optimum selection, placement and configuration.

FIG. 1c illustrates a room 101 requiring the use of two M/S bars 124 units mounted on separate walls which would be considered supported and in scope of a preferred embodiment of the invention. The location of the bar units 124 for example may be mounted on the ceiling, same wall, opposite walls or ninety degrees (orthogonal) to each other as illustrated. Both M/S bars 124 contain microphone arrays 125 with their own unique and independent coverage patterns. If the room 101 requirements are sufficiently large, any number of M/S bars 124 can be mounted to meet the room 101 coverage needs and is only limited by the specific audio conference system 120 limitations for scalability. Selection and installation locations become increasingly critical as more audio equipment 120 is required and added to room 101 as the equipment 120 can be pushed to work in more extreme environments 101 and at the edge of performance capabilities as companies try to minimize equipment 120 to control costs and complexity thus requiring expert knowledge across acoustics and equipment disciplines.

FIG. 1d illustrates the use of two microphone beamforming arrays 111 and three speaker 106 units mounted on the ceiling which would be considered supported and in scope of a preferred embodiment of the invention. It is becoming clear that accounting for the diverse number of device topologies, form factors and performance capability options can be challenging, even for a well experienced installer to manage the pure manual process and the numerous device properties especially in the context of room 101 acoustics and room 101 usage scenarios.

FIG. 1e extends the room types to show a presentation/collaboration room 101 which could be considered a hybrid room 101 variant and would be considered supported and in scope of a preferred embodiment of the invention. Tables 105a, 105b, 105c, and 105d are distributed throughout the room 101. Shown are three undesired internal noise sources 127, such as HVAC vents, distributed around the room 101 that are active periodically and for ad hoc periods of time 129 during the day. As undesired internal noise sources 127 activate, they degrade the acoustic room 101 properties by increasing background noise in those locations and potentially for the overall room 101. Installers can locate certain internal noise sources 127 by the location of the physical vents and accordingly adjust the audio system 120 peripheral installation locations, however without measuring the internal noise sources 127, ex. HVAC acoustic properties the installer may underestimate their negative contribution and make poor choices for room 101 location and configuration of the audio conference system 120 peripherals. It is therefore important to understand the complete room 101 acoustic picture and profile even in the frequency dimension to make the best choices for audio conference equipment 120 selection, installation and configuration. The way the room 101 is used and setup can alter the location, calibration and configuration requirements of the audio conference system 120 and peripherals significantly. This can lead to installers specializing in one type of room 101 such a boardrooms, or presentation spaces or class rooms which can be very costly to maintain or potentially even more detrimental is installers that generalize across multiple room types and by default setup up lower performance systems that kind of work are constantly requiring technician support and do not meet the expectations of the customer for the highest quality room 101 audio for all rooms 101 in the business. It would be more beneficial to have an automated measurement and recommendation process and application with the built in capabilities to account for room type, acoustics, room usage and equipment types to manage best equipment type and placement recommendations than would otherwise be possible.

FIG. 1f illustrates a classroom room 101 type with the addition of an external noise source 128 which can be traffic patterns, landing patterns of airplanes and other on schedule 129 external noise sources. With a manual acoustic analysis process, such as when an acoustic specialist measures a room 101 at a random time of day 129 it can be difficult to capture all of the acoustic properties and influences that a room 101 can have. As a result, depending on the external noise source 128 an incomplete acoustic analysis can lead to insufficient recommendations for room 101 treatment and equipment 120 setup and configuration. By being able to capture all undesired sound sources internal noise sources 127, external noise sources 128 to fully understand the complete room 101 acoustics analysis and their influences is an important factor in establishing an overall room measurement and quality performance metric map.

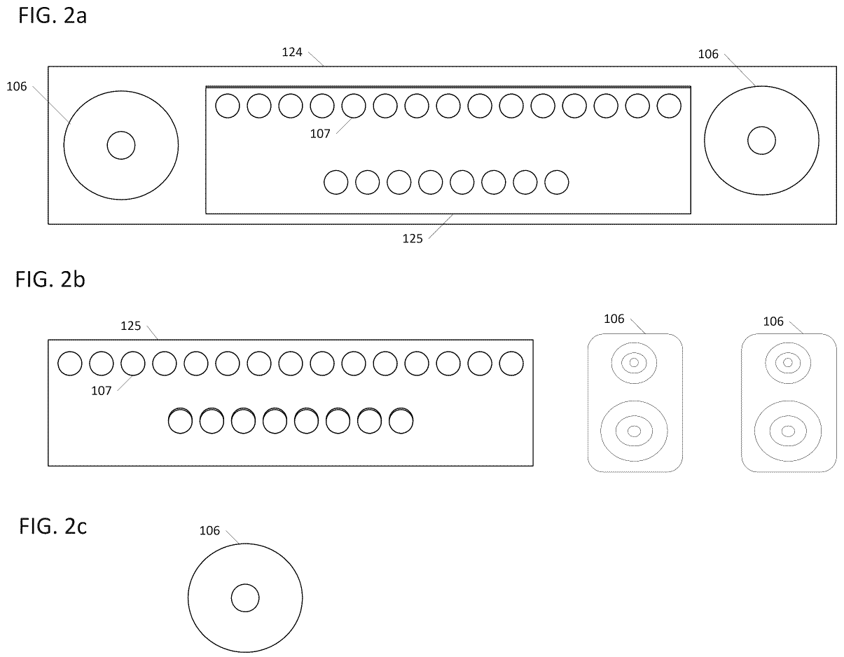

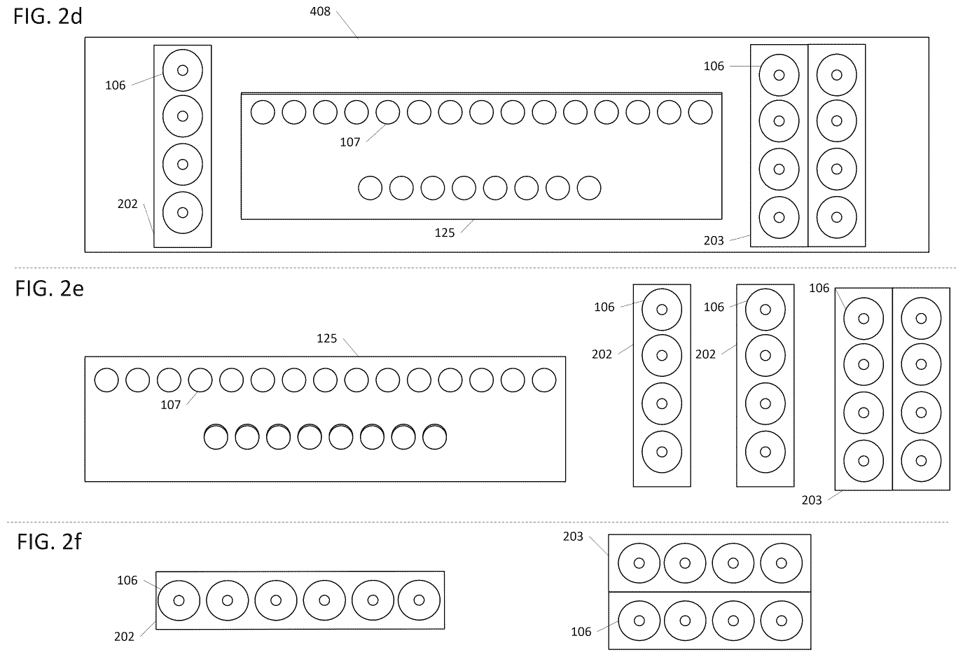

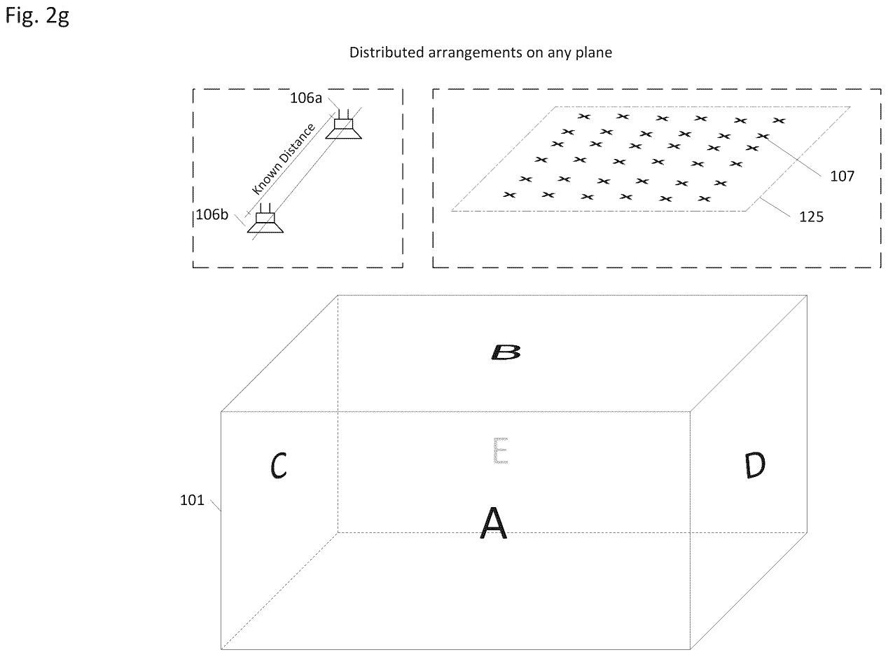

With reference to FIGS. 2a, 2b, 2c, 2d, 2e and 2f contains representative examples, but not an exhaustive list, of microphone array and microphone speaker bar and separate speaker combinations and layouts supported in a preferred embodiment of the invention

FIG. 2a illustrates a M/S bar 124 combination that contains a microphone array 125 that consists of one or more microphone elements 107. The exact layout and number of the microphone elements 107 are not germane to the invention. Any number of and arrangements of microphone elements 107 is supported and within scope of the invention. Also shown is that the M/S bar 124 contains two separate speaker elements 106 which forms a complete M/S bar 124 unit. As per the microphone array 125 the number and arrangement of the speakers 106 is not germane to the invention and any number of and arrangement of the speaker elements 106 are supported and considered within scope of the invention.

FIG. 2b illustrates a microphone array 125 and speakers 106 as separate and distinct elements which are not combined into a combination M/S bar 124 unit. The number and arrangement microphone arrays 125 and speakers 106 is not germane to the invention and any number of and arrangement the individual microphone arrays 125 and speakers 106 are supported and considered within scope of the invention.

FIG. 2c illustrates the support of an individual speaker 106 or any number of individual speakers 106 without an associated microphone array 125 and is supported as a separate element within context of the invention.

FIGS. 2d, 2e and 2f illustrate the incorporation of speaker arrays into the various combination of supported arrangements in the context of the invention. FIG. 2d illustrates a combination of a linear speaker array 202 and a speaker matrix array 203. Speaker linear array 202, speaker matrix array 203 are known in the art and the structure and arrangement is not pertinent to the invention other than to say both speaker linear array 202 and speaker matrix array 203 are supported within the context of the invention and combination microphone array 125 and speaker linear array 202, speaker matrix array 203 bars microphone array and speaker array bar 408 are supported. FIG. 2e illustrates a separate microphone array 125 and speaker linear array 202, speaker matrix array 203 bars arrangement that is not combined into a microphone array and speaker array bar 408. FIG. 2f extends the arrangements shown separate speaker linear array 202, speaker matrix array 203 bars as standalone units. As previously stated one or more of each element type speaker linear array 202, speaker matrix array 203, microphone array and speaker array bar 408, microphone array 125 is supported and within the scope of the invention.

FIG. 2g extends the microphone array 125 and speakers 106 to a form factor that is not constrained to a specific enclosure type and can be dispersed as individual microphone elements 107, speakers 106 made up of microphone elements 107 and speaker elements 106a and 106b. The ad-hoc and/or structured placement of the microphones 107 may be used as discrete microphones 107 or combined into a microphone array 125 and/or be combined into a combination of discrete microphone elements 107 and microphone arrays 125. The placement of the individual microphone elements 107 and speaker elements 106a and 106b is not constrained to a single plane and can be installed (mounted) on any wall or ceiling plane as indicated by A, B, C, D, and E in the room 101 and be construed to be within scope of the invention.

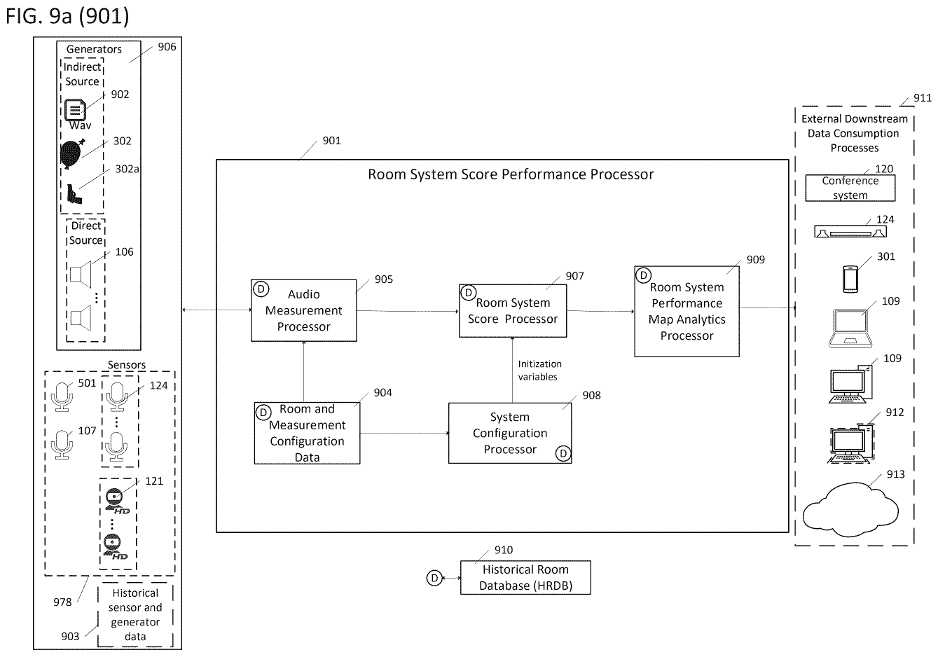

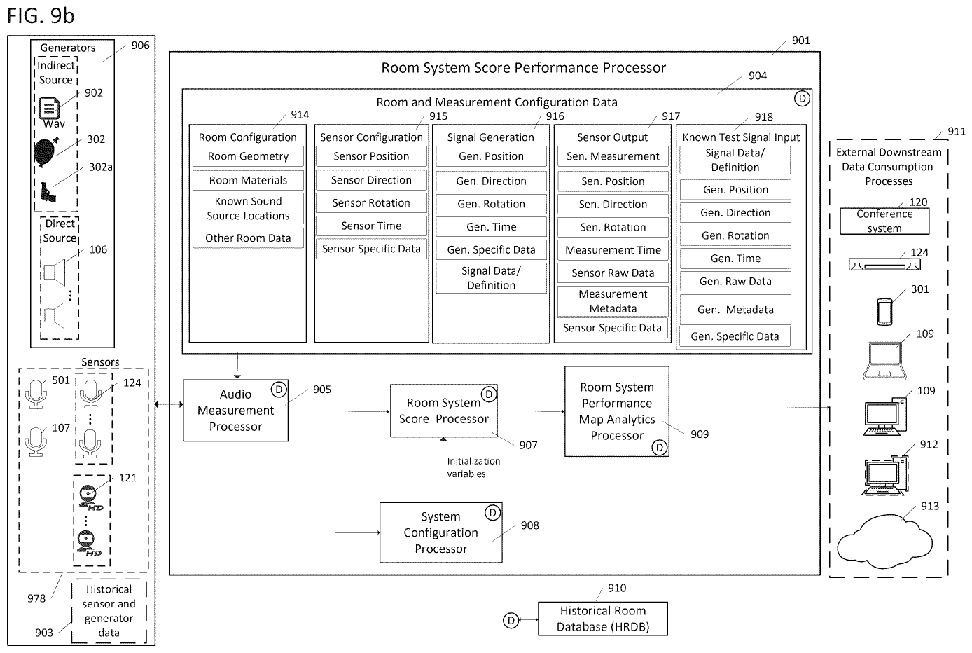

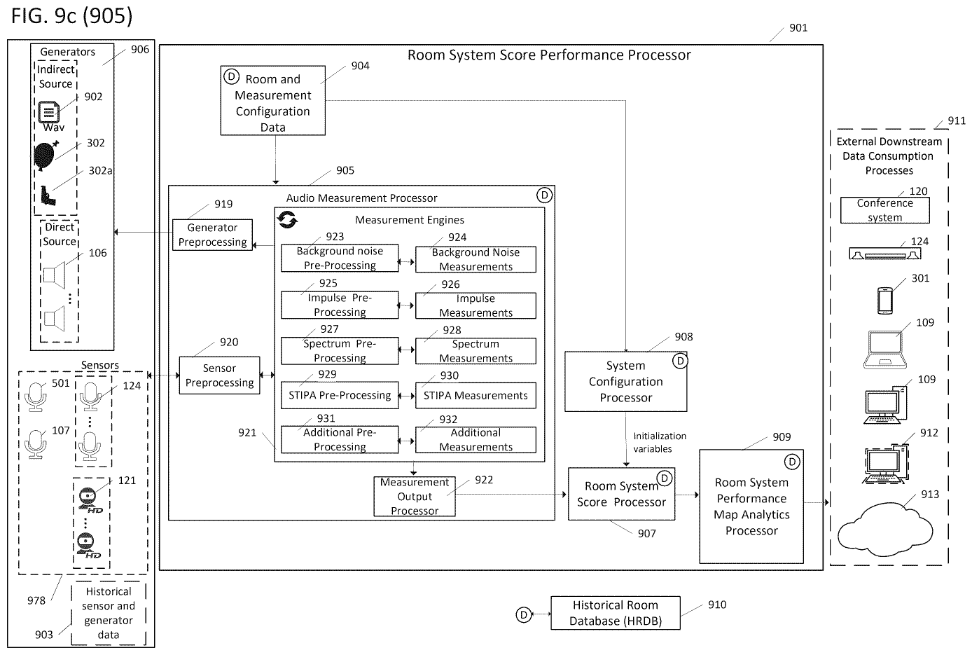

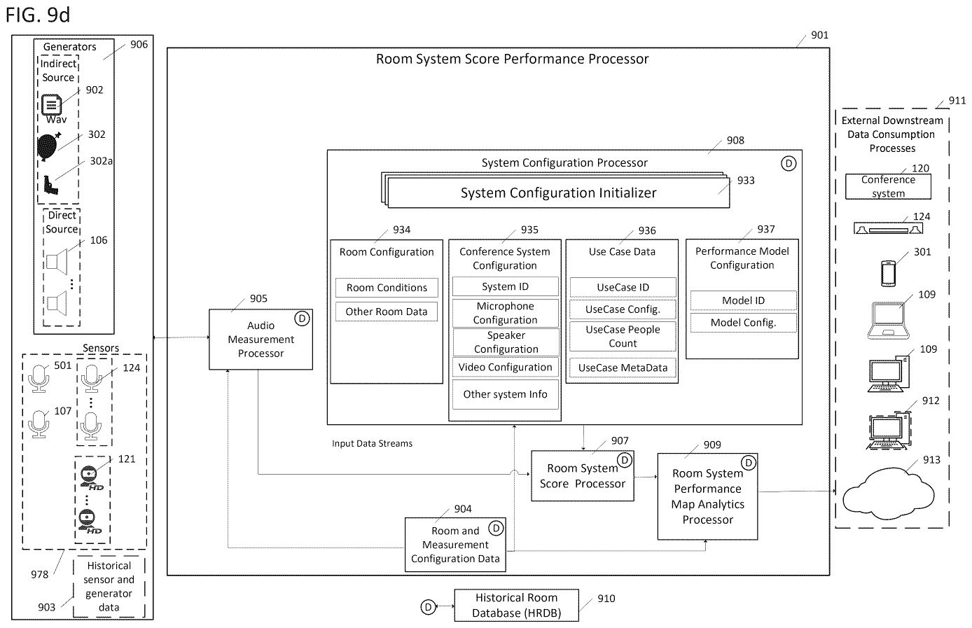

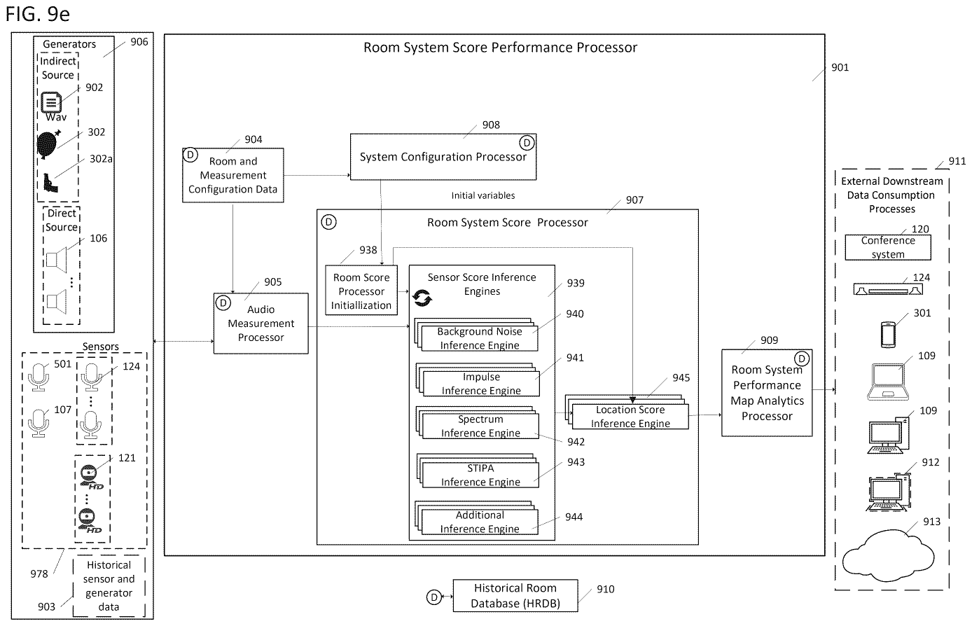

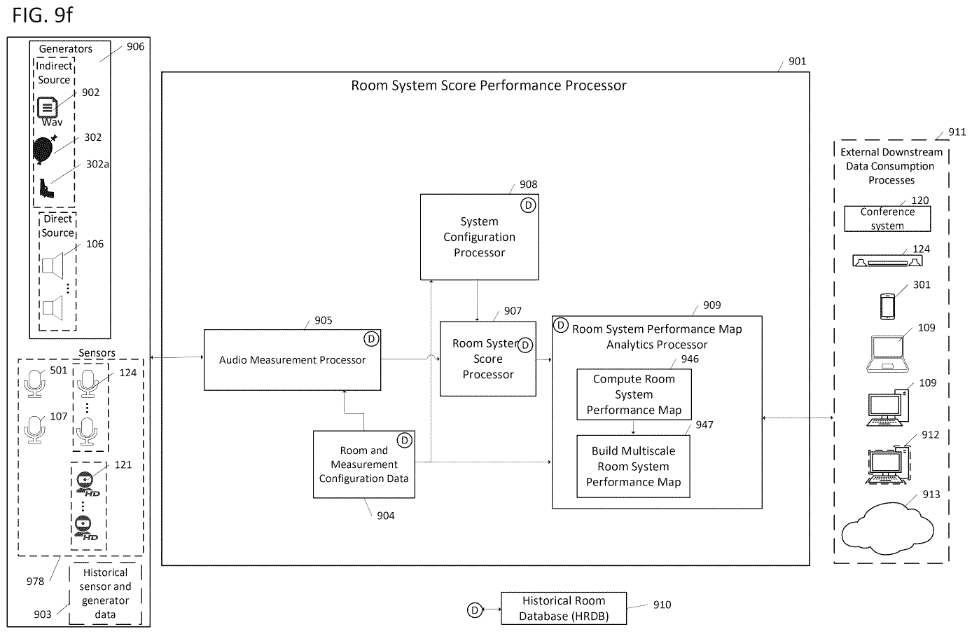

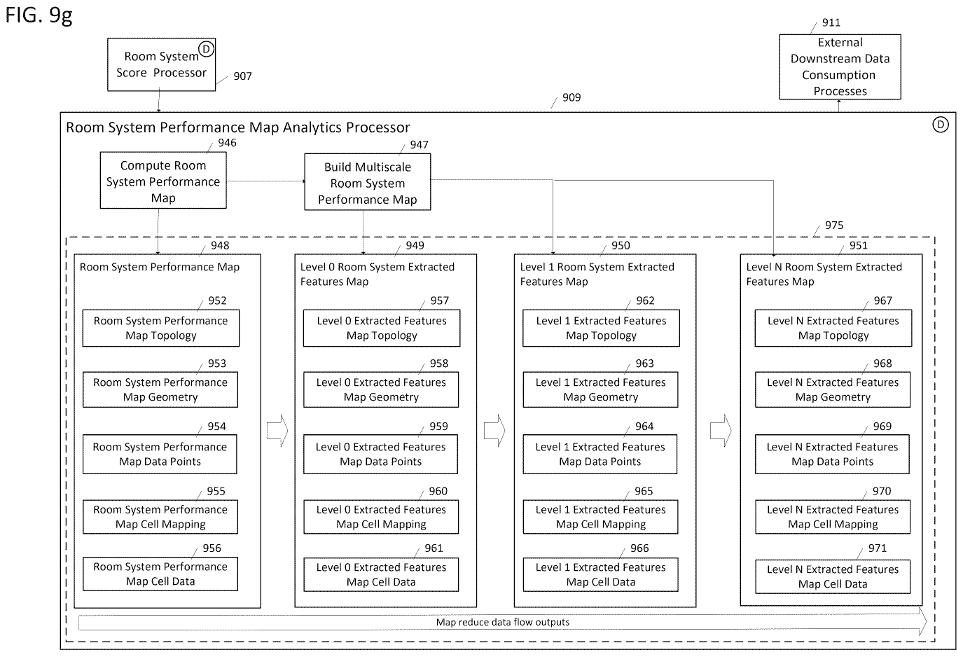

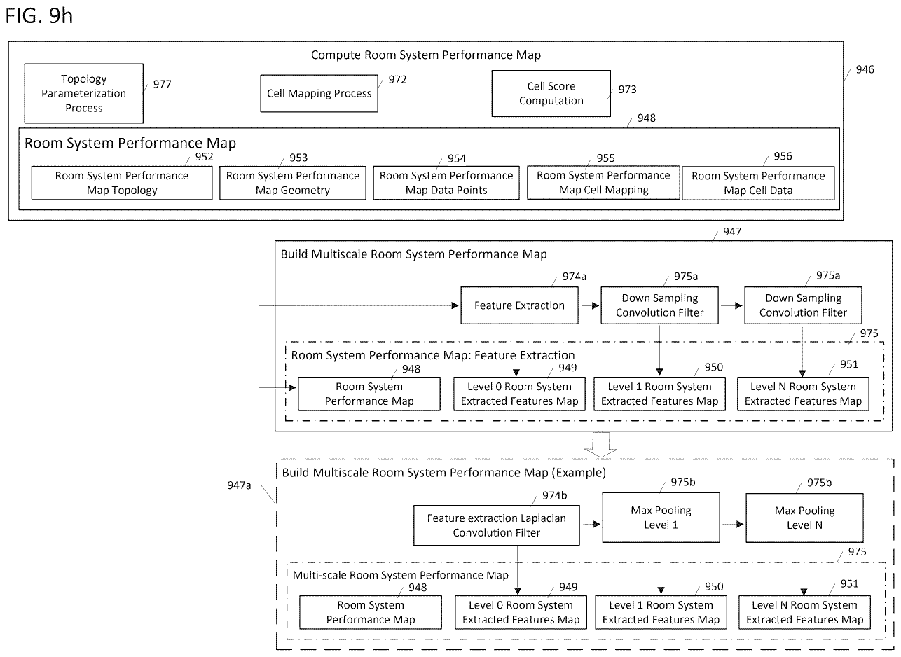

The intent is to illustrate that the exact arrangement of and number of the elements is not important as each arrangement can be characterized and modeled to be used later by the Room System Score Performance Processor 901 (FIG. 9a), to form an overall system score. Thus, the arrangement is a set of configuration parameters 935 (FIG. 9d) forming a model to be used by a preferred embodiment of the invention.

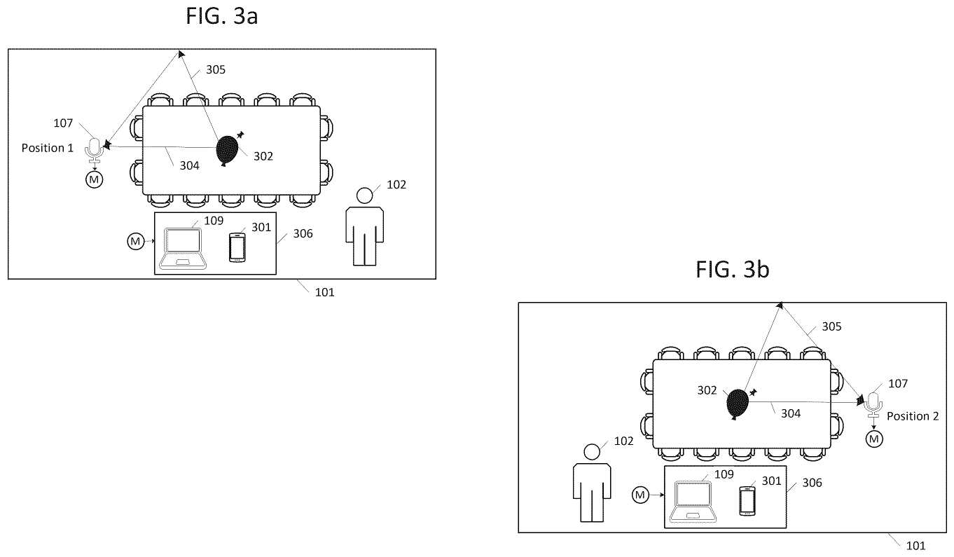

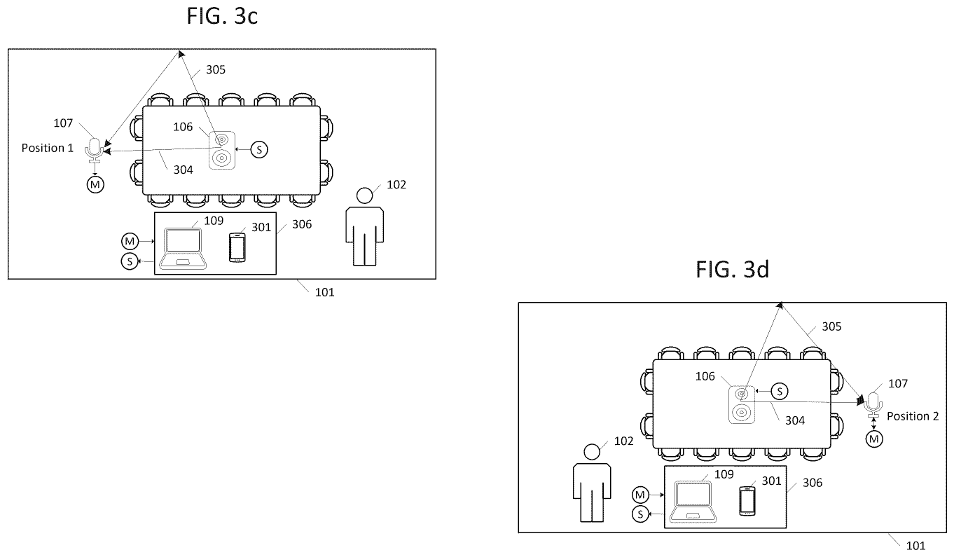

With reference to FIGS. 3a, 3b, 3c and 3d are illustrations of in-room acoustic measurement techniques and typical outputs that can be used by a preferred embodiment of the invention. The acoustic measurements are well known in the industry and are often performed by standalone specialized measurement equipment by an acoustician. A subset of measurement types is shown for illustration, and it should be construed that a full suite of acoustic measurements can be included and utilized and be considered within scope of the invention.

FIG. 3a Illustrates an indirect measurement technique where an sound source such as a ballon pop 302 is used to generate an impulse signal that is picked up by the measurement microphone 107 “Position 1” which captures direct reference signal 304 and reflected signals 305 and is connected to a measurement system 306 consisting of for example but not limited to a standalone device such as a smart phone 301 or other specialized hand held measurement device, not illustrated, or a computer 109 which hosts and runs specialized acoustic measurement software that derives acoustic measurements to be displayed to the technician 102. This technique is referred to as an indirect measurement approach because the measurement software has no reference signal (internally self-generated known signal with specific statistical properties) to compare against during the measurement and instead uses external sourced signal generator (balloon) 302 that is capable of generating an appropriate signal type (impulse signal) that can be used by the acoustic measurement software to derive acoustic measurements. Measurement approaches of this type are convenient and simple to execute; however, they do have the drawback of potentially not having enough dynamic range in the measurement to make the necessary and accurate measurement.

FIG. 3b illustrates the same measurement taken at a second location 107 “Position 2”. It is good practice to take the measurements at multiple room 101 locations to formulate a comprehensive overall room 101 and location-based acoustic measurement analysis.

FIG. 3c Illustrates a direct measurement technique where a sound source such as a speaker 106 is used to generate an impulse signal that is picked up by the microphone 107 “Position 1” which are both connected to a measurement system 306 consisting of for example but not limited to a standalone device such as a smart phone 301 or other specialized hand held measurement device, not illustrated, or a computer 109 which hosts and runs specialized acoustic measurement software that derives acoustic measurements to be displayed to the technician 102. This technique is referred to as a direct measurement technique because the measurement software generates a known reference signal (internally self-generated known signal with specific statistical properties) to compare against the received measurement microphone 107 signal that is used by the acoustic measurement software to derive acoustic measurements and parameters. Measurement approaches of this type are convenient and more complex to execute; however, they do have the benefit of potentially having more dynamic range (higher signal to noise characteristics) in the measurement to make the necessary and accurate measurements.

FIG. 3d illustrates the same measurement taken at a second location 107 “Position 2”. It is good practice to take the measurements at multiple room 101 locations to formulate a comprehensive overall room 101 and location-based acoustic measurement analysis.

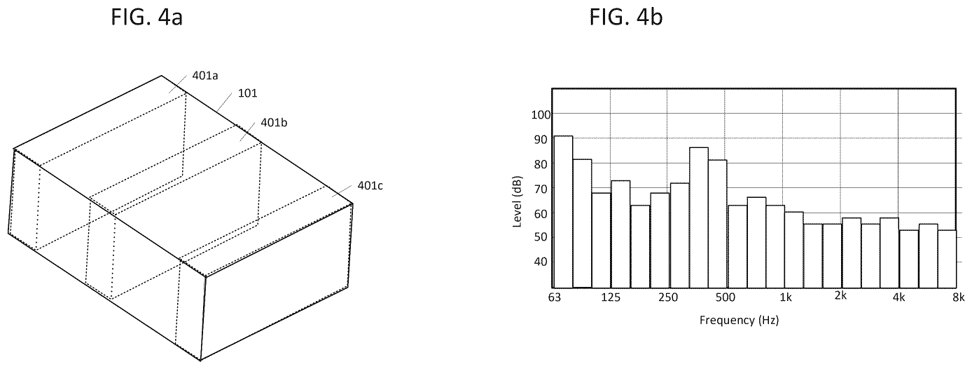

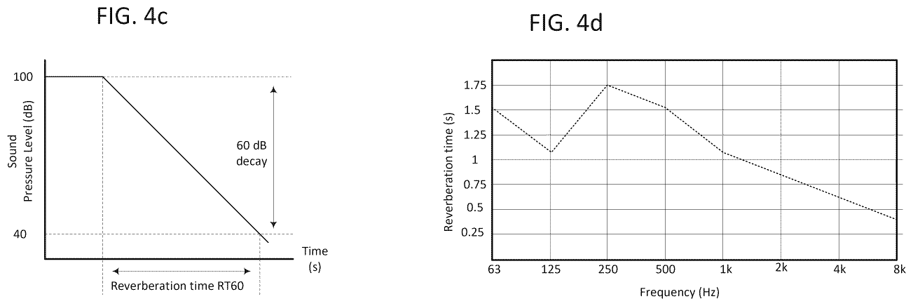

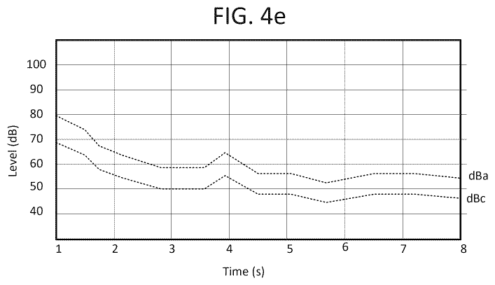

With reference to FIGS. 4a, 4b, 4c 4d and 4e illustrated are some of the common industry acoustic room 101 properties that can be measured and characterized forming a suite of measurements to characterize a room 101 acoustically. This is by no means an exhaustive list of measurements supported by a preferred embodiment of the invention.

FIG. 4a illustrates a simple output of a room modal analysis with three room modes 401a, 401b and 401c. Only one mode is shown for one room 101 dimension for clarity. A full analysis would show room modes for all three-room dimensions, length, width and height. Room 101 modes are well understood in the current art, so a detailed description is not required. Understanding and grading a room's 101 room modes 401a, 401b and 401c is important for speaker 106 systems that play frequencies typically below 200 hz, the Schroeder frequency of the room 101 and less. Once the room 101 modes such as 401a, 401b and 401c are identified through calculation and measurement and then the optimum placement of speakers 106 can be recommend, especially for subwoofer 106 applications if the system contains the speaker 106 types in the set of system configuration parameters 935 (FIG. 9d). Subwoofer 106 placement is critical to have a proper tonal and frequency balance in the room 101 and thus knowing proper locations in the room 101 is very important for optimum audio quality from the systems speaker 106 systems. Improper placement can mean the subwoofer is heard too loud or almost not at all resulting in uneven room 101 audio level balance.

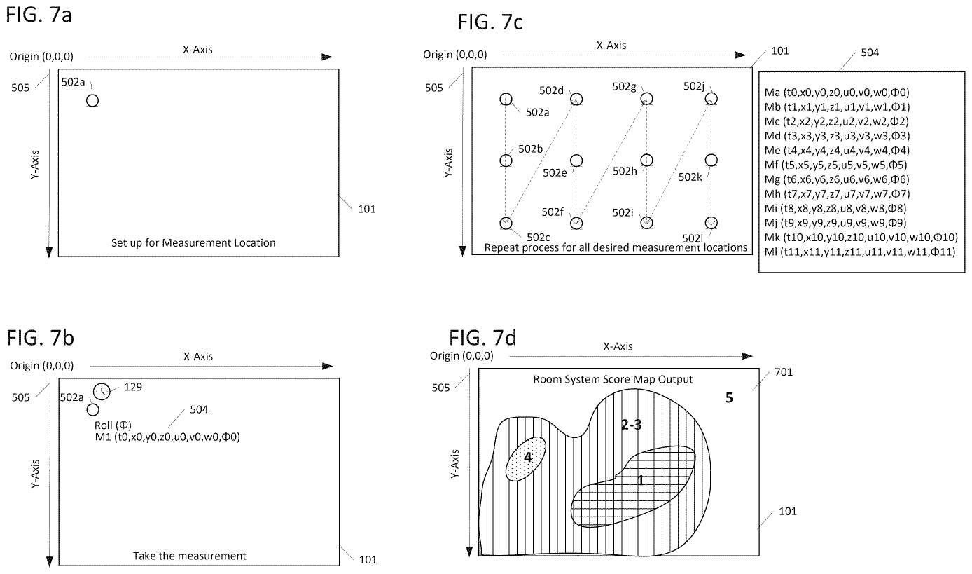

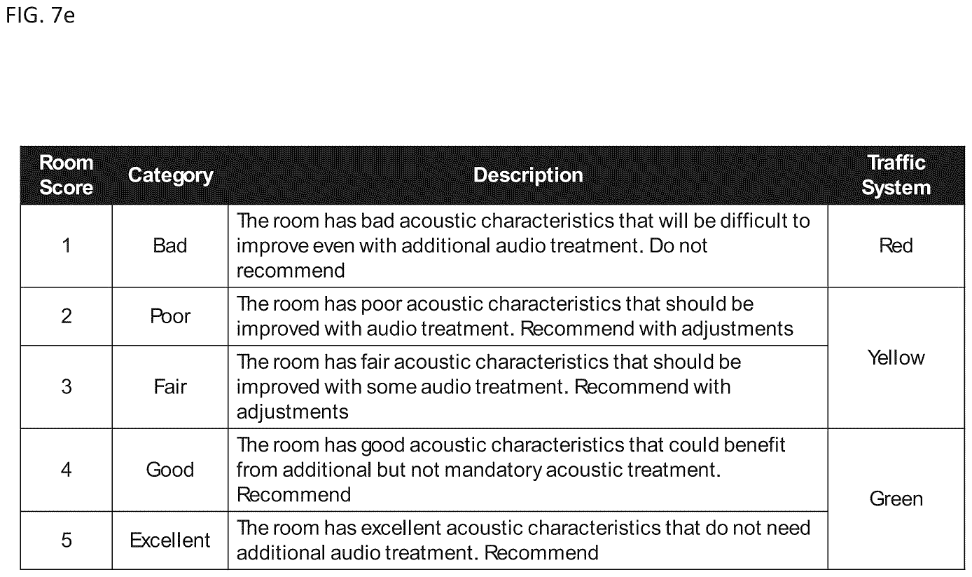

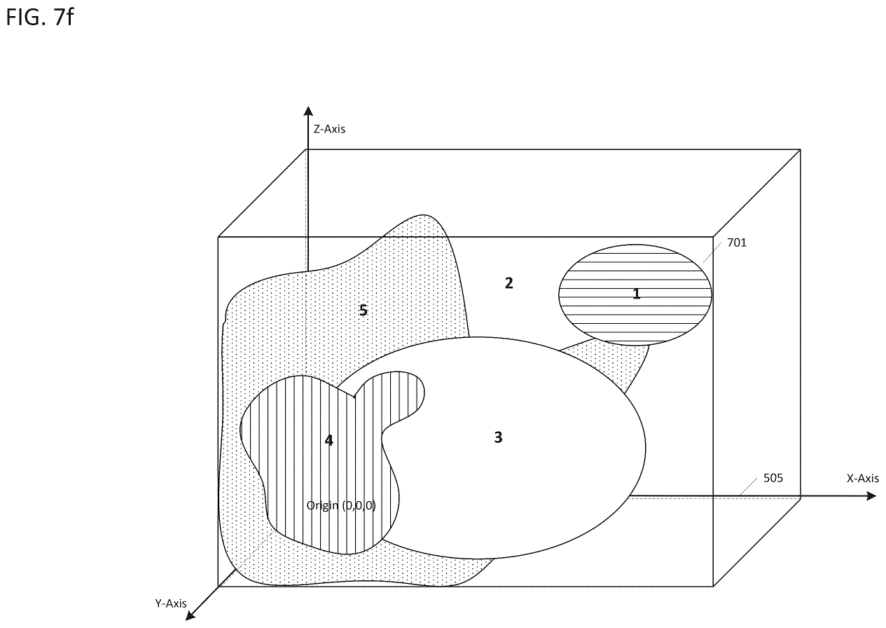

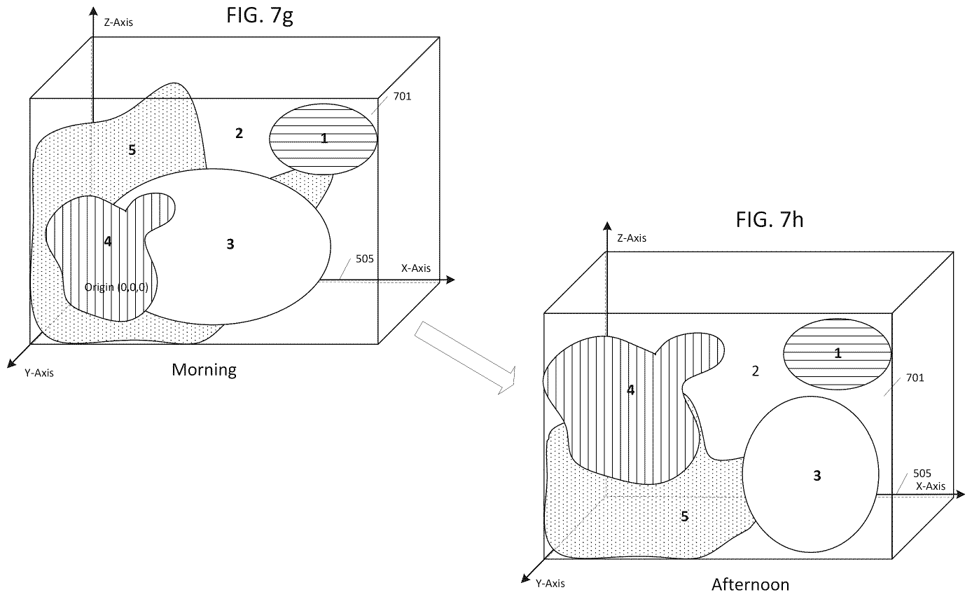

FIG. 4b extends the high-level description to include spectrum measurements. Spectrum measurements can be used for threshold monitoring, alarming, peak frequency detection and numerous other measurements. Once a spectrum measurement is captured acoustic and audio analyses can be done and passed onto further processors for grading. The specific spectrum analysis technique is not important as each method can be characterized and have measurement outputs that are suitable for future processing and analysis. For example but not limited to are spectrum measurements that show specific frequencies above a tolerable and configurable threshold which can be identified and passed on to the Room System Score Processor 907 (FIG. 9e) for use in the scoring inference engines. HVAC and/or Fans 127 that are noisy, will show up and result in a degradation of the Room System Performance Location Score (FIG. 7d) for that location in the room 101 as the measurement was taken at a specific location.

FIGS. 4c and 4d illustrate time domain impulse measurements that are used for but not limited to reverb RT-60 and variants, echo measurements and early reflection analysis. The outcome as per the spectrum FIG. 4b and room 101 modal FIG. 4a measurements and analysis can be formatted into a set of measured results that can then be used by the Room System Score Processor 907 FIG. 9e for the combined analysis and grading of the complete system.

FIG. 4e extends the measurement example type to background noise which can have weights applied such as but not limited to dB (A) and/or dB (C) weightings across various time measurement windows. The output of the measurement is used in the downstream analysis and scoring processor, the Room System Score Processor 907 (FIG. 9e).

The measurement examples illustrated in FIGS. 4a, 4b, 4c, 4d and 4e are used to collect acoustic data about the room 101, the conference system 120, and noise sources both internal 127 and external 128 to the room 101. STIPA (Speech Transmission Intelligence public address) standard type of measurement, (not shown) can also be supported with the appropriate measurement modules incorporated in the Room System Score Processor 907 (FIG. 9e). All the above mentioned measurement approaches are integrated into the Room System Score Processor 907 for further analysis and scoring. Details of the exact measurement types and techniques are known in the current art and can be incorporated into the preferred embodiment of the invention through normal open source and licensed code modules through 3^{rd} party sources as needed. Any number of acoustic measurements can be incorporated and encapsulated and be construed to be in scope of the preferred embodiment of the invention.

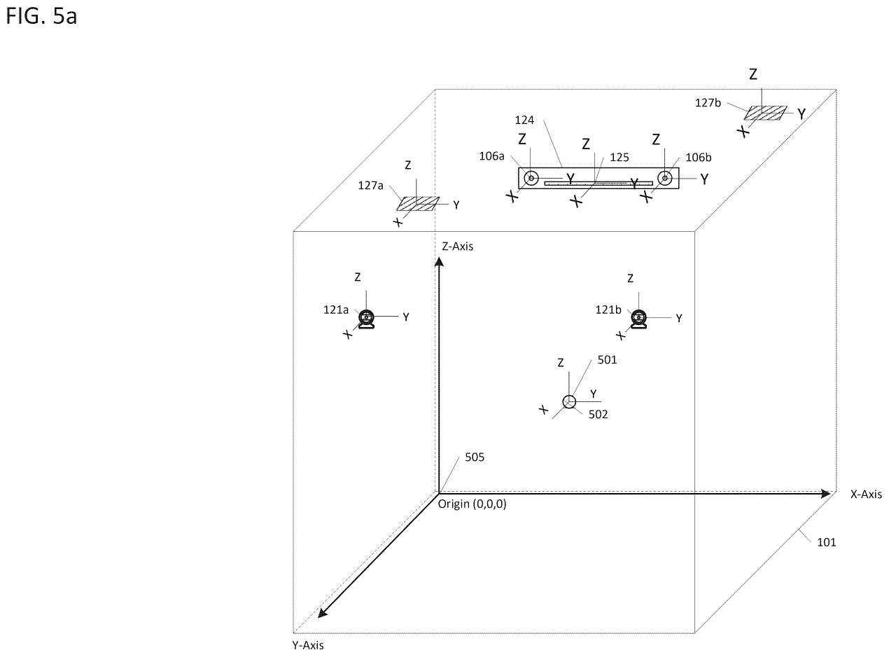

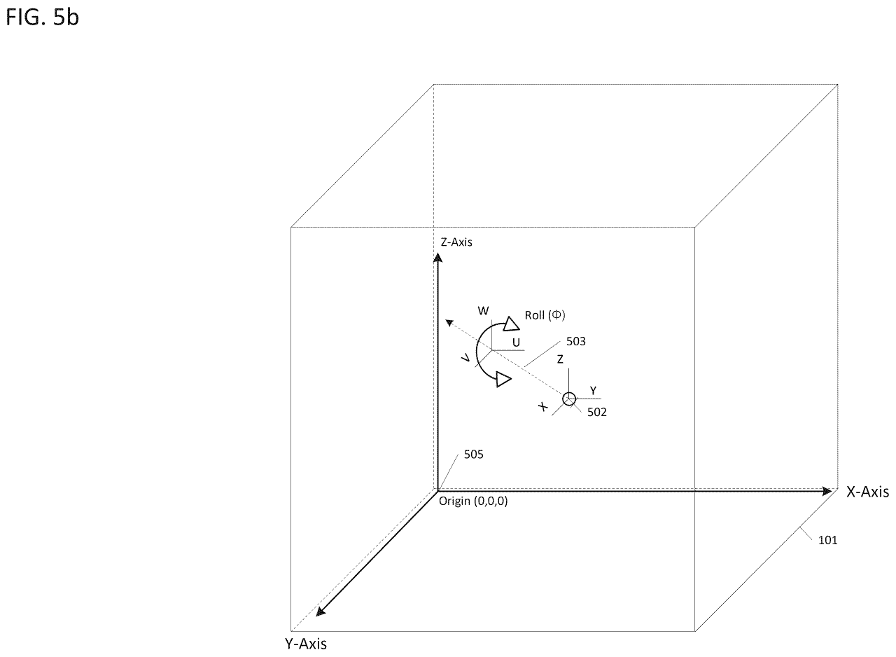

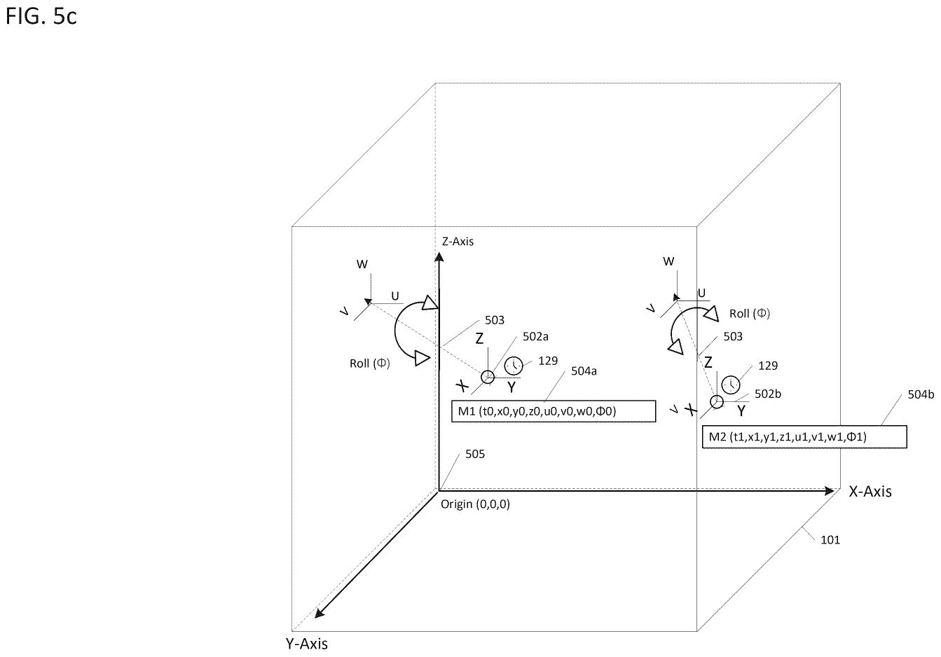

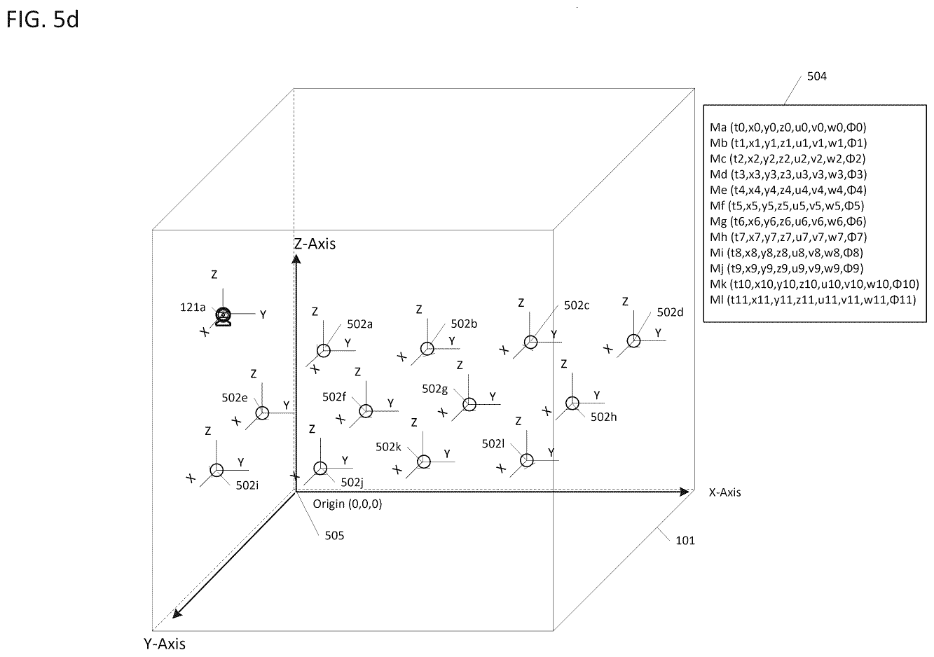

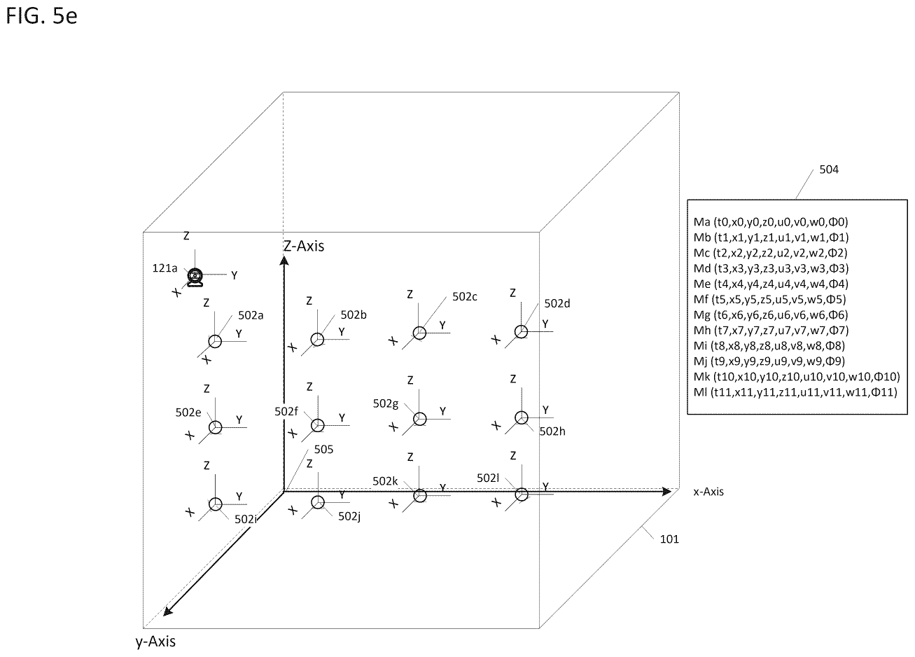

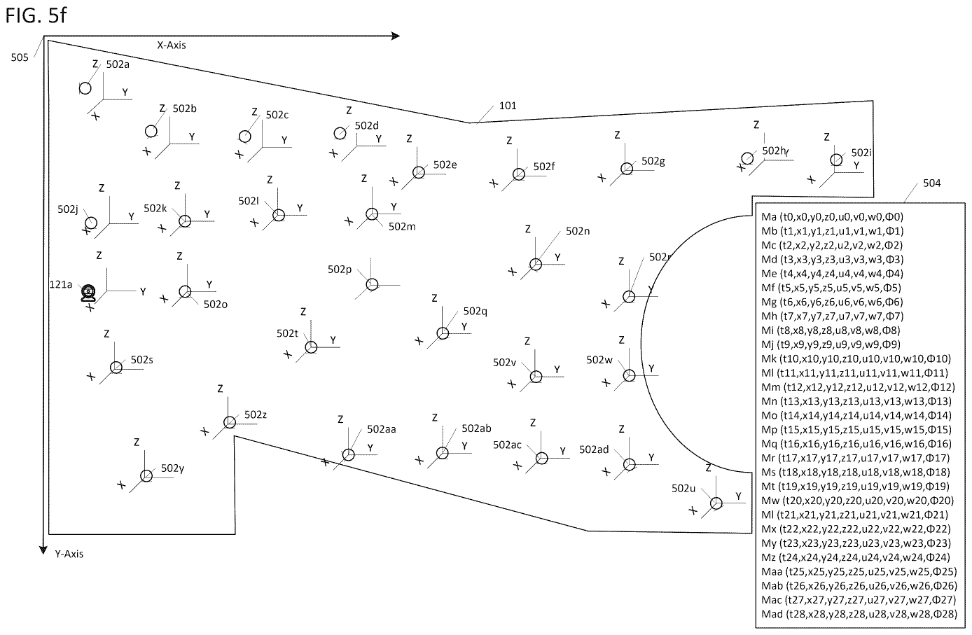

With reference to FIGS. 5a, 5b, 5c, 5d, 5e and 5f are illustrative examples of the room 101 geometry and measurement location (coordinate structure and orientation) and time 129 vector used by the preferred body of the invention referred to as the Coordinate Reference Frame 505. As illustrated, the Coordinate Reference Frame 505 is a cartesian coordinate frame, but it should be noted that other coordinate frames, such spherical coordinates, topocentric coordinates are also accommodated. It is important to configure and maintain a proper coordinate (x, y, z) reference framework 505 for the room 101. An origin (0,0,0) is established and all equipment 121a and 121b and 124 installations, if known, and undesired internal noise sources 127a and 127b and measurement locations 502 are captured through configuration and/or onsite measurement to then be used in the downstream processes as discussed later in the specification. By establishing a reference grid framework referred to as the Coordinate Reference Frame 505 all data can then be analyzed and referenced in a 3D map as illustrated in Room System Score Spatial Map 701 (FIG. 7f) for display and further processing by other applications and devices 911 (FIG. 9a). By establishing and maintaining a Coordinate Reference Frame 505 all measurements can be repeated and the impacts on the room equipment cameras 121a and 121b and M/S bar 124 can be analyzed and predicted which would be very hard to do in disparate processes that do not work with a Coordinate Reference Frame 505.

FIG. 5a illustrates a room 101 with two undesired internal noise sources at 127a and 127b which are noted to be at specific locations (x, y, z) in the room 101 within the Coordinate Reference Frame 505. It should be noted that the origin (0,0,0) is located in the bottom left-hand corner of the room 101 but could be established at any location that makes sense for the room 101 and system 120 equipment. The origin location is a choice made at the time of system setup and configuration and preferably should be maintained as a standard throughout the room 101 and the application into other rooms 101 into the historical database 910 (FIG. 9a). Two cameras 121a, 121b are shown for illustration at two locations (x, y, z) which are also recorded into the Coordinate Reference Frame 505. A single M/S bar 124 with a microphone array 125 and speakers 106a, 106b are noted and represented within the Coordinate Reference Frame 505 with specific coordinates (x, y, z). This is important as the location of all the devices web cameras 121a and 121b and M/S bar 124 and undesired noise sources 127a and 127b will be used to inform the scoring process (FIGS. 7a, 7b, 7c, 7d, 7e and 7f) as the location of the devices 121a, 121b, 124 in combination with the room 101 acoustics measurements FIGS. 4a, 4b, 4c, 4d, and 4e and the device types and installed numbers are all used to derive the room system score spatial map 701 (FIG. 7f). All measurements data structures 504 locations 502 are represented within the Coordinate Reference Frame 505 which are captured by a measurement microphone 501. The term acoustic measurement, measurement and measurement data, measurement data structure implies the obtaining of the acoustic measurement and the collection of data and storing into a measurement data structure 504 and can be used interchangeably with this understanding throughout the specification. The measurement data structure 504 contains the measurement data and the reference coordinate information location 502 and rotation 503 and time (t) 129 associated with the measurement. The measurement locations 502 may be preconfigured and prescribed and/or done in an ad-hoc manner or in a combination of both. It is important that the measurement location 502 is recorded and maintained as part of the measurement process for each measurement undertaken in the room 101.

With reference to FIG. 5b the Coordinate Reference Frame 505 is extended to capture the direction and rotation (roll (φ)) 503 of the measurement microphone 501, or other such measurement sensors 501 at each measurement location 502. The rotation (roll, φ) 503 refers to the angle at which a given measurement microphone 501 is rotated along the resultant three-dimensional vector of its direction (defined by u, v, and w), within the Coordinate Reference Frame 505. This extends the meta and parameter data set of the measurement for completeness and further analysis. Certain measurement sensor 501 may be directional in nature and it is important to capture this information to have a complete understanding of the measurement data 504.

FIG. 5c illustrates two measurement locations 502a and 502b within the Coordinate Reference Frame 505 and measurement data structures 504a and 504b respectively. It should be noted that a time 129 data point has been added to the Coordinate Reference Frame 505 as the measurement data structure 504 have a temporal dimension 129 for single point measurements and for repeated measurement data structure 504 at the same location over different time periods such as for example but not limited to minutes, hours, weeks, month or years. The temporal dimension 129 is common in data collection and analysis. Measurement location 502a is captured in the following measurement data structure format M1(t0, x0, y0, z0, u0, v0, w0, φ0) 504a and direction 503. M1 denotes the indexed measurement number and the measurement values captured, to denote the time 129 of the measurement data structure 504a which can be formatted into standard UTC or other supported frameworks as needed, (x0, y0, z0) denote the location 502 of the measurement in the Coordinate Reference Frame 505 and the (u0, v0, w0) denotes the direction 503 of the measurement sensor 501 relative to the location coordinate (x0, y0, z0) 502 in the Coordinate Reference Frame 505, and the roll (φ0) parameter captures the rotation of the measurement sensor 501 in degrees around the direction vector (u0, v0, w0) completing a full description of the measurement sensor 501 in the Coordinate Reference Frame 505 that is reference to the room 101 with a specified origin (0,0,0) location 502. The measurement location 502 has its own measurement data structure M2(t1, x1, y1, z1, u1, v1, w1, φ1) 504b captured as part of the measurement process.

FIGS. 5d and 5e illustrate a plurality of measurement locations 502a to 5021 on a horizontal grid (FIG. 5d) and vertical grid (FIG. 5e) layout that are preconfigured and represented within the Coordinate Reference Frame 505 during the measurement process. The measurement locations 502 as stated previously can be predetermined and/or ad-hoc, however the specific measurement location 502 preferably needs to be recorded. Although twelve measurements locations 502a to 5021 are illustrated and distributed throughout the room 101. Any number of measurement locations 502 are supported with a higher density of measurements preferably. A single point measurement location 502 in the middle of the room 101 is typically considered a broad overview for a simple quick room 101 analysis and do not provide enough spatial resolution to account for most rooms 101 that are not homogenous but instead contain non-standard cubic or geometric room 101 shapes which typically contain different materials and composition of furniture and other equipment such as monitors, projectors 103 and other systems that are not typically evenly distributed throughout the space 101. Although two planes FIGS. 5d and 5e are illustrated, for clarity purposes, a full 3D coordinate measurement grid with measurements distributed on any axis coordinate (x, y, z) is supported and within the context of the invention. The measurement data structure 504 is a representation of the full data set captured for each measurement as stated previously.

FIG. 5f. is a representation of an irregular room 101 shape to illustrate that the Coordinate Reference Frame 505 is not constrained to rooms 101 that have a regular shape or geometry. FIG. 5f illustrates the importance of capturing a high density of measurement locations 502a to 502ad, in this case 29 in total, as noted in the Coordinate Reference Frame 505 with the corresponding measurement data structures 504. The irregular room 101 shape will typically present unique acoustic properties and a high density of measurement locations 502 within the spatial measurement Coordinate Reference Frame 505 will highlight good and bad acoustic locations 502 in the room 101 facilitating equipment and furniture 105 placement suggestions and recommendations. Measuring a plurality of locations 502 in both the horizontal and the vertical dimensions will give a better understanding and more comprehensive analysis supporting seated height and standing height acoustic room 101 behaviors. For diverse use cases such as multi-use rooms 101 and collaboration spaces with dynamic and non-static participants 102 this is important for the placement of the audio conference and voice lift equipment 120 peripherals to optimize performance and participant 102 satisfaction. Depending on how the room 101 is going to be used, the Room System Performance Map 948 (FIG. 9g) will be computed accordingly, and the analysis will generate results adjusted based on the number of locations 502 measured 504, to the changes in the room 101 and its use.

With reference to FIGS. 5a, 5b, 5c, 5d, 5e and 5f, data created, retrieved, updated, and deleted by the Room System Score Performance Processor 901 (FIG. 9a) is referenced to the defined Coordinate Reference Frame 505. At the lowest level there are Sensors 978 (FIG. 9a) with defined locations 502 and temporal 129 coordinates, as illustrated in FIGS. 5a, 5b, 5c, 5d, 5e and 5f. Sensors 978 are the origin of data entering the system in the form of audio measurements to be stored in measurement data structures 504 at defined measurement locations 502, see FIG. 9c for details.

As is further illustrated in FIG. 9e, data from audio measurements, at defined spatial 505 locations 502 and times 129, combined with other data about the room 101, the conference system 120, and intended uses cases for the room 101 to infer a location score in room system score spatial map 701 (FIG. 7d) which is corresponds to the Room System Performance Location Score (for example, 1-5 shown in FIG. 7d) for the specific location 502 and time 129. The process involved in determining the location score of the room system score spatial map 701 is covered in detail in FIG. 9e. For now, it is sufficient to note that location scores are derived from Sensors 978, and they have a defined spatial 505 location 502 and time 129.

For any given room 101, that has defined spatial 505 extent, and for a given time 129 extent we can build a collection of location scores in the room system score spatial map 701 (FIG. 7d) that are contained within the spatial 505 and temporal 129 bounds of the extent. The collection of location scores in the room system score spatial map 701 (FIG. 7d) is a set of data associated with locations 502 and times 129 that have no implied structure defining any form of relationship between them. These are the location scores in the room system score spatial map 701 (FIG. 7d) relate to defined points in space 505 and in time 129.

The purpose of the Room System Performance Map Analytics Processor 909 (FIG. 9e) is to map these location scores in the room system score spatial map 701 onto a spatial 505 and temporal 129 structure, that is defined by both topology and geometry, which associates the results with small volumes (space 505 and time 129) rather than just points. This produces the Room System Performance Map (FIGS. 7e, and 7f). The Room System Performance Map processor 948 and maps (FIGS. 7e, and 7f) are down sampled to create higher-scaled spatial and temporal variants Level 0 Room System Extracted Features Map 949, Level 1 Room System Extracted Features Map 950, Level N Room System Extracted Features Map 951 (FIG. 9g). Collectively the Room System Performance Map (FIGS. 7e, and 7f) and FIG. 9g Room System Performance map 948, along with the scaled versions of it Level 0 Room System Extracted Features Map 949, Level Room System Extracted Features Map 950, Level N Room System Extracted Features Map 951, form the Multiscale Room System Performance Map 975 (FIG. 9g).

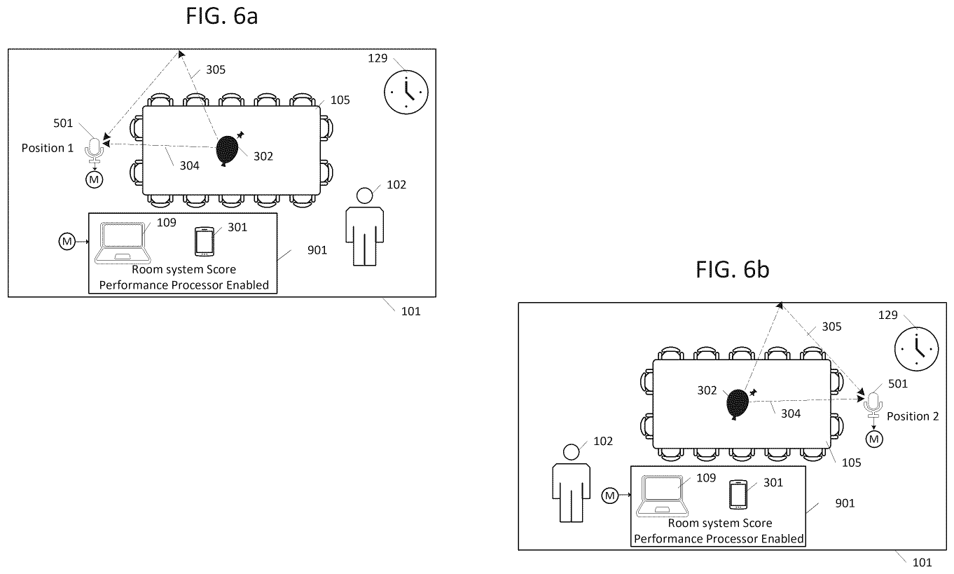

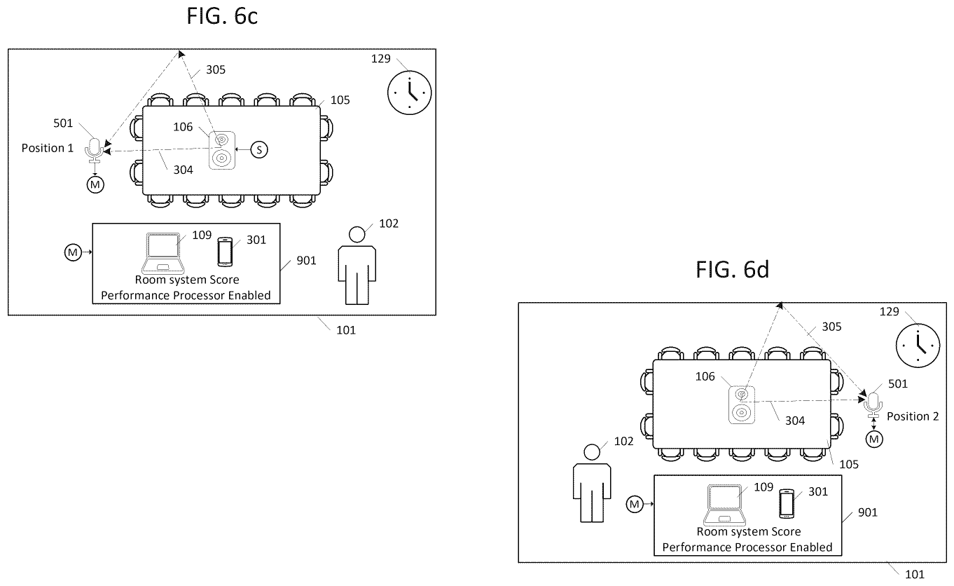

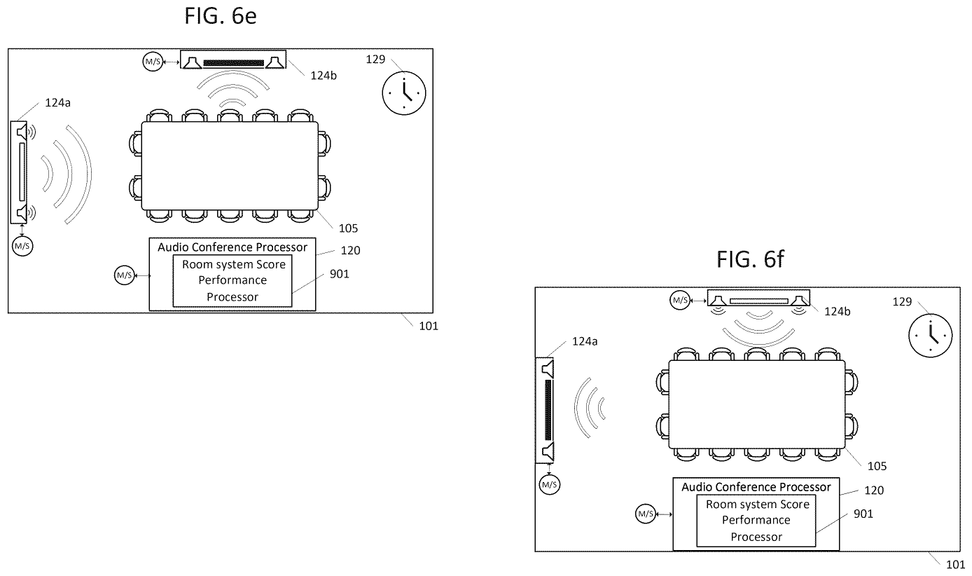

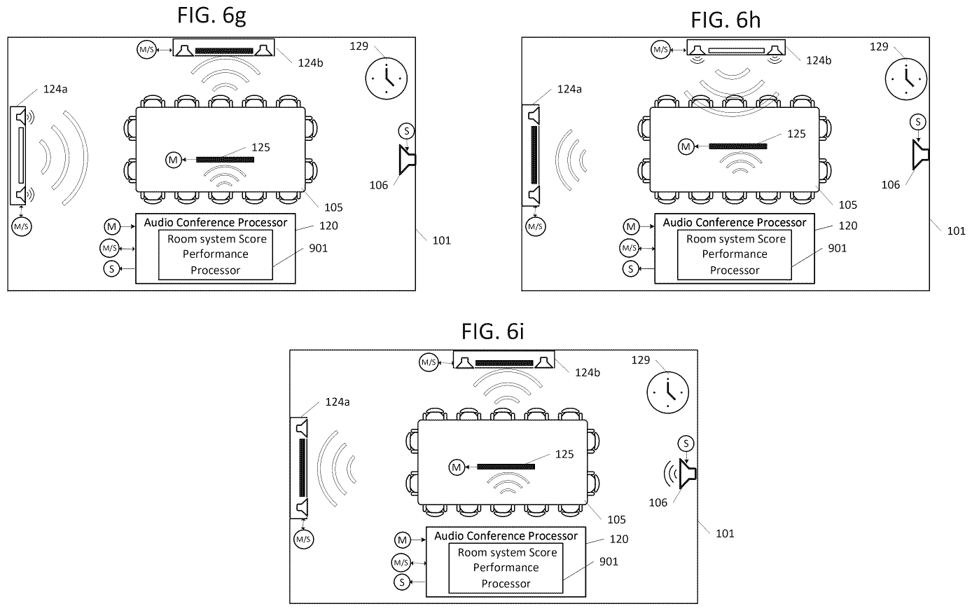

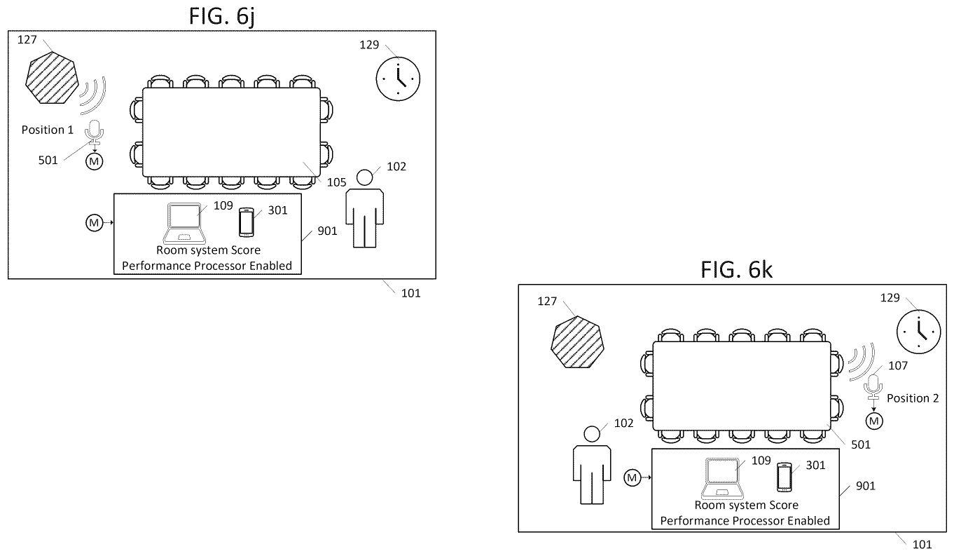

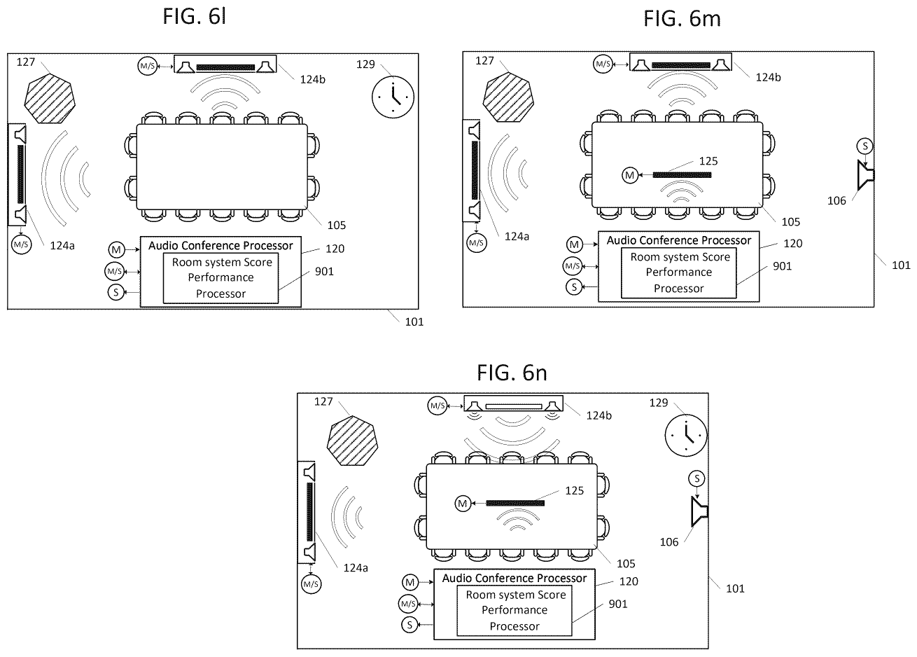

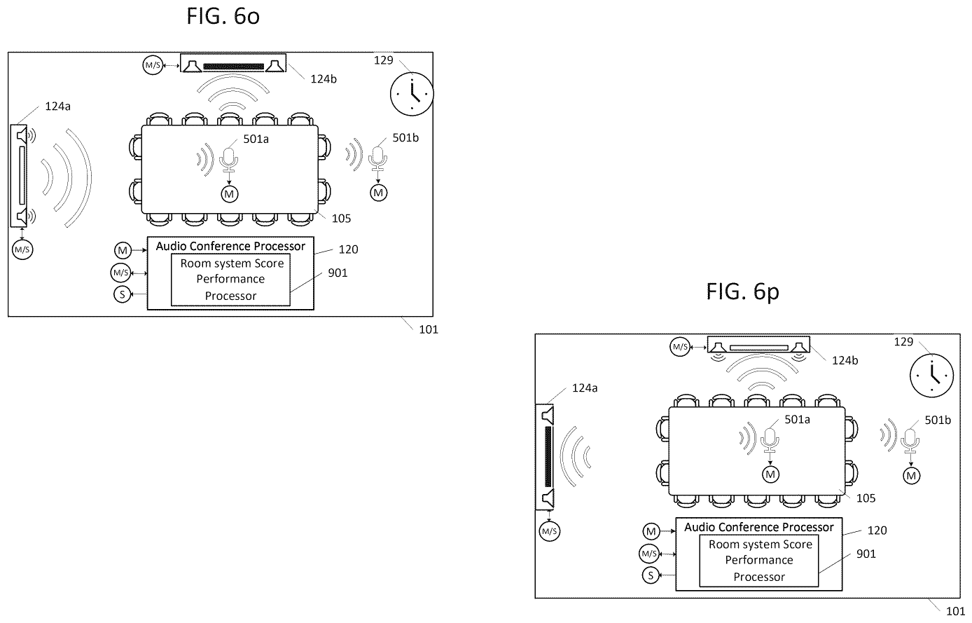

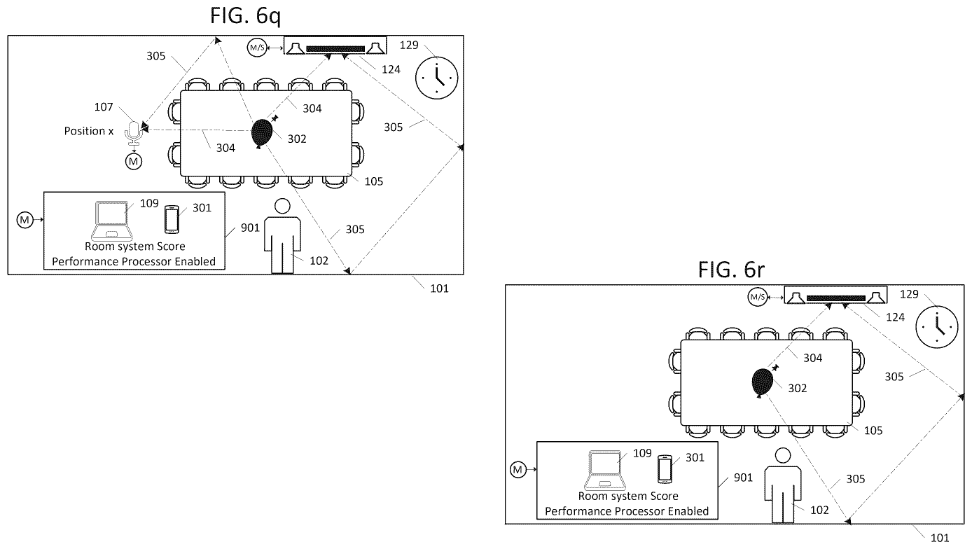

With reference to FIGS. 6a, 6b, 6c, 6d, 6e, 6f, 6g, 6h, 6i, 6j, 6k, 6l, 6m, 6n, 6o, 6p, 6q and 6r are exemplary diagrammatic illustrations of measurement approaches and techniques supported by the invention. Both indirect and direct measurement techniques are supported as individual measurement techniques and/or in combination to support the complete acoustic measurement suite required based on the room 101, conference equipment 120 and use cases. Supported but not limited to are standard acoustic measurements as outlined in FIGS. 3c and 3d and measurement techniques in FIGS. 4a, 4b, 4c, 4d and 4e, the significant difference is the use of the Room System Score Performance Processor 901 (FIG. 9a) which can be standalone in a computer, mobile smart device or imbedded into the conference system 120 that takes into account the room 101, audio conference equipment 120 and the use case to analyze the measurement data 504 and infer a Room System Performance Location Score in FIG. 7e which is plotted for each measurement location 502 into a Room System Performance map 948 as outline in more detail in FIGS. 7f, 7g, and 7h.

FIGS. 6a and 6b illustrates a standard indirect measurement technique using an impulse signal source such as a balloon pop 302 to generate an impulse signal which is then captured by the measurement microphone 501 and sent to the computer 109 or smartphone 301 which contains and runs the Room System Score Performance Processor 901. The Room System Score Performance Processor 901 will guide the person 102 through the measurement process and collection of the location data including the time dimension 129 at each location 502. FIG. 6a illustrates one location “Position 1” 107 and FIG. 6b illustrates a second location “Position 2” of the measurement microphone 501. Both direct reference signal 304 and reflected signals 305 are captured, analyzed and measured to form the room 101 acoustic profiles and Room System Performance map 948 as outline in more detail in FIGS. 7f, 7g, and 7h.

FIGS. 6c and 6d illustrates a standard direct measurement technique where a reference loudspeaker 106 is used instead of a balloon pop or similar device 302 to generate an impulse signal that can be used by the Room System Score Performance Processor 901 to take the acoustic measurements of the room 101. Direct measurements offer the advantage of a known impulse signal, generated by the Room System Score Performance Processor 901, which is sent out via the reference speaker 106 which is then picked up by the measurement microphone 501 and routed back to the Room System Score Performance Processor 901, to then be analyzed and then create the Room System Performance map 948 as outline in more detail in FIGS. 7f, 7g, and 7h after the acoustic measurements are made. Since the impulse signal is known to the measurement system 901, there are measurement advantages to be gained which are known in the art such as better noise floor performance resulting in better signal to noise ratio in the measurements which give higher quality and reliability to the measurements. Indirect and direct measurements which both have their advantages are supported by the Room System Score Performance Processor 901 and considered to be in-scope of the invention.

FIGS. 6e and 6f are diagrammatic illustrations demonstrating an embodiment of the invention where the Room System Score Performance Processor 901 is embedded into the Audio Conference System 120 as an integrated functional capability. In this case the audio conference system 120 has two M/S bar systems M/S bar 124a and M/S bar 124b respectively mounted orthogonally on two separate walls. In FIG. 6e the M/S bar 124a is outputting the reference impulse response and the microphone of M/S bar 124b which is substituting as the measurement microphone 501 is picking up the impulse signal and sending the signal to the Room System Score Performance Processor 901 which is embedded into the Audio Conference System 120 for analysis and reported in the Room System Performance Map 948 (FIG. 9g) output. Extending the functionality of the Room System Score Performance Processor 901 from a standalone application into an embedded application has benefits of being able to measure and monitor the room 101 audio quality as well as the audio equipment 120 and M/S bar 124a and M/S bar 124b health and performance over time adding a new dimension to the acoustic room system analysis, by tracking the temporal dimension. The temporal dimension (time) 129 can be measured at any time interval that makes sense for the room 101. The room's 101 overall Room System Performance Map 948 can change sufficiently and in unexpected ways as HVAC and other room internal noise sources 127 and external noise sources 128 do not run continuously but instead periodically for undetermined amounts of time. Standalone measurement systems are at the mercy of the specific time of day the measurements are undertaken and most likely cannot get a complete and overall acoustic performance analysis of the room 101 resulting in an incomplete acoustic analysis. There is an opportunity to capture this room 101 acoustic impacting behavior, because the Room System Score Performance Processor 901 is embedded in the audio conference system 120 the measurements can be run during times of non-use in the room 101. And with the resulting Room System Performance Map 948 data the system 120 can then be adjusted either manually or automatically to adapt its audio parameters to compensate for the various room 101 acoustic measurements as the room changes throughout the day and seasons. Parameters such as noise filters, room microphone and speaker equalization curves and gain structures can be altered to compensate for changes in the room 101 as they are determined as needed. Thus, creating an adaptive approach for the complete system made up of the room 101, and system 120, M/S bar 124a and M/S bar 124b using measurement techniques in a predictive and real-time manner not supported in the current art for conference and voice lift systems. The fact that a Room System Performance Map 948 is created means the room 101 and system 120, M/S bar 124a and M/S bar 124b and use case interactions are accounted for, and not solely focused on just the room 101 acoustics which is typical of the current art. FIG. 6f is an example of the invention switching the generation and receiving of the impulse signal to the M/S bar 124b as the generator and M/S bar 124a set as the microphone receiver. By switching the two measurement functions around between the available M/S bar units 124a, and 124b the acoustical properties of the room 101 and system 120 combination will change because the speakers 106 are loading the room 101 and stimulating the acoustic nodes FIG. 4a in a different way and the microphone arrays 125 of M/S bar 124a are situated in a different relationship to the room 101 boundaries and internal noise sources 127. The result is a more comprehensive Room System Performance Map 948 can be generated and utilized by the audio conference system 120.

FIGS. 6g, 6h and 6i extend this capability to a combination of two M/S bars 124a, 124b, a standalone speaker 106 and a standalone microphone array 125 all connected to the audio conference system 120 which has embedded within it the Room System Score Performance Processor 901. FIG. 6g has the M/S bar 124a set as the impulse generator while the microphone array 125 in the M/S bar 124b and the standalone microphone array 125 mounted on the ceiling are used to pick up the impulse signal and send it back to the Room System Score Performance Processor 901 in the audio conference system 120. Adding more microphones arrays 125 to operate as measurement microphones 105 and loudspeakers 106 will create a more comprehensive Room System Performance Map 948 for the room 101. FIGS. 6h and 6i demonstrate the same speakers 106 and microphone arrays 125 alternating (round robin) as in the FIGS. 6e and 6f. illustrations.

FIGS. 6j and 6k illustrate the functioning and support of noise FIG. 4e and spectrum FIG. 4b measurements arrangements supported by the Room System Score Performance Processor 901. In this instance the measurements are done with no impulse signal stimulus. The goal is to measure the room 101 internal noise sources 127 and if present external noise sources 128 for SPL level and noise weighted measurements dB (A), and dB (C) for example, and the spectral content of the noise sources 127 for further analysis by the Room System Score Performance Processor 901 to generate the Room System Performance Map 948. In this instance the Room System Score Performance Processor 901 is run in a standalone format/method via a computer 109 and/or smart phone/device 301. Two microphone locations are shown: FIG. 6j measurement microphone 501 “Position 1” and FIG. 6k measurement microphone 501 “Position 2”. Although two positions are shown any number of room locations 502 are supported and a much higher density is preferred as this supports higher spatial resolution in the Room System Performance Map 948. Time 129 is recorded as a measurement parameter for each time a measurement is taken by the Room System Score Performance Processor 901. This applies to all measurement modalities and types and is not limited to any one measurement modality and/or type. Within scope of the measurement equipment 501 and the Room System Score Performance Processor 901 is the ability to take parallel measurements within the invention to facilitate the usage of more than one measurement microphone 501 to take concurrent measurements at the same time and collecting the data accordingly. This increases the efficiency of the measurement process as well as the opportunity to take measurements at more locations 502 and increases the spatial density for room system location scores of the Room System Performance Map 948. Noise, spectrum and indirect impulse measurements support parallel measurement capture scenarios. Direct measurements do support a parallel microphone 107 capture approach, however it is best to only engage one loudspeaker 106 locations at a time due to the nature of the measurement constraints.

FIGS. 6l and 6m illustrate the same noise and spectrum measurements as previously described in FIGS. 6j and 6k, however the standalone measurement microphones 501 have been replaced with the microphone arrays 125 in the M/S bars 124a and 124b. Each M/S bar 124a and 124b can take measurements independently or concurrently. In FIG. 6m a standalone microphone array 125 is added to the room 101 system thus improving the acoustical measurement's location 502 points for the embedded Room System Score Performance Processor 901. As stated previously the room 101 acoustic properties can change over time and the ability to embed the Room System Score Performance Processor 901 into the Audio conference processor 120 system supports a measurement modality that is not available in the current art. Monitoring the room 101 and equipment 120 leads to better room 101 uptime and utilization as well as optimized audio conference system 120 performance reducing poor performance and rooms 101 taken offline in an ad-hoc manner to address issues that are typically found during actual conference call startup at the beginning of meetings.

With reference to FIG. 6n, illustrated is an audio spectrum capture of a set of speakers 106 from the M/S bar 124b. This measurement using the other microphones 125 in the M/S bar 124a and the standalone microphone array 125 and a reference signal such as but not limited to pink noise spectrum transmitted from the speaker 106 can give an approximation of the in room 101 speaker response and as a function of frequency vs level from 20 Hz-20 Khz as in FIG. 4e that can be used in the Room System Score Performance Processor 901. There is also a capability to support STIPA style measurements STIPA Pre-Processing 929, STIPA Measurements 930 (FIG. 9c) for an industry standard quality metric that can also be part of the Room System Score Performance Processor 901. The goal is to energize each speaker 106 system in M/S bar 124a, M/S bar 124b and 106 in the room 101 one at a time and to measure the in-room spectrum vs level response that each speaker system in M/S bar 124a, M/S bar 124b and loudspeaker 106 produces. All speakers can be energized at once for a combined response when there is a standalone microphone array 125 in the system 120. As the spectrum measurements are collected and analyzed and a location score can be inferred and assigned based on the room usage use case and performance metrics used by the Room System Score Performance Processor 901 in the generation of the Room System Performance Map 948.

With reference to FIGS. 60 and 6p standalone measurement microphones 501a and 501b have been added to the Room System Score Performance Processor 901 system, adding two more measurement locations to the system. A combination of standalone measurement microphones 501a and 501b in combination with M/S bars 124a and 124b is fully supported and within scope of the invention. Any microphone 107 or microphone array 125 type that can be used for gathering noise, impulse and spectrum data can be utilized if it can be configured and calibrated to appropriate parameters to support the desired measurement type.

With reference to FIGS. 6q and 6r an indirect impulse generator, for example a balloon pop 302 has been incorporated into the impulse measurement process replacing the direct speaker 106 approach. In situations where a single M/S bar 124 installation is installed, indirect impulse measurements make the most sense as the speakers 106 are typically in close proximity to the microphones array 125 to make a valid impulse response measurement. Direct or indirect acoustic measurements both situations and is considered to be in scope of the invention.

With reference to FIGS. 7a, 7b, 7c, 7d, 7e, 7f, 7g and 7h illustrated is an exemplary high-level embodiment of the present invention measurement process from the start of the measurement to the output and display of a Room System Performance Map 948.

FIG. 7a shows a standard room 101 that has been configured for a series of 12 measurements within the Coordinate Reference Frame 505 established for the room 101 ahead of time either by the current user 102 of the system or by the IT manager or system specialist.

In FIG. 7b the user 102 starts at the first measurement location 502a and takes the measurement which is stored in a measurement data structure 504 with the Coordinate Reference Frame 505 location coordinates 502 collected by the system and entered by the user 102 as needed.

In FIG. 7c the user 102 proceeds to go to each specific location 502a, 502b, 502c, 502d, 502e, 503f, 502g, 502h, 502i, 502j, 502k and 5021 to undertake and record a measurement 504 using the Coordinate Reference Frame 505 configuration for the room 101. Once the full suite of desired measurements 504 is taken, use case data and potential system type are provided, if needed.

Then as illustrated in FIG. 7d the Room System Score Performance Processor 901 will generate the Room System Performance Map 948 which can be output and displayed on an appropriate computer 109 or smart phone 301 as a Room System Score Spatial Map 701. The Room System Score Spatial Map 701 shows the derived system room performance scores on the Coordinate Reference Frame 505 layout. Five scoring areas are illustrated with reference to the Coordinate Reference Frame 505 layout between a value of 1 to 5 with 5 being the best locations 502 and 1 being the worst locations 502 within the Coordinate Reference Frame 505 layout across the suite of acoustical measurements 504 such as those defined in FIGS. 4a to 4e. that are considered in context of use case, equipment and room 101 acoustic measurements as predefined in the configuration database elaborated on in the FIG. 9 system drawings.

FIG. 7e is an example of a typical scoring rubric table that is used to interpret the Room System Score Spatial Map 701 values. It should be noted that the number of available ranges and definitions can be configured and the example shown is illustrative and should not be used to constrain the invention. Room 101 acoustics is rarely a black and white issue meaning that a binary single room score of good (green) or bad (red) is insufficient to report back to the user 102. In addition, considering acoustics in isolation and separate of the room 101 usage and equipment 120 leads to incorrect interpretations and recommendations of how to deal with the room 101 acoustics issues or even if they need to be dealt with at all. Diverse usages such as classroom, presentation room, collaboration, hybrid, boardrooms, churches and live music venues have unique requirements and acceptance levels for various acoustic room properties. It is important to be able to grade the room 101 in context of usage and the audio system 120 across range of room score values. Rarely do rooms 101 have consistent acoustic properties across the whole space in the 3 dimensions (X,Y,Z) so it is important to measure many locations 502 and derive room scores for those locations 502 based on the multidimensional parameters of acoustic properties, usage, equipment measured performance and type so problems can be found, localized and recommendations made to address those problems whether it is acoustic treatment placements, room 101 equipment 127 maintenance and or audio system 120 placement and/or selection recommendations. By providing a range of room score values the severity of the combined measured acoustic issues can be determined and decisions made as to the appropriate mitigation strategy required if any.

For example, a derived room score of “1” by the Room System Score Performance Processor 901 for any given location area 502 such as those shown in FIG. 7d would be considered as very bad acoustically, problem areas, which can be the result of a that location 502 in the room 101 being susceptible to certain acoustic properties and/or parameters measuring very bad acoustically and/or a combination of acoustic parameters aggregating and causing a overall poor acoustics at that set of locations 502 in the room 101. Poor acoustics may result for a location 502 measuring for example a very high noise floor and/or a set of problem frequencies that would be considered an issue for the audio system 120 end-to-end performance and/or the in-room participant 102 at that location which could be the result of a extra noisy HVAC vent or blower fans 127 that have developed issues in the system. Other measured parameters such as a high RT60 score of for example 2.0 s would be considered unacceptable for a conference system 120 to be installed and expected to perform well. If either situation or combination of a high noise floor, problem frequencies and/or very bad RT60 performance are not addressed the audio system 120 will most likely under perform and the room 101 issues should be addressed with prescription of acoustic treatment and other mitigation strategies and appropriate fixes to address the room 101 noise level issues if they have been identified. Extending the example if STIPA is measured and graded which is a measure of system performance for speech intelligibility at various locations in the room 101 and the values are low such as 0 to 0.3 range the room score will be adversely affected and reported. At which point appropriate mitigation actions such as equipment 120 selection, placement and setup may need to be addressed in possible combination with room 101 mitigation strategies such as addressing an overly high noise floor issue which can also degrade STIPA performance.

At the other end of the scale would be a score of “5” as measured and derived by the Room System Score Performance Processor 901 for any given area such as those shown in FIG. 7d which would be room 101 locations 502 that are determined to be very good acoustically with measured and interpreted results to be very suitable for the intended equipment and room 101 usage. Room scores between the range of “2” to “4” have been determined to have varying degrees of issues that the user 102 may chose to address based on their budgets, usage and utilization of the room 101. For example The room 101 may present high noise at that location 502 or time of day 129 but the RT60 values are acceptable and based on the room 101 layout and intended usage the room score may be a “3” or “4” at which point the user 102 may live with the room 101 issues making an intelligent decision based on the information presented through the room score and the corresponding Room System Score Spatial Map 701.

The above examples illustrate how it is necessary to consider the room 101 acoustics, equipment 120 and usage as a total wholistic system across many locations 502 and temporal 129 dimensions across a range of room score values to optimize audio performance for the in-room 101 participants 102 and remote participants 108.

FIG. 7f is a diagrammatic illustration of a 3D spatial representation of the Room System Score Spatial Map 701 values on a Coordinate Reference Frame 505 layout. When a full suite of measurements from various locations 502, in all axes (X, Y, Z), are taken a high-resolution Room System Score Spatial Map 701 can be generated which facilitates the placement of audio conference equipment 120 microphones 107, microphone arrays 125 and speakers 106 in the typical locations they would be placed. Typically, acousticians or technical specialist will focus their measurements at a common height location such as seated participant 102 head height, to get generic room acoustic measurements, however microphones 107, microphone arrays 125 and speakers 106 are rarely placed at those heights so the measurements have less real applicability to where and how the equipment 120 is being installed and used. Having a full 3D Room System Score Spatial Map 701 allows for more reliable and useful measurements and outcomes for predicting room 101, system 120 and expected use case performance.

With reference to FIGS. 7g and 7h, illustrated is how a room 101 may change between morning (FIG. 7g) and afternoon (FIG. 7h) on a Room System Score Spatial Map 701. Using the temporal dimension 129, the difference between time periods can be captured and analyzed though post processing methods using a variety of established methods, well-documented in prior art, and include such techniques as spatiotemporal modeling, and data mining, among others. Multiple factors can contribute to the room 101 and conference system 120 locations scoring being different between time 129 periods such as but not limited to HVAC cycles and environmental settings, rooms 101 usage changes and external noise ingress. The conference system 120 can be adapted either manually or in real-time through feedback of the Room System Performance Map 948 data to the external processes as described in the FIG. 9 system diagrams.

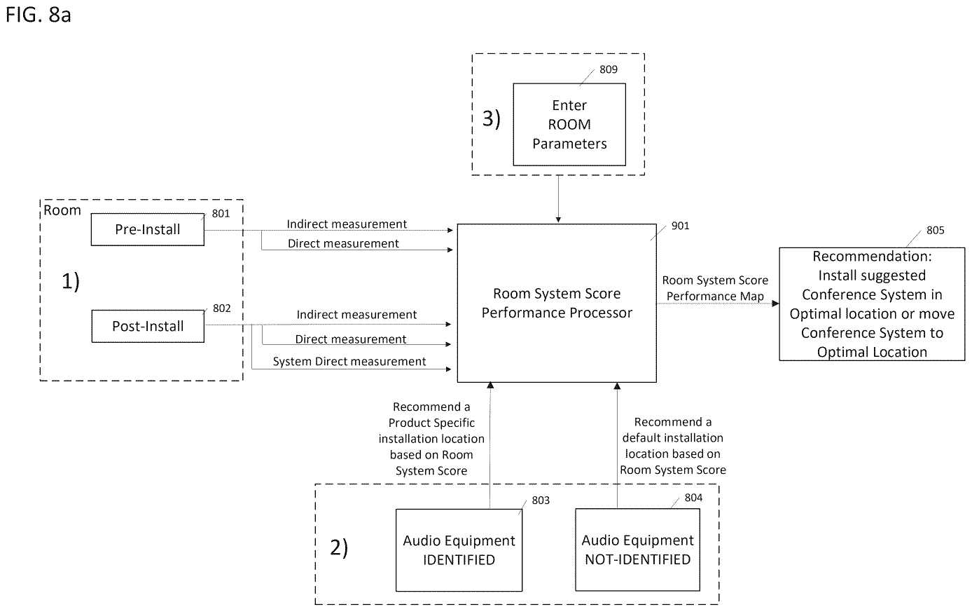

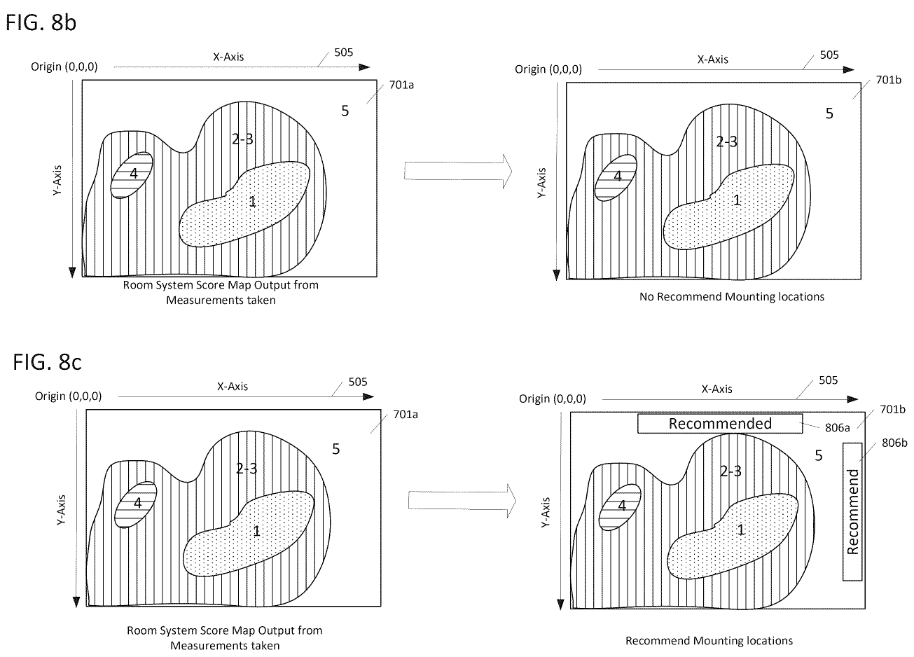

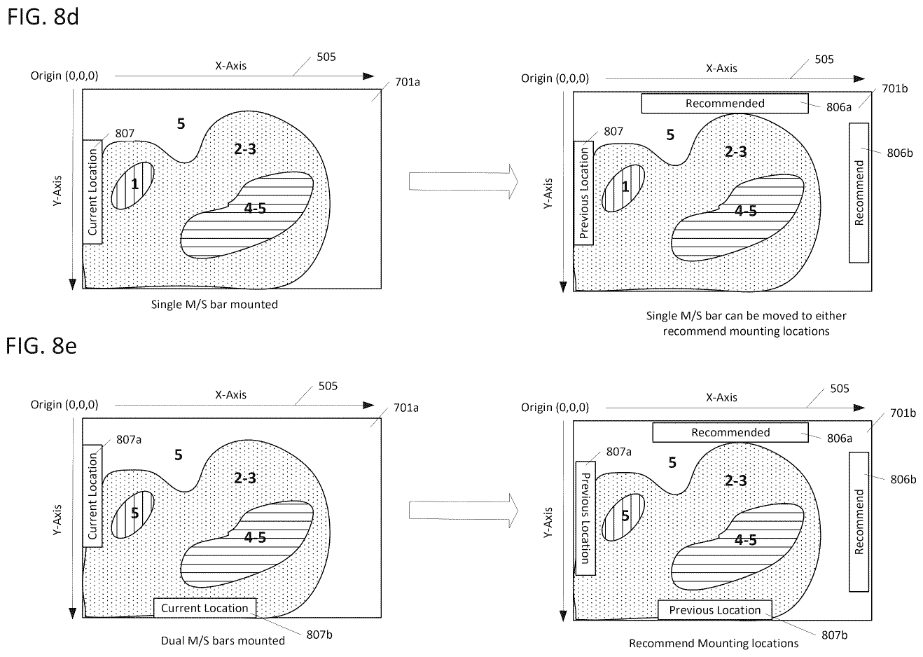

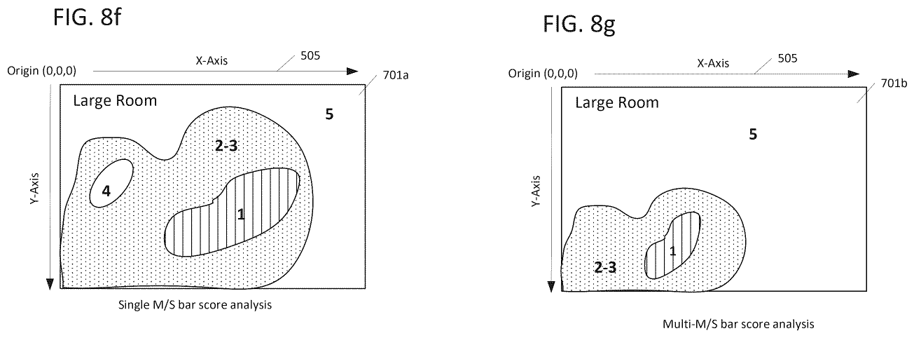

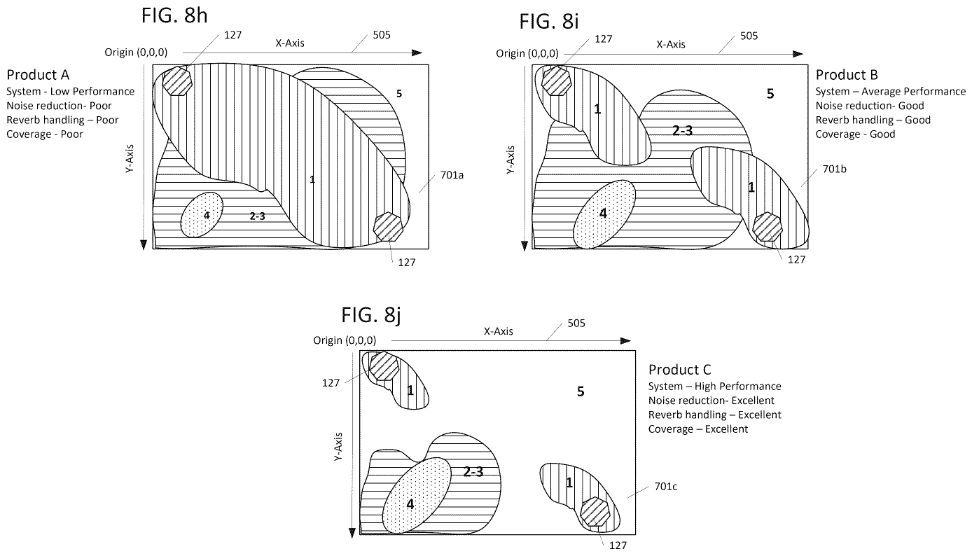

With reference to FIGS. 8a, 8b, 8c, 8d, 8e, 8f, 8g, 8h, 8i and 8j these are example workflow illustrating how integrating the input of room 101 and audio equipment 120 selection parameters can drive predictive analysis and recommendations 805 (FIG. 8a) by the Room System Score Performance Processor 901 (FIG. 9a) that can be displayed on a Room System Performance Map (FIG. 9g) in a Coordinate Reference Frame 505 (FIG. 5a) can be completed when a complete holistic approach is taken in combination with preferred as outlined in the acoustic measurement process FIGS. 7a, 7b, 7c, 7d, 7e, and 7f.

With reference to FIG. 8a, it illustrates a simplified overall workflow between the selection of either:

Input 1) a room 101 pre-install 801 audio conference and/or voice lift equipment 120 installation, or a room 101 post-install 802 audio conference and/or voice lift equipment 120 installation in combination with the selection of either.

Input 2) audio conference 120 and/or voice lift equipment IDENTIFIED 803 or the audio conference 120 and/or voice lift Equipment NOT-IDENTIFIED 804.

Input 3) Select Room parameters 809 such as but not limited to LARGE, MEDIUM or SMALL for example.

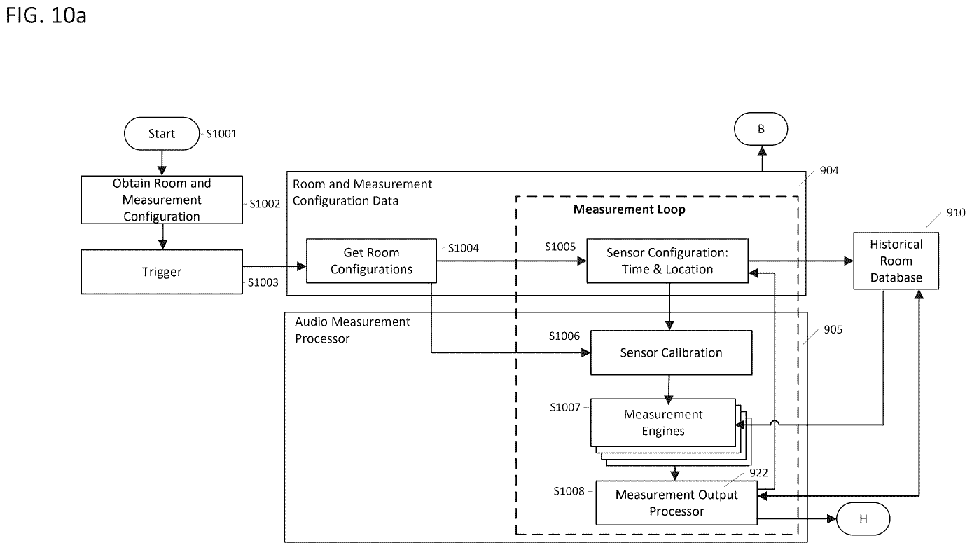

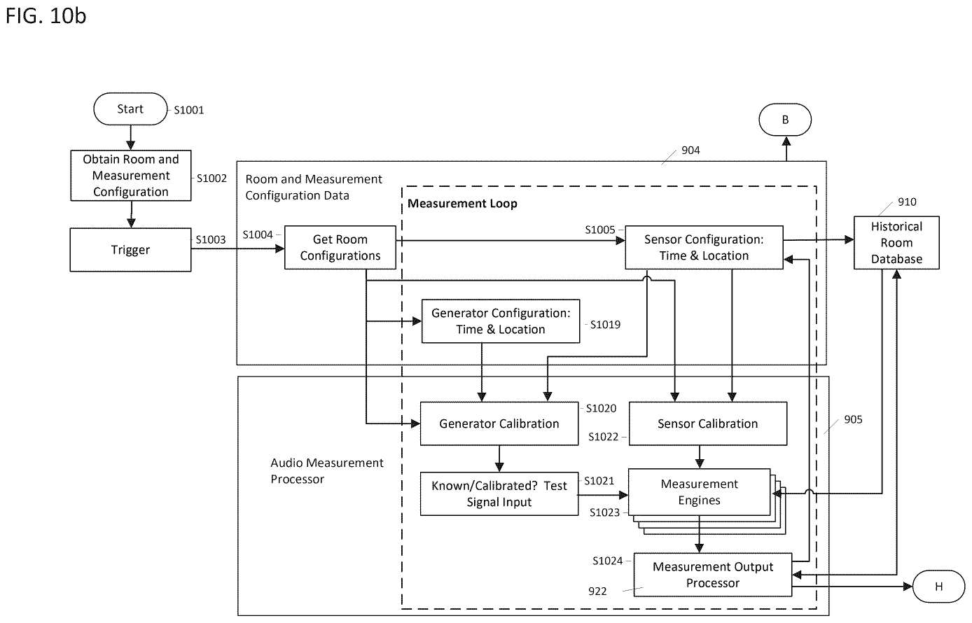

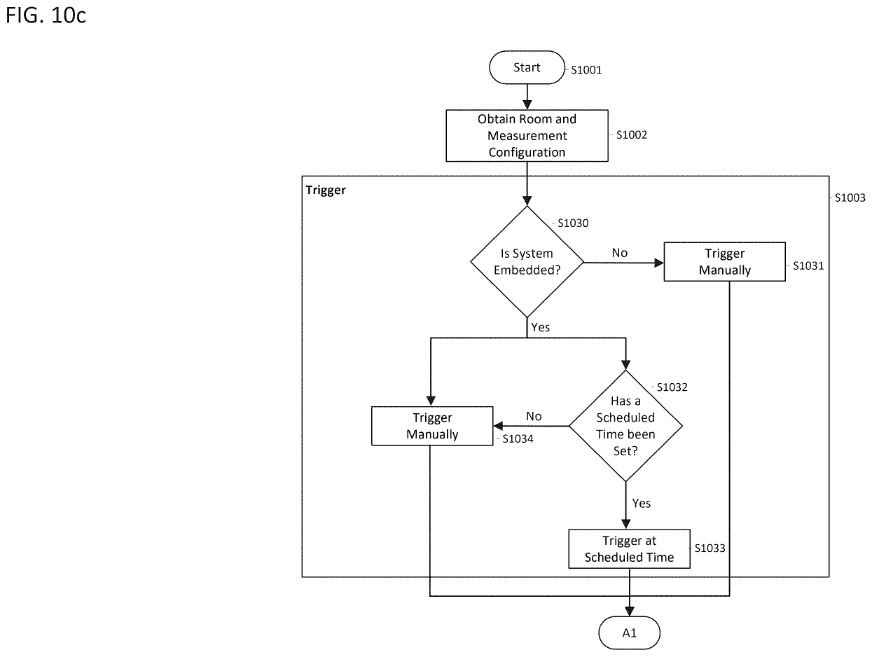

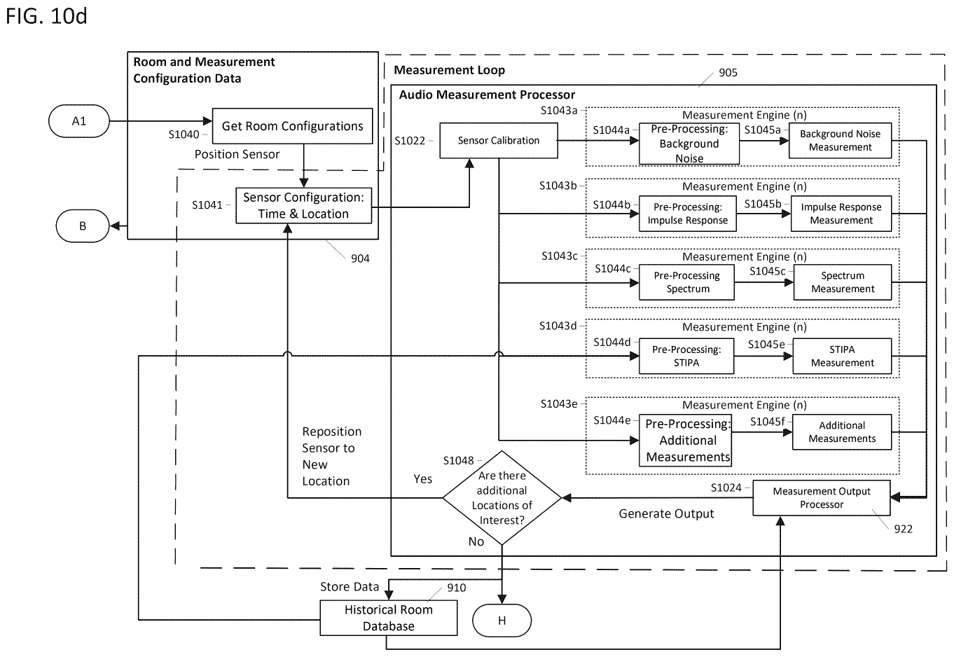

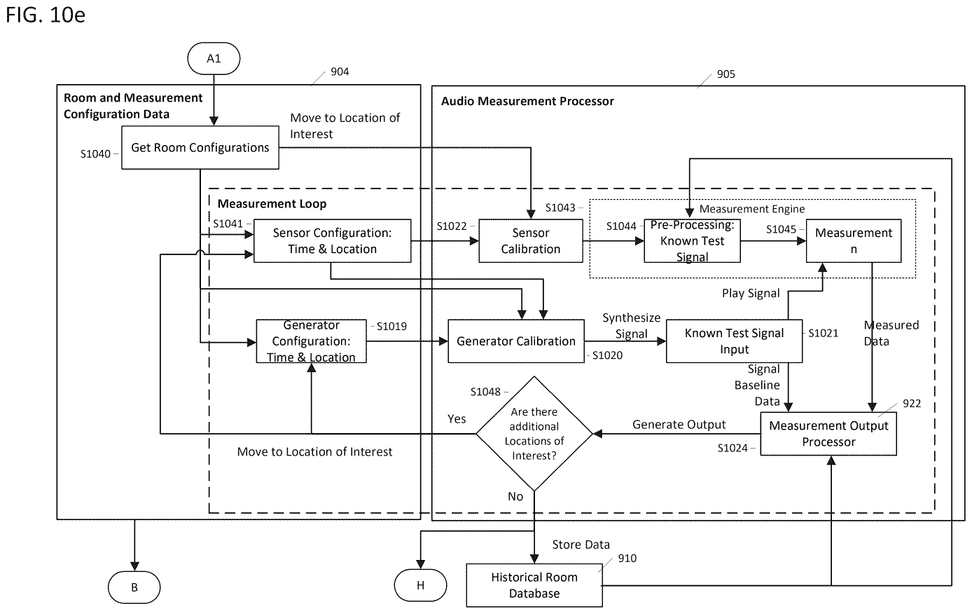

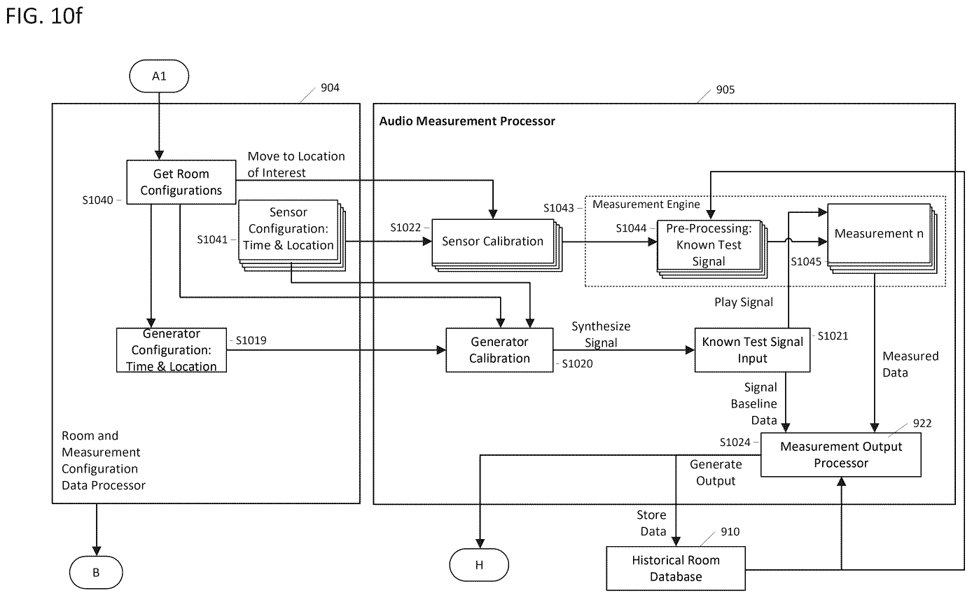

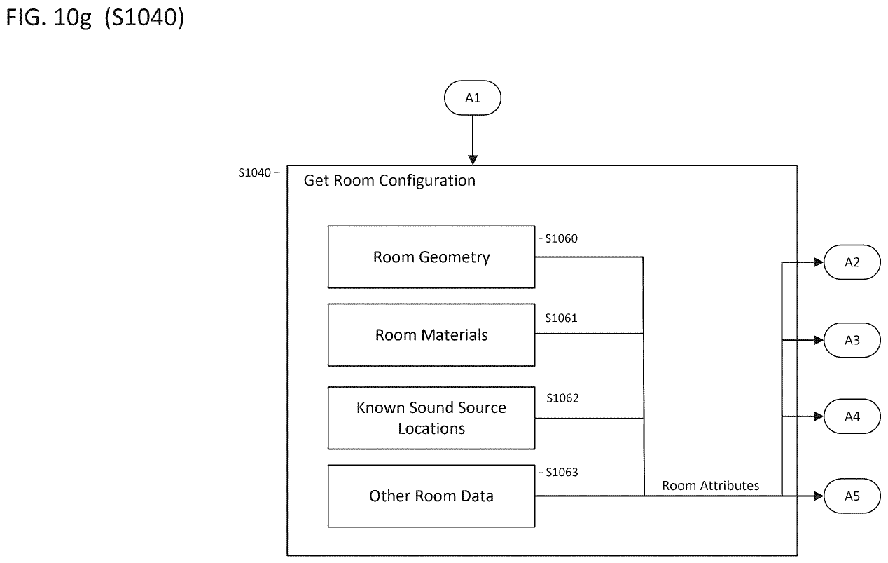

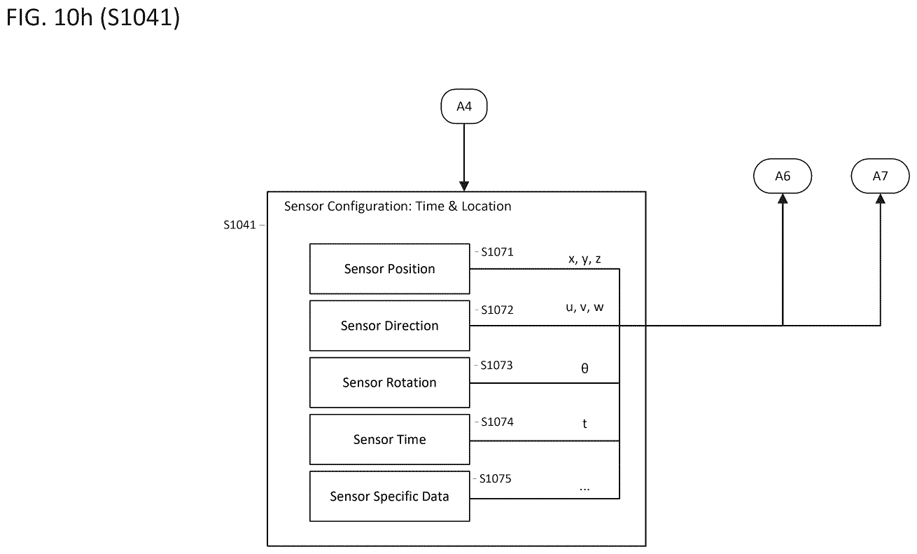

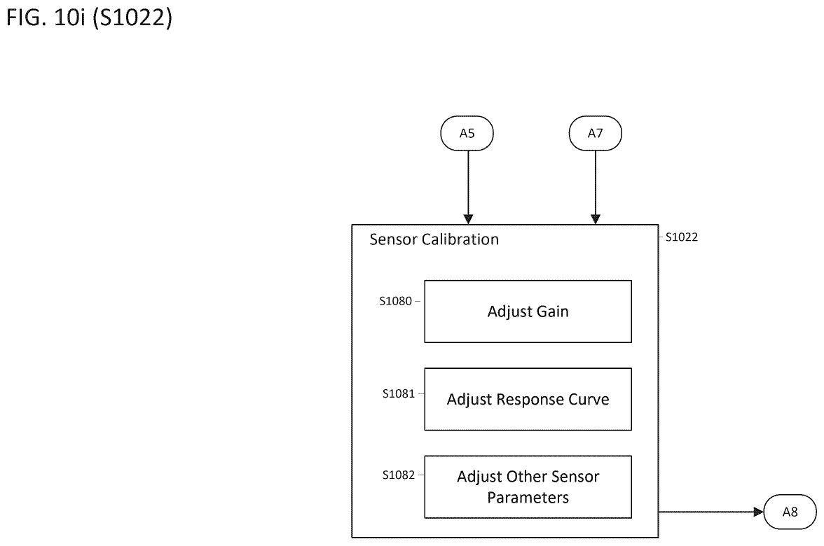

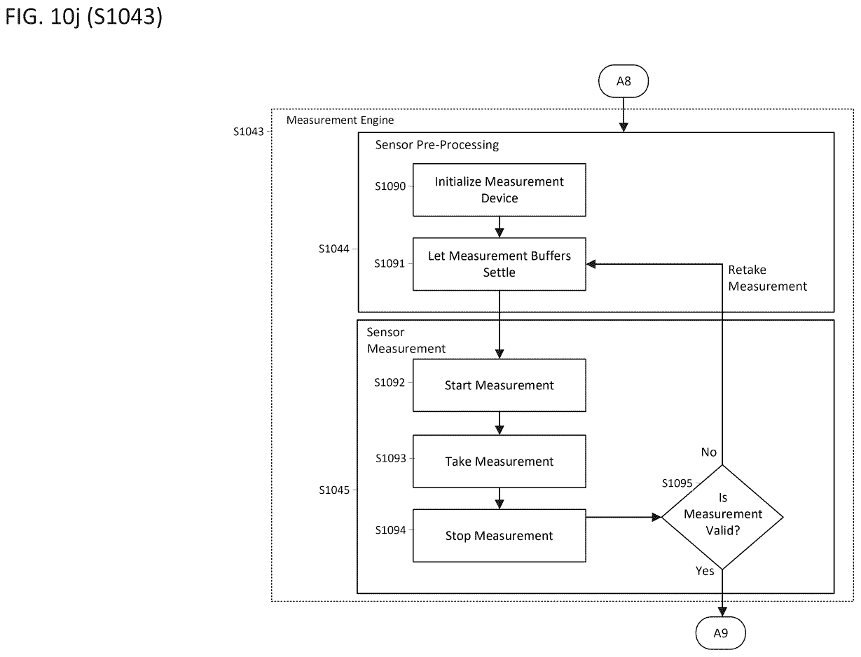

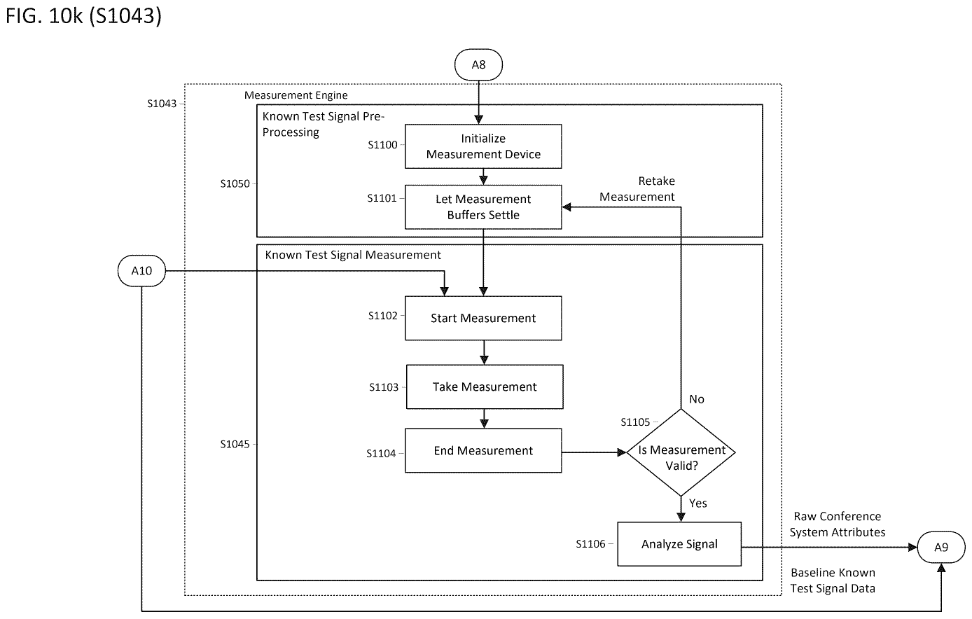

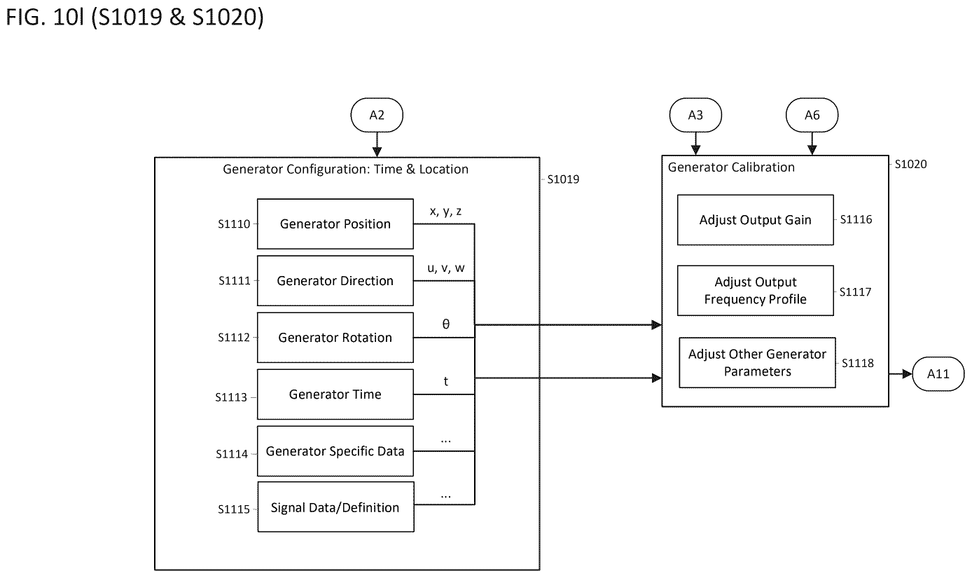

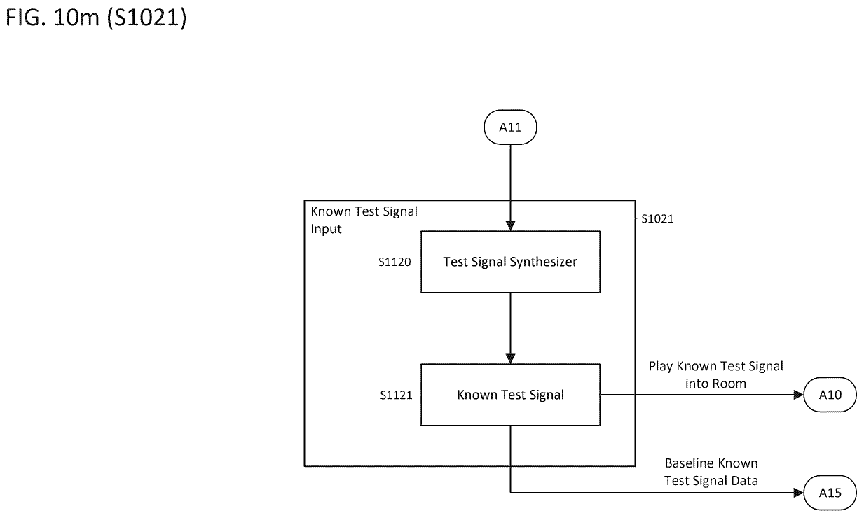

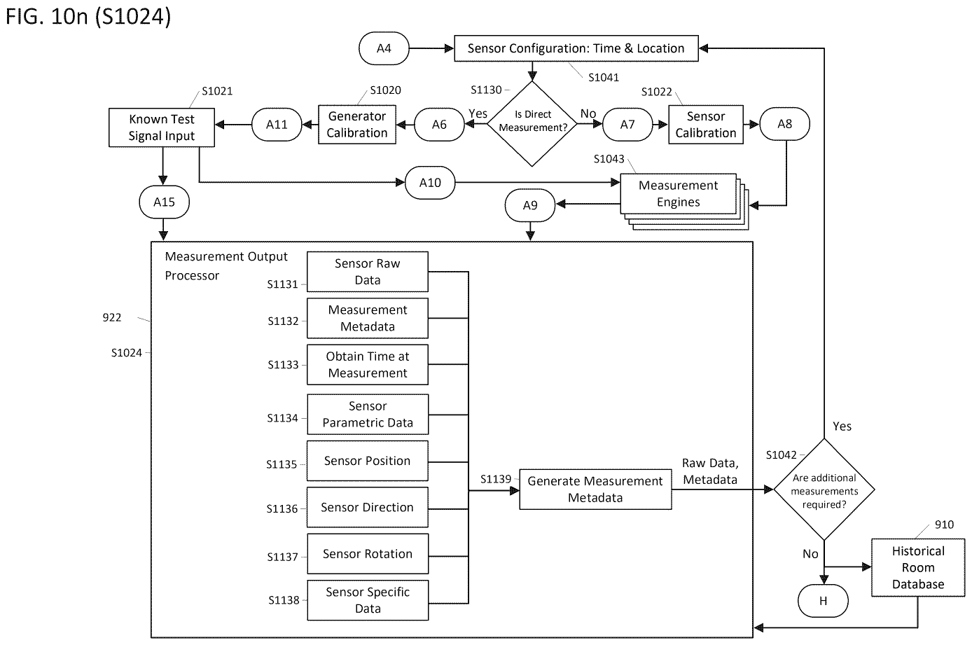

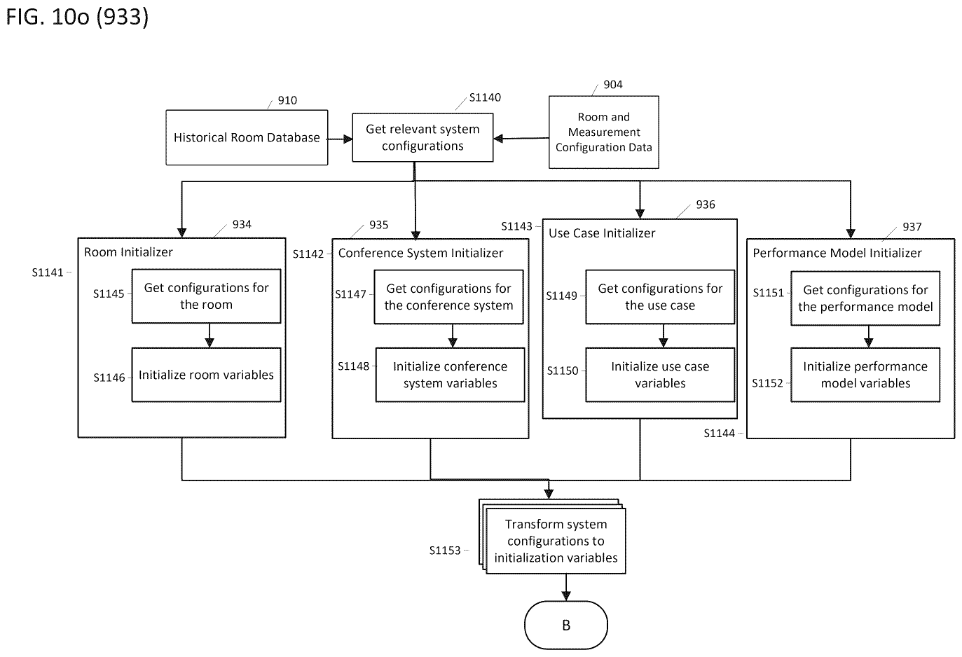

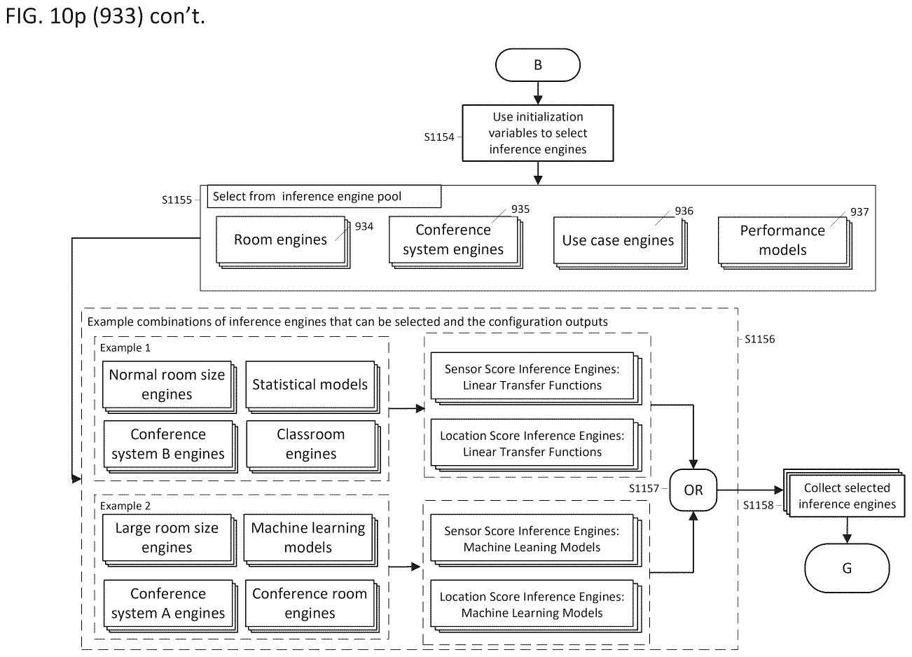

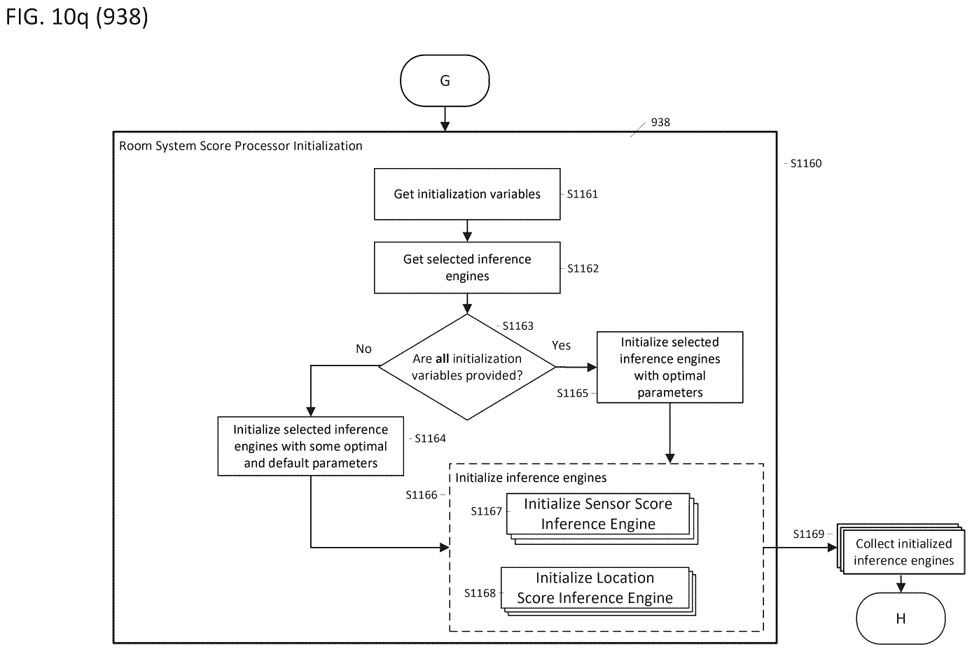

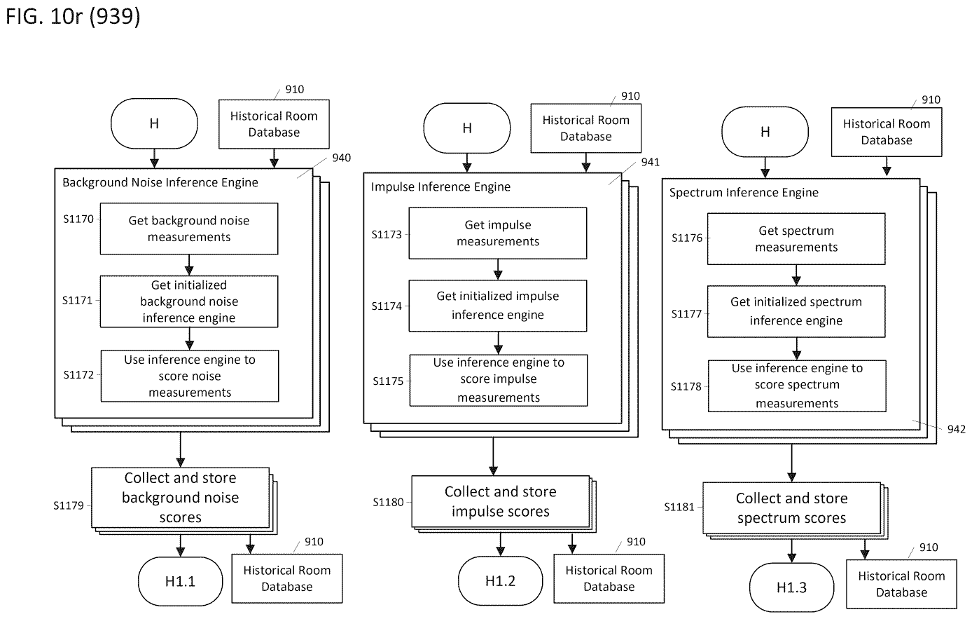

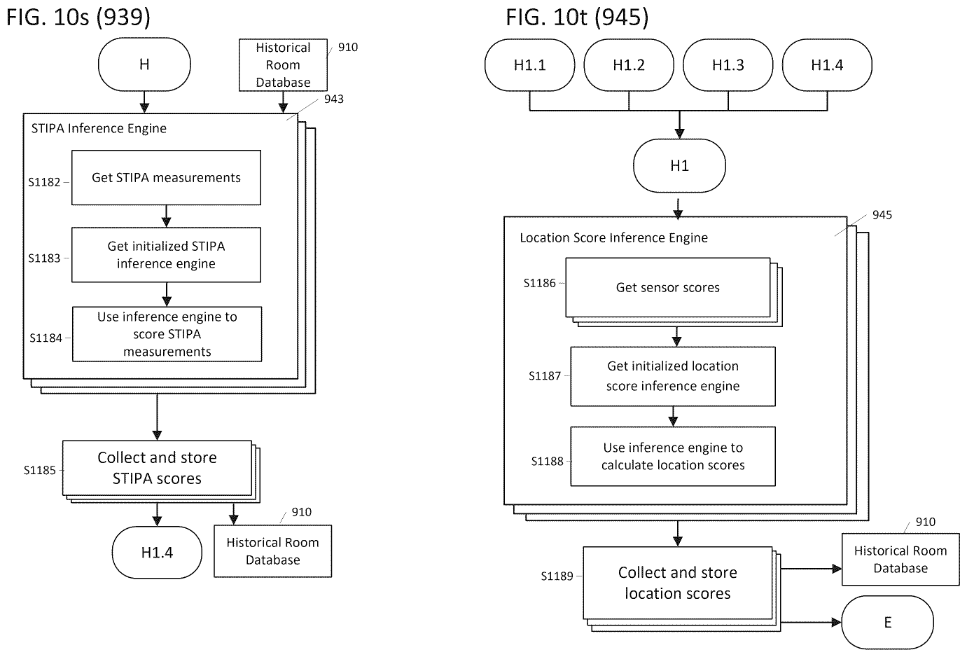

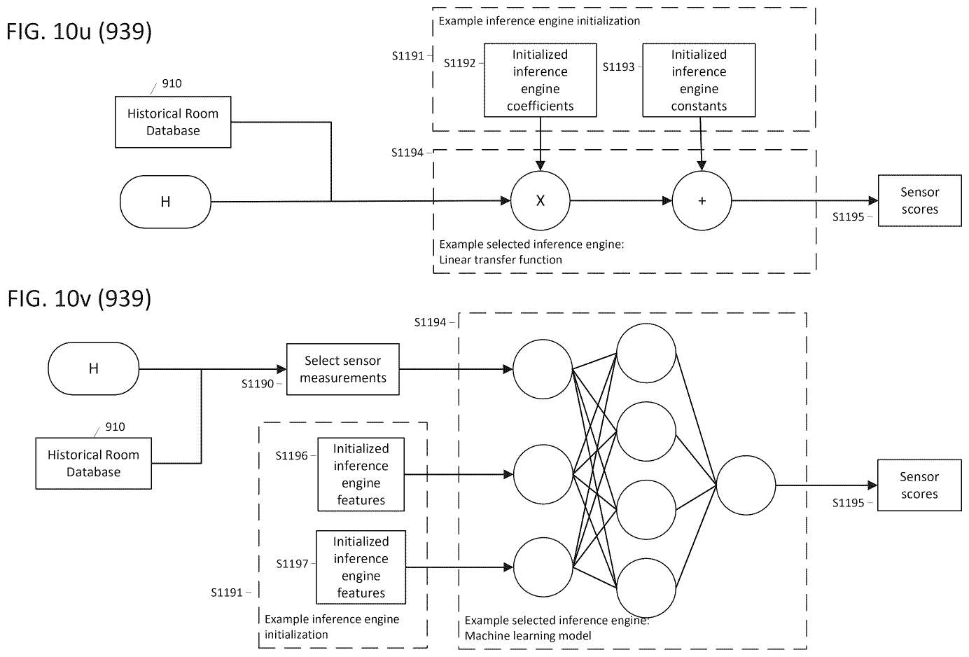

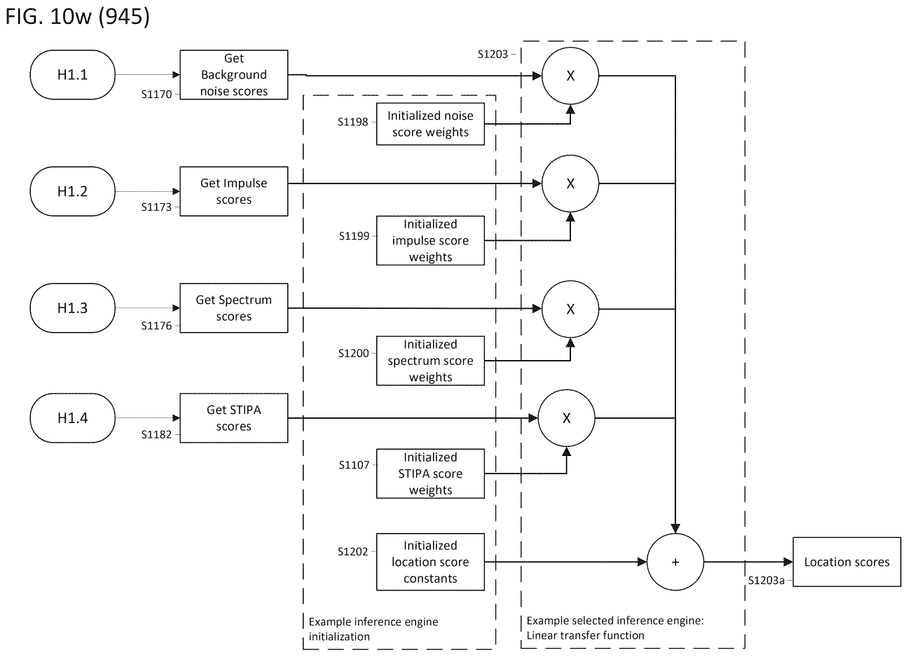

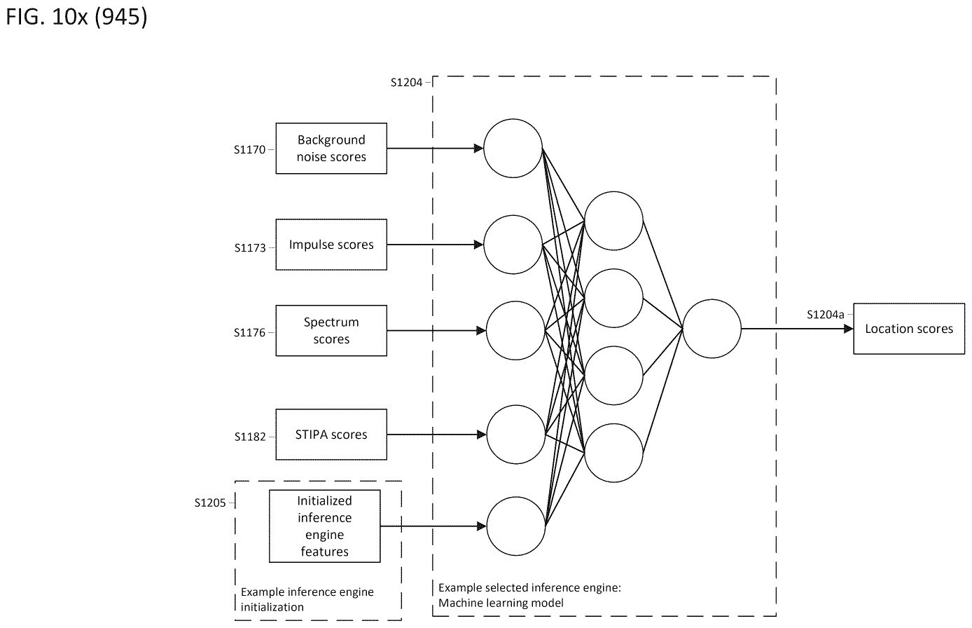

All inputs are used to drive the processing logic of the Room System Score Performance Processor 901 for the purpose of analyzing and making recommendations 805 that are appropriate based on the room 101 location 502 based acoustic measurements, selected audio equipment 120 and the selected room 101 size, which are then analyzed to display the Room System Score Spatial Map 701 that can be used by the user 102 to make recommendations 805 such as but not limited to smart equipment 120 selection and install location choices. More detailed logic and workflow support is outlined referring to FIG. 9 series through FIG. 10 series drawings.

Input 1) allows the selection of a Pre-Install 801 or a Post-Install 802 use case path. To support the Pre-Install 801 use case input requirements for the Room System Score Performance Processor 901, two measurement workflows are available as noted in FIGS. 6a to 6r, those being the “indirect measurement” (FIGS. 6a to 6b, FIGS. 6j to 6k) and “direct measurement” (FIGS. 6c to 6d), The post-Install 802 use case can have both of those measurement approaches “indirect measurement” (FIGS. 6a and 6b, FIGS. 6j to 6k) and “direct measurement” (FIGS. 6c and 6d) as well as a third approach that can use the installed conference equipment 120 “indirect measurement” (FIGS. 6q and 6r, FIGS. 6l and 6m) and installed conference equipment 120 “direct measurement” (FIGS. 6e to 6i) that is already in the room 101. Having multiple room system measurement options available supports a flexible and scalable approach to making acoustic measurements in conjunction with the room 101 and system 120, providing a unique method and apparatus for the generating a usable Room System Performance Map 948 solution that does not require or rely on the standalone measurement equipment and applications that also require the cross discipline of one or more specialist to go from a pre-install state to an optimized post-install system 120 state supporting a diverse set of rooms 101, equipment types 120 and potential use cases.

Input 2) audio conference and/or voice lift Equipment 120 Identified 803 or the audio conference and/or voice lift Equipment 120 NOT-IDENTIFIED 804 is pretty straight forward. The audio equipment parameters such as but not limited to the configuration types of equipment for example (microphone speaker bar 124, discrete microphones 107, separate microphone array 125, speakers 106), and number of each, are then used by the Room System Score Performance Processor 901 for the purpose of making intelligent choices about the fit for purpose and/or optimal location of the equipment 120 in the room 101 based on the Room System Score Spatial Map 701.

Input 3) Select Room parameters 809 such as a relative size but not limited to LARGE, MEDIUM or SMALL for example is selected by the user 102 or predetermined by configuration. This parameter has a definite effect on how the acoustic measurements (FIGS. 4a to 4e) are interpreted and the influence of the acoustic measurements on the equipment 120 selected Audio Equipment

IDENTIFIED 803 and/or Audio Equipment NOT-IDENTIFIED 804 that is reflected in the Room System Score Spatial Map 701. For example, equipment 120 that scores well in a small room 101 may score poorly in a large room 101 because there may be insufficient speakers 106 and microphones 107 or microphone arrays 125 to support the large room 101 volume so the room system performance scores will reflect that. For another example, rooms 101 that have high noise floor measurements may also need more speakers 106 and microphones 107 than would be thought normal in the industry to install to support that size of room 101. There are too many permutations to illustrate, so a few are chosen to demonstrate a simplified workflow and output result of the apparatus and methods of making using acoustic measurements (FIGS. 4a to 4e) to intelligently infer and influence how the equipment 120 will work in any given room 101.

With reference to FIG. 8b, illustrated is when the Pre-Install 801 and the Audio Equipment NOT-IDENTIFIED 804 input use case selected and is used by the Room System Score Performance Processor 901 to determine the system performance score recommendation which is presented on the Room System Score Spatial Map 701a. In this case, since no equipment 120 has been selected, no recommendation 805 is made for equipment type or placement and the Room System Score Spatial Map 701b shows the outcome of the acoustic measurements and room 101 influences only.

With reference to FIG. 8c, illustrated is when the Pre-Install 801 and the Audio Equipment is IDENTIFIED 804 input use case selected and is used by the Room System Score Performance Processor 901 to determine the system performance score recommendation 805 which is presented on the Room System Score Spatial Map 701b. In this case, since the equipment has been selected in this case a single or dual M/S bar 124 system, a recommendation is made for the room 101 placement options 806a and 806b within the Room System Score Spatial Map 701b that is based on the Coordinate Reference Frame 505 that has been established previously. The goal is to place the M/S bar 124 system where the room system performance scores are the best to optimize the performance of the room 101 and audio conference system 120 combination. It is important to realize that all of the valid location based acoustic measurements, room 101 parameters and equipment 120 parameters are utilized to make an intelligent placement decision within the 3D room 101 space.

With reference to FIG. 8d, illustrated is a single M/S bar 124 system already installed in the room 101 at a location 807 and is not performing optimally. The technician 102 runs the Room System Score Performance Processor 901 process to troubleshoot and understand what is going on. The current M/S bar 124 installation may have been based on any combination of, for example, manufacturer's recommendations, visual cues or perhaps what the installer/technician 102 thought was the best location 807 in the room 101. The results from the Room System Score Performance Processor 901 application as illustrated in Room System Score Spatial Map 701a show the M/S bar 124 to be installed in a suboptimal acoustic region 807 of the room 101 as the scores for that region 807 are in the “2-3” range which is a rather poor spot to place the M/S bar 124 system and this is why the audio performance was suboptimal. The Room System Score Spatial Map 701b scores shows the recommended 805 regions 806a or 806b to place the single M/S bar 124 in the room 101 as the scores for that area of the room 101 are at a “5” which is the best audio quality location inferred. This type of method and apparatus process takes the guess work out of where to install the single M/S bar 124 system which is a significant improvement over current approaches in the art.

With reference to FIG. 8e, illustrated is a dual M/S bar 124a and 124b system which is installed in a room 101 with regions 807a and 807b that have a suboptimal score of “2-3” on the Room System Score Spatial Map 701a. Both M/S bars 124a and 124b are in poor regions 806a or 806b. The Room System Score Performance Processor 901 derives a set of recommended 805 regions 806a or 806b as shown on the Room System Score Spatial Map 701b. Room System Score Spatial Map 701b. As per the single M/S bar 124 example, the recommended regions 806a and 806b are inferred to the best acoustic spots in the room 101 to get the best performance out of the dual M/S bar 124a and 124b system.

It should be noted that all permutations of room 101 M/S bar 124 placements 807a and 807b cannot be illustrated and that a few were shown. If one M/S bar 124a was in a good room location measuring a “5” and the second M/S bar 124b was in a poor location measuring a “2-3” or even a “1” the Room System Score Performance Processor 901 would recommend 805 another placement of the second M/S bar 124b taking into account the M/S bar 124a and 124b system requirements and configuration parameters that is determine to be more suitable.

With reference to FIG. 8f, illustrated is a single M/S bar 124 system that has been installed into a room 101 that may be a bit too “large” to perform optimally and the Room System Score Spatial Map 701 shows this as most of the room 101 is covered with suboptimal scores between “1-3”.

Illustrated in FIG. 8g, if the technician 102 selects to insert a dual M/S bar 124a and 124b system into the same room the Room System Score Spatial Map 701 improve significantly as shown as a much larger area of the room 101 is showing a score of “5” because the dual M/S bar system 124a and 124b has more microphones arrays 125 and speakers 106 to overcome the larger room 101 requirements and acoustic properties.

With reference to FIGS. 8h, 8i and 8j, conceptually illustrated is how the Room System Score Performance Processor 901 can undertake a combined room 101 and equipment 120 analysis and then show on the Room System Score Spatial Map 701 the differences between similar systems of component size, as performance quality is incrementally increased as shown in “Product A” FIG. 8h, “Product B” FIG. 8h and “Product C” FIG. 8h respectively. No specific products are cited or inferred, and the descriptions are generalized for illustrative purposes. The room 101 is a fixed dimension and would be suitable for all products from room 101 size and a product recommendation perspective. The room 101 has a higher average noise floor perhaps in the 68 dB (A) and is reverberant beyond typical accepted parameters perhaps between 1.0-1.5 s. Two noise sources (HVAC vents) 127a and 127b are in opposite corners of the room 101 in the ceiling and are active most of the time causing the high noise floor in the room 101.

With reference to FIG. 8h, “Product A” is considered a low performance product category. Such products typically prioritize price over performance parameters. An example of some generalized performance parameters which can be characterized as Noise Reduction=low, Reverb Handling=low and Microphone 107 and Speaker 106 coverage=low. Low means poor performing in contrast to much better and higher spec'd Products. In the case of “Product A” the Room System Score Spatial Map 701a shows poor room system performance scores between a “1-3” which is far from optimal with only one small area of the room 101 showing a score of ‘5″. This informs the technician 102 that although “Product A” may be appropriate from a manufacturer's recommendation based on room 101 size it is not suitable based on the actual measured room 101 acoustics and “Product A” configuration parameters.

With reference to FIG. 8i, “Product B” is considered an average performance product category. Such products typically try to balance price and performance, attempting to get the best of both worlds so to speak. An example of some generalized performance parameters can be characterized as Noise Reduction=good, Reverb Handling=good and Microphone 107 and Speaker 106 coverage=good. With “Product B” the Room System Score Spatial Map 701b shows better room systems performance scores between a “2-3” which is reduced in area and the “1” area being significantly reduced and split into 2, located near the internal noise sources 127. This is still well below optimal with only a moderate increase in the area of the room 101 showing a score of ‘5″. This tells the technician 102 that although “Product B” may be more appropriate from a manufacturer's recommendation based on the room 101 size it is still not suitable based on the actual measured room 101 acoustics and “Product B” configuration parameters.

With reference to FIG. 8j, “Product C” is considered a high-performance product category. Such products typically sacrifice costs to obtain the highest performance possible and are state-of-the-art in performance. An example of some generalized performance parameters can be characterized as Noise Reduction=excellent, Reverb Handling=excellent and Microphone 107 and Speaker 106 coverage=excellent. In the case of “Product C” the Room System Score Spatial Map 701c shows much better room system performance scores with the “2-3” area significantly reduced and the “1” area being almost eliminated and split into 2 small areas located at the internal noise sources 127 which is more optimal with very large increase in the area of the room 101 showing a score of ‘5″. This tells the technician 102 that “Product C” is the product that will perform the best in this room 101 environment, and they can feel more confident in making a purchase and installation recommendation based on the actual measured room 101 acoustics in combination with “Product C” configuration parameters. If the room 101 noise floor was much lower and/or the reverb scores where more typical the average say 60 dB (A) or less “Product B” and maybe even “Product A” could have demonstrated much better room system performance scores resulting in those products being able to be recommended and a cost savings obtained.

With reference to FIGS. 9a, 9b, 9c, 9d, 9e, 9f, 9g and 9h, shown are exemplary illustrations of the primary processing components that make up the Room System Score Performance Processor 901 of a preferred embodiment of the invention.

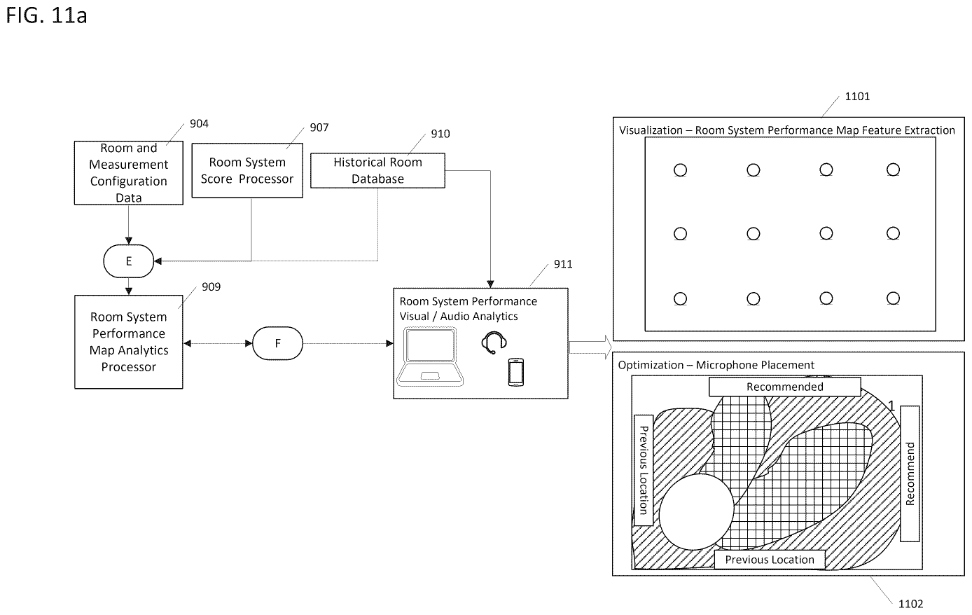

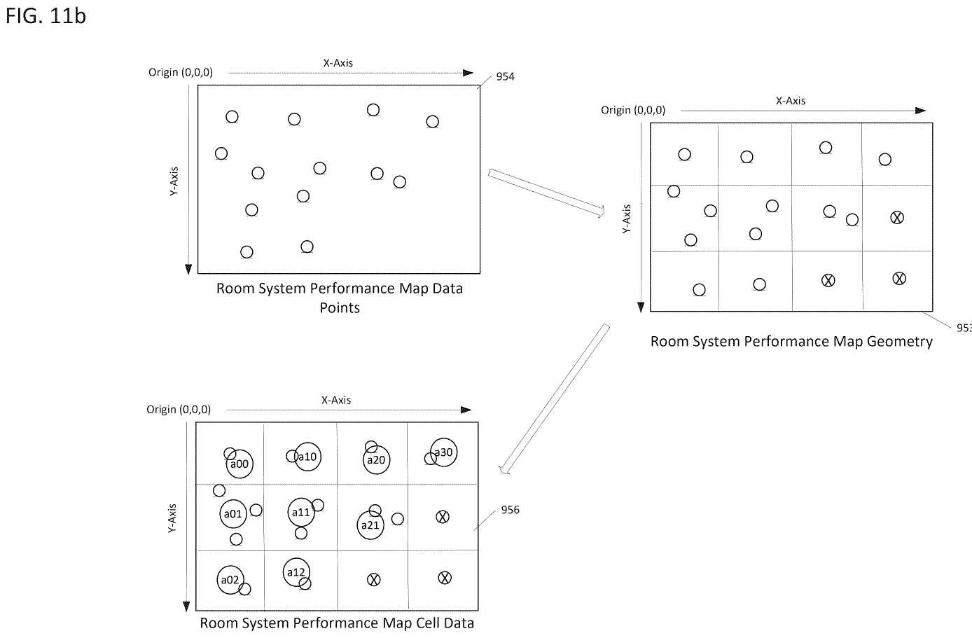

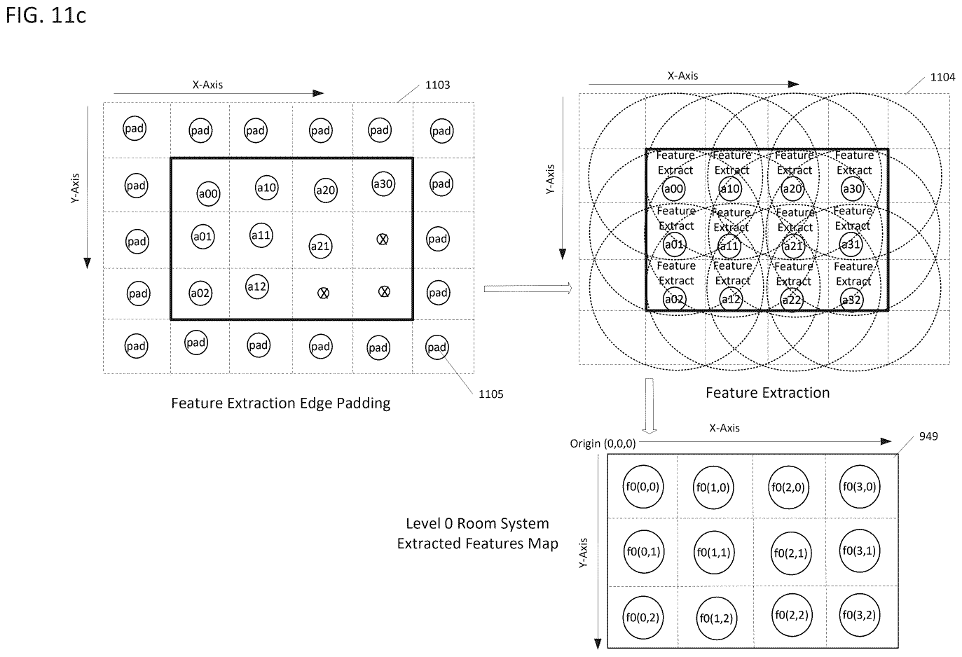

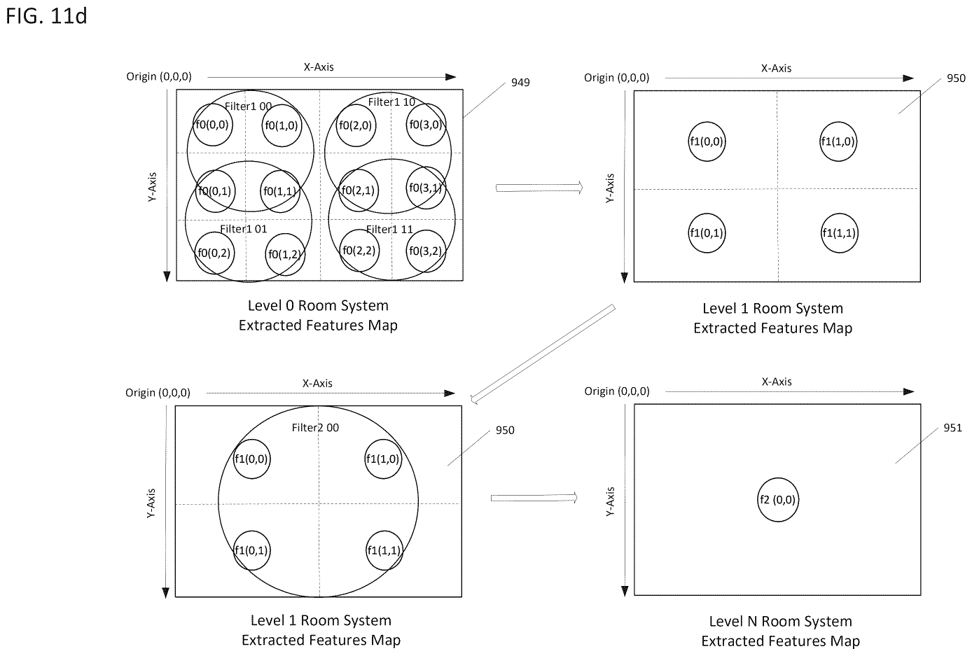

FIG. 9a depicts an overview of the principal components of the system. The input and output devices of the system are a collection of Generators 906, Sensors 978, and Historical Sensor and Generator Data 903. Information from these components is used by the Room System Score Performance Processor 901, whose principal output is a Multiscale Room System Performance Map 975 (FIG. 9g). The Multiscale Room System Performance Map 975 is a composite structure made up from the Room System Performance Map 948 and multiple scaled representations derived from Build Multiscale Room System Performance Map 947 (FIG. 9h). The Room System Performance Map 948 is a map that models the room system performance at various locations 502 in the room 101 and over given time 129 periods. The output of the Room System Score Performance Processor 901 is made available to various External Downstream Data Consumption Processes 911 such as conference systems 120, conference peripherals such as M/S bars 124, smart phones and tablets 301, computers 109, virtual machines 912 and cloud based computing 913 including applications such as a Room System Performance Visual/Audio Analytics Applications 911 (FIG. 11a) where visual representations (Room System Score Spatial Map) 701 of the Multiscale Room System Performance Map 975 can be explored as illustrated in FIGS. 7f to 7h and other room optimizations can be recommended, such as microphone 107 and speaker 106 placement as illustrated in FIGS. 8b, 8c, 8d, 8e and 8f or the performance of different products compared FIGS. 8h, 8i and 8j.

With continued reference to FIG. 9a, Generators 906 are devices or other methods or mechanisms that emit signals into the room 101. They are broken into Indirect Sources and Direct Sources. Examples of Indirect Sources include the use of items such as balloons 302, starter pistols 302a, or separate sound files 902 not generated by the Room System Score Performance Processor 901 to generate sound in the room 101. Direct Sources include the use of speakers 106 to play various sounds into the room 101. The sounds played by Direct Sources include known test or reference signals 918 from the Historical Sensor and Generator data 903. Sensors 978 are devices, such as measurement microphones 501, 107, M/S bar 124, and camera 121, that produce sensor readings known as measurements which get stored in a measurement data structure 504 (FIGS. 5c-5f) at different locations 502 (FIG. 5f) in the room 101, producing a location 502 based measurement which get stored in a measurement data structure 504 (FIG. 5c), which is a combination of the Sensor 979 location, orientation, roll, and measurement data point. The Room System Score Performance Processor 901 as described in this specification focuses on the use of measurement microphones 501 as the most used Sensor 978. The purpose of Sensor 978 is to make a measurement which get stored in a measurement data structure 504 for that room 101 that can be used in the inference of room system and use case performance at various locations 502 and as such, a range of other Sensors 978 such as cameras 121, can also be used.

At the highest level the Room System Score Performance Processor 901 works by using one or more Generators 906 to emit some sound into the room 101, for example using a balloon pop 302 in the process of determining an impulse measurement (RT60) (FIGS. 4c and 4d). The Room System Score Performance Processor 901 also uses one or more Sensors 978, to measure the room's 101 response to the Generator's 906 signal. It should be noted that the Room System Score Performance Processor 901 can also use the Sensors 978 to take measurements which get stored in a measurement data structure 504 in the room 101 without the introduction of a Generator 906 signal first, for example in the measurement of background noise (FIG. 4e). The location of Generators 906 and Sensors 978 are defined in and obtained from the Room and Measurement Configuration Data 904. The Room and Measurement Configuration Data 904 define a range of other Generator 906 and Sensor 978 parameters which are illustrated in FIG. 9b

The output 501 from one or more Sensors 978, at given locations 502 within the Coordinate Reference Frame 505, are provided to the Audio Measurement Processor 905 as a defined measurement which are subsequently stored in a measurement data structure 504 which computes one or more acoustic measurements from them. Sensors 978 output standard sensor measurement data structure 504 to the Audio Measurement Processor 905 through standard connection and communication protocols. Examples of measurements of acoustic parameters (acoustic measurements) include but are not limited to Background Noise made up of Background noise Pre-Processing 923 and Background Noise Measurements 924 (FIG. 9c), Impulse Measurements made up of Impulse Pre-Processing 925 and Impulse Measurements 926 (FIG. 9c), Spectrum Measurements made up of Spectrum Pre-Processing 926 and Spectrum Measurements 928 (FIG. 9c), and STIPA Measurements made up of STIPA Pre-Processing 929 and STIPA Measurements 930 (FIG. 9c) respectively

With continued reference to FIG. 9a, the outputs of the Audio Measurement Processor 905 are, now, provided to the Room System Score Processor 907. The Room System Score Processor is the core of the Room System Score Performance Processor 901 as it brings together the measurements from the Audio Measurement Processor 905, with information about the room 101, the conferencing system 120, and use case information, such as meeting rooms, conference rooms, hybrid rooms and classrooms. The Room System Score Processor 907 uses this data to infer a room system location score for the location 502 associated with the measurements data structure 504 as a composite or aggregate value derived from all the input configuration and measurements. This is achieved in a two-step process. The first step uses one or more Sensor Score Inference Engines 939 (FIG. 9e), one inference engine for each type of measurement for the given location 502, to infer the impact each specific measurement contained in a measurement data structure 504 will have on the final room system location score for the given location 502. The second step uses a Location Score Inference Engine 945 (FIG. 9e) to infer the final room system location score, for the given location 502 as an aggregation of all the inputs from the Sensor Score Inference Engines 939. Both the Sensor Score Inference Engine 939 and the Location Score Inference Engine 945 use information about the room 101, the conference system 120, and the use case scenario when making their determinations. In this way information from specific measurements is combined with details of the room 101, the conference system 120, and the intended use case in the determination of the room system location score by the Room System Score Processor 907. The Room System Score Processor 907 generates room system location scores in this fashion for multiple locations 502 in the room 101—see FIG. 5f for an illustration. The Room System Score Processor 907 builds a Room System Performance Map 948 as collection of these location scores. Although the illustrations (e.g. FIG. 5f) depict locations 502 in two-dimensions, it is important to note that locations 502 are defined in three spatial dimensions and can have varying measurements stored in measurement data structure 504 over time 129. Therefore, the Room System Performance Map 948 is a four-dimensional object that has both spatial and temporal dimensions. More details about the Room System Score Processor 907 can be found in FIG. 9e.

The System Configuration Processor 908 configures and initializes the Room System Score Processor 907. The System Configuration Processor 908 uses data from the Room and Measurement Configuration Data 904, which describes the room 101, the conferencing system 120, and the use cases, to configure the Room System Score Processor 907 to accurately infer room performance location scores for each different locations 502 in the room 101. As indicated previously, the Room System Score Processor 907 uses several Sensor Score Inference Engines and Location Score Inference Engines 945 to determine the room system location scores. The output from the System Configuration Processor 908 is used to create and configure Sensor Score Inference Engines 939 and Location Score Inference Engines 945 that are appropriate for the current environment. More details of the System Configuration Processor 908 are shown in FIG. 9d.

The Room System Performance Map Analytics Processor 909 uses the location 502 scores produced by the Room System Score Processor 907 and the Historical Room Database 910 to produce a Room System Performance Map 948, which provides a structure for spatial and temporal interpolation between individual location 502 scores, allowing performance scores to be determine over surfaces and volumes in the room 101, and not only at defined locations 502 within the coordinate reference frame 505. The location scores provided to the Room System Performance Map Analytics Processor 909 are an unstructured collection or cloud of data points defined within the Coordinate Reference Frame 505 and within a defined time 129 period. The spatial and temporal bounds of the data are defined and obtained from the Room and Measurement Configuration Data 904. The Room System Performance Map Analytics Processor 909 also produces a Multiscale Room System Performance Map 975 which is derived from the Room System Performance Map 948. The Multiscale Room System Performance Map 975 is derived from the Room System Performance Map 948 by extracting interesting or important features from it, then modeling these features at various scales. A Multiscale Room System Performance Map 975 is produced because it has numerous benefits to External Downstream Data Consumption Processes 911 that would use it, such as a Room System Performance Visual/Audio Analytics Applications 911 (FIG. 11a) where visual representations of the Multiscale Room System Performance Map 975 can be explored as illustrated in FIGS. 7f to 7h. More details of the Room System Performance Map Analytics Processor 909 can be seen in FIGS. 11a to 11d, FIGS. 12a to 12d, and FIGS. 13a to 13h inclusive.

Data produced and consumed by components in the Room System Score Performance Processor 907 are created, retrieved, updated, and deleted in the Historical Room Database (HRDB) 910. The Historical Room Database 910 is a central data repository, which may be housed locally, on a server, or in the cloud in various instantiations. The Historical Room Database 910 uses the Coordinate Reference Framework 505 as its spatial (x, y, z) and temporal (t) reference system. Other components in the Room System Score Performance Processor 901 access and utilize the data in the Historical Room Database 910 by referencing the Coordinate Reference Framework 505 illustrated as by the (D) connection point in FIG. 9a. For example, results from the Room System Score Processor 907, in the form of measurements stored in measurement data structure 504 obtained at various locations 502 and at various times 129 are stored in the Historical Room Database 910. Later uses of the Room System Score Performance Processor 901 can retrieve previous results by specifying Coordinate Reference Framework 505 coordinates and time 129 periods corresponding to the space and time coordinates associated with the results associated with the specific room 101 of interest when they were first created. Note that the spatial and temporal bounds that are used by processing components, such as the Room System Performance Map Analytics Processor 909, to determine which results to retrieve from the Historical Room Database 910 are defined and obtained from the Room and Measurement Configuration Data 904.

To summarize the components in FIG. 9a, the Room System Score Performance Processor 901 is configured using the Room and Measurement Configuration Data 904 and the System Configuration Processor 908. Measurements are taken through sensors 978 using the Audio Measurement Processor 905, which uses various measurement engines 921 (FIG. 9c) to output raw measurement data taken at a given locations 502 and times 129. The Room System Score Processor 907 then generates sensor scores derived from the raw measurement data 504 through the use of various Sensor Score Inference Engines 939 (FIG. 9e). Sensor scores are representations of various raw measurement data 504 initially described in different units that are translated into a uniform normalized scale to allow different values and units of various measurement types to be aggregated together. Once sensor scores are generated, Location Score Inference Engines 945 (FIG. 9e) are used within the Room System Score Processor 907 to generate location scores, each of which refer to a score generated for a given location 502 at a given time 129 through the aggregation and analyses of one or more sensor scores derived from various measurements. This step acts to aggregate various sensor scores together by location 502 and time 129. Finally, a Room System Location Performance Score is generated, which represents a collection of various location scores that are taken within a room 101 during a given timeframe 129 which can be processed into a Room System Performance Map 948 (FIG. 9g) and visualized as a Room System Score Spatial Map 701.

FIG. 9b illustrates the Room and Measurement Configuration Data 904 component in more detail. Room and Measurement Configuration Data 904 performs the central function of managing information needed to configure and initialize all other processor components within the Room System Score Performance Processor 901. It defines the spatial and temporal context that the Room System Score Performance Processor 901 will use. The contents of Room and Measurement Configuration Data 904 may be stored in a non-transitory storage medium of the Room System Score Performance Processor 901.

Room and Measurement Configuration Data 904 can be manually entered by a user 102 of the Room System Score Performance Processor 901. For example, if dynamic real time analysis is being conducted in a specific room 101 and the Room Score Performance Processor 901 is processing data from Sensors 978 and providing immediate analysis and feedback, in this scenario, the user 102 may manually tweak elements of the Room and Measurement Configuration Data 904 and see the impact the change has on the system 120 output. Room and Measurement Configuration Data 904 data can also be sourced from previously saved Room and Measurement Configuration Data 904, from previous uses of the Room System Score Performance Processor 901. Room and Measurement Configuration Data 904 can also be retrieved from the Historical Room Database 910, by providing spatial and temporal bounds (i.e. the room 101 and the time 129) of the Room and Measurement Data 904 required. It is also possible that some or all elements of the Room and Measurement Configuration 904 come from other upstream sources. For example, specification of the Room Geometry could be provided by a laser scanner that automatically determines the size and shape of the room 101, Sensor 978 and Generator 906 locations 502 could be provided directly from the conference system 120 being used and input into the coordinate reference frame 505 and so on.

The data that the Room and Measurement Configuration Data 904 contains falls into three main categories. It contains details of the Room Configuration 914, the definition and configuration information for all Sensors 978 in the room 101, which includes Sensor Configuration 915, and Sensor Output 917 information. Lastly it contains the definition and configuration information for all Generators 906 and Known Test Signals 918 that are used to drive the Generators 906.

The Room Configuration 914 describes the spatial and temporal context that will be used by the Room System Performance Processor 901. This information includes the Room Geometry, which not only defines the spatial location, size, and shape of the room 101, within the Coordinate Reference Frame 505, but also a temporal dimension, specifying the time period 129 associated with the outputs from the Room System Performance Processor 901. The Room Geometry is used as the coordinate reference frame 505 for all data created, retrieved and updated by the Room System Performance Processor 901, including Generators 906, Sensors, 978, Known Sound Source Locations, Sensor Score Inference Engines 939, Location Score Inference Engines 945, the Room System Performance Map 948, the Multiscale Room System Performance Map 975, and the Historical Room Database 910.

The Room Configuration 914 will also contain additional configuration data that describes or informs other processing and analysis that will be done by the Room System Score Performance Processor 901. For example, it will include a definition of room 101 materials which describes the acoustic properties of the objects and surfaces within the room 101, for example their absorptive and reflective properties. It also includes the location 502 of Known Sound Sources such as undesired sound sources and/or internal noise sources 127, in the room 101. The Room Configuration 914 will contain other room data that informs the creation and configuration of other data processing functions used in the Room System Score Performance Processor 901, including the Audio Measurement Processor 905, Room System Score Processor 907, System Configuration Processor 908, and the Room System Performance Map Analytics Processor 909. More details are presented later in the respective sections.

Room and Measurement Configuration Data 904 also includes data that defines the Sensor Configuration 915 in the room 101. For all Sensors 978 used, e.g. microphones 107, microphone array 124 or measurement microphones 501 etc., this data defines the spatial (x, y, z) 502 and temporal (t) 129 parameters of the Sensor 978. This includes, but isn't limited to position, direction, and rotation about the sensor's direction as described in FIGS. 5a to 5c. It's important to note that Sensor Configuration 915 also includes a temporal component meaning that Sensor Configuration 915 data can vary in time 129. For example, the sensor's position, direction, or orientation can change over time 129.

Related to Sensor Configuration Data 915, the Room and Measurement Configuration Data includes data that describes Sensor Output 917, this being the data stream that is received from each Sensor 978 by the Audio Measurement Processor 905. Sensor Output 917 includes the spatial 501 and temporal parameters 129 of the Sensor 978 which creates the output, including the position, direction, and orientation information as described in FIGS. 5a to 5c. This supports the modeling and use of Sensors 978 which are at one location 502 at a given time 129 (t1) a Sensor Output 917 also includes the raw data from the Sensor 978, for example a WAV file recorded from a microphone 107, microphone array 124 or measurement microphone 501. Finally, Sensor Output 917 also contains metadata that is needed to decode the raw sensor data. For example, sample rate, bits per sample, etc.

Like Sensor Configuration Data 915, Room and Measurement Configuration Data 904 also defines data associated with Signal Generation 916. For all Generators 906 used to create signals in the room 101, e.g. speakers 106, balloon pops 302 etc., this data defines the Generator's 906 spatial and temporal parameters. This includes, but isn't limited to position, direction, and rotation about the generator's direction as described in FIGS. 5a to 5c. It's important to note that the Generator Configuration 916 includes a temporal 129 component meaning that Generator Configuration 916 data can vary in time. For example, the generators 906 position, direction, or orientation can change over time 129. Signal Generation 916 also includes Generator Specific Data that is pertinent to the configuration, initialization, and operation of any specific Generator 906 and which might be needed by other processing components to correctly configure, initialize, and drive it. The Signal Generation 916 data includes specific Signal Data/Definition information, which describes the attributes, settings and statistical properties of the test signal that will be generated.

Generators 906 require signals to drive them, that is an input that will cause the Generator 906 (e.g. a speaker 106) to emit sound into the room 101. The Room and Measurement Configuration Data 904 therefore include data describing Known Test Signal Input 918 that are used to drive Generators 906. Known Test Signal Input 918 are signals that have specifically known statistical or acoustic properties which are defined by the Signal Data/Definition which can include waveform properties such as waveform type and shape being for example but not limited to sine, square, ramp, triangle, noise profiles such as but not limited to white, pink, brown, red and/or band-limited start and stop frequencies and power envelope including output levels and level offsets from zero-level output references while also defining signal time periods, pulse rates and lengths such as continuous, swept, gated and time boxed as needed so support the required Generator Raw Data output. The Generator Raw Data, when sent to the Generator 906, will create an audio sound in the room 101 with characteristics defined by the Signal Data/Definition. Like Sensor Output 917, Known Test Signal Input 918 includes the spatial and temporal parameters of the Generator 906 which created the signal in the room 101. This includes the position, direction, and orientation information 502 as described in FIGS. 5a to 5c. It also includes the temporal 129 component of the Generator's 906 configuration, thereby allowing precise details of the location 502 of the Generator 906 over time 129 as the Known Test Signal Input 918 was being emitted. Known Test Signal Input 918 also includes the raw data used to drive the Generator, for example a WAV file used to drive a speaker 106. Finally, Known Test Signal Input 918 also contains metadata that is needed to decode the raw sensor data. For example, sample rate, bits per sample, etc.

The Room and Measurement Configuration Data 904 is stored and made available via the Historical Room Database 910 data repository, indexed on the room 101 properties and attributes, spatial and temporal coordinates 129, from which the Room System Score Performance Processor 901 components and other external processes, can query and retrieve data. Examples of these external processes include tools that allow users to visualize the room 101 performance information computed by the Room System Performance Map Analytics Processor 909 such that it can be explored and insights obtained from it, such as where the room 101 and system 120 is likely to perform well or poorly (FIGS. 7a-h). Other downstream uses of the Multiscale Room System Performance Map 975 include, but are not limited to, using the data to make position and orientation for feasible recommendations as to where conference system 120 components, such as microphones 107, microphone arrays 125, speakers 106 as illustrated in FIGS. 2a to 2g, may be installed or placed to provide better performance in the example rooms 101 illustrated in FIGS. 1a to 1g and FIGS. 8a to 8i. These conference system 120 components may be physically placed or installed according to the feasible recommendations based on the Multiscale Room System Performance Map 975 to practically provide better audio performance in rooms 101.

FIG. 9c illustrates the Audio Measurement Processor 905 in more detail. The Audio Measurement Processor 905 serves to compute audio measurements such as background noise, impulse time domain, spectrum, and STIPA, illustrated in FIGS. 4a to 4e, and then provide them to the Room System Score Processor 907. These measurements are computed by various Measurement Engines 921 and processed by the Measurement Output Processor 922, which enriches the output of the Measurement Engine 921 with additional contextual data, including Sensor Configuration 915 data and Sensor Output Data 917. The Measurement Output Processor 922 transforms the measurement data from each Measurement Engine 921 into a common format and structure before being output to and used by the Room System Score Processor 907.

The Audio Measurement Processor 905 is configured using data from Room and Measurement Configuration Data 904. Elements of this data including Sensor Configuration 915, Sensor Output 917, Signal Generation 916, Known Test Signal Input 918, and Room Configuration 914 to ensure that the Measurement Engines 921 are created and configured to take measurements correctly.

Audio measurements are taken using Sensors 978, such as microphones 107 and cameras 121, as described in FIGS. 7a to 7d. The output from Sensors 978 are processed by the Sensor Preprocessing unit 920 which involves Sensor 978 calibration that ensures Sensors 978 are ready to take accurate measurements.

As illustrated in FIGS. 3a to 3d, acoustic measurements can be taken through direct and indirect methods. Using direct measurements, Know Test Signals are emitted into the room 101 using Generators 906, such as speakers 106, as depicted in FIGS. 6c to 6i. Before a Known Test Signal 918 is used to drive a Generator 906, Generators 906 are set up by the Generator Preprocessing unit 919 which ensures that the Generator 906 (e.g. a speaker 106) is correctly configured. Configuration of a Generator 906, for example, may include adjusting the output gain, the output frequency profile, phase and signal type or otherwise adjusting Generator 906 parameters to ensure that the Generator 906 is specifically tuned and calibrated to the room 101 and Sensor 978 such that the Known Test Signal 918 drives the Generator 906 to emit the necessary signal in the room 101 for the Sensor 978 to be used to take accurate measurements. Therefore, with direct measurement, the response of the room 101, to the signal emitted by the Generator 906, is measured by one or more Sensors 978, at known locations 502, and time 129 within the room 101, as illustrated in FIGS. 6a to 6b.

Using indirect measurements Generators 906, such as balloon pops 302, at known locations 502, are used by a user 102 to emit a signal into the room 101. Again, the response of the room 101 to the emitted signal is measured by one or more Sensors 978, at known locations 502, and times 129 within the room 101, as illustrated in FIGS. 6a to 6b.

FIG. 9c, illustrates the support for specific Measurement Engines 921, for different types of audio measurement. For example, there are specific Measurement Engines 921, Background Noise made up of Background noise Pre-Processing 923 and Background Noise Measurements 924, Impulse Measurements made up of Impulse Pre-Processing 925 and Impulse Measurements, 926 Spectrum Measurements made up of Spectrum Pre-Processing 926 and Spectrum Measurements 928, and STIPA Measurements made up of STIPA Pre-Processing 929 and STIPA Measurements 930 respectively. As can be seen, each type of Measurement Engine 921 contains two stages. The first stage involves Pre-Processing, which for example would include but not be limited to Background Noise Preprocessor 923, Impulse Pre-processing 925, Spectrum Preprocessor 927, and STIPA Pre-Processor 929, one pre-processing stage for each type of measurement we want to compute. The purpose of the pre-processing stage is to initialize and warm up and stabilize the Sensors 978 and to start the actual measurement process in the second stage. The second stage is where measurements 504 are computed from the data coming from the associated Sensor 978. There is specific second stages for each type of measurement including for example Background Noise Measurements 924, Impulse Measurements 924, Spectrum Measurements 928, and STIPA Measurements 930. It is important to note that certain Measurement Engines 921 can be run in parallel depending on the constraints and requirements of the measurement. It should also be noted that standard and best practice approaches to initializing and setting up sensors 978 and the approach to recording and computing measurements are well understood in the prior art. Additional Measurement Engines (931, 932) can readily be added using Pre-Processing and Measurement stage implementations that are derived from prior art, provided by 3^{rd} parties in whole or in part and incorporated into the Audio Measurement Processor 921. As such, the specific measurement implementations fall outside the primary scope of this specification.

So far, the description of the Audio Measurement Processor 905 has described how it is used in a real-time fashion. That is when the Audio Measurement Processor 905 is receiving data from real Sensors 978 in a real room 101 in real-time. The Audio Measurement Processor 905 can also be operated in an off-line mode. In this mode of operation, the inputs to each of the Measurement Engines 921, rather than coming from a physical Sensor 978, comes from the Historical Room Database 910. The Historical Room Database 910 uses the Coordinate Reference Framework 505 as its spatial and temporal reference system. Previous uses of the Room System Score Performance Processor 901 stores data produced in the Historical Room Database 910 using the Coordinate Reference Frame 505. This includes the Room and Measurement Configuration Data 904, which includes the Room Configuration 914, Sensor Configuration 915, Signal Generation 916, Sensor Output 917, and Known Test Signal Input 918. Data is retrieved from the Historical Room Database 910 by providing it with a spatial reference (i.e. the coordinates of a room 101) and a temporal reference (i.e. the time 129 period, start and end) associated with the data we are interested in. Retrieving historic data, and particularly the Room Configuration 914, the Sensor Configuration 915, and the Sensor Output 917, allows the Audio Measurement Processor 905 to replay past scenarios allowing other processing components in the Room System Score Performance Processor 901 to also be driven by this retrieved off-line data. For example, different analysis can be performed by adjusting the parameters used by the Room System Performance Map Analytics Processor 909. Or, different Sensor Score Inference Engines 939 or Location Score Inference Engines 940, can be used to explore location scores for different configurations of conference systems 120 or use cases without having to repeat data collection and analysis in real rooms 101 in real time.

FIG. 9d illustrates the details of the System Configuration Processor 908 and its role in configuring and initializing the Room System Score Processor 907. Unlike previous measurement techniques, from the prior art, used by acousticians, the Room System Score Performance Processor 901, does not simply or only use various audio measurements 502, potentially from unspecified locations 502 and unspecified times 129 from a room 101 to determine how a particular conferencing system 120 might perform in that room 101. The Room System Score Processor 907 uses audio measurements stored in measurement data structures 504, from known locations 502, within a defined Coordinate Reference Frame 505 and at various and known times 129. This data, which is provided by the Audio Measurement Processor 905, is enriched by the Room System Score Processor 907 with additional information about the room 101, the conferencing system 120, and the intended use case. This data subsequently used by the Room System Score Processor 907 to make accurate inferences about the room systems location scores at various locations 502 and at various times 129. The core of the technique used by the Room System Score Processor 907 in producing the room system location score is the use of a range of Sensor Score Inference Engines 939 and Location Score Inference Engines 945. The precise details of these are described in FIG. 9e. For now, we focus on how the System Configuration Processor 908 selects and determines initial conditions, or initialization variables that will be used, by Room Score Processor Initializer 938 (FIG. 9e).

The System Configuration Processor 908 maintains a collection of data that describe the properties or configuration of the environment (i.e. the room 101, the conference system 120, and the intended use case) which the Room System Score Processor 907 will be evaluating. These details are modeled in the System Configuration Processor 908 as Room Configuration 934, Conference System Configuration 935, Use Case Data 936, and Performance Model Configuration 937. The data is obtained from Room and Measurement Configuration Data 904 or from the Historic Room Database 910. The function of the System Configuration Processor 907 is to transform this environment configuration data into Initialization Variables and their values that the Room System Score Processor 907 can use to establish, that is, select and configure, the necessary Sensor Score Inference Engines 939 and Location Score Inference Engines 945 to make accurate inferences about the defined room systems location scores at various locations 502 and at various times 129.

The System Configuration Processor 908 uses the System Configuration Initializer 933 to manage the creation of the Initialization Variables, and the selection of appropriate Sensor Score Inference Engines 939 and Location Score Inference Engines 946 using the Room Configuration 934, Conference System Configuration 935, Use Case Data 936, and Performance Model Configuration 937. This information is passed to the Room Score Processor Initializer 938 which initializes or bootstraps the Room System Score Processor 907 by initializing and configuring the selected Sensor Score Inference Engines 939 and Location Score Inference Engines 945 using the Initialization Variables provided. The Room System Score Processor 907 then uses the configured Sensor Score Inference Engines 939 and Location Score Inference Engines 945 to accurately infer room system location scores fine-tuned based to the room 101, conference system 120, and use case intended.

The System Configuration Processor 908 uses Room Configuration 934 data to provide the Room System Score Processor 907 with the data that it needs to fine tune the Room System Score Processor 907 to the details of the room 101. A range of data is defined which includes, but is not limited to the room 101 conditions, which includes room 101 geometry and materials, known sound source location (as defined in Room Configuration 914). The Room Configuration 934 data will also contain additional data that might be required as input to specific implementations of Sensor Score Location Inference Engines 939 or Location Score Inference Engines 945. For example, specific implementations of these engines 939 might require the identification and location of furniture in the room 101, or they may require data about humidity and temperature, in which case these factors would be included in the Room Configuration 934 data.

The System Configuration Processor 908 also uses specific Conference System Configuration 935 information to adjust the Room System Score Processor 907 so that it considers specific details of the conferencing system 120 when inferring room system performance location scores. Examples of Conference System Configuration 935 data include the type of the conferencing system 120, a system ID that identifies the manufacturer and model of the particular conferencing system 120, details of how the conferencing system microphones 107, and/or microphone arrays 125 have been positioned and configured in the room 101, details of how the conferencing system speakers 106 have been positioned and configured, and details of any video components or other relevant system information. The Conference System Configuration 935 may also include a range of other system information specific to conference system 120 implementations or configurations. For example, this system 120 information can include the polar patterns of microphones 107, microphone array 125 setup parameters used in the system 120, or the configuration and use of specific noise suppression techniques and audio post processing functions such as gain structure, EQ and filtering.

The System Configuration Processor 908 also uses specific Use Case Data 936 when configuring the Room System Score Processor 907. Use Case Data 936 contains information that identifies the Use Case, via a Use Case ID, for example identifying the use case as a presentation, a meeting, a musical performance, classroom, hybrid room and so on. Use Case Data 936 also contains Use Case Config data that contains a collection of constants and coefficients that describe the use case, and which would adjust the Room System Score Processor 907 to more accurately infer results for the particular use. For example, some use cases can be less sensitive to background noise but reverberation might pose larger concerns. In this case, the Location Score Inference Engine 945 may weight Sensor Score Inference Engine 939 scores for background noise lower than those for reverberation. Use Case Data 936 may also include details about the expected number of people (participants) 102 in the room and a range of other metadata that describes the use case overall. Additional metadata for a use case may include details around different camera 121 and audio zones in the room 101, for example where presenters 102 are located, where the audience is and so on.

The data detailing the Room Configuration 934, the Conference System Configuration 935, and the Use Case Data 936 are all used to fine tune the Sensor Score Inference Engines 939 and the Location Score Inference Engines 945 will be used by the Room System Score Processor 907. The System Configuration Processor 908 has configuration data that is important to the performance of the Room System Score Processor 907 referred to as the Performance Model Configuration 937. This data is used to determine what inference models are available, can be used, and how they should be configured for the Sensor Score Inference Engines 939 and the Location Score Inference Engine 945. For any Sensor Score Inference Engine 939 and Location Score Inference Engine 945 type there may be a range of inference models available. For example, but not limited to there may be simple Rule-Based inference models, a collection of “if-then” rules to derive conclusion from the inputs. There could be other models that derive conclusions from inputs using a simple linear relationship between the inputs and the outputs. Other models may be based on a Fuzzy Logic approach, where reasoning is approximate rather than fixed, providing flexibility to deal with uncertain or imprecise inputs. Finally, there can be Machine Learning (ML) models that use an underlying Neural Network which has been pre-trained for types of rooms 101, different conference system 120, or various use cases, or any combination of these factors. Performance Model Configuration 937 also contains a set of Model Config data. The Model Config data will inform the Room Score Processor Initializer 938 how the chosen Sensor Score Inference Engine 939 or Location Score Inference Engine 945 should be configured. For simple inference models, that use a linear model for example, the Model Config data may be as simple as a small set of coefficients and offsets to use. For more complex Neural Networks, the Model Config will identify the structure of the Neural Network and the weights to apply to it.

The Performance Model Configuration 937 is therefore a collection of data, with elements for each inference model that can be used. Performance Models that can be used will be governed by the Room Configuration 934, because not all models will be appropriate for all rooms 101, the Conference System Configuration 935, because some conference systems 120, may have more accurate models than others, and Use Case Data 936, because again, not all models will be appropriate for every use case.

FIG. 9e depicts details of the Room System Score Processor 907. As can be seen, the Room System Score Processor 907 processes the audio or acoustic measurements from the Audio Measurement Processor 905. The Audio Measurement Processor 905 provides the audio and/or acoustic measurements, from one or more Measurement Engines 921, which derived input 501 from either one or more Sensors 978, in a room 101, at different locations 502 and at different times 129 within the defined Coordinate Reference Framework 505, or from the Historical Room Database 910.

The Room System Score Processor 907 processes the input audio (or acoustic) measurements according to the Initialization Variables provided by the System Configuration Processor 908 and Room and Measurement Configuration Data 904. The definition of the spatial and temporal extent in the Room and Measurement Configuration Data 904 is used to determine if real-time data or historic, pre-recorded data, or some combination of both is being used. As described earlier, the Audio Measurement Processor 905 can provide measurements retrieved from the Historical Room Database 910. This means that the Room Score Processor 907 also has two sources from which it can receive input. It can receive real-time data, as it is being collected from Sensors 978 in a room 101, and it can process data that has been previously recorded by Sensors 978 for the analysis of past events or conditions. The definition of the spatial 505 and temporal 129 extent, in the Room Configuration Data 904, determines if real-time data from Sensors 978 is being used or if historic, pre-recorded data from the Historical Room Database 910 is being used. Historical Room Database 910 will be used as a source if the spatial extent of the data being requested (as defined in the Room and Measurement Configuration Data 904), is larger than the current room 101. That is, it indicates that data from other rooms 101 should also be retrieved. Historical Room Database 910 will also be used as a source, if the temporal extent of the data being requested includes time 129 in the past. The Room System Score Processor 907 can work simultaneously with both sources of data, thereby enabling real-time analysis to be combined or augmented by previous measurements 504.

The Room System Score Processor 907 processes one or more input measurements from the Audio Measurement Processor 905 using one or more inference engine pipelines. There is one inference engine pipeline for each location 502 in the room 101, from which the Room System Score Processor 907 produces a room system location score to be associated with the given location 502, and the given time 129. For example, with reference to FIG. 5f, in this room 101, the Room System Score Processor 907 would use up to 29 (there are 29 Sensors 978, at various locations 502) different inference engine pipelines to produce room location scores for each location 502. There would be 29 pipelines used simultaneously if the constraints on the audio measurements being obtained allow measurements to occur in parallel (for example if we are only using background noise measurements). If, for whatever reason, multiple measurements cannot be taken simultaneously then fewer inference engine pipelines would be used at the same time.

Each inference engine pipeline used in the Room System Score Processor 907 contains two stages. The first stage is a Sensor Score Inference Engine 939, and the second stage is the Location Score Inference Engine 945. The Sensor Score Inference Engine 939 is used to derive a room system location score impact weight from the audio measurements provided to it for each measurement and location 502. The impact weight inferred from the input audio measurements will be based on the measurement data on the Initialization Variables provided by the System Configuration Processor 908. This allows the Sensor Score Inference Engine 939 not only to consider the specific audio measurements 504 and their location 502, but a host of other data including Room Configuration 934, Conference System Configuration 935, Use Case Data 936, and a set of Performance Model Configurations 937 values fine-tuned based on this information.

The Room System Score Processor 907 will have one or more Sensor Score Inference Engines 939 for each type of measurement the Audio Measurement Processor 905 produces via its available Measurement Engines 921. Examples of Sensor Score Inference Engines 939, include but are not limited to Background Noise Inference engine 940, Impulse Inference engine 941, Spectrum Inference engine 942, STIPA Inference engine 943. As additional measurement engines (931, 932) are added then Additional Inference Engines 944 would also be used accordingly.

Each Sensor Score Inference Engine 939 used is initialized using the Room Score Processor Initialization 938. As mentioned earlier (see FIG. 9d), Sensor Score Inference Engines can contain several inference models that the Sensor Score Inference Engine 939 (and the Location Score Inference Engine 945) can use. Not all inference models are appropriate for every situation. The System Configuration Processor 908 ensures that the Room System Score Processor 907 is only presented with the most appropriate Sensor Score Inference Engines 939 for the current situation. It uses information from the current Room Configuration 934, the Conference System Configuration 935, the Use Case Data 936, and the Performance Model Configuration 937 to determine and specify these and provide the information to the Room Score Processor Initialization as a collection of Initialization Variables. The Room Score Processor Initialization 938 uses these Initialization Variables to create and configure specific Sensor Score Engines 939, that are optimized and fine-tuned to the room 101, conference system 120, and use case conditions.

The second stage in each inference engine pipeline is the Location Score Inference Engine 945. There is one Location Score Inference Engine 945 for each location 502 that the Room System Score Processor 907 will produce a room system location score for. Whereas Sensor Score Inference Engines 939 produce an impact weight, inferring the impact individual audio measurements are expected to have on the room system location score for a given location 502 and time 129, the Location Score Inference Engine 945 produces the final, aggregated, room system location score for the location 502 and time 129. Location Score Inference Engines 945 produce the room system location score, for each location 502, based on an aggregation of one or more Sensor Score Inference Engines 939. Although the Location Score Inference Engine 945 bases its output on all the Sensor Score Inference Engine 939 inputs, these are not the only factors that it uses.

The Location Score Inference Engine 945 infers the room system location score, not only from the Sensor Score Inference Engine 939 inputs, but also on data from the Initialization Variables provided by the System Configuration Processor 939. This allows the Location Score Inference Engine 945 not only to consider the impact several audio measurements will have on the final room system location score, but also to use the location 502, the time 129 and other information describing the environment including the Room Configuration 934, Conference System Configuration 935, Use Case Data 936, and a set of Performance Model Configurations 937 values fine-tuned based on this information.

Therefore, like the Sensor Score Inference Engine 939, each Location Score Inference Engine 945 used is initialized using the Room Score Processor Initialization 938. And like the Sensor Score Inference Engines 939, there are several inference models that the Location Score Inference Engine 945 can use. Again, for clarity, not all inference models are appropriate for every situation. The System Configuration Processor 908 uses the Room Configuration 934, the Conference System Configuration 935, the Use Case Data 936, and the Performance Model Configuration 937 to ensure that only appropriate inference models are used for the current situation. Like the Sensor Score Inference Engines 939, the System Configuration Processor 908 provides the appropriate configuration data to the Room Score Processor Initialization 938, in the form of a set of Initialization Variables. The Room Score Processor Initialization 938 uses these Initialization Variables to create and configure specific Location Score Engines 939, that are optimized and fine-tuned to the room 101, conference system 120, and use case conditions.

Since multiple locations can be measured simultaneously, multiple instances of the Location Score Inference Engines 945 may be used and can be run sequentially or concurrently. The overall room system location score output is preferably a normalized value between a range of 0.0 to 1.0. The final output of the Room System Score Processor 907 is therefore an unstructured (from a spatial and temporal perspective) cloud or collection of data points, where each data point has a defined location 502 and time 129, i.e. there are spatial and temporal components associated with it, within the Coordinate Reference Frame 505 associated to each room 101 and use case 936 the measurement was taken and processed with. Each data point contains the output of a single Location Score Inference Engine 945, which defines the room system location score at the data points location 502 and time 129. The output of the Location Score Inference Engine 945 is defined from a hierarchy of inputs from other components. This hierarchy contains the output from multiple Sensor Score Inference Engines 939, which in turn receive audio measurements from one or more Measurement Engines 921, which produce measurements from the output of one or more Sensors 978. The data associated with Sensors 978 can originate from real-time use of actual Sensors 978 or be retrieved from pre-recorded data stored in the Historical Room Database 910. This collection of data points, i.e. output from one or more Location Score Inference Engines 945, is utilized downstream by the Room System Performance Map Analytics Processor 909 (FIGS. 9f to 9h), where it is used to generate the Multiscale Room System Performance Map 948 (FIGS. 9g to 9h) which is used by External Downstream Data Consumption Processes 911.

FIG. 9f shows the final part of the Room System Score Performance Processor 901, the Room System Performance Map Analytics Processor 909. The Room System Performance Map Analytics Processor 909 receives, as input, a collection of Room System Performance Location Scores (location scores), which are the output of one or more Location Score Inference Engines 945, that define the Room System Performance Location Score, for locations 502, and time 129, within the Coordinate Reference Frame 505 associated with the room 101 and use case 936. This location scores input, is received from the Room System Score Processor 907 and the Historical Room Database 910. The precise collection of location scores received is determined by the spatial 505 and temporal 129 bounds specified by Room and Measurement Configuration Data 904, and specifically the spatiotemporal geometry defined in the Room Geometry 914.

Regardless of their source, the location scores equate to a collection of data points, defined in both space 505 and time 129 dimensions, as output by the Location Score Inference Engines 945. There will be one location score for each location 502 and time 129 that falls within the spatial 505 and temporal 129 bounds defined by Room Geometry 914. Depending on these bounds some of the location scores will come from the Room System Score Processor 907, for example if we are actively doing real time analysis within a room 101. Others will come from the Historical Room Database 910, for example if we wish to include results previously obtained for the room or wish to combine results for different rooms 101. The Room System Performance Map Analytics Processor 909 can combine data from both sources also.

From the input collection of location scores, the Room System Performance Map Analytics Processor 909 computes a Room System Performance Map 948 (FIG. 9g) (Compute Room System Performance Map 946). As there are typically no underlying or implied spatial or temporal structures to the location scores, a significant function of Compute Room System Performance Map 946 is to transform these unstructured location scores onto a structured grid or map. Once a Room System Performance Map 948 has been computed, the Room System Performance Map Analytics Processor 909 builds a Multiscale Room System Performance Map 947 (FIG. 9g) from the Room System Performance Map 948. Build Multiscale Room System Performance Map 947 (FIG. 9g) does this by first applying one or more Feature Extraction 974a (FIG. 9h) filters to the Room System Performance Map 948 to create the Room System Extracted Features Map 949 (FIG. 9g). The Room System Extracted Features Map 949 is used to determine the existence of important features both spatially 505 and temporally 129 within the data. Build Multiscale Room System Performance Map 947 builds a multiscale representation of the Room System Extracted Feature Map 949 by iteratively applying a Down Sampling Convolution Filter 975a (FIG. 9h) to it, producing several variants of it at different spatial and temporal scales Level 1 Room System Extracted Features Map 950, Level N Room System Extracted Features Map 951 Once the Multiscale Room System Performance Map 975 has been computed, the data is made available to External Downstream Data Consumption Processes 911.

The Room System Performance Map Analytics Processor 909 transforms the input data to a structured grid because it represents several advantages for External Downstream Data Consumption Processes 911, and processes described in FIG. 11a, and FIGS. 7d to 7g including: Simplified Data Processing: Structured grids often simplify the implementation of numerical methods and algorithms. Many computational techniques, such as finite difference methods, are easier to apply on structured grids. Improved Visualization: Visualization tools and software are typically optimized for structured grids. This can make it easier to create clear and accurate visual representations of the data. Multiscale representations enable smooth zooming and panning in visualizations, allowing users to explore data at different resolutions seamlessly Interpolation and Resampling: Structured grids facilitate interpolation and resampling of data. This can be useful for creating uniform datasets from irregularly spaced data points, which is often necessary for further analysis. Compatibility with Existing Tools: Many existing software tools and libraries known in the Art are designed to work with structured grids. Converting to a structured grid can make it easier to use these tools without needing extensive modifications. Data Storage and Access: Structured grids can lead to more efficient data storage and faster access times. This is because the data structure is predictable, allowing for optimized storage schemes. Numerical Stability: Some numerical methods exhibit better stability and convergence properties when applied to structured grids, which can be crucial for accurate simulations and analyses.

Efficient Data Management: Multiscale representations allow for efficient storage and management of large datasets by representing data at various levels of detail. This can significantly reduce memory usage and improve performance of downstream processes that would use the performance map. Scalable Analysis: Different levels of detail can be used for different types of analysis. For example, coarse levels can be used for quick, high-level overviews, while finer levels can be used for detailed, localized analysis. Adaptive Processing: Algorithms can adaptively process data at different scales, focusing computational resources on areas of interest. This can lead to more efficient and faster computations. A specific example would be using this with an importance driven approach to microphone 107 and/or microphone array 125 localization in the microphone coverage and focus patterns. Noise Reduction: Filtering data to create multiscale representations can help in reducing noise and highlighting significant features. Hierarchical Modeling: Multiscale representations support hierarchical modeling, where models at different scales can be integrated. Enhanced Compression: Data compression techniques often benefit from multiscale representations, as they can exploit redundancies at different scales to achieve higher compression ratios.

FIG. 9g illustrates more detail associated with the process and data structures that the Room System Performance Map Analytics Processor 909 produces. The overall output of the Room System Performance Map Analytics Processor 909 is the Multiscale Room System Performance Map 947. This output is made up of two significant data structures: the Room System Performance Map 948 and a multiscale derivative of this data that is made up of a base Level 0 Room System Extracted Features Map 949 and several multiscale variants of it (Level 1 Room System Extracted Features Map 950—Level N Room System Extracted Features Map 951).

The Room System Performance Map Analytics Processor 909 creates these data structures using a map-reduce data flow. First the input data is mapped onto the Room System Performance Map 948 by the Compute Room System Performance Map 946 component. Then the output of Compute Room System Performance Map 946 is reduced by computing multiscale derivatives of it using the Build Multiscale Room System Performance Map 947.

The Room System Performance Map 948 is generated from the input obtained from the Room System Score Processor 907 and the Historical Room Database 910, that is a collection of Room System Performance Location Scores (location scores). The spatial 505 and temporal 129 bounds of this data are defined by the Room and Measurement Configuration Data 904. The temporal 129 bounds are used to determine if historical sensor and generator data 903 should be retrieved, through an interface of the historical sensor and generator data 903, from the Historical Room Database 910 corresponding to previous uses of the Room System Score Processor 907. The spatial 505 bounds can also be used to determine if additional data from other rooms 101 should be retrieved from the Historical Room Database 910.

Each location score in the input to the Room System Performance Map Analytics Processor 909 is therefore either a current output from the Room System Score Processor 907 or some previous output from it that was archived in the Historical Room Database 910. Each location score consumed by the Room System Performance Map Analytics Processor 909 is, therefore, the output of a Location Score Inference Engine 945, for a given location 502 and time 129, all within the spatial 505 and temporal 129 bounds defined in the Room and Measurement Configuration Data 904.

The Room System Performance Map Analytics Processor 909 creates a Room System Performance Map 948 from this input using the Compute Room System Performance Map 946 component. The Compute Room System Performance Map 946 creates a Room System Performance Map 948 by first creating a base input data from which the performance map will be derived. This is called the Room System Performance Map Data Points 954, and it consists of the collection of location scores, i.e. Location Score Inference Engine 945 outputs contained within the spatial and temporal bounds defined by the Room and Measurement Configuration Data 904.

Next, Compute Room System Performance Map 946 creates a structure or topology, called the Room System Performance Map Topology 952, which the Room System Map Data Points 954 will be mapped onto. The Room System Performance Map Topology 952 defines how we partition the spatial 505 and temporal 129 dimensions into map cells and the relationship and connection between them. For simple cases, where we want to map the data onto a uniform grid the topology is simply defined as the spacing between map cells in each of the spatial 505 and temporal 129 dimensions. For more complex cases, where we want to use a less uniform grid, the topology is defined as an array of spacings between map cells for each of the spatial 505 and temporal 129 dimensions. The primary role of the Room System Performance Map Topology 952 is to provide the basis for generating the Room System Performance Map Geometry 953, which provides details for the actual location, both spatially 502 and temporally 129, and the size, and shape of map cells in the map which is based on the Coordinate Reference Frame 505.

Using the Room System Performance Map Topology 952, and the Room System Performance Map Geometry 953, the Compute Room System Performance Map 946 now has a collection of structured map cells, defined with specific spatial 505 and temporal coordinates 129, that it can use to start mapping the Room System Performance Map Data Points 954 onto. Using this information, we can build the Room System Performance Map Cell Mapping 955 which simply determines which Room System Performance Map Data Points 954 belong to which map cell as defined by the specific map cell geometry from Room System Performance Map Geometry 953.

Once the Room System Performance Map Cell Mapping 955 has been determined there will be map cells that contain zero, one, or more points. The Compute Room System Performance Map 946 now creates data associated with each map cell by summarizing or aggregating all the Room System Performance Map Data Points 954 within each map cell as identified by the Room System Performance Map Cell Mapping 955.

After Compute Room System Performance Map 946 has mapped the Room System Performance Map Data Points 954 and created the Room System Performance Map 948, the Build Multiscale Room System Performance Map 947 takes the Room System Performance Map 948 as input and reduces it by creating one or more multiscale versions of it.

The first multiscale version of the Room System Performance Map 948 is computed from it by applying one or more Feature Extraction 974a (FIG. 9h) filters to it. This Feature Extraction 974a filter doesn't reduce the spatial 505 or temporal 129 dimensions of the Room System Performance Map 948 but instead determines the presence or absence of features from the Room System Performance Map Data Points 954 and the Room System Performance Map Cell Data 956. The output of the Feature Extraction 974a filters is the Level 0 Room System Extracted Features Map 949. This map contains the same data structures as the Room System Performance Map 948 in that it defines the map topology (Level 0 Extracted Features Map Topology 957), the map geometry (Level 0 Extracted Features Map Geometry 958), the map data points (Level 0 Extracted Features Map Data Points 959), the map cell mapping (Level 0 Extracted Features Map Cell Mapping 960) and the map cell data (Level 0 Extracted Features Map Cell Data 961). All these data structures, except for the Level 0 Extracted Features Map Cell Data 961, have data that is directly copied from the corresponding data structure in the Room System Performance Map 948. The Level 0 Extracted Features Map Cell Data 961 has different data because this structure stores the output from the Feature Extraction 947a (FIG. 9h) filters used.

Once the Level 0 Room System Extracted Features Map 949 has been computed the Build Multiscale Room System Performance Map 947 iteratively builds lower spatial and temporal resolution versions of it. It does this by using a Down Sampling Convolution Filter 975a (FIG. 9h). The Level 0 Room System Extracted Features Map 949 is used as the initial input to this process. The Down Sampling Convolution Filter 975a is applied to the input and produces the Level 1 Room System Extracted Features Map 950 which is a lower resolution version of the input map. The process of applying the Down Sampling Convolution Filter 975a is repeated using the Level 1 Room System Extracted Features Map 950 as input producing additional lower resolution versions of the data. The process continues until a Level N Room System Extracted Features Map 951 is produced where the spatial 505 and temporal 129 resolution of the map is less than or equal to a defined minimum.

The Extracted Features Maps (Level 1 Room System Extracted Features Map 950, Level N Room System Extracted Features Map 951) for Levels 1 and above have the same data structure as the original Level 0 Room System Extracted Features Map 949, however, except for the Extracted Features Map Data Points (Level 1 Extracted Features Map Data Points 964, Level N Extracted Features Map Data Points 969) the data they contain will be different, representing the fact the data is defined at different spatial 505 and temporal 129 scales. The Extracted Features Map Topology (Level 1 Extracted Features Map Topology 962, Level N Extracted Features Map Topology 967) will contain fewer map cells, with larger map cell dimensions (both spatially 505 and temporally 129) defined for the spatial and temporal axes. The Extracted Features Map Geometry (Level 1 Extracted Features Map Geometry 963, Level N Extracted Features Map Geometry 968) will define cells that cover larger volumes (both spatially 505 and temporally 129). The Extracted Features Map Cell Mapping (Level 1 Extracted Features Map Cell Mapping 965, Level N Extracted Features Map Cell Mapping 970) will contain more data points per map cell due to the larger spatial 505 and temporal 129 sizes. The Extracted Feature Map Cell Data (Level 1 Extracted Features Map Cell Data 966, Level N Extracted Features Map Cell Data 971) will contain different data representing the presence or absence of features detected by the Feature Extraction 974a filter at different spatial 505 and temporal 129 scales.

When the Compute Room System Performance Map 946 and the Build Multiscale Room System Performance Map 947 have completed, the output is a complete Multiscale Room System Performance Map 975. This is subsequently made available to External Downstream Data Consumption Processes 911.

FIG. 9h illustrates how the Compute Room System Performance Map 946 and the Build Multiscale Room Performance Map 947 produce the Complete Multiscale Room System Performance Map 975 as the final output of the Room System Performance Map Analytics Processor 901.

Compute Room System Performance Map 946 creates the Room System Performance Map 948 from the output of the Room System Score Processor 907 and the Historical Room Database as determined by the spatial and temporal bounds defined by the Room and Measurement Configuration Data 904.

The first step in this process is the Topology Parameterization Process 977. This step uses the spatial 505 and temporal 129 bounds of the data, from the Room and Measurement Configuration Data 904, along with data describing the map cell spacing to use for the spatial 505 and temporal 129 dimensions to build a structured grid to represent how we will map the unstructured Room System Performance Location Scores (location scores) coming from the Room System Score Processor 907 into a model of the volume of space 505 and time 129 being analyzed. The output from this process is the initial version of the Room System Performance Map 948 which contains the definition of the map topology (Room System Performance Map Topology 952) and the specific geometry (both spatial 505 and temporal 129) for the map (Room System Performance Map Geometry 953).

The next step in the Topology Parameterization Process 977 is to get the location scores that will be mapped onto the above structure. The Room and Measurement and Configuration Data 904 defines the spatial 505 and temporal 129 bounds of the data we need, and this is used to retrieve the location scores (i.e. the Location Score Inference Engine 945 data) from the Room System Score Processor 907 and the Historical Room Database 910. This data is added to the Room System Performance Map 948 as the Room System Performance Map Data Points 954.

The next step in the Compute Room System Performance Map 946 is the Cell Mapping Process 972 which determines which location scores, in the Room System Performance Map Data Points 954, belong to which map cell as defined by the Room System Performance Map Topology 952 and the Room System Performance Map Geometry 953. The output of this process the Room System Performance Map Cell Mapping 955 which is added to the Room System Performance Map 948. This structure has a list for each map cell in the map (Room System Performance Map Topology 952), where the list contains the Room System Performance Map Data Points 954 that are contained within the map cell.

The last step in the Compute Room System Performance Map 946 is Cell Score Computation 973. This process computes a summary or aggregation score for each map cell in the Room System Performance Map Topology 952. When the Room System Performance Map Cell Mapping 955 is computed there can be multiple Room System Performance Map Data Points 954 in each map cell. The Cell Score Computation 973 summarizes or aggregates all location scores in each map cell and assigns this result to the Room System Performance Map Cell Data 956. The Room System Performance Map Cell Data 956 therefore doesn't represent data associated with individual points 502 in space 505 and time 129, it represents data associated with volumes of space 505 and time 129 as defined by the Room System Performance Map Geometry 953.

Once the Room System Performance Map Cell Data 956 is completed it is added to the Room System Performance Map 948 and the Compute Room System Performance Map 946 process is complete and we now move to the Build Multiscale Room System Performance Map Process 947.

The first step in the Build Multiscale Room System Performance Map Process 947 is a Feature Extraction Process 974a. The Feature Extraction Process 974a takes the Room System Performance Map 948 as input and applies one or more feature extraction filters to it. This generates the Level 0 Room System Extracted Features Map 949. This map contains the same data as the input Room System Performance Map 948, in terms of topology, geometry, location scores, and cell mapping. However, it has different Level 0 Performance Map Cell Data 961, as the cell data now represents the presence or absence of one or more features in the new map cell.

An example feature extraction is shown in Build Multiscale Room System Performance Map (Example) 947a. In this example a specific Feature Extraction 974a filter is used. We use a Laplacian Convolution Filter 974b which detects where there are edges in the underlying data—i.e. location scores. The output of this filter will highlight regions (spatial and temporal) where there are rapid changes in the location scores.

Once the Feature Extraction 974a process has completed the output Level 0 Room System Extracted Features Map 949, along with the Room System Performance Map 948 are added to the Complete Multiscale Room System Performance Map 975, forming the start of the final output of the Room System Performance Map Analytics Processor 909.

The next step in the Build Multiscale Room System Performance Map Process 947, takes the Level 0 Room System Extracted Features Map 949 and builds multiscale versions of it. This is done by iteratively applying a Down Sampling Convolution Filter 975a to the Level 0 Room System Extracted Features Map 949. Each time we apply the Down Sampling Convolution Filter 975a, a new reduced spatial 505 and temporal 129 resolution extracted features map is produced. This allows us to represent features in the Room System Performance Map 948 at multiple different spatial 505 and temporal 129 scales.

The first time the Down Sampling Convolution Filter 975a is applied it produces a Level 1 Room System Extracted Features Map 950. The process is repeated until the output extracted features map has a resolution less than a defined minimum as defined in the Room and Measurement Configuration Data 904. The last iteration of applying the Down Sampling Convolution Filter 975a, produces the minimum resolution data Level N Room System Extracted Features Map 951.

An example Down Sampling Convolution Filter 975a is shown in Build Multiscale Room System Performance Map (Example) 947. In this example a specific Down Sampling Convolution Filter 975a is used. We use a Max Pooling 975b filter. This filter uses the output of the Laplacian Feature Extraction filter 974b and down samples the data by computing the maximum value for all the cells the down sampling filter is applied to. The amount of down sampling done is dependent on how the Down Sampling Convolution Filter 975b is configured. More down sampling will occur if the stride length, or how much the filter is moved in each of the spatial 505 and temporal dimensions is large. The iterative application of the Max Pooling 975b filter will generate several multiscale versions of the Level 0 Room System Extracted Features Map 949 where areas of maximum change (i.e. strongest edges) are continually highlighted.

Once the Down Sampling Convolution Filtering 975a process has completed the outputs (Level 1 Room System Extracted Feature Map 950 through Level N Room System Extracted Feature Map 951) are added to the Complete Multiscale Room System Performance Map 975. This forms the complete output of the Room System Performance Map Analytics Processor 909 and the data is available for subsequent External Downstream Data Consumption Processes 911.

FIGS. 10a, 10b, 10c, 10d, 10e, 10f, 10g, 10h, 10i, 10j, 10k, 10l, 10m, 10n, 10o, 10p, 10q, 10r, 10s, 10t, 10u, 10v, 10w and 10x are exemplary logic flows of a preferred embodiment of the invention.

FIG. 10a depicts the overall logic flow for taking Indirect Acoustic Measurements as illustrated in FIGS. 6q and 6r using the Room System Score Performance Processor 901 which is embedded in an audio conference system 120. Instantiation of the Room System Score Performance Processor 901 can be done either manually by a user 102 or automatically through a system 120 process if configured appropriately. Since the indirect measurement uses an external stimulus not directly connected to the measurement system 901, user 102 is required to create the impulse signal via a device such as a balloon 302 for example. Once the measurement process is instantiated the process begins at Start step S1001. Step Room and Measurement Configuration S1002 is then executed to obtain room and measurement configuration data from the Room and Measurement Configuration Data 904 through manual entry, or directly from the Audio-Conferencing System 120 based on the method of instantiation and available pre-configured data in the Room System Score Performance Processor 901 and/or the audio system 120.

The next step Trigger S1003 determines whether this process was Triggered Manually in Step S1031 (FIG. 10c) or set to automatically Trigger at a Scheduled Time as in step S1033 (FIG. 10c) and triggers the appropriate measurement process, which is appropriate and will signals the user 102 to create the impulse signal or external sensor 978 stimulus as needed to support the measurements based on the Room System Score Performance Processor 901 state of instantiation within the Audio-Conferencing System 120.

Once the Room System Score Performance Processor 901 has been triggered in step S1003 the Room and Measurement Configuration Data 904 process is queried by the step Get Room Configurations S1004 which obtains the appropriate configuration data to support either a manual Trigger or an automatic Trigger operation as determined in step S1003. The room and measurement configuration data which is obtained from the Room and Measurement Configuration Data 904 is used by the Sensor Configuration: Time & Location in step S1005 which sets the configurations and parameters used for the sensor 978 (FIG. 9a) to take the acoustic measurements 504 for each measurement location 502 in the room 101. Get Room Configurations process in step S1004 passes configuration data to the Sensor Calibration step S1006 in the Audio Measurement Processor 905 of the Room System Score Performance Processor 901.

The Sensor Calibration in step S1006 is performed next which determines and sets up the sensors 978 based on the configurations of the Get Room Configurations process in step S1004 and Sensor Configuration: Time & Location in step S1005 to ensure that the sensor 978 is properly set up for the room 101, the audio system 120, and the acoustic measurements being used.

Once the Sensor Calibration step S1006 processes are complete, the Measurement Loop process can begin which executes and guides the overall functions which can include prompting the user 102 to generate the impulse signals 302, if required at the proper time to take one or more measurements 504 at one or more locations 502 (FIGS. 7a to 7c) within the room 101. Measurement Engines in step S1007 are executed to take user or system prescribed acoustic measurements as illustrated in FIGS. 6j to 6p of the room 101. The results of the Measurement Engines in step S1007 are then sent to the Measurement Output Processor in step S1008.

The Measurement Output Processor in step S1008 outputs the measurement data 504 to the Historical Room Database 910, to node H the Room System Score Processor 907 which will execute next as shown in FIG. 10q, and back into Sensor Configuration Time & Location Step in step S1005 for recursive measurement operations. The Room Configurations in step S1004 and Sensor Configuration: Time & Location in step S1005 are also stored in the Historical Room Database 910 for future use and reference in subsequent steps as part of the measurement data 504.

Note that Room and Measurement Configuration Data 904 and data output by the Measurement Output Processor in step S1008 in historical sensor and generator data of previous runs 903 (FIG. 9a) can also be used directly from the Historical Room Database 901 by the Measurement Engines in step S1007 or the Measurement Output Processor 922 to compute or re-process previous Measurement data and Metadata to be used later by the Room System Score Performance Processor 901 (FIG. 9a).

Room and Measurement Configuration Data 904 is passed to the System Configuration Processor 908, (FIG. 9a), step node B.

FIG. 10b depicts the overall logic flow for taking Direct Measurements FIGS. 6e, 6f, 6g, 6h, 6i, 6l, 6m, 6n, 6o and 6p using the Room System Score Performance Processor 901 which is embedded in an audio conference system 120. This process begins similarly to FIG. 10a, in which the process begins at Start in step S1001, to Obtain Room and Measurement Configuration in step S1002, and determine the Trigger in step S1003 that begins the measurement process, however since the measurement is fully self-contained in the system 120 external user 102 intervention and prompting may not be required. Room and Measurement Configuration Data 904 is obtained through Get Room Configurations in step S1004 from Obtain Room and Measurement Configuration in step S1002. The Get Room Configurations in step S1004 gets information via Sensor Configuration: Time & Location in step S1005, Sensor Calibration in step S1022, as well as Generator Configuration: Time & Location in step S1019, and Generator Calibration in step S1020. Sensor Configuration: Time & Location in step S1005 and Generator Configuration: Time & Location in step S1019 begin the Measurement Loop. Room and Measurement Configuration Data 904 is also used by the System Configuration Processor 908, (FIG. 9a) step node B.

Detailed explanations of Sensor Configuration: Time and Location in step S1005 and Generator Configuration: Time and Location in step S1019 are provided in FIG. 9b as Sensor Configuration 915 and Signal Generation 916. Sensor Calibration in step S1022 also follows from Sensor Calibration in step S1006 (FIG. 10a).

Unique to FIG. 10b, Generator Calibration in step S1020 occurs based on the configurations set in Get Room Configurations in step S1004, Generator Configuration: Time & Location in step S1019, and Sensor Configuration: Time & Location in step S1005. Once Generator Calibration in step S1020 is complete and detailed in FIG. 10l, a Known Test Signal Input in step S1021 is generated, which is then measured by the Measurement Engines in step S1023.

In both FIG. 10a and FIG. 10b, The Measurement Output Processor in step S1008 (FIG. 10a), and in step S1024 (FIG. 10b) obtains Measurement data from steps Sensor Raw Data in step S1131, Measurement Metadata in step S1132, Obtain Time at Measurement in step S1133, Sensor Parametric Data in step S1134, Sensor Position in step S1135, Sensor Direction in step S1136, Sensor Rotation in step S1137, Sensor Specific Data in step S1138 (FIG. 10n), to Generate Measurement Metadata in step S1139 (FIG. 10n), all of which can be stored in the Historical Room Database 910 and passed on to the Room System Score Processor 907, (FIG. 9a), step node H to be used further downstream within the Room System Score Performance Processor 901 (FIG. 9a).

If more measurements are required at different locations, the Measurement Loop can continue by revisiting and updating the Sensor Configuration: Time & Location, in step S1005 (FIGS. 10a and 10b). The Measurement Loop can be completed as many times as necessary.

FIG. 10c depicts a detailed view of the Trigger in step S1003 included in FIGS. 10a and 10b which begins after the execution of Obtain Room and Measurement Configuration in step S1002. The step Trigger S1003 defines how the measurement process is initiated, either through a manual operation via Trigger Manually in step Trigger Manually S1031 and step Trigger Manually S1034, in which the measurement process is manually started, or through step Trigger at Scheduled Time S1033, in which the Conference System 120 triggers the acoustic measurement process to start at the scheduled time.

The Trigger in step S1003 first checks if the Room System Score Processor 907 (FIG. 9a) is Embedded in step Is System Embedded? S1030 within the Conferencing System 120. If the Conference System 120 does not have the Room System Score Performance Processor 901 (FIG. 9a) embedded into it, acoustic measurements cannot be scheduled to run automatically within the Conference System 120 as it lacks the Room System Score Performance Processor 901 (FIG. 9a) to handle and process acoustic measurements. Thus, the acoustic measurement process must have been triggered manually in step Trigger Manually S1031. Alternatively, if the Room System Score Performance Processor 901 is Embedded in the system 120 in step Is System Embedded? S1030, the acoustic measurement process can be trigger manually in step Trigger Manually S1034 or the acoustic measurement process can Trigger at Scheduled Time in step S1033 by the Conferencing System 120 if a Scheduled Time Has Been Set in step Has a Scheduled Time been Set? S1032.

Upon either trigger manually in step Trigger Manually S1031 or step Trigger Manually S1034, or trigger at a scheduled time in step Trigger at Scheduled Time S1033, Room and Measurement Configuration Data 904 (FIGS. 9a and 9b) can be obtained through node A1 from Obtain Room and Measurement Configuration in step S1002 (FIGS. 10a and 10b) and Get Room Configurations in step S1004, (FIGS. 10a and 10b) to continue the measurement process.

FIG. 10d depicts the Mobile Indirect Measurement process initially described in indirect measurement use cases FIGS. 6a, 6b, 6q and 6r. One or more acoustic measurements 504 can be taken in one or more locations 502 of interest, which are any locations within the spatial and temporal context of a room 101 that may have acoustic properties influential to the performance of a Conferencing System 120.

Room and measurement configuration data 904 (FIG. 9a) is received from the Room and Measurement Configuration Data 904 (FIG. 9a) by Get Room Configurations in step S1040 through node A1 from Trigger step S1003 to begin the Mobile Indirect Measurement process. Once the sensors 978 and impulse generators 302 (FIG. 9a) are positioned at the desired locations 502, within the room 101, Sensor Configuration: Time & Location in step S1041 can be obtained to begin the Measurement Loop process.

Once Sensor Configuration: Time & Location in step S1041 is executed, Sensor Calibration in step S1022 occurs within the Audio Measurement Processor 905 according to the system 120 configuration from step Sensor Configuration: Time & Location 1041. Note that details regarding Sensor Configuration: Time & Location in step S1041 are further explained in FIG. 10h, and details regarding Sensor Calibration in step S1022 are explained in FIG. 10i. Room and measurement configuration data 904 is received from the Room and Measurement Configuration Data 904 is also used by the System Configuration Processor 908.

The Audio Measurement Processor 905 executes the installed and configured measurement engines each of which handles an audio measurement such as Background Noise in step S1043a, Impulse Response in step S1043b, Spectrum in step S1043c, STIPA in step S1043d, as well as Additional Measurements in step S1043e respectively. Note that Measurement Engines in steps S1043a to S1043e which are instantiated and utilized are determined based on the room and measurement configuration data 904 is received from the Room and Measurement Configuration Data 904. As stated previously with regard to indirect measurements the user 102 will be prompted to generate impulse signals 302 as needed during the appropriate measurement process.

Within each Measurement Engine processor noted in steps Background Noise in step S1043a, Impulse Response in step S1043b, Spectrum in step S1043c, STIPA in step S1043d, as well as Additional Measurements in step S1043e respectively, contain the following two-step processing steps for each measurement engine processor such as Pre-Processing: Background Noise S1044a which precedes the step Background Noise Measurement S1045a, Pre-Processing: Impulse Response S1044b which precedes the step Impulse Response Measurement S1045b, Pre-Processing: Spectrum S1044c which precedes the step Spectrum Measurement S1045c, Pre-Processing: STIPAS 1044d which precedes the step STIPA Measurement S1045d, and Pre-Processing: Additional Measurements S1044e which precedes the step Additional Measurement S1045e. Pre-Processing in steps Pre-Processing: Impulse Response S1044b, Pre-Processing: Impulse Response S1044b, Pre-Processing: Spectrum S1044c, Pre-Processing: STIPAS 1044d, and Pre-Processing: Additional Measurements S1044e handles the measurement device initialization in step S1090 (FIG. 10j) and acts as the starting point for when the measurement 504 is taken while the Measurement in steps Background Noise Measurement S1045a, Impulse Response Measurement S1045b, Spectrum Measurement S1045c, STIPA Measurement S1045d, and Additional Measurement S1045e defines the process of taking and completing the acoustic measurement. Additional details are provided in FIG. 10j.

Data obtained from the Measurement Engines in steps Background Noise in step S1043a, Impulse Response in step S1043b, Spectrum in step S1043c, STIPA in step S1043d, as well as Additional Measurements in step S1043e respectively is collected and processed by the Measurement Output Processor in step S1024. Measurement Engines in steps Background Noise in step S1043a, Impulse Response in step S1043b, Spectrum in step S1043c, STIPA in step S1043d, as well as Additional Measurements in step S1043e respectively can be executed in sequence (serial) or in parallel, based on the nature of the acoustic measurement or the number and type of sensors 978 (FIG. 9a) used. For example, if multiple sensors 978 (FIG. 9a) are used to simultaneously measure background acoustic noise, several Background Noise Measurement Engines in step S1043a can be configured to execute in parallel.

Once the Measurement Output Processor in step S1024 generates the required output and there are additional locations 502 of interest in step S1048 within the room 101, the Measurement Loop can continue by either the user 102 or the system 120 selecting and/or repositioning the sensor 978 (FIG. 9a) to a new location 502 and updating the sensor configuration time & location in step Sensor Configuration: Time & Location S1041. Additional measurements 504 can then be made in the new location 502, continuing the Measurement Loop. Additional locations 502 of interest are determined in step Are there additional Locations of Interest? S1048, and if there are not the Measurement Loop exits and data from the Measurement Output Processor 922 in step Measurement Output Processor S1024 can be stored in the Historical Room Database 910 for future use or reference and propagated to the Room System Score Processor 907 (FIG. 9a) by Node H.

Note that historical room 101 and system 120 data from the Historical Room Database 910 can also be used directly by the Measurement Engines in steps Background Noise in step S1043a, Impulse Response in step S1043b, Spectrum in step S1043c, STIPA in step S1043d, as well as Additional Measurements in step S1043e respectively to re-process previous measurements using the same or different processing and setup variables to test permutations and to restimulate results.

FIG. 10e depicts the Mobile Direct use case as described in FIGS. 6c, 6d, 6j, and 6k. Similar to FIG. 10d, one or more measurements can be taken in one more location 502 of interest.

The process begins where the Room System Score Performance Processor 901 has been Triggered in step S1003 which is connected at node A1 and then Get Room Configurations in step S1040 is executed within a processor for Room and Measurement Configuration data 904. Room Configurations in step S1040 are then used in Sensor Configuration: Time & Location in step S1041, and Generator Configuration: Time & Location in step S1019 to determine the setup parameters for the Sensor 978 (FIG. 9a) and Generator 906 (FIG. 9a) and how they should be calibrated. Once the configurations have been set, Sensor Calibration in step S1022 occurs based on Get Room Configurations parameters obtained in step S1040 and Sensor Configuration: Time & Location in step S1041, like FIG. 10d. However, specific to FIG. 10e, Generator Calibration in step S1020 is executed within the Audio Measurement Processor 905 based on room 101, sensor 978 (FIG. 9a), and generator 906 (FIG. 9a) configurations obtained in Get Room Configurations process in step S1040, Sensor Configuration: Time & Location in step S1041, and Generator Configuration: Time & Location in step S1019. Note that the Generator 906 (FIG. 9a) is specifically calibrated to the Sensor 978 (FIG. 9a) and measurement requirements so that the Known Test Signal Input in step S1021 is synthesized and tuned specifically to the Sensor 978 (FIG. 9a) and measurement types to be executed.

Once the Sensor Calibration in step S1022 process is complete, the Measurement Engine in step S1043 undergoes a Pre-Processing in step S1044 step to Initialize the Measurement Device in step S1100 (FIG. 10k). Once the Known Test Signal Input in step S1021 is played into the room 101, the Measurement Engine in step S1043 takes a measurement of the Known Test Signal Input in step S1021. Then, the measured data from the Measurement Engine in step S1043 and the raw known test signal data from the Known Test Signal Input in step S1021 is passed into the Measurement Output Processor 922. The known test signal data received by the Measurement Output Processor 922 can be used further downstream to compare the measured known test signal data to the original known test signal data.

As done in FIG. 10d, the Measurement Output Processor receives measurement data and Generates Measurement Metadata in step S1039, all of which are stored in the Historical Room Database 910 and passed into the Room System Score Processor 901, (FIG. 9a) node H if additional locations 502 of Interest do not exist in step S1048. However, if additional locations 502 of interest in step Are there additional Locations of Interest? S1048 exist, the Sensor 978 (FIG. 9a) can be placed in a new location 502. Sensor Configuration: Time & Location in step S1041 and Generator Configuration: Time & Location in step S1019 can be updated to continue the measurement loop.

Note that historical sensor and generator data 903 stored in the Historical Room Database 910 can be queried by the measurement engines in step Measurement Engines S1043, and the Measurement Output Processor 922 in step Measurement Output Processor S1024 to re-process previous measurements. Room and Measurement Configuration Data 904 is also used by the System Configuration Processor 908 (FIGS. 9a and 9b).

FIG. 10f depicts the Embedded Direct Measurement Process in more detail initially described in FIG. 10b and follows similar logic to a Mobile Direct Measurement Process depicted in FIG. 10e. However, unlike the Mobile Direct Measurement Process FIG. 10e, the Embedded Direct Measurement Process FIG. 10f involves the use of a Conferencing System 120 that has a Room System Score Performance Processor 901 (FIG. 9a) embedded into it. Because the Room System Score Performance Processor 901 is embedded into the Conferencing System 120, the generators 906 (FIG. 9a) and sensors 978 (FIG. 9a) within the Conferencing System 120 are used to synthesize a Known Test Signal Input in step S1021 and take measurements through the Measurement Engine in step S1043. Within this process, sensors 978 (FIG. 9a) and generators 906 (FIG. 9a) do not need to be placed in locations 502 of interest, since they are a part of the Conference System 120. As a result, unlike the Mobile Measurement Processes depicted in FIGS. 10d and 10e, FIG. 10f does not involve a Measurement Loop to perform measurements at multiple locations 502 individually that may require user 102 intervention. Note that if multiple sensors 978, (FIG. 9a) exist within the Conferencing System 120, measurements can be taken in sequence or concurrently.

Like FIGS. 10d and 10e, the Embedded Direct Measurement Process begins at Get Room Configurations in step S1040 after node A1. Based on the room 101 configurations received, Sensor Configuration: Time & Location in step S1041 and Generator Configuration: Time & Location in step S1019 occur to set the configurations required for the sensors 978 (FIG. 9a) and Generator 906 (FIG. 9a) within the Conferencing System 120. Room and Measurement Configuration Data 904 is also used by the System Configuration Processor 908 (FIGS. 9a and 9b).

The Audio Measurement Processor 905 follows similar logic to the Mobile Direct Process FIG. 10e. Following the Room 101, Sensor 978 (FIG. 9a), and Generator 906 (FIG. 9a) configurations in step S1004 (FIG. 10a), in step S1005 (FIG. 10a), in step S1019 (FIG. 10b), the sensor 978, (FIG. 9a) is calibrated to the Room and Sensor Configurations in step S1004 (FIG. 10a), in step S1005 (FIG. 10a). The Generator 906 (FIG. 9a) is calibrated based on the Room 101, outputs from Sensor 978 (FIG. 9a), and Generator Configurations in step S1004 (FIG. 10a), in step S1005 (FIG. 10a), in step S1019 (FIG. 10b). The Measurement Engine in step S1043 undergoes Pre-Processing in step S1050 to Prepare the Measurement Device in step S1100, (FIG. 10k) for measurements, and a Known Test Signal Input in step S1021 is synthesized by the Generator 906 (FIG. 9a). Once the Known Test Signal Input in step S1021 is played into the room, it is Measured in step S1045 by the Measurement Engine in step S1043. Measured data and the Known Test Signal data is passed into the Measurement Output Processor in step S1024 to generate an output that is stored in the Historical Room Database 910 and passed downstream to node H, the Room System Score Processor 907 (FIG. 9a).

Note that unlike FIG. 10e, there are no additional locations 502 of interest, and thus Sensor Configuration: Time & Location in step S1041 and Generator Configuration: Time & Location in step S1019 do not occur again to create a Measurement Loop.

Historical sensor and generator data 903 (FIG. 9a) stored in the Historical Room Database 910 can be used by the measurement engine in step Measurement Engine S1043, and the Measurement Output Processor in step S1024 to re-process previous measurements.

FIG. 10g depicts the Get Room Configuration step S1040 process. Within Get Room Configuration in step S1040, various room 101 attributes such as the room geometry (x,y,z dimensions and square area) in step Room Geometry S1060, materials used within the Room 101 in step Room Materials S1061, the known undesired and desired sound source locations in step Known Sound Source Locations S1062, and other room data in step Other Room Data S1063 are queried and obtained from Room and Measurement Configuration Data 904 via the Obtain Room and Measurement Configuration step S1002 (FIG. 10a) node A1. The Room 101 Attributes are collected by the Get Room Configuration S1040 Process and passed on to node A2 to A5 respectively, to be used by the Sensor Configuration: Time & Location in step S1005 (FIG. 10a). Generator Configuration: Time & Location in step S1019 (FIG. 10b), Sensor Calibration in step S1006 (FIG. 10a), and Generator Calibration in step S1020, (FIG. 10b) processes.

FIG. 10h depicts the Sensor Configuration: Time & Location in step S1041 process. The room and measurement configuration data is obtained via the Room and Measurement Configuration Data 904 (FIG. 9a) and received through Get Room Configurations in step S1004 (FIG. 10a) node A4.

In the case of a audio conference system 120 post-install scenario, initially depicted in FIGS. 8a, 8c to 8e, a sensor 978 (FIG. 9a) integrated into a Conferencing System 120 may have already been configured. However, current sensor configuration data including the sensor position in step S1071, sensor direction in step S1072, sensor rotation in step S1073, sensor time in step S1074, and other sensor specific data in step S1075 is received from Get Room Configurations in step S1004 (FIG. 10a) node A4 and set in their respective processes in steps Sensor Position S1071, Sensor Direction S1072, Sensor Rotation S1073, Sensor Time S1074, Sensor Specific Data S1075. If the sensor 978 (FIG. 9a) has not yet been configured, configurations set manually by a user 102 or by the conferencing system 120 are also obtained through Get Room Configurations in step S1004, (FIG. 10a) node A4 which are likewise set in the respective processes in steps Sensor Position S1071, Sensor Direction S1072, Sensor Rotation S1073, Sensor Time S1074, Sensor Specific Data S1075. The sensor configuration data can then be used by downstream processes Generator Calibration in step S1020 (FIG. 10b) node A6 and Sensor Calibration in step S1006 (FIG. 10a) node A7.

FIG. 10i depicts the Sensor Calibration Process. Based on Get Room Configuration in step S1004 (FIG. 10a and FIG. 10g) and Sensor Configuration: Time & Location in step S1005 (FIG. 10a and FIG. 10h), the sensor 978 is calibrated to adjust for sensor 978 offset errors and/or measurement specific calibrations known in the art to ensure correctness of the measurements 504 taken. This occurs through Adjust Gain in step S1080, Adjust Response Curve in step S1081, and Adjust Other Sensor Parameters in step S1082. Adjust Gain in step S1080, for example, can be used for measurement microphones 501 to ensure that signals do not overwhelm the measurement microphones 501 in a smaller room 101 and/or to put the measurement into a specific measurement SPL level, or that the measured signal is loud enough in a larger room 101. Adjust Response Curve in step S1081 could also be used to adjust sensor measurement microphones 501 to compensate for frequencies that may be artificially boosted or attenuated due to the acoustic characteristics of the microphone 501. Once the measurement microphones 501 calibration is complete, Measurement Engines in step S1007 (FIG. 10a) node A8 can be used to take acoustic measurements 504. Note that if multiple sensors 978 (FIG. 9a) are used, they each must be calibrated. The calibration process can occur in sequence or in parallel as required and/or can be supported.

FIG. 10j depicts the Measurement Engine step S1043 logic flow for taking Indirect Measurements using the Room Score Processor 901. A single measurement logic flow is illustrated however this logic flow applies to all measurement types supported by the Room Score Processor 901. The measurement process begins at node A8 once Sensor Calibration in step S1022 (FIG. 10i) is complete, and Sensor Pre-Processing begins in step S1044. During Sensor Pre-Processing in step S1044, the Measurement Engine in step S1043 Initializes the Measurement Device in step S1090 which involves preparing the sensor 978 (FIG. 9a) to take measurements including processes such as but not limited to creating and initializing buffers used for measurements. Once Initialize Measurement Device in step S1090 is complete, the measurement engine idles briefly to let the measurement buffers settle and/or the sensors in step Let the Measurement Buffers Settle S1091. For example, this step ensures that any unwanted noise within the Room 101 is not picked up by the measurement. If a background noise measurement is taken, this process ensures that any unwanted noise such as footsteps or rustling of clothes introduced by movement have dissipated and are not factored into the measurement. For other measurements such as averaged spectrum measurements and power measurements the appropriate amount of time is established to support the measurement settings. The idle time for this process is set by Sensor Configuration in step S1041 (FIG. 10h). This marks the end of the Measurement Engine in step S1043 Sensor Pre-Processing in step S1044 step.

Once Sensor Pre-Processing in step S1044 is complete, Sensor Measurement in step S1045 begins. This process begins with Start Measurement in step S1092, in which the sensors 978 and/or generators 906 are prompted to begin the measurement process. Then, in the Take Measurement in step S1093, the measurement is taken, which includes measurements such as background noise, RT60, etc. FIGS. 6j to 6n. In the case where a generator 906 is required the user 102 may be prompted to excite the generator 906 at the appropriate time at which point the measure can continue. The Stop Measurement in step S1094 stops the measurement once the measurement has completed all the appropriate steps, which can be achieved manually or automatically after a set measurement time has elapsed, or the measurement signal is captured and analyzed by the Room Score Processor 901. Once the measurement is complete, the Sensor Measurement in step S1045 is validated in step Is Measurement Valid? S1095 to ensure the measurement is complete with no flagged errors and or is within expected ranges and values appropriate for that measurement type. This process involves validation steps such as checking the range of values measured, or that unwanted artifacts are not present within the measurement. If the measurement is invalid, and the Room Score Processor 901 is configured to retake the measurement the Measurement Engine in step S1043 Lets the Measurement Buffers Settle in step S1091 again before a new measurement is taken at Start Measurement in step S1092. If the measurement is valid, the measurement data 504 is passed on to node A9 for the Measurement Output Processor in step S1024 (FIG. 10n).

FIG. 10k depicts a Direct Measurement logic flow for a Measurement Engine in step S1043 using the Room Score Processor 901. This process is largely the same as the Measurement Engine in step S1043 Indirect Measurement FIG. 10j in which the Measurement Engine in step S1043 consists of a Pre-Processing in step S1050 and Measurement in step S1045. However, for Direct Measurements, a Known Test Signal Input in step S1021 (FIG. 10m) node A10, is used within the Measurement in step S1045 for the specific measurement type such as RT60 (time domain impulse response measurements or loudspeaker 106 spectrum and distortion measurements).

The Known Test Signal Pre-Processing in step S1050 step follows very closely to the Sensor Pre-Processing in step S1044 step in FIG. 10j, in which Initialize Measurement Device in step S1100 and Let Measurement Buffers Settle in step S1101 occur, however, for Known Test Signal Pre-Processing in step S1050, the sensors 978 and generators 906 used to perform the measurement are both initialized, configured and setup and allowed to settle and primed for the measurement 504.

Once Let Measurement Buffers Settle in step S1101 is complete, Known Test Signal Measurement in step S1045 occurs, which involves Start Measurement in step S1102, Take Measurement in step S1103, and End Measurement in step S1104 as done in the Indirect Measurement process FIG. 10j. However, the Known Test Signal Input in step S1021 (FIG. 10m) node A10 is sourced from the room score processor 901 and set to output into the room 101 at Start Measurement in step S1102, and the Take Measurement in step S1103 step specifically captures the measurement for the Known Test Signal Input S1021 (FIG. 10m) node A10. Upon End Measurement in step S1104, the measurement is validated in step S1105, and if the measurement is deemed invalid, the Measurement Engine in step S1043 Lets the Measurement Buffers Settle in step S1101 again to retake the measurement. If the measurement of the Known Test Signal Input in step S1021 (FIG. 10m) node A10 is valid, the Analyze Signal in step S1106 step parses the measured signal to derive and output Raw Conference System Attributes to node A9, the Measurement Output Processor in step S1024 (FIG. 10n). The Raw Conference System Attributes include derived values measured from the Known Test Signal Input in step S1021 (FIG. 10m) node A10 such as signal strength, spectral features, delay, and impulse response. Note that the Baseline Known Test Signal Data generated by the Known Test Signal Input in step S1021 (FIG. 10m) node A10 is also passed to the Measurement Output Processor in step S1024 (FIG. 10n) node A9 to be used for further analysis.

FIG. 10l depicts the logic steps for the Generator Configuration S1019 and Calibration process S1020 respectively. This process begins at node A2, once Get Room Configuration in step S1040 (FIG. 10g) is complete. Generator Configuration: Time & Location in step S1019 is used to obtain information regarding the Generator 906 (FIG. 9a) such as the Generator Position in step S1110, Generator Direction in step S1111, Generator Rotation in step S1112, Generator Time in step S1113, Generator Specific Data in step S1114, and other Signal Data/Definition in step S1115. This information can be manually provided or derived from the Conferencing System 120 itself in upstream processes such as Sensor Configuration: Time & Location in step S1041 (FIG. 10h). The information received from these upstream processes is set in their respective processes in steps: Generator Position S1110, Generator Direction S1111, Generator Rotation S1112, Generator Time S1113, Generator Specific Data S1114, and Signal Data/Definition S1115 respectively.

Generator Position in step S1110 defines the x, y, and z coordinates within the Coordinate Reference Frame 505 which describes the physical location of the Generator 906 (FIG. 9a). Generator Direction in step S1111 defines the u, v, and w coordinates within the Coordinate Reference Frame 505 which describes which way the Generator 906 (FIG. 9a) is pointing in, within a three-dimensional space. Generator Rotation in step S1112 defines 0, the roll or rotation of the Generator 906 (FIG. 9a). Generator Time in step S1113 defines t, the time at which a Known Test Signal Input S1021 (FIG. 10b) will be played. Generator Specific Data in step S1114 defines any other data that describes the Generator 906 (FIG. 9a) itself, including model, make, hardware and firmware versions, and type of Generator 906 (FIG. 9a). Signal Data/Definition in step S1115 defines any configurations that describe what the Known Test Signal Input S1021 (FIG. 10b) should consist of, such as the type of noise, impulse, or wave used.

Once Generator Configuration, Time & Location in step S1019 is complete, Generator Calibration in step S1020 occurs. The Generator Calibration in step S1020 process occurs based on the Generator Configuration Time & Location in step S1019, but also the room configuration data obtained in Get Room Configuration in step S1040 (FIG. 10g) node A3, as well as sensor configuration data obtained in Sensor Configuration: Time & Location in step S1041, node A6. The room 101, sensor 978 (FIG. 9a), and generator 906 (FIG. 9a) configuration data are then used to inform the Generator Calibration process how to adequately Adjust Output Gain S1116, Adjust Output Frequency Profile S1117, and Adjust Other Generator Parameters S1118 to ensure that the generator 906 (FIG. 9a) is specifically tuned and calibrated for the specific measurement type such that the Known Test Signal Input S1021 (FIG. 10b) generated is with the correct phase, frequency and amplitude properties.

Adjust Output Gain in step S1116 sets the loudness of the Known Test Signal Input in step S1021 (FIG. 10b) that is generated once it is played into the room 101. Adjust Output Frequency Profile in step S1117 alters the amplitude of various frequency bands of the Known Test Signal Input in step S1021 (FIG. 10b) to compensate for any requirements of the specific measurement chosen. Adjust Other Generator Parameters in step S1118 acts to adjust any other parameters that could affect the Known Test Signal Input in step S1021 (FIG. 10b) that is played into the Room 101. which could affect the measurements taken by the Measurement Engines in step S1043 (FIG. 10k).

FIG. 10m depicts the Known Test Signal Input logic flow in step S1021 process. The process picks up from node A11 once Generator Calibration in step S1020 (FIG. 10l) completes. Test Signal Synthesizer in step S1120 is used to synthesize the Known Test Signal in step S1121 based off the room 101, sensor 978 (FIG. 9a), and generator 906 (FIG. 9a) configuration data used in Generator Calibration in step S1020, (FIG. 10l). The Known Test Signal in step S1121 is then finally played into the room 101 for the Measurement Engines in step S1043 (FIGS. 10k) to measure. The Known Test Signal in step S1121 is also passed to the Measurement Output Processor in step S1024 (FIG. 10n) node A15 to serve as a baseline to which the Raw Conference System Attributes measured from the Known Test Signal data by the Measurement Engines in step S1043 (FIG. 10k) can be compared to.

FIG. 10n depicts the logic flow for the Measurement Output Processor in step S1024. The data input to the Measurement Output Processor in step S1024 differs based on whether the measurements taken by the Measurement Engines in step S1043 (FIGS. 10j and 10k) follow an indirect FIG. 10d or a direct FIGS. 10e and 10f measurement process as depicted by Is Direct Measurement in step S1130. In the case of an indirect measurement FIGS. 10d, data from the Measurement Engines in step S1043 is passed to the Measurement Output Processor in step S1024. On the other hand, for direct measurements in step S1130, data from the Measurement Engines in step S1043, as well as the Baseline Known Test Signal Data generated by the Known Test Signal Input in step S1021 is passed into the Measurement Output Processor in step S1024.

Within the Measurement Output Processor in step S1024 data such as Sensor Raw Data in step S1131, Measurement Metadata in step S1132, Time at Measurement in step S1133, Sensor Parametric Data in step S1134, Sensor Position in step S1135, Sensor Direction in step S1136, Sensor Rotation in step S1137, and other Sensor Specific Data in step S1138 are used to Generate Measurement Metadata in step S1139 that describes the sensor 978 and the measurements 504 taken. Once Generate Measurement Metadata in step S1139 is complete, step S1042 checks if additional measurements are required to determine if there are additional Locations 502 that require more measurements 504. If more measurements are required, the Measurement Loop can be continued at Sensor Configuration: Time & Location in step S1041 (FIG. 10e). If additional measurements 504 are not required, raw data in steps Sensor Raw Data S1131, Measurement Metadata S1132, Obtain Time at Measurement S1133, Sensor Parametric Data S1134, Sensor Position S1135, Sensor Direction S1136, Sensor Rotation S1137, and Sensor Specific Data S1138 and the metadata generated through Generate Measurement Metadata in step S1139 are passed to the Room System Score Inference Engines 940 to 943 (FIGS. 10r and 10s) through node H.

Sensor Raw Data in step S1131 contains the raw data stream received from the sensor 978 (FIG. 9a). Measurement Metadata in step S1132 contains the units of data that describe how to translate and process the Sensor Raw Data in step S1131. Sensor Parametric Data in step S1134 contains the formatted data derived from the Sensor Raw Data in step S1131 such as a wav file created from audio buffers.

FIG. 10o illustrates the logic steps for how the System Configuration Processor 908 (FIG. 9d) is initialized using several different System Configuration Initializers 933 (FIG. 9d).

The system configuration data is also known as the room and measurement configuration data that drives the System Configuration Initializer 933 (FIG. 9d) is retrieved in step Get relevant system configurations S1140 from the Room and Measurement Configuration Data 904 (FIG. 9b) and the Historic Room Database (HRDB) 910 (FIG. 9a). The room and measurement configuration data 904 (FIG. 9b), is a wide range of data that describe details about the current room 101 that is being analyzed and the details of the measurement procedure and analysis that will be performed, the configuration and other details of sensors 978 (FIG. 9a), for example measurement microphones 501, microphones 107 and microphone arrays 125 in the room 915 and 917 (FIG. 9b), configuration parameters and other details of generators 906, for example speakers 106, in the room consisting of Signal Generation 916 and Known Test Signal Input 918 (FIG. 9b) parameters.

The function of the System Configuration Initializer 933 (FIG. 9d) is to transform the system configuration data in step Get relevant system configurations S1140 into values for variables, which we refer to as Initialization Variables, that the Room System Score Processor 907 (FIG. 9e) can use. For example, the Room System Score Processor 907 (FIG. 9e) will use this information to determine which Sensor Score Inference Engines 939 (FIG. 9e) and which Location Score Inference Engines 945 (FIG. 9e) to be used and how they should be initialized.

There is one System Configuration Initializer 933 (FIG. 9d) for the various types of Initialization Variables needed by the Room System Score Processor 907 (FIG. 9e). The initializers are the Room Initializer in step S1141, 934 (see also FIG. 9d), the Conference System Initializer in step S1142, 935 (see also FIG. 9d), the Use Case Initializer in step S1143, 936 (see also FIG. 9d), and the Performance Model Initializer in step S1144, 937 (see also FIG. 9d).

Each of the initializers has two main steps. Get system configuration specific to the initializer (in step Get configurations for the room S1145, in step Get configurations for the conference system S1147, in step Get configurations for the use case S1149, and in step Get configurations for the performance model S1151) and then use this configuration to appropriately set initialization variables (in step Initialize room variables S1146, in step Initialize conference system variables S1148, in step Initialize use case variables S1150, in step Initialize performance model variables S1152) that can be used to initialize the Room System Score Processor 907 (FIG. 9e).

The Room Initializer in step S1141 handles all room 101 (FIG. 1a) related configurations and creates room 101 (FIG. 1a) specific initialization variables. Examples include but are not limited to the room 101 geometry and surface materials (see Room Initializer 934 (FIG. 9d)). Specific values of these variables might change the Sensor Score Inference Engines 939 (FIG. 9e) or the Location Score Inference Engines 945 (FIG. 9e). Some inference engines 939, for example, might be better suited to smaller rooms 101, others to less reverberant rooms 101. This data could also be used to specify or adjust constants, coefficients, and other weights that are used in different Sensor Score Inference Engines 939 (FIG. 9e).

In a similar manner the Conference System Initializer in step S1142 handles all Conference System 120 (FIG. 9a) system configuration data (see also 935 FIG. 9d). For example, within the same room 101 (FIG. 1a), Conference System A and Conference System B would have different properties that cause their location scores (Location Score Inference Engines 945 (FIG. 9e)) to be different. That is, the system supports the use of pre-trained Sensor Score Inference Engines 939 (FIG. 9e) and Location Score Inference Engines 945 (FIG. 9e) for different Conferencing Systems 120 (FIG. 9a).

The Room System Score Processor 907 (FIG. 9e) can also be configured to account for different use cases by using the User Case Initializer in step S1143 (see also Use Case Data 936 FIG. 9d). For example, for a given room 101 size and Audio Measurement Processor 905 (FIG. 9c) outputs for classroom 101 use and conference room 101 use might have different requirements resulting in different Sensor Score Inference Engines 939 (FIG. 9e) and Location Score Inference Engines 945 (FIG. 9e) results. The Performance Model Initializer in step S1144 is used to determine what type of inference model 937 (FIG. 9d) should be used given the established room 101, conference equipment 120, and use case requirements (see also Performance Model Configuration 937 FIG. 9d). For example, in some environments 101 we may only be able to use simple linear models for the different Sensor Score Inference Engines 939 (FIG. 9e) and Location Score Inference Engines 945 (FIG. 9e) because more complex models are not available, for instance for the given Conference System 120 (FIG. 9a). We might also choose simpler models to trade off processing speed with accuracy. In other situations, more complex machine learning models, specifically trained for the room 101, use case, and conferencing system 120 configuration might be available. The Performance Model Initializer in step S1144 establishes various constants, coefficients, and other weights that will be used to correctly configure the chosen approach (e.g. simple linear, or complex machine learning) to make accurate predictions for different Sensor Score Inference Engines 939 (FIG. 9e) and Location Score Inference Engines 945 (FIG. 9e).

The final step Transform system configurations to initialization variables S1153 in the System Configuration Initializer 933 (FIG. 9d) is to aggregate and transform all the specific initializer variables into a consistent set of Initialization Variables that will drive the Room System Score Processor 907 (FIG. 9e).

FIG. 10p illustrates the continued process used by the System Configuration Initializers (FIG. 9d). In the previous figure (FIG. 10o) we have generated several initialization variables from the various system configuration components.

In FIG. 10p, the first step S1154 is where we start to use the initialization variables to determine appropriate inference engines (945, (FIG. 9e), 939 (FIG. 9e)) to use in the Room System Score Processor 907 (FIG. 9e).

The Room System Score Processor 907 (FIG. 9e) has a range of Sensor Score Inference Engines 939, and Location Score Inference Engines 945 ranging from simple linear models to more complex machine learning models. Sensor Score Inference Engines 939, and Location Score Inference Engines 945 include inference engines that are tuned or trained to predict performance from different kinds of rooms 101 (Room Configuration engines 934 (FIG. 9d)), different kinds of conference systems 120 (conference system engines 935 (FIG. 9d)), for different use cases (use case engines 936 (FIG. 9d)) and different performance models (performance models configurations 937 (FIG. 9d)).

The Room System Score Processor 907 (FIG. 9e) selects in step Select from inference engine pool S1155 from the available pool of inference engines and constructs a processing pipeline from them to determine performance scores for various sensors 978 and measurements 504 (outputs from the Audio Measurement Processor 907 (FIG. 9e)) using Sensor Score Inference Engines 939 (FIG. 9e) and overall, per location scores using Location Score Inference Engines 945 (FIG. 9e).

The combination of Sensor Score Inference Engines 939, and Location Score Inference Engines 945 used and how they are initialized is determined using the initialization variables from step Use initialization variables to select inference engines S1154. This is a fundamental difference between the Room System Score Performance Processor 901 (FIG. 9a) and prior art solutions. The Room System Score Performance Processor 901 (FIG. 9a) doesn't simply present physical standalone acoustic measurements from the room 101. It predicts room acoustic and conference equipment 120 performance (using the various types of performance prediction models) by inferring performance data from measurements 504 combined with other specific parameters about the room 101, the conferencing system 120, and the intended use cases.

Step Example combinations of inference engines that can be selected and the configuration outputs S1156 illustrates two examples of Sensor Score Inference Engines 939, and Location Score Inference Engines 945 selection and combination. In example 1, room engines tailored to normal or averaged sized rooms 101 are used, Conference System engines tailored to the specific Conference System 120 being used (Conference System B) are used, and specific Classroom 101 use case engines are also used. In this example the performance model selected is a simple statistical performance prediction model.

In Example 2 we are using Sensor Score Inference Engines 939, and Location Score Inference Engines 945 tailored to larger rooms 101, and we are using a different conferencing system 120, Conferencing System A. In addition, the use case is now a Conference Room and not a Classroom, and rather than use statistical models for the Sensor Score Inference Engines 939 (FIG. 9e) and the Location Score Inference Engines 945 (FIG. 9e), instead we are using machine learning models to support this function.

In both examples, the data provided by the performance model is used later (in step Are all initialization variables provided? S1163, in step Initialize selected inference engines with some optimal and default parameters S1164, in step Initialize selected inference engines with optimal parameters S1165, in step Initialize inference engines S1166, in step Initialize Sensor Score Inference Engine S1167, in step Initialize Location Score Inference Engine S1168 (FIG. 10q)) to configure Sensor Score Inference Engines 939 (FIG. 9e) and the Location Score Inference Engines 945 (FIG. 9e). Data from the other engines are used as input to and to otherwise adjust the operation and output of the Sensor Score Inference Engines 939 and the Location Score Inference Engines 945 to reflect the impact the specific room 101, conference system, and use case would have with respect to predicting room 101 performance.

Step OR S1157 simply indicates that, in these examples, we would use one or the other configurations. As the rooms 101, use cases, and conferencing systems 120 are different in both examples it is not reasonable to combine them or otherwise use them in parallel in the same room 101. This clearly would generate inconsistent results because the environments in each example are quite different. The last step in the process in step Collect selected inference engines S1158 aggregates the selected Sensor Score Inference Engines 939, and Location Score Inference Engines together and makes them available to the next step in the process illustrated in FIG. 10q.

FIG. 10q shows the logic flow of how the initialization variables determined in FIG. 10o and the selected Sensor Score Inference Engines 939, and Location Score Inference Engines 945 determined in FIG. 10p are used to setup and create instances of the final set of Sensor Score Inference Engines 939 and Location Score Inference Engines 945 that the Room System Score Processor 907 (FIG. 9e) will use to predict performance from the specified room 101, conference system 120, and use case.

The process begins by retrieving the initialization variables in step Get initialization variables S1161 and selected inference engines in step Get selected inference engines S1162 from in step Initialize performance model variables S1152 (FIG. 10o) and in step Collect selected inference engines S1158 (FIG. 10p) respectively.

In the next step Are all initialization variables provided? S1163 we determine if the initialization variables we obtained are complete and allow us to fully initialize the Sensor Score Inference Engines 939 (FIG. 9e) and Location Score Inference Engines 945 (FIG. 9e). Or are some initialization variables not provided; in which case we don't have complete details about the room system. Incomplete information would occur when some data were missing or not provided for the Room Configuration 934 (FIG. 9d), Conference System Configuration 935 (FIG. 9d), Use Case Data 936 (FIG. 9d), or Performance Model Configuration 937 (FIG. 9d).

The preferred case is where all initialization variables are provided and the Sensor Score Inference Engines 939, and Location Score Inference Engines 945 can be initialized optimally (in step Initialize selected inference engines with optimal parameters S1165, in step Initialize inference engines S1166, in step Initialize Sensor Score Inference Engine S1167, in step Initialize Location Score Inference Engine S1168) using detailed knowledge from the Room Configuration 934 (FIG. 9d), Conference System Configuration 935 (FIG. 9d), Use Case Data 936 (FIG. 9d), or Performance Model Configuration 937 (FIG. 9d). For example, if we have complete details about the Conference System 120 (FIG. 9a) and we know that this specific system has poor noise reduction, but handles reverberation well, then we can configure the Sensor Score Inference Engines 939 (FIG. 9e) so that more weight is put on the noise scoring as it will affect the room 101 system performance more than changes in reverberation in step Initialize Sensor Score Inference Engine S1167. In a similar way we could also adjust the input weights for Location Score Inference Engines 945 (FIG. 9e), so that output from Sensor Score Inference Engines 939 (FIG. 9e) associated with noise have a higher impact in step Location Score Inference Engine S1168. Although these various weights could be manually provided, via the Conference System Configuration 935 (FIG. 9d) it should be noted that these weights can also be determined or learned by using the Room System Performance Processor 901 (FIG. 9a) with the given Conference System 120 (FIG. 9a) and evaluating the predicted performance as the various weights are adjusted.

In the case where some of the anticipated initialization variables are not provided the next step Initialize selected inference engines with some optimal and default parameters S1164 will initialize the Sensor Score Inference Engines 939, and Location Score Inference Engines with specific values from initialization variables that were provided and the others from defined default values. A simple example where some initialization variables are not provided would be when we don't know specific details about the Conference System 120 (FIG. 9a) being used, or we don't have a definition of the intended use case for the room 101. In these situations, and others, where initialization variables are missing, the Sensor Score Inference Engines 939, and Location Score Inference Engines remain usable, but they would be less optimized and produce less accurate results. These default values might, for example, assign equal weights to all Sensor Score Inference Engine 939 (FIG. 9e) inputs in step Initialize Location Score Inference Engine S1168 to the Location Score Inference Engines 945 (FIG. 9e). This would produce less accurate results than a system where all the initialization variables are provided.

The final step in step Collect initialized inference engines S1169 of this process aggregates together all the initialized Sensor Score Inference Engines 939 (FIG. 9e) and Location Score Inference Engines 945 (FIG. 9e) to be used by the Room System Performance Processor 901 (FIG. 9a).

FIG. 10r and FIG. 10s illustrate the operation of the Sensor Score Inference Engines 939 (FIG. 9e) within the Room System Score Processor 907 (FIG. 9e) and how they are used to compute sensor scores from inputs provided. The Sensor Score Inference Engines 939 (FIG. 9e) are a collection of various Sensor Score Inference Engines 939 that take the output of the Audio Measurement Processor 905 (FIG. 9e) as input (node H) and data retrieved from the Historical Room Database 910 (FIG. 9a) and generate outputs that represent a sensor 978 weight or a score from the raw measurements 504 provided to it (from the Audio Measurement Processor 905 (FIG. 9e)). Details on how sensors 978 scores are calculated are shown later in FIG. 10u, and FIG. 10v. At a high level, though, they form the mechanism by which the Room System Score Processor 907 (FIG. 9e) uses a range of measurements 504, (as provided by the Audio Measurement Processor 905 (FIG. 9e)) as facts about the room 101, combined with specific other details about the environment or domain such as the Room Configuration 934 (FIG. 9d) the Conference System Configuration 935 (FIG. 9d), the Use Case Data 936 (FIG. 9d) and the underlying Performance Model Configuration 937 (FIG. 9d) to transform one or more measurements 504 from the room 101 into a score (i.e. to infer new knowledge) that is indicative of and predicts the expected performance of the overall room 101 system.

The Room System Score Processor 907 (FIG. 9e) can support any number of Sensor Score Inference Engines 939 (FIG. 9e), including but not limited to Background Noise Inference Engines (FIG. 9e), Impulse Inference Engines 941 (FIG. 9e), Spectrum Inference Engines 942 (FIG. 9e), STIPA Inference Engines 943 (FIG. 9e), and other Additional Inference Engines 944 (FIG. 9e) as might be available or needed.

Regardless of the type of Sensor Score Inference Engine 939 (FIG. 9e), they all operate in the same fashion. First (in step Get background noise measurements S1170, in step Get impulse measurements S1173, in step Get spectrum measurements S1176, in step Get STIPA measurements S1182 (FIG. 10s)) the Sensor Score Inference Engine 939 retrieves raw measurements from the Audio Measurement Processor 905 (FIG. 9e) or the Historical Room Database 910 (FIG. 9a). Next, we get the initialized version of inference engines 939, (in step Get initialized background noise inference engine S1171, in step Get initialized impulse inference engine S1174, in step Get initialized spectrum inference engine S1177, in step Get initialized STIPA inference engine S1183 (FIG. 10s) as established by the Room System Score Processor Initialization, in step Room System Score Processor Initialization S1160 (FIG. 10q). Lastly the inference engine 939 is used to compute a weight or a score (in step Use inference engine to score noise measurements S1172, in step Use inference engine to score impulse measurements S1175, in step Use inference engine to score spectrum measurements S1178, in step Use inference engine to score STIPA measurements S1184 (FIG. 10s)) to the inputs it retrieved.

It is the last steps (in step Use inference engine to score noise measurements S1172, in step Use inference engine to score impulse measurements S1175, in step Use inference engine to score spectrum measurements S1178, in step Use inference engine to score STIPA measurements S1184 (FIG. 10s)) that fundamentally differentiate the types of inference engines 939. The process used to infer sensor scores from background noise, is different from that for impulse scores, and spectrum scores, and STIPA scores. More details can be found in FIG. 10u, and FIG. 10v.

As is shown in FIG. 10r, multiple inference engines can be run in parallel and be applied to the same or different inputs coming from the Audio Measurement Processor 905 (FIG. 9e) or the Historical Room Database 910 (FIG. 9a). The final step (in step Collect and store background noise scores S1179, in step Collect and store impulse scores S1180, in step Collect and store spectrum scores S1181, in step Collect and store STIPA scores S1185 (FIG. 10s)) for each inference engine 939 instance is to collect all the sensor scores determined by each of the Score Inference Engines 939 (FIG. 9e). The collected outputs nodes (H1.1, H1.2, H1.3, H1.4 (FIGS. 10r and 10s)) are then made available to the Location Score Inference Engines 945 (FIG. 9e) as input node H1 (FIG. 10t) and stored in the Historical Room Database 910 (FIG. 9a) where they can be retrieved for future use as required.

The spatial and temporal reference for the input data (node H and Historical Room Database 910 (FIG. 9a)) that each of the Sensor Score Inference Engines 939 (FIG. 9e) uses is defined in the room and measurement configuration data retrieved via the Room and Measurement Configuration Data 904 (FIG. 9e). For example, if we process room and measurement configuration data obtained through previous uses of the Room System Score Performance Processor 901 (FIG. 9a), the spatial and temporal reference would specify the space/room 101 that we want data for and the time frame we are interested in. This room and measurement configuration data would then be retrieved from the Historical Room Database 910 (FIG. 9a). Similarly, if we are using the room and measurement configuration data via the Room System Score Processor 907 (FIG. 9e), in a real time fashion, for example, in an actual physical room 101, then the room and measurement configuration data would come directly from the Audio Measurement Processor 905 (FIG. 9e) as input node H. The Sensor Score Inference Engines 939 (FIG. 9e) can also use room and measurement configuration data from both sources simultaneously. That is, we are using real time data from current measurements 504 from the room 101 and we are combining them with previously obtained results for the same or potentially different room 101. We would consider a different room 101, for example, because we wish to visualize or analyze the effects one room 101 has on another, potentially associated with understanding the changes in background noise on the room 101 performance.

FIG. 10t illustrates the final steps that the Room System Score Processor 907 (FIG. 9e) uses to determine room performance scores for different locations within the room 101. The Room System Score Processor 907 (FIG. 9e) uses Location Score Inference Engines 945 (FIG. 9e) to compute performance scores for different locations 502 in the room 101 and collectively these form a collection of data points node E, in both space and time 504, that predict the overall room system performance. This collection of data points, i.e. the collection of every Location Score Inference Engine 945 (FIG. 9e) is made available, downstream, to the Room System Performance Map Analytics Processor 909 (FIG. 9g) where it forms the Room System Performance Map Data Points 954 (FIG. 9g) which is the raw data used to compute the Room System Performance Map 948 (FIG. 9g). The output of the Location Score Inference Engines 945 (FIG. 9e) are stored in the Historical Room Database 910 (FIG. 9e) where they can be used later for further analysis by Room System Performance Map Analytics Processor 909 (FIG. 9g).

As illustrated in FIG. 10t, the input to each Location Score Inference Engine 945 (FIG. 9e) is the output from one or more Sensor Score Inference Engines (in step Collect and store background noise scores S1179, in step Collect and store impulse scores S1180, in step Collect and store spectrum scores S1181 from FIG. 10r and in step Collect and store STIPA scores S1185 from FIG. 10s). There will be at least one Sensor Score Inference Engine 939 (FIG. 9e) for each location measured in the room 101. There typically are more than one Sensor Score Engine 939 (FIG. 9e) for each location 502 as we wish to use inferences drawn from multiple measurements 504 and statistics as this would improve the ultimate predictive accuracy of the Location Score Inference Engine 945 (FIG. 9e). For example, we could configure the Room System Score Processor 907 (FIG. 9e) to only consider Impulse Measurements 926 (FIG. 9c) using an Impulse Inference Engine 941 (FIG. 9e) and then using the output of this alone as the input to the Location Score Inference Engine 945 (FIG. 9e). This might generate a reasonable Room System Performance Map Data Points 954 (FIG. 9g), but the accuracy could be poor if the room 101 had significant background noise from time to time also. In this case the accuracy of the Room System Score Performance Processor 901 would be improved by considering at least Background Noise Measurements 924 (FIG. 9c) with a Background Noise Inference Engines 940 (FIG. 9e) and potentially also Spectrum Measurements 928 (FIG. 9c) with a Spectrum Inference Engines 942 (FIG. 9e). So, in this example there are three Sensor Score Inference Engines 939 (FIG. 9e) feeding into each Location Score Inference Engine 945 (FIG. 9e).

The objective of each Location Score Inference Engine 945 (FIG. 9e) is therefore to aggregate all the Sensor Inference Engine 939 (FIG. 9e) scores into a single room performance score per location 502 and as is shown in FIG. 10t it does this in a similar way to the Sensor Score Inference Engines 939 (FIG. 9e). First the Location Score Inference Engine 945 (FIG. 9e) retrieves all the input Sensor Score Inference Engine 939 (FIG. 9e) scores in step Get sensor scores S1186. Then it retrieves the initialized versions of the location score inference engine 945 to use in step Get initialized location score inference engine S1187, as established previously by the Room System Score Processor Initialization in step S1160 (FIG. 10q). Lastly the location score inference engine 945 is used to determine the performance score for the location in step Use inference engine to calculate location scores S1188 taking into consideration each of the weights or scores provided by all the input Sensor Score Inference Engines 939 (FIG. 9e). More details of how the Location Score Inference Engine works are shown in FIG. 10w and FIG. 10x.

Location Score Inference Engines 945 (FIG. 9e) infer location scores in a manner similar to how the Sensor Score Inference Engines 939 (FIG. 9e) infer scores from specific measurements 504. Sensor Score Inference Engines 939 (FIG. 9e) infer scores for individual audio measurements 504 (from data provided by the Audio Measurement Processor 905 (FIG. 9e) and the Historical Room Database 910 (FIG. 9a). They infer scores, however, not only using the audio measurements 504 themselves but also a range of other information describing details of the room 101, the conferencing system 120, and the use case. In a similar, manner the Location Score Inference Engine 945 (FIG. 9e) infers location performance scores not only from several Score Inference Engine 939 (FIG. 9e) inputs, but also by considering specific other details about the Room Configuration 934 (FIG. 9d) the Conference System Configuration 935 (FIG. 9d), the Use Case Data 936 (FIG. 9d) and the underlying Performance Prediction Model Configuration 937 (FIG. 9d).

Therefore, unlike existing systems in the current art, which typically present an aggregation of various direct and indirect measurements (simple facts about the standalone acoustics of the room 101) as an indication of room 101 performance, the Room System Score Processor 907 (FIG. 9e) takes these measured facts and using a series of inference engines (Sensor Score Inference Engines 939 (FIG. 9e) and Location Score Inference Engines 945 (FIG. 9e)) combined with specific other details of the environment or domain (Room Configuration 934 (FIG. 9d), Conference System Configuration 935 (FIG. 9d), the Use Case Data 936 (FIG. 9d), and the underlying Performance Prediction Model Configuration 937 (FIG. 9d)) and makes informed, expert predictions about the room system performance.

As is shown in FIG. 10t, there are multiple Location Score Inference Engines 945 (FIG. 9e), one for each location 502 measured in the room 101, and potentially running in parallel, that is at the same time. The final step is therefore to collect in step Collect and store location scores S1189 all the performance scores from each location 502 and make available downstream via node E to the Room System Performance Map Analytics Processor 909 (FIG. 9g). The collection of Location Score Inference Engine 945 (FIG. 9e) is also stored in the Historical Room Database 910 (FIG. 9e) where they can be retrieved for future analysis as needed.

FIGS. 10u and 10v now present two examples of how Sensor Score Inference Engines 939 (FIG. 9e) operate. In the first example (FIG. 10u), we show how a simple linear performance model is used for the inference engine 939 and in the second example (FIG. 10v), the linear model is replaced with a Machine Learning (ML) model.

The System Configuration Initializer 933 (FIG. 9d) as described in FIG. 10o and FIG. 10p is used to determine which Sensor Score Inference Engines 939 (FIG. 9e) should be used and to determine initial configuration variables for the selected engine 939. The System Configuration Initializer 933 (FIG. 9d) is the component in the Room System Score Performance Processor 901 (FIG. 9a) that has details and knowledge of the environment (via Room Configuration 934 (FIG. 9d), Conference System Configuration 935 (FIG. 9d), Use Case Data 936 (FIG. 9d) and Performance Model Configuration 937 (FIG. 9d)). The System Configuration Initializer 933 (FIG. 9d) use this information with one or more initializers (Room Initializer in step Room Initializer S1141, Room Configuration 934 (FIG. 10o), the Conference System Initializer in step Conference System Initializer S1142, Conference System Configuration 935 (FIG. 10o), the Use Case Initializer S1143, Use Case Data 936 (FIG. 10o), and the Performance Model Initializer in step S1144, Performance Model Configuration 937 (FIG. 10o)) to select, create and initialize appropriate Sensor Score Inference Engines 939 (FIG. 9e) for the given environment 101.

It is the Performance Model Initializer in step S1144, Performance Model Configuration 937 (FIG. 10o) that determines the underlying performance model (e.g. linear model, Machine Learning (ML) model, etc.) used by the Sensor Score Inference Engines 939 (FIG. 9e). The other initializers will determine the various other parameters for the model selected. With this process, default versions of Sensor Score Inference Engines 939 (FIG. 9e) can be selected and optimized specifically for the environment 101 they will operate in.

FIG. 10u shows an example of a Sensor Score Inference Engine 939 (FIG. 9e), where the underlying performance model used is a simple linear model in step Example selected inference engine: Linear transfer function S1194. The inputs node H to this model can be any one of the outputs produced from the Audio Measurement Processor 905 (FIG. 9c), including but not limited to background noise measurements, impulse measurements, spectrum measurements, or STIPA measurements. Input to the Sensor Score Inference Engine 939 (FIG. 9e) can also include measurements obtained from the Historical Room Database 910 (FIG. 9a).

The linear model would be used when there is a linear relationship between the input measurement and the sensor 978 score that should be inferred from it. As is illustrated in step Example selected inference engine: Linear transfer function S1194, along with the audio measurement inputs (node H and Historical Room Database 910 (FIG. 9a) a linear model uses initialization values in step Example inference engine initialization S1191 (determined by the System Configuration Initializer 933 (FIG. 9d)) to determine the output sensor score in step Sensor scores S1195. The linear model in step Example selected inference engine: Linear transfer function S1194 uses coefficients in step Initialized inference engine coefficients S1192 and constants in step Initialized inference engine constants S1193, determined by the System Configuration Initializer 933 (FIG. 9d) to compute the final sensor score. In this way the score inferred from the measurement input by the Sensor Score Inference Engines 939 (FIG. 9e) is optimized based on the room 101, the conference system 120 in use, and the intended use case.

Below is a simple concrete example of how a Sensor Score Inference Engine 939 (FIG. 9e) infers the sensor score from a background noise measurement using a linear model. In this example we assume that we have a background noise measurement of 56 dB (A), from Audio Measurement Processor 905 (FIG. 9c):

$$noise = 56$$

The System Configuration Initializer 933 (FIG. 9d) returns the following coefficients and constants to use for a background noise measurement. Note these would be derived from details about the room 101, the conference system 120 and the use case:

$$scale = 0.6$$

$$offset = - 20$$

The performance model used specifies that the background noise inference engine 940 (FIG. 9e) should compute the score for the background noise measurement such as:

$$score = scale \times noise + offset$$

Resulting in a Sensor Score of

$$score = 0.6 \times 56 - 20$$

$$score = 13.6$$

Linear models as illustrated in FIG. 10u, are fast and easy to understand as there is a direct linear relationship between the input measurement and the output sensor score. Other performance models can also be readily used. For example, a model for the spectrum inference engine 942 (FIG. 9e) could simply report the number of frequencies in the spectrum that have an amplitude above a given baseline. The input to this model would be the spectrum measurements from Audio Measurement Processor 905 (FIG. 9c), providing an array of frequency bands and their associated amplitude. The initialization of this model would define a baseline amplitude (for example 65 dB (A)) and the model would simply return the number of frequency bands that are above this amplitude.

More complex statistical models can also be used, and as shown in FIG. 10v. ML models are also supported. ML models are useful because they can model the potentially non-linear relationships between Rooms 101 (FIG. 1a), Conference Systems 120 (FIG. 9a), and various use cases FIGS. 1e and 1f. It is possible to develop and train different ML models for any combination of room 101, conference system 120, or use case.

As can be seen in FIG. 10v, a Sensor Score Inference Engine using an ML model as the underlying performance model operates in a similar manner to one that uses a linear model. The inputs (node H) to this model again come from the Audio Measurement Processor 905 (FIG. 9c) and the Historical Room Database 910 (FIG. 9a).

In this example, the audio measurement input is provided in step Select sensor measurements S1190 one of the neurons in the input layer of the neural network in step Example selected inference engine: Machine learning model S1194. This is for illustrative purposes only. The input data could be presented to any number of input neurons or various characteristic features, or other statistics, could be extracted from the audio measurement and presented to one or more neurons in the input layer.

In this example (FIG. 10v) the neural network in step Example selected inference engine: Machine learning model S1194 only has three input nodes, one hidden layer with four nodes, and finally one output layer. This is purely for illustrative purposes and without limitation other ML models could be used, such as Convolutional Neural Networks, Recurrent Neural Networks, Long Short-Term Memory Networks, Generative Adversarial Networks, Autoencoders, and Transformer Networks.

As is illustrated in FIG. 10v, along with the audio measurement inputs (node H and Historical Room Database 910 (FIG. 9a) the neural network in step Example selected inference engine: Machine learning model S1194 also uses initialization values in step Example inference engine initialization S1191, determined by the System Configuration Initializer 933 (FIG. 9d)) as input. This input includes details and knowledge of the environment 101 as determined by one or more initializers (Room Initializer in step S1141, Room Configuration 934 (FIG. 10o), the Conference System Initializer in step S1142, Conference System Configuration 935 (FIG. 10o), the Use Case Initializer in step S1143, Use Case Data 936 (FIG. 10o), and the Performance Model Initializer in step S1144, Performance Model Configuration 937 (FIG. 10o)). From this data the ML performance model can extract one or more features (in step Initialized inference engine features S1196, in step Initialized inference engine features S1197) and present this to the input layer of the ML model.

The data (i.e. the sensor measurements and other environment features) are presented to the input layer and is then fed through the ML model in step Example selected inference engine:

Machine learning model S1194. The ML model is a pre-trained model, optimized for various combinations of Rooms 101 (FIG. 1a), Conference Systems 120 (FIG. 9a), and various use cases FIGS. 1e and 1f. The structure of the neural network (for example the number of layers, number of neurons, and connections between them) and other parameters needed to configure it (for example the weights on connections between neurons) are all provided by the System Configuration Initializer 933 (FIG. 9d), specifically the output from the Performance Model Initializer 937 (FIG. 10o).

The output of the ML model is then a sensor score in step Sensor scores S1195 that is optimized based on the room 101, the conference system 120 in use, and the intended use case.

FIGS. 10w and 10x present examples of how the Location Score Inference Engines 945 (FIG. 9e) operate. In the first example (FIG. 10w) we show how a simple linear model is used to infer the location score from a collection of one or more Sensor Score Inference Engine 939 (FIG. 9e) outputs. In the second example (FIG. 10x) another example is shown where the linear model is replaced with a Machine Learning model.

The System Configuration Initializer 933 (FIG. 9d) as described in FIG. 10o and FIG. 10p is used to determine which Location Score Inference Engines 945 (FIG. 9e) should be used and to determine initial configuration variables for it. The System Configuration Initializer 933 (FIG. 9d) is the component in the Room System Score Performance Processor 901 (FIG. 9a) that has details and knowledge of the environment 101 (via Room Configuration 934 (FIG. 9d), Conference System Configuration 935 (FIG. 9d), Use Case Data 936 (FIG. 9d) and Performance Model Configuration 937 (FIG. 9d)). The System Configuration Initializer 933 (FIG. 9d) use this information with one or more initializers (Room Initializer in step S1141, Room Configuration 934 (FIG. 10o), the Conference System Initializer in step S1142, Conference System Configuration 935 (FIG. 10o), the Use Case Initializer in step S1143, Use Case Data 936 (FIG. 10o), and the Performance Model Initializer in step S1144, Performance Model Configuration 937 (FIG. 10o) to select, create and initialize appropriate Location Score Inference Engines 945 (FIG. 9e) for the given environment 101.

It is the Performance Model Initializer in step S1144, Performance Model Configuration 937 (FIG. 10o) that determines the underlying performance model (e.g. linear model, ML model, etc.) that will be used by the Location Score Inference Engines 945 (FIG. 9e). The other initializers will determine the various other parameters for the model selected. With this process, default versions of Location Score Inference Engines 945 (FIG. 9e) can be selected and optimized specifically for the environment 101 they will operate in.

FIG. 10w shows an example of a Location Score Inference Engine 945 (FIG. 9e) where the underlying performance model used is a simple linear model in step Example selected inference engine: Linear transfer function S1203. The inputs to this model are the outputs from one or more Sensor Score Inference Engines 939 (FIG. 9e). The Sensor Score Inference Engines 939 (FIG. 9e) infer how various measurements 504 taken from the room 101 could impact the room system performance given details of the environment as described by the Room Configuration 934 (FIG. 9d), Conference System Configuration 935 (FIG. 9d), Use Case Data 936 (FIG. 9d) and Performance Model Configuration 937 (FIG. 9d)).

In the FIG. 10w example, the Location Score Inference Engine 945 (FIG. 9e) is using inputs from four different Sensor Score Inference Engines 939 (FIG. 9e) that provide insight about how background noise in step Get Background noise scores S1170, impulse response in step Get Impulse scores S1173, frequency spectrum in step Get Spectrum scores S1176 and STIPA in step Get STIPA scores S1182 scores will impact the room system performance for the location 502 (spatial and temporal) the Location Score Inference Engine 945 (FIG. 9e) is associated with. Although the example shows the use of four Sensor Score Inference Engines 939 (FIG. 9e) as input, any number inference engines 939 can be used as might be available.

Like the linear models shown in FIG. 10u, the linear model for the Location Score Inference Engine 945 (FIG. 9e) infers the location performance score as a linear combination of all the input Sensor Score Inference Engine 939 (FIG. 9e) inputs. As is shown in step Example selected inference engine: Linear transfer function S1203 in this example the linear combination is a weighted sum of all the inputs (in step Get Background noise scores S1170, impulse response in step Get Impulse scores S1173, frequency spectrum in step Get Spectrum scores S1176 and STIPA in step Get STIPA scores S1182) plus a defined offset in step Room System Performance Map Cell Data S1202. The weights to use for each of the inputs and the offset to use is determined by the System Configuration Initializer 933 (FIG. 9d). And like the Sensor Score Inference Engines 939 (FIG. 9e), this allows the linear model for the Location Score Inference Engine 945 (FIG. 9e) to adapt its location score output based on environmental factors as described by the Room Configuration 934 (FIG. 9d), Conference System Configuration 935 (FIG. 9d), Use Case Data 936 (FIG. 9d).

In the example shown in FIG. 10w, different weights are determined and used for different measurements. Background noise scores use one weight in step Initialized noise score weights S1198, impulse scores another weight in step Initialized impulse score weights S1199, spectrum scores another weight in step Initialized spectrum score weights S1200, and STIPA scores another weight in step Initialized STIPA score weights S1107. As can be seen in FIG. 10w, each of the various input scores are modulated by their score weight and summed to produce the location score in step Location scores S1203a. The final location score is then determined by adding the offset in step Initialized location score constants S1202. In this way the Location Score Inference Engine 945 (FIG. 9e) computes the performance score for the location inferred from insight from a range of different Sensor Score Inference Engines 939 (FIG. 9e) in a way that, not only uses basic facts as described by the raw measurement scores but also using specific characteristics of the room 101 and system 120.

Below is a simple example of how a Location Score Inference Engine 945 (FIG. 9e) would compute a location score from multiple Sensor Score Inference Engines 939 (FIG. 9e) using a linear model. The linear model is simply a sum of products plus an offset as shown in the formula below:

$$LocationScore = {\sum }_{i = 0}^{n} W ( i ) \cdot S ( i ) + C$$

In this formula:
n=The number of input Sensor Scores Inference Engines
W (i)=The weight determined for i^{th} Sensor Score Inference Engine
S (i)=The Sensor Score from the i^{th} Sensor Score Inference Engine
C=The offset to use for the configured Location Score Inference Engine
   For the example shown where we use for Sensor Score Inference Engines 939 (FIG. 9e) the location score would be:

$$S ( 0 ) = NoiseScore = 13.6 , W ( 0 ) = NoiseWeight = 0.1$$

$$S ( 1 ) = ImpulseScore = 2.5 , W ( 1 ) = ImpulseWeight = 0.3$$

$$S ( 2 ) = SpectrumScore = 4 , W ( 2 ) = SpectrumWeight = 0.4$$

$$S ( 3 ) = STIPAScore = 0.69 , W ( 3 ) = STIPAWeight = 0.2$$

$$C = - 3$$

The score then is

$$LocationScore = W ( 0 ) \cdot S ( 0 ) + W ( 1 ) \cdot S ( 1 ) + W ( 2 ) \cdot S ( 2 ) + W ( 3 ) \cdot S ( 3 ) + C$$

$$LocationScore = 0.1 \times 13.6 + 0.3 \times 2.5 + 0.4 \times 4 + 0.2 \times 0.69 - 3$$

$$LocationScore = 1.36 + 0.75 + 1.6 + 0.138 - 3$$

$$LocationScore = 0.848$$

Again, similar to the case with Sensor Score Inference Engines 939 (FIG. 9e) linear models are fast and easy to understand because of the direct linear relationship between the inputs and the output location score. Other performance models can also be readily used. FIG. 10x shows a second example where an ML model is used to infer the room system location performance score. As can be seen, a Location Score Inference Engine 945 (FIG. 9e) Using an ML model as the underlying performance model operates in a similar way to one using a linear model. In this example (FIG. 10x) the neural network in step Example selected inference engine:
Machine learning model S1204 has an input layer with five input nodes, one hidden layer with four nodes, and an output layer with a single node. This is purely for illustrative purposes and without limitation other ML models could be used, such as Convolutional Neural Networks, Recurrent Neural Networks, Long Short-Term Memory Networks, Generative Adversarial Networks, Autoencoders, and Transformer Networks.

As is shown in FIG. 10x, the input provided to the neural network in step Example selected inference engine: Machine learning model S1204 consists of the output from one or more Sensor Location Inference Engines 939 (FIG. 9e) for example (in step Background noise scores S1170, in step Impulse scores S1173, in step Spectrum scores S1176, in step STIPA scores S1182) along with initialized inference engine features Example inference engine initialization S1205.

The inference engine features in step Example inference engine initialization S1205 are determined by the System Configuration Initializer 933 (FIG. 9d), which uses details and knowledge of the environment determined by one or more initializers (Room Initializer in step S1141, Room Configuration 934 (FIG. 10o), the Conference System Initializer in step S1142, Conference System Configuration 935 (FIG. 10o), the Use Case Initializer in step S1143, Use Case Data 936 (FIG. 10o), and the Performance Model Initializer in step S1144, Performance Model Configuration 937 (FIG. 10o)). This data allows the ML performance model, not only to use data derived from one or more measurements 504 in the room 101, using one or more Sensor Location Inference Engines 939 (FIG. 9e), but also to optimize the inferred location performance score using specific details about the room 101, the conference system 120 in use, and the intended use case of the room 101.

In the example (FIG. 10x) several Sensor Score Inference Engine 939 (FIG. 9e) outputs are also given as input to the ML model in step Example selected inference engine: Machine learning model S1204. Any number of inputs could be presented, depending on the available Sensor Score Inference Engines 939 (FIG. 9e) score that are available for the location 504 (spatial and temporal) that the Location Score Inference Engine 945 (FIG. 9e) is analyzing. In the example we show the use of background noise scores in step S1170, impulse scores in step S1173, spectrum scores in step S1176, and STIPA scores in step S1182. It should be noted that this data is not simply direct measurements made of the room 101. The data represents information inferred from these measurements 504 which also considers other factors including, but not limited to, Room Configuration 934 (FIG. 9d), Conference System Configuration 935 (FIG. 9d), Use Case Data 936 (FIG. 9d) and Performance Model Configuration 937 (FIG. 9d).

In this example, the sensor scores (in step Background noise scores S1170, in step Impulse scores S1173, in step Spectrum scores S1176, in step STIPA scores S1182) and the inference engine 939 features in step Example inference engine initialization S1205 are presented to only one of the nodes in the input layer in step Example selected inference engine: Machine learning model S1204. This is for illustrative purposes only. The input data could be presented to any number of input neurons or various characteristic elements, or other statistics could be extracted from the sensor scores and inference engine features and provided to one or more nodes in the input layer.

The data (i.e. the sensor scores and other inference engine features) are presented to the input layer and then fed through the ML model in step Example selected inference engine: Machine learning model S1204. The ML model is a pre-trained model, optimized for various combinations of Rooms 101 (FIG. 1a), Conference Systems 120 (FIG. 9a), and various use cases FIGS. 1e and 1f. The structure of the neural network (for example the number of layers, number of nodes, and connections between them) and other parameters needed to configure it (for example the weights on connections between nodes) are all provided by the System Configuration Initializer 933 (FIG. 9d), specifically the output from the Performance Model Initializer 937 (FIG. 10o).

The output of the ML model is the final location performance score in step Location scores S1204a for the given location 502 in both space and time 129 optimized based on the room 101, the conference system 120 in use, and the intended use case.

With reference to FIGS. 11a, 11b, 11c and 11d an exemplary detailed description of the Room System Performance Map Analytics Processor 909 (FIG. 9f).

FIG. 11a presents the overall context of the Room System Performance Map Analytics Processor 909 (FIG. 9f). The input (E) to this processor is a collection of the output from the Room System Score Processor 907 (FIG. 9e), previous results obtained from the Historical Room Database 910 (FIG. 1a), and Room and Measurement Configuration Data 904 (FIG. 9b).

As was shown (FIGS. 10o, 10p, 10q, 10s, 10t, 10u, 10v, 10w and 10x) the Room System Score Processor 907 (FIG. 9e) produces a set of location scores (945 (FIG. 9e), and in step Collect and store location scores S1189 FIG. 10s) in spatial and temporal dimensions for given room 101 (FIG. 1a), conference system 120 (FIG. 9a), and use case FIGS. 1e and 1f scenarios.

These locations scores 945 (FIG. 9e) can be combined with additional results from the Historical Room Database 910 (FIG. 1a), corresponding to previous results obtained from the Room System Score Processor 907 (FIG. 9e).

Details of the spatial and temporal extent of which location scores should be used are defined by the Room and Measurement Configuration Data 904 (FIG. 9b). The Room and Measurement Configuration Data 904 (FIG. 9b) will also contain additional details around the analysis that will be performed by the Room System Performance Map Analytics Processor 909 (FIG. 9f). This additional data includes configuration data for one or more Feature Extraction 974a (FIG. 9h) functions and Down Sampling Convolution Filters 975a (FIG. 9h) that should be used.

The primary function of the Room System Performance Map Analytics Processor 909 (FIG. 9e and FIG. 11a) is to perform a range of analysis functions on the input set of location scores (node E). These analysis functions derived additional room system performance information (node F) from the location scores, using one or more Feature Extraction 974a (FIG. 9h) functions and various Down Sampling Convolution Filters 975a (FIG. 9h) to generate the Multiscale Room System Performance Map 975 (FIG. 9g).

At a high level, the Multiscale Room System Performance Map 975 (FIG. 9g) maps the unstructured collection of input location scores (node E) onto a structured grid or map, in both spatial and temporal dimensions, which we call the Room System Performance Map 948 (FIG. 9g). Using this Room System Performance Map 948 (FIG. 9g) the Multiscale Room System Performance Map 975 (FIG. 9g) extracts important features from the map, creating the Level 0 Room System Extracted Features Map 949 (FIG. 9g). The Multiscale Room System Performance Map 975 (FIG. 9g) then computes a multiscale representation of these extracted features map (Level 1 Room System Extracted Features Map 950 (FIG. 9g) through Level N Room System Extracted Features Map 951 (FIG. 9g). The Multiscale Room System Performance Map 975 (FIG. 9g) therefore represents the initial input location scores (node E) along with a multiscale spatial and temporal map of important features extracted from it.

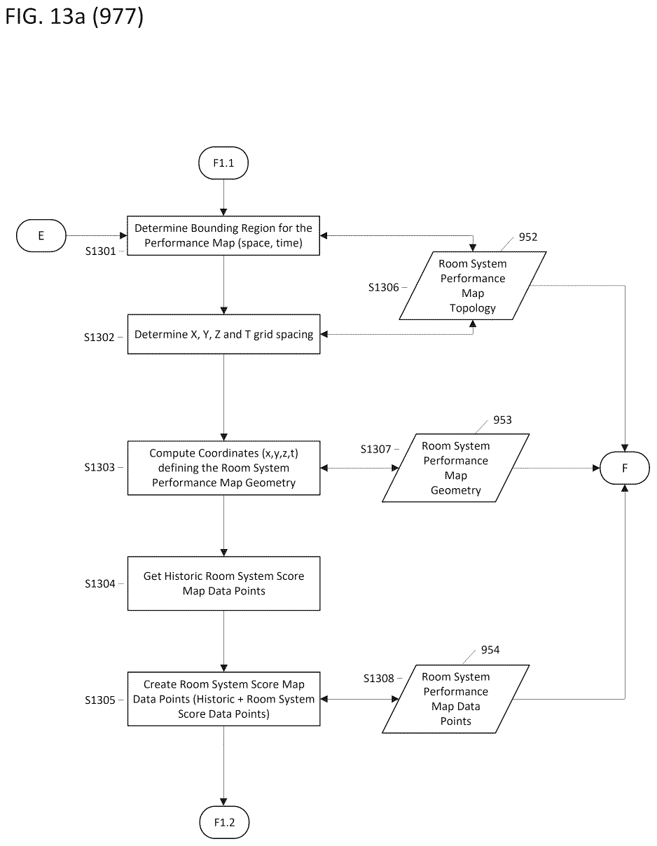

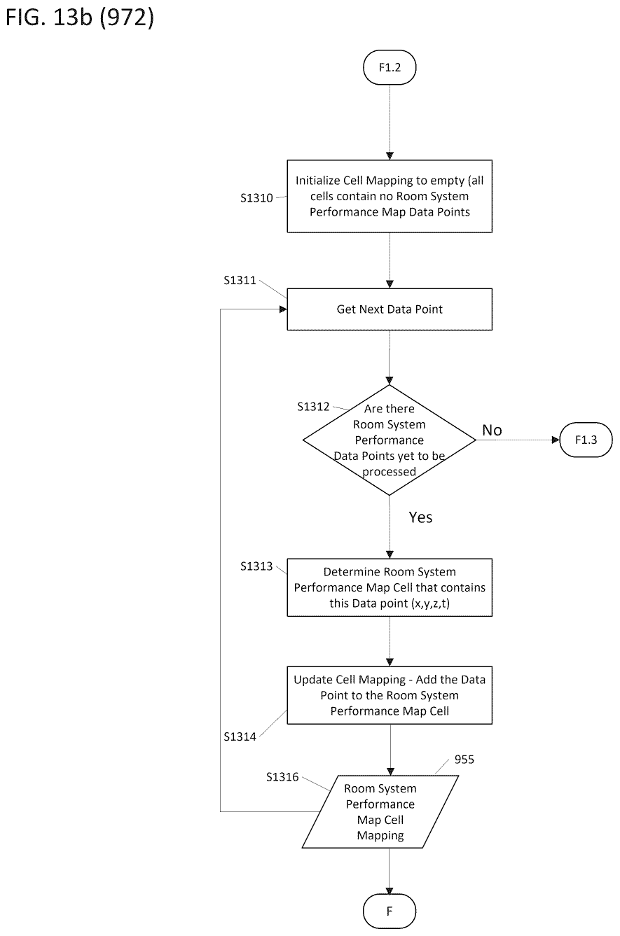

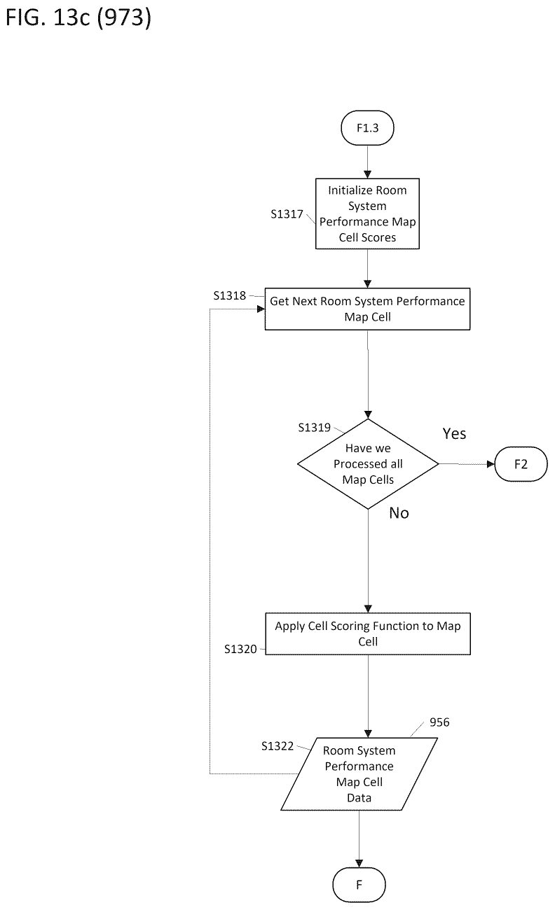

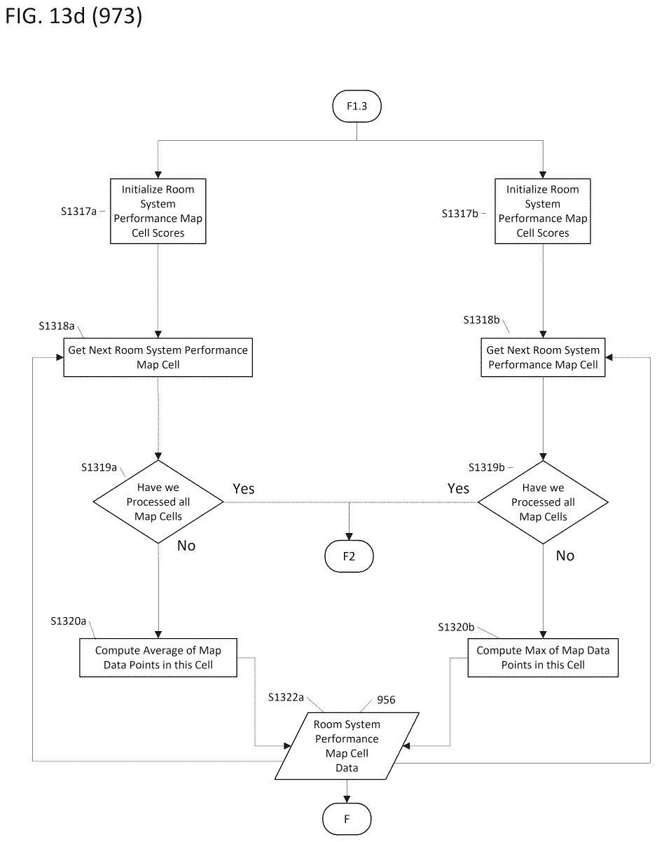

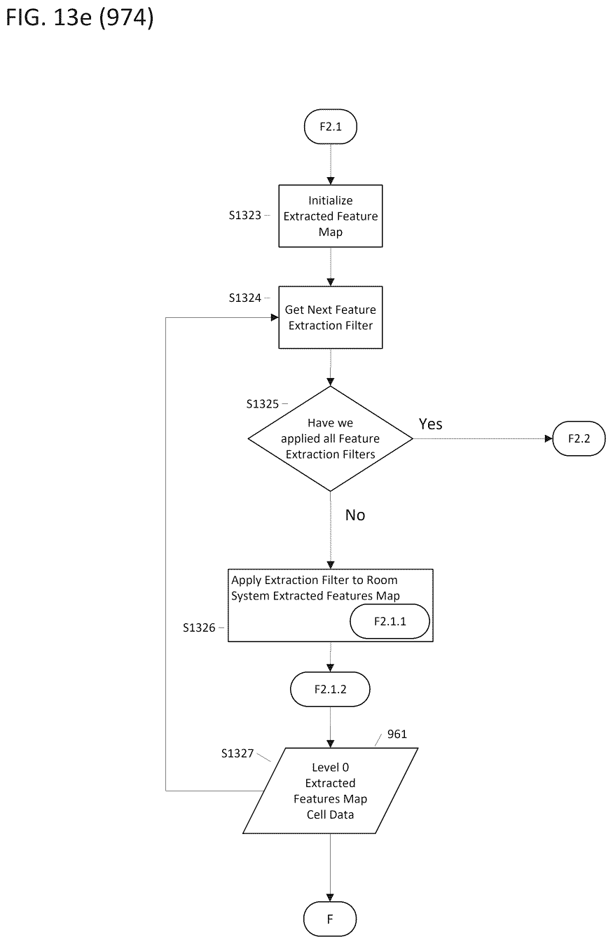

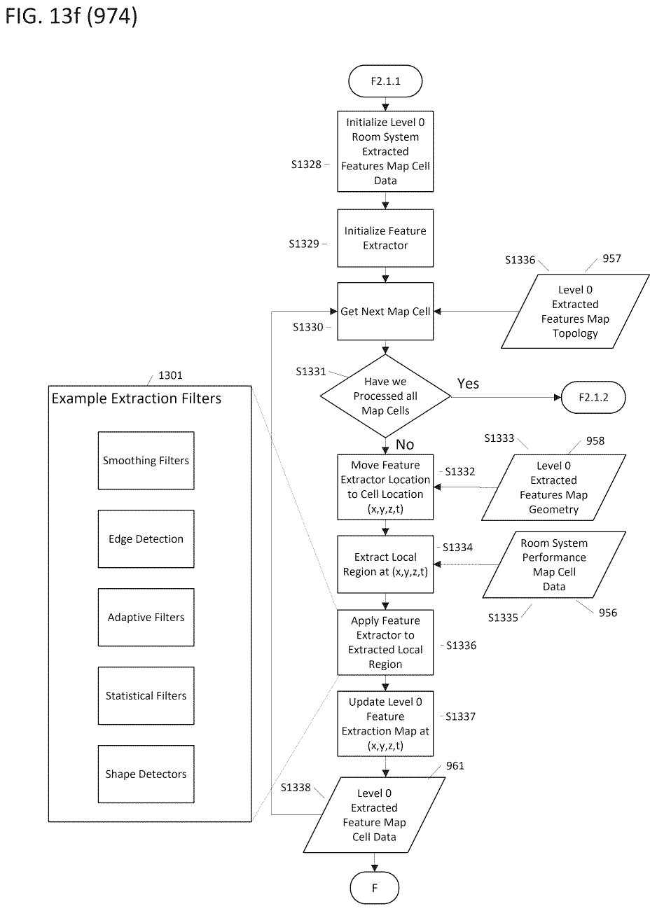

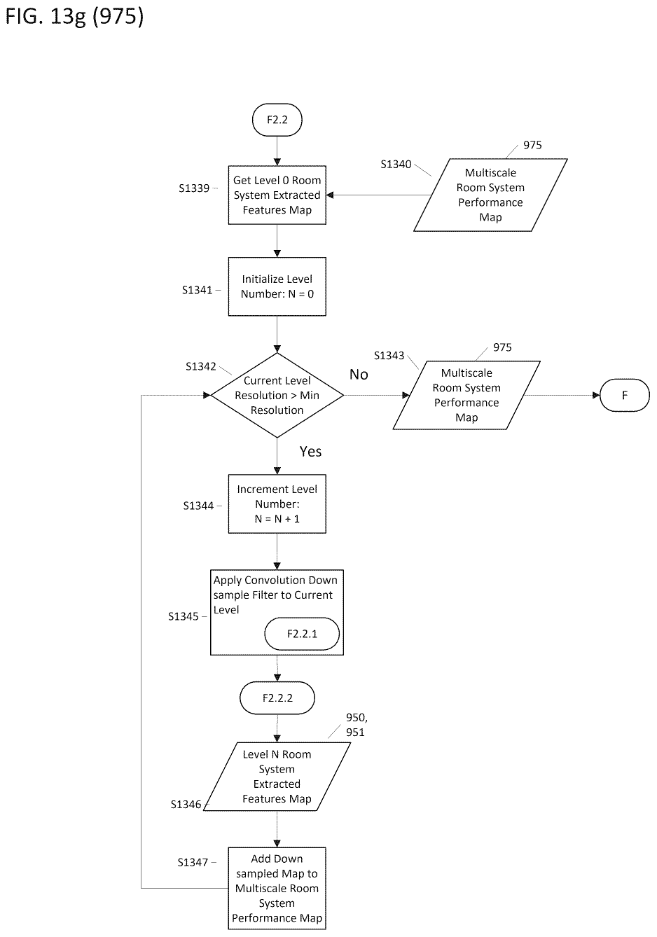

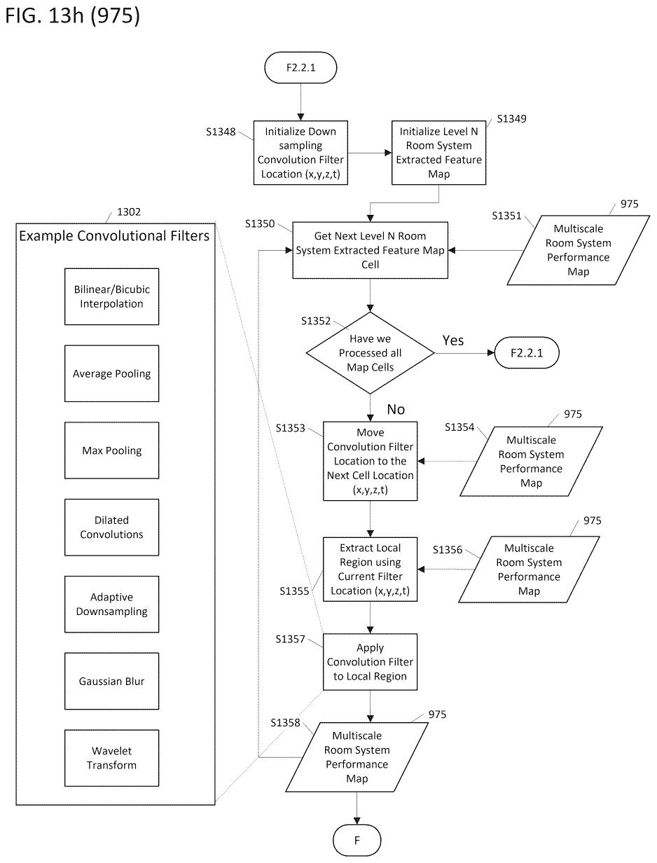

The Multiscale Room System Performance Map 975 is then used by a range of External Downstream Data Consumption Processes 911 (FIG. 9f). Simple examples of these downstream processes include tools that allow users to visualize the room performance information computed by the Room System Performance Map Analytics Processor 909 (FIG. 9f) enabling exploration and insight discovery from it. For example, external processes may render visualizations of the Room System Performance Map Feature Extraction, 1101 (FIG. 11a) also FIGS. 11c and 11d, (FIG. 13f), making the raw output, Multiscale Room System Performance Map 975, more interpretable. In addition, external tools use the Multiscale Room System Performance Map 975 (FIG. 9g) to determine and visualize where the room system is likely to perform well or poorly (1102 FIG. 11a and FIGS. 7a to 7h). Other downstream uses of the Multiscale Room System Performance Map 975 (FIG. 9g) include, but are not limited to, using the data to make recommendations as to where conference system 120 components, such as microphones 107, microphone arrays 125 speakers 106 illustrated in FIGS. 2a to 2g, could be positioned to provide better performance in rooms illustrated in FIGS. 1a to 1g and FIGS. 8a to 8i).

The Room System Performance Map Analytics Processor 909 (FIG. 9f) uses a two-step process in the production of its output Multiscale Room System Performance Map 975 (FIG. 9g). The first step involves Computing the Room System Performance Map 946 (FIG. 9f), which generates the Room System Performance Map 948 (FIG. 9g) from the input collection of location scores. The second step, 947 (FIG. 9g) involves building a multiscale, spatial and temporal, version of the Room System Performance Map 975 (FIG. 9g), which generates the Level 1 Room System Extracted Features Map 950 (FIG. 9g) through Level N Room System Extracted Features Map 951 (FIG. 9g).

FIG. 11b provides an overview of the first step, Computing the Room System Performance Map 946 (FIG. 9f). For clarity, the examples shown are illustrated using two spatial 505 dimensions X and Y. It must be remembered however that the data (Room System Performance Location Scores) produced by the Room System Score Processor 907 (FIG. 9e) are four dimensional made up from three spatial 505 dimensions (X, Y, Z) and one temporal 129 dimension (T). Also FIG. 11b illustrates the process using a simple uniform rectilinear grid that covers the room space 505 and time 129 dimensions. Other forms of structure can be used including less uniform rectilinear grids, where the spacing (spatial 505 and temporal 129 between individual map cells would be completely specified in the Room System Performance Map Topology 952 (FIG. 9g). Curvilinear grids are also possible where not only the spacing between map cells is specified, but so are the specific details (spatial 505 and temporal 129 coordinates) of the Room System Map Geometry 953 (FIG. 9g).

The input to this process is the output associated with a collection of Location Score Inference Engine 945 (FIG. 9e). The elements included in this collection are defined by the spatial and temporal extents defined in Room and Measurement Configuration Data 904 (FIG. 9b). In the Room System Performance Map Analytics Processor 909 (FIG. 9f) this forms the Room System Performance Map Data Points 954 (FIG. 9g), which is the foundation of the Room System Performance Map 948 (FIG. 9g).

Computing the Room System Performance Map 946 (FIG. 9f) involves generating Room System Performance Map Geometry 953 (FIG. 9g), which is determined from the Room System Performance Map Topology 952 (FIG. 9g). This defines a set of spatial and temporal bounding volumes or map cells that will be used to determine which points and how many points from the Room System Performance Map Data Points 954 (FIG. 9g) belong to each cell.

Computing the Room System Performance Map 946 (FIG. 9f) generates the Room System Performance Map Cell Mapping 955 (FIG. 9g), which simply identifies which map cell each of the Room System Performance Map Data Points 954 (FIG. 9g) belong to. The Room System Performance Map Cell Mapping 955 (FIG. 9g) is the input to the final step where a single score is computed for each of the map cells. Some map cells will have more than one Room System Performance Map Data Points 954 (FIG. 9g) data point associated with them and this step applies an aggregation function aXY (a00, a10, a20, a30 . . . a12, FIG. 11b) to the Room System Performance Map Data Points 954 (FIG. 9g) data points. Here, XY represents the spatial index of the map cell, which is shown in 2D in this example, but the same approach extends to 3D and can incorporate temporal dimensions. Many aggregation functions could be used; for instance, aXY might compute an average, determine a minimum or maximum, or apply other statistical measures. The output of this aggregation process is the Room System Performance Map Cell Data 956 (FIG. 9g), which now associates the input Room System Performance Map Data Points 954 (FIG. 9g), not with a specific location 502 and 129 time, but with a small, bounded volumes of space and time.

We also note here that Computing the Room System Performance map 946 (FIG. 9f) can be an iterative process. The process can start with an initial definition of the Room System Performance Map Topology 952 (FIG. 9g), generate a Room System Performance Map Geometry 953 (FIG. 9g) from this topology, then determine how many Performance Map Data Points 954 (FIG. 9g) are in each of the map cells. If we find that most of the map cells contain too many data points, for example more than one, or some other defined maximum, then we can adjust the spatial and temporal spacing defined in the Room System Performance Map Topology 952 (FIG. 9g), re-run the process until a better Room System Performance Map 948 (FIG. 9g) is obtained.

FIGS. 11c and 11d illustrate the next step 947 (FIG. 9g) that the Room System Performance Map Analytics Processor 909 (FIG. 9f) uses in the production of its output Multiscale Room System Performance Map 975 (FIG. 9g). This step uses the Room System Performance Map 948 (FIG. 9g), computed as shown in FIG. 11b to build a multiscale, spatial, and temporal version of it-Level 0 Room System Extracted Features Map 949 (FIG. 9g) through the Level N Room System Extracted Features Map 951 (FIG. 9g). Collectively, with the Room System Performance Map 975 (FIG. 9g), these form the Multiscale Room System Performance Map 975 (FIG. 9g). FIG. 11c illustrates the first step of this process, computing the Level 0 Room System Extracted Features Map 949 (FIG. 9g), while FIG. 11d illustrates the second step of computing multiscale versions of it.

The first part of this process is the computation of the Level 0 Room System Extracted Features Map 949 (FIG. 9g) from the Room System Performance Map 975 (FIG. 9g). The Level 0 Room System Extracted Feature Map 949 (FIG. 9g) is first initialized by copying the Room System Performance Map 948 (FIG. 9g). All the data in the Level 0 Room System Extracted Feature Map 949 (FIG. 9g), will be identical to the Room System Performance Map 948 (FIG. 9g), except for the Level 0 Extracted Features Map Cell Data 961 (FIG. 9g) as this is used to ultimately store the results of the feature extraction process on a cell-by-cell basis. Everything else remains identical because there is no change in the Room System Performance Map Topology 952 (FIG. 9g), the Room System Performance Map Geometry 953 (FIG. 9g), the Room System Performance Map Data Points 954 (FIG. 9g) or the Room System Performance Map Cell Mapping 955 (FIG. 9g) between the Room System Performance Map 948 (FIG. 9g) and the Level 0 Room System Extracted Features Map 949 (FIG. 9g).

The cell data, in the Level 0 Extracted Features Map Cell Data 961 (FIG. 9g) is generated by the application of one or more feature extraction filters (f0 FIG. 11c) to Room System Performance Map Cell Data 956 (FIG. 9g). Again, for clarity FIG. 11c shows this process using only two spatial dimensions.

Typically, although not always, feature extractors are applied to every map cell, and process one or more neighboring map cells, that is the feature extractor has defined dimensions, both spatially and temporally, that are often larger than one map cell. An example of a simple feature extractor that wouldn't process neighboring cells is a pass-through filter, where the input Room System Performance Map Data Cell Data 956 (FIG. 9g) are simply copied directly into the Level 0 Extracted Features Map Cell Data 961 (FIG. 9g).

When feature extractors process neighboring cells, before they are applied to Room System Performance Map Cell Data 956 (FIG. 9g), a copy of it is made and the edges of the data are padded with appropriate values 1103 (FIG. 11c). The amount of padding (pad) 1103 to apply, and the values to use are dependent on the specific details of the feature extraction function being used. For example, a Max Pooling feature extractor would ensure that the feature extraction edge padding (pad, 1103 (FIG. 11c) would use values that simply duplicate the Room System Performance Map Cell Data 956 (FIG. 9g), along the edge of the map.

Each of the feature extractors are applied to each cell in Room System Performance Map Topology 952 (FIG. 9g) as shown in map 1104 (FIG. 11c) and each generates a scalar for each cell in the map. If multiple feature extractors are applied, then a scalar representing the output of each feature extractor is computed. Collectively the output from all feature extractors is collected and form the data point for the underlying cell in the Level 0 Room System Extracted Features Map Cell Data 961 (FIG. 9g) as part of the overall Level 0 Room System Extracted Feature Map (FIG. 9g).

In FIG. 11c, the output of the application of the filter extractors, in the generation of the Level 0 Room System Extracted Feature Map 949 (FIG. 9g) are illustrated as the output of a function f0 (i, j), where i, and j are the indices of the map cell within the Level 0 Room System Extracted Features Map Topology 957 (FIG. 9g). The example illustrates the use of only a single feature extraction function; multiple feature extraction functions can also be used.

FIG. 11d illustrates the final step in the production of the Multiscale Room System Performance Map 975 (FIG. 9g). As shown in FIG. 11d, the process starts with the Level 0 Room System Extracted Features Map 949 (FIG. 9g), computed as shown in FIG. 11c. Higher scale versions are computed by applying a Down Sampling Convolutional Filter 975a (FIG. 9h) to down sample the data. There are several variants of Down Sampling Convolutional Filters 975a (FIG. 9h) that could be used, for example we can simply average the values from the Level 0 Extracted Features Map Cell Data 961 (FIG. 9g), or we could select minimum or maximum values and so on. The minimum or maximum values here refer to the minimum or maximum value produced by the Feature Extraction Filter 974a that originally created the Level 0 Extracted Features Map Cell Data 961 (FIG. 9g). The specific type of filter and its configuration is provided by the Room and Measurement Configuration Data 904 (FIG. 9b). The Down Sampling Convolutional Filters f1 (i,j) in FIG. 11d, and Down-sampling Convolution Filters 975a (FIG. 9h) is convolved with the Level Room System Extracted Features Map 949 (FIG. 9g) which creates a lower resolution, or higher scale version of the map, both spatially and temporally, called the Level 1 Room System Extracted Features Map 950 (FIG. 9g).

The application of the Down Sampling Convolution Filter 975a (FIG. 9h) is then repeated. Now the input to the Down Sampling Convolution Filter 975a (FIG. 9h) is the Level 1 Room System Extracted Features Map 950 (FIG. 9g) and the output is a lower resolution version of it. The process is repeated until we have a Level N Room System Extracted Features Map 951 (FIG. 9g) that is less than or equal to a pre-defined minimum as specified in the Room and Measurement Configuration Data 904 (FIG. 9b).

We compute the Multiscale Room System Performance Map 975 (FIG. 9g) because it has several benefits for External Downstream Data Consumption Processes 911 (FIG. 9f) including, but not limited to, the following:

(i) Efficient Data Management: Multiscale representations allow for efficient storage and management of large datasets by representing data at various levels of detail. This can significantly reduce memory usage and improve performance of downstream processes that would use the performance map.

(ii) Scalable Analysis: Different levels of detail can be used for different types of analysis. For example, coarse levels can be used for quick, high-level overviews, while finer levels can be used for detailed, localized analysis.

(iii) Improved Visualization: Multiscale representations enable smooth zooming and panning in visualizations, allowing users to explore data at different resolutions seamlessly.

(iv) Adaptive Processing: Algorithms can adaptively process data at different scales, focusing computational resources on areas of interest. This can lead to more efficient and faster computations. A specific example would be using this with an importance driven approach to microphone localization in the bubble map.

(v) Noise Reduction: Filtering data to create multiscale representations can help in reducing noise and highlighting significant features.

(vi) Hierarchical Modeling: Multiscale representations support hierarchical modeling, where models at different scales can be integrated.

(vii) Enhanced Compression: Data compression techniques often benefit from multiscale representations, as they can exploit redundancies at different scales to achieve higher compression ratios.

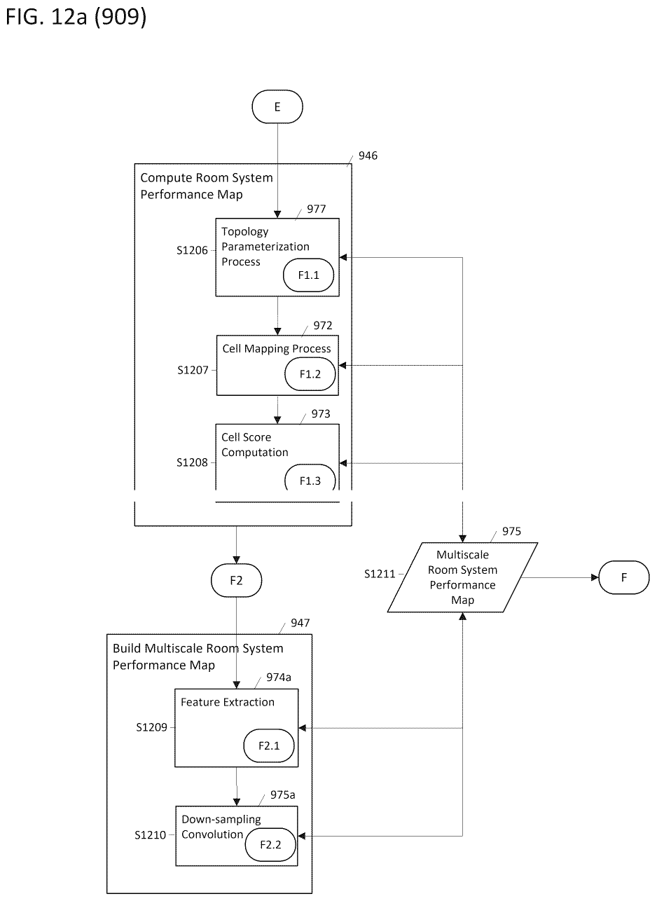

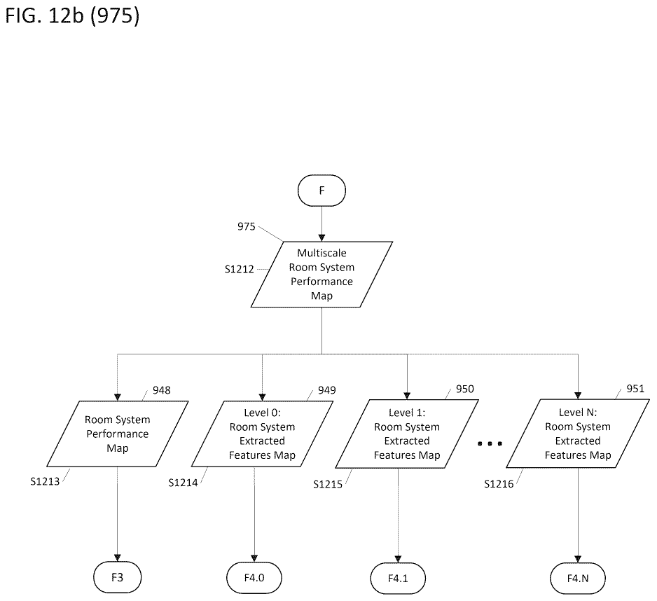

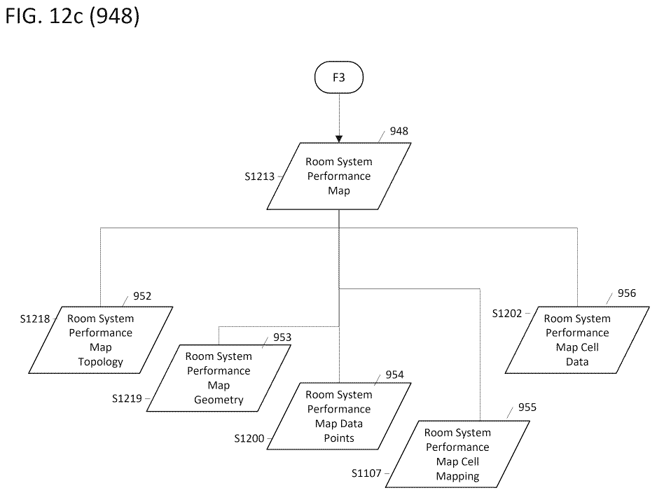

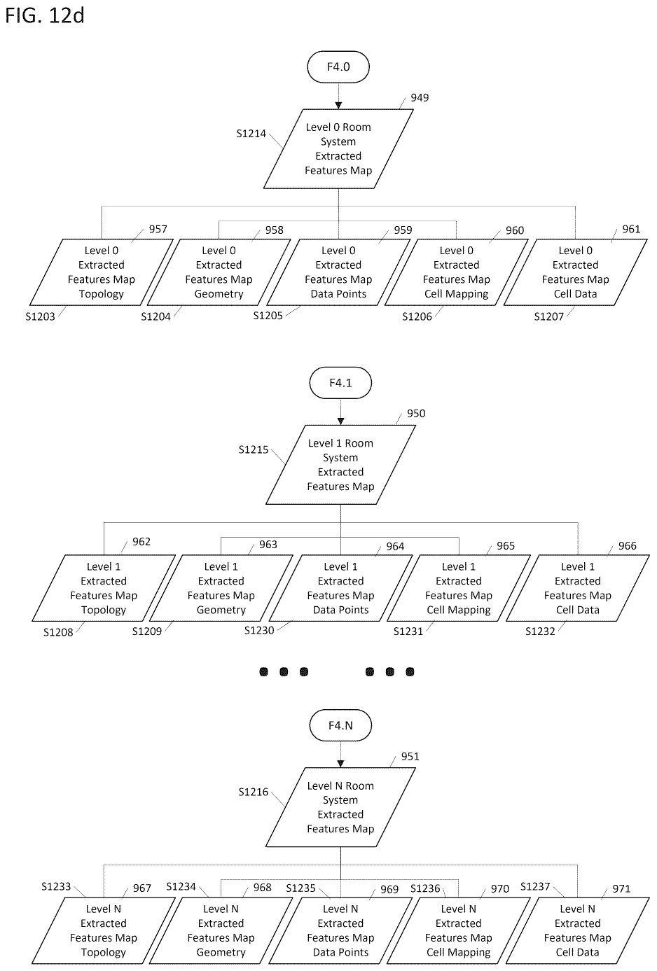

With reference to FIGS. 12a, 12b, 12c and 12d are exemplary logic flows Room System Performance Map Analytics Processor 909 (FIG. 9f) of a preferred embodiment of the invention.

FIG. 12a shows the overall process that the Room System Performance Map Analytics Processor 909 (FIG. 9f) uses to generate the Multiscale Room System Performance Map 975 (FIG. 9g).

The input to the process (node E) consists of Room and Measurement Configuration Data 904 (FIG. 9b), the output from the Room System Score Processor 907 (FIG. 9e) and data from the Historical Room Database 910 (FIG. 9a). The Room System Performance Map Analytics Processor (FIG. 9f) then computes the Multiscale Room System Performance Map 975 (FIG. 9g) using two functions: Compute Room System Performance Map 946 (FIG. 9f) and Build Multiscale Room System Performance Map 947 (FIG. 9f).

The Compute Room System Performance Map 946 (FIG. 9f) uses this data (node E), to build the underlying Room System Performance Map 948 (FIG. 9g). This is done in three steps: in step Topology Parameterization Process S1206, Topology Parameterization Process, in step Cell Mapping Process S1207, Cell Mapping, and in step Cell Score Computation S1208 Cell Score Computation. These three steps are explored in detail later in F1.1 (FIG. 13a), F1.2 (FIGS. 13b), and F1.3 (FIG. 13c). The three steps generate the Room System Performance Map Topology 952 (FIG. 9g), the Room System Performance Map Geometry 953 (FIG. 9g) and finally the Room System Performance Map Data Points 954 (FIG. 9g). These are all foundational elements of the Multiscale Room System Performance Map 975 (FIG. 9g) where they are stored via step Multiscale Room System Performance Map S1211 in the Historic Room Database 910 (FIG. 9a).

The Build Multiscale Room System Performance Map 947 (FIG. 9f) takes the output (node F2), the Room System Performance Map 948 (FIG. 9g), from the Compute Room System Performance Map 946 (FIG. 9f) and builds several multiscale versions of it. This is done in two steps: in step Feature Extraction S1209 and in step Down Sampling Convolution S1210 Down Sampling Convolution. The details of these two steps are explored in detail later in F2.1 (FIGS. 13e) and F2.2 (FIG. 13f). These steps generate the Level 0 Room System Extracted Features Map 949 (FIG. 9g) through to the Level N Room System Extracted Features Map 951 (FIG. 9g). These with the Room System Performance Map 948 (FIG. 9g) form the completed Multiscale Room System Performance Map 975 (FIG. 9g). in step Multiscale Room System Performance Map S1211 stores the now complete Multiscale Room System Performance Map 975 (FIG. 9g) in the Historic Room Database 910 (FIG. 9a) where it is available to one or more External Downstream Data Consumption Processes 911 (FIG. 9f).

With reference to FIGS. 12b, 12c and 12d show the detailed makeup of the output from the Room System Performance Map Analytics Processor (node F) from FIG. 11a and FIG. 12a.

As is shown in FIG. 12b the output (node F) is a composite data structure called the Multiscale Room System Performance Map 975 (FIG. 9g). This data structure is made up from two main data structures. The first part is the Room System Performance Map 948 (FIG. 9g), computed by the Compute Room System Performance Map 945 (FIG. 12a) and the second part is a collection of extracted feature maps derived from the Room System Performance Map 948 (FIG. 9g), these being called the Level 0 Room System Extracted Features Map 949 (FIG. 9g), the Level 1 Room System Extracted Features Map 950 (FIG. 9g) up to the Level N Room System Extracted Features Map 951 (FIG. 9g). These are computed using the Build Multiscale Room System Performance Map function 947 (FIG. 12a). The exact number of these extracted feature maps depends on the size of the Room System Performance Map 948 (FIG. 9g) on which it is based, and the specifics of the Down Sampling Convolution Filter 975a (FIG. 9h) used to create them, and on the minimum required resolution for the final Level N Room System Extracted Features Map 951 (FIG. 9g).

The details of these data structures are stored in the Historic Room Database 910 (FIG. 9a) via, in step Multiscale Room System Performance Map S1212, in step Room System Performance Map S1213, in step Level 0: Room System Extracted Features Map S1214, in step Level 1: Room System Extracted Features Map S1215 and in step Level N: Room System Extracted Features Map S1216 where they can be retrieved and used by various External Downstream Data Consumption Processes 911 (FIG. 9f) as illustrated in External Downstream Data Consumption Processes 911, Visualization-Room System Performance Map Feature Extraction map 1101, and Optimization—Microphone Placement map 1102 from FIG. 11a. All data in the Multiscale Room System Performance Map 975 (FIG. 9g) are defined on a common spatial and temporal coordinate frame 505 which is how External Downstream Data Consumption Processes 911 (FIG. 9f) can query and retrieve data from the Historic Room Database 910 (FIG. 9a).

More details on each of these structures are provided in node F3, FIG. 12c, for the Room System Performance Map 948 (FIG. 9g), and node F4.0, node F4.1 and node F4.N in FIG. 12d for the Level 0 Room System Extracted Features Map 949 (FIG. 9g), the Level 1 Room System Extracted Features Map 950 (FIG. 9g) and the Level N Room System Extracted Features Map 951, (FIG. 9g) respectively.

FIG. 12c continues to illustrate the details of the Multiscale Room System Performance Map 975 (FIG. 9g) by expanding on the structure and purpose of the Room System Performance Map 948 (FIG. 9g). As can be seen (node F3) the Room System Performance Map is one of the main elements of the Multiscale Room System Performance Map 975 (FIG. 9g). Its main purpose is to map the results of one or more Location Score Inference Engine 945 (FIG. 9e), as produced by the Room System Score Processor 907 (FIG. 9e), or obtained through the Historical Room Database 910 (FIG. 9a), as determined by the spatial and temporal extents defined in the Room and Measurements Configuration Data 904 (FIG. 9b). It does this using the following data structures: the Room System Performance Map Topology 952 (FIG. 9g), the Room System Performance Map Geometry 952 (FIG. 9g), the Room Performance Map Data Points 954 (FIG. 9g), the Room System Performance Map Cell Mapping 955 (FIG. 9g) and the Room System Performance Map Cell Data 956 (FIG. 9g).

The Room System Performance Map Topology 952 (FIG. 9g) represents the global spatial and temporal structure or cell map that will be used to model the data. It defines the underlying shape and connectivity of map cells used to model the spatial and temporal properties of the data being analyzed (see FIG. 11b). The output of Location Score Inference Engine 945 (FIG. 9e) from the Room System Score Processor 907 (FIG. 9e) or obtained through the Historical Room Database 910 (FIG. 9a) is an unstructured cloud of data points. These data points represent the spatial and temporal locations associated with each Location Score Inference Engine 945 (FIG. 9e). The Room System Performance Analytics Processor 909 (FIG. 9f) maps this cloud of points onto the topology defined by the Room System Performance Map Topology 952 (FIG. 9g).

The Room System Performance Map Geometry 953 (FIG. 9g) represents the instantiation (spatial and temporal) of the Room System Performance Map Topology 952 (FIG. 9g). It is defined as a collection of points (spatial and temporal) that describes the precise location, size, and shape of each of the map cells (see FIG. 11b) in the Room System Performance Map Topology 952 (FIG. 9g). Together the Room System Performance Map Topology 952 (FIG. 9g) and the Room System Performance Map Geometry 953 (FIG. 9g) provide the spatial and temporal basis for the Room System Performance Analytics Processor 909 (FIG. 9f) to analyze, visualize, and explore the data.

The Room Performance Map Data Points 954 (FIG. 9g) are the unstructured cloud of Location Score Inference Engine 945 (FIG. 9e) data points from the Room System Score Processor 907 (FIG. 9e) or obtained through the Historical Room Database 910 (FIG. 9a). This is the raw input data used by Room System Performance Analytics Processor 909 (FIG. 9f) in the production of the Room System Performance Map 948 (FIG. 9g). See FIG. 11b for a simple example.

The Room System Performance Map Cell Mapping 955 (FIG. 9g) indicates which map cell, in the Room Performance Map Data Points 954 (FIG. 9g), each of the Room Performance Map Data Points 954 (FIG. 9g) belongs too. As was seen in FIG. 11b, map cells may have no points, meaning no data points from the Room Performance Map Data Points 954 (FIG. 9g), falls within the bounds of the given cell, one point one data point falls within the bounds of the map cell, or multiple points, two or more data points falls within the bounds of the map cell.

The Room System Performance Map Cell Data 956 (FIG. 9g) represents an aggregation or summary of all the Room Performance Map Data Points 954 (FIG. 9g) for each map cell defined by the Room System Performance Map Topology 952 (FIG. 9g). As was shown in FIG. 11b, Room System Performance Map Cell Data 956 (FIG. 9g) no longer associates data with specific points in space or time but instead associates the underlying data with small, bounded volumes (the map cells) in space and time.

The details of these data structures are stored in the Historic Room Database 910 (FIG. 9a) via, in step Room System Performance Map S1213, in step Room System Performance Map Topology S1218, in step Room System Performance Map Geometry S1219, in step Room System Performance Map Data Points S1200, in step Room System Performance Map Cell Mapping S1107, in step Room System Performance Map Cell Data S1202 where they can be retrieved and used by various. As illustrated in External Downstream Data Consumption Processes 911 (FIG. 9f) as illustrated in External Downstream Data Consumption Processes 911, Visualization-Room System Performance Map Feature Extraction map 1101, and Optimization-Microphone Placement map 1102 from FIG. 11a. All data in Room System Performance Map 948 (FIG. 9g) is defined on a common spatial and temporal coordinate frame 505 which is how External Downstream Data Consumption Processes 911 (FIG. 9f) can query and retrieve data from the Historic Room Database 910 (FIG. 9a).

FIG. 12d continues to illustrate the details of the Multiscale Room System Performance Map 975 (FIG. 9g) by expanding on the structure and purpose of the Level 0 Room System Extracted Features Map 949 (FIG. 9g) and F4.0 (FIG. 12c) and each of the down sampled versions of it (e.g. the Level 1 Room System Extracted Feature Map 950 (FIG. 9g) and F4.1 (FIG. 12c) through to the Level N Room System Extracted Feature Map 951 (FIG. 9g) and F4.N (FIG. 12c).

The main purpose of each of these structures is to represent important features, extracted from the Room System Performance Map 948 (FIG. 9g) at various scales both spatially and temporally, which we refer to as Levels. The elements of each of these structures mirror that of the Room System Performance Map 948 (FIG. 9g). Each of the Levels contains map topology (like the Room System Performance Map Topology 952 (FIG. 9g)), map geometry (like the Room System Performance Map Geometry 952 (FIG. 9g)), map data (like the Room Performance Map Data Points 954 (FIG. 9g), map data to cell mapping (like the Room System Performance Map Cell Mapping 955 (FIG. 9g) and map cell data (like Room System Performance Map Cell Data 956 (FIG. 9g)).

There are N Levels within the Multiscale Room System Performance Map 975 (FIG. 9g). Of these the Level 0 Room System Extracted Features Map 949 (FIG. 9g) is the highest resolution version of the map, being directly computed from the Room System Performance Map 948 (FIG. 9g), using one or more Feature Extraction 974a (FIG. 9h) filters.

The topology, Level 0 Extracted Feature Map Topology 957 (FIG. 9g), the geometry, Level 0 Extracted Feature Map Geometry 958 (FIG. 9g), the data points, Level 0 Extracted Feature Map Data Points 959 (FIG. 9g), and the cell mapping, Level 0 Extracted Feature Map Cell Mapping, are all identical to the corresponding data in the Room System Performance Map 948 (FIG. 9g). The cell data, Level 0 Extracted Features Map Cell Data 961 (FIG. 9g) are different. The Level 0 Extracted Features Map Cell Data 961 (FIG. 9g) contains a data point that represents the output of each of the Feature Extraction 974a (FIG. 9h) filters applied to the underlying map cell.

The next Level, the Level 1 Room System Extracted Features Map 950 (FIG. 9g) is obtained by applying a Down Sampling Convolution Filter 975a (FIG. 9h) to the Level 0 Room System Extracted Features Map 949 (FIG. 9g). Level 1 Room System Extracted Features Map 950 (FIG. 9g) as a result will have different topology, geometry, cell mapping, and cell data from the Level 0 Room System Extracted Features Map 950 (FIG. 9g). The Level 1 Extracted Features Map Data Points 964 (FIG. 9g) remains unchanged as this data represents the raw input data from which the cell data is derived.

The Level 1 Extracted Features Map Topology 962 (FIG. 9g) will be different as we are representing the data on a higher scale map, that is the size of map cells and their relationship to neighboring cells will be different. There will be larger and fewer cells in the map overall.

The Level 1 Extracted Features Map Geometry 963 (FIG. 9g) will also be different due to the higher scale of the map. Map cells will be larger and represent a larger bounding spatial and temporal volume for each map cell.

The Level 1 Extracted Feature Map Cell Mapping 954 (FIG. 9g) will also be different. As each of the map cells are larger, they will contain more underlying Level 1 Extracted Features Map Data Points 964 (FIG. 9g).

The Level 1 Extracted Features Map Cell Data 961 (FIG. 9g) will also be different because the Level 1 Extracted Feature Map Cell Mapping 954 (FIG. 9g) will have changed—i.e. there are more points in each cell that need to be aggregated.

Subsequent levels in the Multiscale Room System Performance Map 975 (FIG. 9g) are defined by iteratively applying the Down Sampling Convolution Filter 975a (FIG. 9h) to the Level 1 Room System Extracted Features Map 949 (FIG. 9g). This process is repeated until a Level N Room System Extracted Features Map is produced that has a required minimum resolution. And again, the topology Level N Extracted Feature Map Topology 967 (FIG. 9g), the geometry Level N Extracted Feature Map Geometry 968 (FIG. 9g), the cell mapping Level N Extracted Feature Map Cell Mapping 970 (FIG. 9g), and the cell data Level N Extracted Features Map Cell Data 971 (FIG. 9g) are all down sampled, higher scale, versions of the previous Level.

The details of these data structures are stored in the Historical Room Database 910 (FIG. 9a). The Level 0 Room System Extracted Feature Map 949 (FIG. 9g) and all its component data are stored via in step Level 0: Room System Extracted Features Map S1214, in step Level 0 Extracted Features Map Topology S1203, in step Level 0 Extracted Features Map Geometry S1204, in step Level 0 Extracted Features Map Data Points S1205, in step Level 0 Extracted Features Map Cell Mapping S1206, and in step Level 0 Extracted Features Map Cell Dat S1207 a. The Level 1 Room System Extracted Feature Map 950 (FIG. 9g) via in step Level 1 Room System Extracted Features Map S1215, in step Level 1 Extracted Features Map Topology S1208, in step Level 1 Extracted Features Map Geometry S1209, in step Level 1 Extracted Features Map Data Points S1230, in step Level 1 Extracted Features Map Cell Mapping S1231, and in step Level 1 Extracted Features Map Cell Data S1232, and the final Level N Room System Feature Map 951 (FIG. 9g) via in step Level N Room System Extracted Features Map S1216, in step Level N Extracted Features Map Topology S1233, in step Level N Extracted Features Map Geometry S1234, in step S1235 Level N Extracted Features Map Data Points, in step S1236 Level N Extracted Features Map Cell Mapping, and in step S1237 Level N Extracted Features Map Cell Data. As illustrated in External Downstream Data Consumption Processes 911 (FIG. 9f) as illustrated in External Downstream Data Consumption Processes 911, Visualization-Room System Performance Map Feature Extraction map 1101, and Optimization-Microphone Placement map 1102 from FIG. 11a, External Downstream Data Consumption Processes 911 (FIG. 9f) can retrieve and use this data from the Historical Room Database 910 (FIG. 9a).

With reference to FIGS. 13a to 13d illustrated are processes involved with the Compute Room System Performance Map 946 (FIG. 9f) function in more detail. These diagrams explain how the Room System Performance Map 948 (FIG. 9g) is produced. FIG. 13a expands on the details of how Topology Parameterization 977 (FIG. 9h) and node F1.1 (FIG. 12a) is done. FIG. 13b expands on the details of how Cell Mapping 972 (FIG. 9h) and node F1.2 (FIG. 12a) is done. FIG. 13c expands on the details of how Cell Score Computation 973 (FIG. 9h) and node F.13 (FIG. 12a) is done. FIG. 13d provides a simple example of Cell Score Computation 973 (FIG. 9h).

FIG. 13a illustrates the logic involved in the Topology Parameterization F1.1 (FIG. 12a) process. The input to this process (node E) is a collection of Location Score Inference Engine 945 (FIG. 9e) outputs, obtained from the Room System Score Processor 907 (FIG. 9e) and the Historical Room Database 910 (FIG. 9a) as determined by the spatial and temporal extents defined in the Room and Measurement Configuration Data 904 (FIG. 9a).

With the Location Score Inference Engine 945 (FIG. 9e) outputs as the input the first step Determine Bounding Region for the Performance Map S1301 (space, time) is to determine the bounding region or volume, in space and time, that will form the basis for the final Room System Performance Map 948 (FIG. 9g) output. The extent of the bounding volume is defined directly in the Room and Measurement Configuration Data 904 (FIG. 9a) which is used to drive the overall Room System Performance Analytics Processor 909 (FIG. 9f). This information is used to initialize in step Room System Performance Map Topology S1306 the Room System Performance Map Topology 952 (FIG. 9g).

The next step, Determine X, Y, Z and T grid spacing S1302, we complete the initialization of the Room System Performance Map Topology 952 (FIG. 9g). Although the input Location Score Inference Engine 945 (FIG. 9e) is an unstructured cloud of data points, the Room System Performance Analytics Processor 909 (FIG. 9f) requires a defined structure to represent the data. It is the Room System Performance Map Topology 952 (FIG. 9g) that defines this structure. The structure is defined by determining the spatial X, Y, and Z and temporal T spacing to use for each of the map cells. This spatial and temporal spacing information is obtained from the Room and Measurement Configuration Data 904 (FIG. 9a).

For a regular, rectilinear grid, with uniform spacing in each of the dimensions, the grid spacing is represented using a single scalar value for each dimension. For less regular grids, with varying map cell sizes, there is varying spacing between each map cell in each dimension, and therefore the grid spacing is provided by an array of grid spacing for each of the spatial and temporal axes.

The output of the first two steps (Determine Bounding Region for the Performance Map (space, time) S1301 and Determine X, Y, Z and T grid spacing S1302) is the completed Room System Performance Map Topology 952 (FIG. 9g).

The next step Compute Coordinates (x,y,z,t) S1303 defining the Room System Performance Map Geometry we use the created Room System Performance Map Topology 952 (FIG. 9g) and create the Room System Performance Map Geometry 953 (FIG. 9g). Whereas the Room System Performance Map Topology 952 (FIG. 9g) represents the global spatial and temporal structure or cell map that will be used to model the data, the Room System Performance Map Geometry 953 (FIG. 9g) represents the local instantiation of this topology with specific spatial and temporal coordinates. in step Compute Coordinates (x,y,z,t) S1303 defining the Room System Performance Map Geometry therefore computes the spatial (x, y, z) and temporal (t) coordinates that will represent the location, size, and shape of each of the cells that will make up the Room System Performance Map 948 (FIG. 9g).

The origin of the Room System Performance Map Geometry is a point in space and time that defines a fixed point from which all other coordinate points are defined relative to. This origin is provided by the Room and Measurement Configuration Data 904 (FIG. 9a). The location, size and shape of each cell defined in the Room System Performance Map Topology 952 (FIG. 9g) is then computed using the origin and the grid spacing defined for each of the spatial (X, Y, Z) and temporal (T) dimensions.

It should be noted that the system can be extended to use fewer regular grids. In this case the coordinates that define the Room System Performance Map Geometry 953 (FIG. 9g) would be obtained directly from the Room and Measurement Configuration Data. For each map cell, defined by the Room System Performance Map Topology 952 (FIG. 9g) there would be a polygonal mesh that defines the specific location, size, and shape of it.

The output of step Compute Coordinates (x,y,z,t) S1303 defining the Room System Performance Map Geometry is used in step Room System Performance Map Geometry S1307 to create the Room System Performance Map Geometry 953 (FIG. 9g) which is added to the developing Room System Performance Map 948 (FIG. 9g) as the basis of the Multiscale Room System Performance Map 975 (FIG. 9g) illustrated by (node F) in FIG. 12b.

In many cases the Room System Performance Analytics Processor 909 (FIG. 9f), is used only with output from the Room System Score Performance Processor 901 (FIG. 9a). This represents a use case where we are analyzing results obtained in real time for a given room, conference system, and use case. The Room System Performance Analytics Processor 909 (FIG. 9f) can also be used in an off-line mode, where rather than obtaining data from the Room System Score Performance Processor 901 (FIG. 9a), we obtain previous results from the Historical Room Database 910 (FIG. 9a). The Room System Performance Analytics Processor 909 (FIG. 9f) can also operate using both real time and off-line data. In this case real time results are obtained from the Room System Score Performance Processor 901 (FIG. 9a) and these are combined with additional results from the Historical Room Database 910 (FIG. 9a). It should be noted in this case that data can include additional data from other rooms 101, beyond the room that the Room System Score Performance Processor 901 (FIG. 9a) is operating in.

Regardless of the mode of operation, the data that the Room System Performance Analytics Processor 909 (FIG. 9f) will use is defined by the Room and Measurement Configuration Data 904 (FIG. 9b) through defining the spatial and temporal extents of the data to use. If the temporal extents define periods of time in the past, then Get Historic Room System Score Map Data Points S1304 is used to retrieve the Location Score Inference Engine 945 (FIG. 9e) corresponding to this time and spatial extent from the Historical Room Database 910 (FIG. 9a).

In the next step Create Room System Score Map Data Points (Historic+Room System Score Data Points) S1305 the Location Score Inference Engine 945 (FIG. 9e) output from the Room System Score Performance Processor 901 (FIG. 9a) are merged with the Location Score Inference Engine 945 (FIG. 9e) results from the Historical Room Database 910 (FIG. 9a) to create the complete set of data points that the Room System Performance Analytics Processor 909 (FIG. 9f) will use. This data is used in step Room System Performance Map Data Points S1308 to create the Room System Performance Map Data Points 954 (FIG. 9g) and added to the Room System Performance Map 948 (FIG. 9g) as the basis of the Multiscale Room System Performance Map 975 (FIG. 9g) illustrated by node F in FIG. 12b.

All this data is then used node F1.2 (FIG. 13b) to determine which map cell defined in the Room System Performance Map Topology 952 (FIG. 9g) each of the data points in the System Performance Map Data Points 954 (FIG. 9g) belong to.

FIG. 13b illustrates the logic involved in the Cell Mapping Process node F1.2 (FIG. 12a). The goal of this process is to build the Room System Performance Map Cell Mapping 955 (FIG. 9g) from the Room System Performance Map Data Points 954 (FIG. 9g) determined in node F1.1 (FIG. 12a).

The inputs, from node F1.1 (FIG. 13a), to this process is the Room System Performance Map Topology 952 (FIG. 9g), defining the properties and relationship between map cells, the Room System Performance Map Geometry 953 (FIG. 9g), specifying the geometry (spatial and temporal) for the map cells, and the Room System Performance Map Data Points 954 (FIG. 9g), being the location 502 (spatial and temporal) at which results are defined.

The first step in the process in step Initialize Cell Mapping to empty S1310 (all cells contain no Room System Performance Map Data Points creates an initial cell mapping structured, indicating that all map cells in the Room System Performance Map Topology 952 (FIG. 9g) contain no data—i.e. no Room System Performance Map Data Points 954 (FIG. 9g).

We then enter a loop that will process every point in the Room System Performance Map Data Points 954 (FIG. 9g). Step Get Next Data Point S1311 starts by getting the next unprocessed point and in step Are there Room System Performance Data Points S1312 yet to be processed determines if we have processed all points yet or not. If in step Are there Room System Performance Data Points S1312 yet to be processed determines that all points are processed, then the Room System Performance Map Cell Mapping 955 (FIG. 9g) data structure is complete and we proceed to scoring, or computing cell level data for all the Room System Performance Map Data Points 954 (FIG. 9g) in each cell node F1.3 (FIG. 13c).

If there are Room System Performance Map Data Points 954 (FIG. 9g) that remain to be mapped to cells then in step S1313 Determine Room System Performance Map Cell that contains this Data point (x,y,z,t) determines which cell, in the Room System Performance Map Topology 952 (FIG. 9g) that the data point is contained within. We determine which cell a Room System Performance Map Data Point 954 (FIG. 9g) belongs to by determining if the spatial and temporal coordinates of the data point are contained within the Performance Map Data Geometry 953 (FIG. 9g) for the given cell. Note if the Room System Performance Map Data Point 954 (FIG. 9g) is not contained within any map cell, then it can be discarded. This may also be flagged as an error because we have data points that are outside the extent defined by the Room and Measurement Configuration Data 904 (FIG. 9b).

In the next step Update Cell Mapping S1314—Add the Data Point to the Room System Performance Map Cell the Room System Performance Map Data Point 954 (FIG. 9g) is added to the list of data points for the map cell that contains it. In step Room System Performance Map Cell Mapping S1316 this data is used to create or update the Room System Performance Map Cell Mapping 955 (FIG. 9g) and added to the Room System Performance Map 948 (FIG. 9g) as the as the basis of the Multiscale Room System Performance Map 975 (FIG. 9g) illustrated by F in FIG. 12b. The loop then repeats, where we get the next Room System Performance Map Data Point 954 (FIG. 9g) and determine which map cell it belongs to.

The output of this process will be the addition of the Room System Performance Map Cell Mapping 955 (FIG. 9g) to the Room System Performance Map 952 (FIG. 9g) defining which Room System Performance Map Data Points 954 (FIG. 9g) belong to which cell in the Room System Performance Map Topology 952 (FIG. 9g). This data is used in F1.3 to compute cell level data, as an aggregation of the Room System Performance Map Data Points 954 (FIG. 9g) that are contained within each cell.

FIG. 13c illustrates the logic involved in the Cell Score Computation F1.3 (FIG. 12a) which is the final stage involved in creating the Room System Performance Map 948 (FIG. 9g). The objective of this stage is to create the Room System Performance Map Cell Data 956 (FIG. 9g) which is a summary or an aggregate of the Room System Performance Map Data Points 954 (FIG. 9g) that belong to each map cell in the Room System Performance Map Topology 952 (FIG. 9g) and the Room System Performance Map Geometry 953 (FIG. 9g) all determined in F1.1 (FIG. 12a) and F1.2 (FIG. 12b). The Room System Performance Map Cell Data 956 (FIG. 9g) therefore no longer represents individual Location Score Inference Engine 945 (FIG. 9e) on a point in space and time basis but instead to the bounded space and time volume defined by Room System Performance Map Geometry 953 (FIG. 9g) for each cell in the Room System Performance Map Topology 952 (FIG. 9g).

The first step in the process Initialize Room System Performance Map Cell Scores S1317 initializes the room system performance map cell scores for every map cell defined in the Room System Performance Map Topology 952 (FIG. 9g) by setting them to a default value of undefined or not available.

The next step Get Next Room System Performance Map Cell S1318 is the start of a loop where we iterate over every map cell in the Room System Performance Map Cell Mapping 955 (FIG. 9g) to aggregate the Room System Performance Map Data Points 954 (FIG. 9g) that are contained in each cell. The loop is started by attempting to get the next map cell that has not yet been scored.

Step Have we Processed all Map Cells S1319 determines if all map cells in the Room System Performance Map Cell Mapping 955 (FIG. 9g) have been processed or not. If they have all been processed, then the Cell Scoring Computation 973 (FIG. 9h) is finished and the Room System Performance Map Cell Data 956 (FIG. 9g) is complete, and we proceed to the next stage where we begin to compute the multiscale versions of the Room System Performance Map 948 (FIG. 9g) as shown in F2 (FIG. 12a).

If there are map cells in the Room System Performance Map Cell Mapping 955 (FIG. 9g) that remain to be scored in step Get Next Room System Performance Map Cell S1318 will have provided an index for the next map cell which is used to find all the Room System Performance Map Data Points 954 (FIG. 9g) the map cell contains from the Room System Performance Map Cell Mapping 955 (FIG. 9g). Next step Apply Cell Scoring Function to Map Cell S1320 applies a cell scoring function to this collection of Room System Performance Map Data Points 954 (FIG. 9g) generating a map cell level summary or aggregation of the data points it contains.

Note that although there is only one Room System Performance Map Cell Data 956 (FIG. 9g) data point per map cell in the Room System Performance Map Topology 925 (FIG. 9g), this data point can contain multiple variables. That is, we can apply multiple cell scoring functions when generating the Room System Performance Map Cell Data 956 (FIG. 9g). See FIG. 13d for a simple example.

In the next step S1322 Room System Performance Map Cell Data the score computed for the map cell is added to the Room System Performance Map Cell Data 956 (FIG. 9g) and added to the Room System Performance Map 948 (FIG. 9g) which forms the basis for the Multiscale Room System Performance Map 975 (FIG. 9g) illustrated by node F in FIG. 12b.

At this point the loop starts again, and we continue to get the next map cell from the Room System Performance Map Cell Mapping 955 (FIG. 9g) until all map cells have been processed.

The output of this process is the addition of the Room System Performance Map Cell Data 956 (FIG. 9g) to the Room System Performance Map 952 (FIG. 9g) defining map cell level data, as a summary or other aggregate of all the Room System Performance Map Data Points 954 (FIG. 9g) contained in each map cell. This completes the construction of the Room System Performance Map 948 (FIG. 9g) as the first element of the Multiscale Room System Performance Map 975 (FIG. 9g). The Room System Performance Map 948 (FIG. 9g) is used in F2 (FIG. 12a) where we complete the construction of the Multiscale Room System Performance Map 975 (FIG. 9g). The first step of this process is illustrated in F2.1 (FIG. 13e).

FIG. 13d illustrates an example of two cell scoring functions and how they can be used in the production of one Room System Performance Map 948 (FIG. 9g). The example uses two functions, but any number of functions could also be used. In one example we use an averaging function to compute the average values of all the Room System Performance Map Data Points 954 (FIG. 9g) in each map cell and in the other example we simply return the maximum value.

The Cell Scoring 973 (FIG. 9h) operates exactly as is described in FIG. 13c, with the exception that two threads of data are processed, one associated with determining the average values, and one associated with determining the max values.

The first step in each is the initialization of the cell scores (in step Initialize Room System Performance Map Cell Scores S1317a and in step Initialize Room System Performance Map Cell Scores S1317b). Then each thread attempts to get the next map cell (in step Get Next Room System Performance Map Cell S1318a, in step Get Next Room System Performance Map Cell S1318b) from the Room System Performance Map Cell Mapping 955 (FIG. 9g). Both then check to see if there are map cells yet to be processed (in step Have we Processed all Map Cells S1319a and in step Have we Processed all Map Cells S1319b) and if there are both threads apply their respective cell scoring function (in step Compute Average of Map Data Points S1320a in this Cell and in step Compute Max of Map Data Points S1320b in this Cell).

In the example in step Compute Average of Map Data Points S1320a in this Cell computes the average value of all the Room System Performance Map Data Points 954 (FIG. 9g) for the current map cell and in step Compute Max of Map Data Points S1320b in this Cell computes the max value of them.

The value computed by in step Compute Average of Map Data Point S1320a in this Cell, and the value computed by in step Compute Max of Map Data Points S1320b in this Cell, are then added to the Room System Performance Map Cell Data 956 (FIG. 9g) for the current cell in step Room System Performance Map Cell Data S1322a. The net result of this process is that each map cell will now have System Performance Map Cell Data 956 (FIG. 9g) that is made up of two values, one being the average (in step Compute Average of Map Data Points S1320a in this Cell) and the other being the max values (in step Compute Max of Map Data Points S1320b in this Cell).

With reference to FIGS. 13e, 13f, 13g, and 13h illustrate the processes involved with the Build Multiscale Room System Performance Map 947 (FIG. 9f) function in more detail. These diagrams explain how the final Multiscale Room System Performance Map 975 (FIG. 9g) is produced. FIGS. 13e and 13f expands on the details of how Feature Extraction 974a (FIG. 9h) and F2.1 (FIG. 12a) is used to create the Level 0 Room System Extracted Features Map 949 (FIG. 9g). FIGS. 13g and 13h expands on the details of how Down Sampling Convolution 975a (FIG. 9h) and F2.2 (FIG. 1a) is then used to create several different scale versions of the Level 0 Room System Features Map 949 (FIG. 9g).

FIG. 13e illustrates the logic involved in the process of Feature Extraction F2.1 (FIG. 12a). The input to this process is the Room System Performance Map 948 (FIG. 9g) and the Room and Measurement Configuration Data 904 (FIG. 9a). Room System Performance Map 948 (FIG. 9g) is computed by the Compute Room System Performance Map 946 (FIG. 9g) and shown previously in FIGS. 13a to 13d. The Room and Measurement Configuration Data 904 (FIG. 9a) contains data that determines the type and configuration of one or more Feature Extraction 974a (FIG. 9g) filters that will be used.

The output of the Feature Extraction F2.1 (FIG. 12a) process is the Level 0 Extracted Features Map 949 (FIG. 9g). As shown in FIG. 12d, the structure of the Level 0 Extracted Features Map 949 (FIG. 9g) is identical to the Room System Performance Map 948 (FIG. 9g), in that it contains a definition of the map topology (Level 0 Extracted Feature Map Topology 957 (FIG. 9g)), geometry (Level 0 Extracted Features Map Geometry 958 (FIG. 9g)), data points (Level 0 Extracted Features Map Data Points 959 (FIG. 9g)), cell mapping (Level 0 Extracted Features Map Cell Mapping 960 (FIG. 9g)) and map cell level data (Level 0 Extracted Features Map Cell Data 961 (FIG. 9g)). Of this set of data all of it is identical to the corresponding data in the Room System Performance Map 948 (FIG. 9g) except for the Level 0 Extracted Features Map Cell Data 961 (FIG. 9g). The Level 0 Extracted Features Map Cell Data 961 (FIG. 9g) is different because this is where the output of the Feature Extraction 974a (FIG. 9g) filters are stored.

The first step in the process in step Extracted Feature Map S1323 Initialize initializes the Level 0 Extracted Feature Map Cell Data 961 (FIG. 9g) by assigning the data for each map cell to an initial a value.

As there can be multiple Feature Extraction 974a (FIG. 9h) filters applied (the number and type being defined in the Room and Measurement Configuration Data 904 (FIG. 9a) the next step in the process, in step Get Next Feature Extraction Filter S1324, is to get the type and configuration of the Feature Extraction 974a (FIG. 9h) filter.

In step Have we applied all Feature Extraction Filters S1325, we now simply check to determine if all Feature Extraction 974a (FIG. 9h) filters have been applied. If they have all been applied, then the Level 0 Room System Extracted Features Map 949 (FIG. 9g) is complete. The Feature Extraction F2.1 (FIG. 12a) exits, and we proceed to the Down Sampling Convolution F2.2 (FIG. 12a) function where the Level 0 Room System Extracted Features Map 949 (FIG. 9g) is down sampled several times to create different scaled representations of it.

If there are Feature Extraction 974a (FIG. 9h) filters yet to be applied, then they are applied to the map cells in step Apply Extraction Filter to Room System Extracted Features Map S1326 in the Level 0 Extracted Features Map Cell Mapping 960 (FIG. 9g) and the results are stored in step Level 0 Extracted Features Map Cell Data S1327 in the Level 0 Extracted Feature Map Cell Data 961 (FIG. 9g). The process of applying Feature Extraction 974a (FIG. 9h) filters is illustrated in F2.1.1 (FIG. 13f).

The result of the Feature Extraction F2.1 (FIG. 12a) process is a collection of data points in the Level 0 Extracted Feature Map Cell Data 961 (FIG. 9g), where there is one data point for each map cell in the Level 0 Extracted Feature Map Topology 957 (FIG. 9g), and where that data point has one value for each of the Feature Extraction 974a (FIG. 9h) filters, defined in the Room and Measurement Configuration Data 904 (FIG. 9a) and applied to the Level 0 Room Systems Extracted Features Map 949 (FIG. 9g).

The output of step Level 0 Extracted Features Map Cell Data S1327 Level 0 Extracted Features Map Cell Data is added to the Level 0 Room System Extracted Features Map 949 (FIG. 9g), where it becomes the highest resolution version of the Room System Performance Map 948 (FIG. 9g) in the Multiscale Room System Performance Map 975 (FIG. 9g) and F (FIG. 12b).

FIG. 13f, illustrates the steps involved in applying a Feature Extraction 974a (FIG. 9h) filter to the Level 0 Room System Extracted Features Map 949 (FIG. 9g). The Level 0 Room System Extracted Features Map 949 (FIG. 9g) is created and initialized as shown in FIG. 13e (steps Initialize Extracted Feature Map S1323, Get Next Feature Extraction Filter S1324, and Have we applied all Feature Extraction Filters S1325) from the input Room System Performance Map 948 (FIG. 9g) created from the Compute Room System Performance Map 946 (FIG. 12a).

The output from applying a Feature Extraction 974a (FIG. 9h) filer to the Level 0 Room System Extracted Features Map 949 (FIG. 9g) is the Level 0 Extracted Features Map Cell Data 961 (FIG. 9g) where the output of the Feature Extraction 974a (FIG. 9h) are stored for each map cell in the Level 0 Extracted Features Topology 957 (FIG. 9g) it is applied to.

The first step, Initialize Level 0 Room System Extracted Features Map Cell Data S1328, is to initialize the feature extraction map cell data for the Feature Extraction 974a (FIG. 9h) filter. This means that for each cell in the Level 0 Extracted Feature Map Topology 957 (FIG. 9g) we associate an undefined or null value with it, simply indicating that the Feature Extraction 974a (FIG. 9h) filter has not yet been applied to that cell.

The next step, Initialize Feature Extractor S1329, is where the specific Feature Extraction 974a (FIG. 9h) filter is created and initialized. The type of Feature Extraction 974a (FIG. 9h) filter to use and how it should be configured is defined in the Room and Measurement Configuration Data 904 (FIG. 9b). Part of this initialization will be specifying the size of the filter in both spatial and temporal dimensions, governing how much (i.e. how many map cells) of the underlying Level 0 Extracted Features Topology 957 (FIG. 9g) will be processed with each filter execution.

As the Feature Extraction 974 (FIG. 9h) filter needs to be applied to all map cell locations, and the filter can be bigger than any one cell (as defined by the Level 0 Extracted Feature Geometry 958 (FIG. 9g) part of the initialization process will involve padding the boundary of the Room System Performance Map 948 (FIG. 9g) with enough map cells, and map cell data so that the configured Feature Extraction 974a (FIG. 9h) filter can be correctly applied along the edges of the map. This process is also illustrated in FIG. 11c. Note the reason we “pad” 1103 the Room System Performance Map 948 (FIG. 9g), and not the Level 0 Room System Extracted Features Map 949 (FIG. 9g) is because the Feature Extraction 974a (FIG. 9h) filter is applied to the Room System Performance Map Cell Data 956 (FIG. 9g) to compute the values for the Level 0 Extracted Features Map Cell Data 961 (FIG. 9g).

Now that the Feature Extraction 947a (FIG. 9h) filter has been created, and initialized, we begin to iterate over all the map cells in the Level 0 Extracted Features Map Topology 957 (FIG. 9g). This loop is started in step Get Next Map Cell S1330 where we get the next map cell to process from the Level 0 Extract Features Map Topology 957 (FIG. 9g). Step Apply Feature Extractor to Extracted Local Region S1336 returns a reference for the next map cell from the Level 0 Extracted Features Map Topology 957 (FIG. 9g). This is used later to determine the spatial and temporal extent of the cell in step Level 0 Extracted Features Map Geometry S1333 from the Level 0 Extracted Features Map Geometry 958 (FIG. 9g).

In step Have we Processed all Map Cells S1331 we determine if there are map cells that yet need to be processed. If there are none, for example when in step Get Next Map Cell Get Next Map Cell S1330 indicates there are no “next” map cells to process, then the application of the Feature Extraction 974a (FIG. 9h) filter to the Room System Performance Map Cell Data 956 (FIG. 9g) to compute the Level 0 Extracted Features Map Cell Data 961 (FIG. 9g) is complete.

At this stage the output of the Feature Extraction 974a (FIG. 9h) filter for each map cell in the Level 0 Feature Map Topology 957 (FIG. 9g) will be stored in the Level 0 Feature Map Cell Data 961 (FIG. 9g). The application of the Feature Extraction 974a (FIG. 9h) filter exits and we return to F2.1.2 (FIG. 13e) where the Level 0 Extracted Features Map Cell Data 961 (FIG. 9g) is added to the Level 0 Room System Extracted Features Map 949 (FIG. 9g) and the process of repeats be determining if there are more Feature Extraction 974a (FIG. 9h) filters that should be applied (in step Get Next Feature Extraction Filter S1324, FIG. 13e).

In FIG. 13f, if in step Have we Processed all Map Cells S1331 indicates that there are more map cells to process then we continue with the feature extraction process. Step Get Next Map Cell S1330 will have returned a reference to a map cell from the Level 0 Extracted Feature Map Topology 957 (FIG. 9g) that is processed next. From this map cell reference we can determine in step Level 0 Extracted Features Map Geometry S1333 the spatial and temporal location of the map cell from the Level 0 Extracted Features Map Geometry 958 (FIG. 9g). The spatial and temporal location of the map cell is then used to move the Feature Extraction 974a (FIG. 9h) to this point in space and time, so that it can be applied to the data in this region in step Move Feature Extractor Location S1332 to Cell Location (x,y,z,t).

The next steps Extract Local Region at (x,y,z,t) S1334 extracts map cell data in the locality of the Feature Extraction 974a (FIG. 9h) filter. As the feature extraction filter is detecting features in the Room System Performance Map 948 (FIG. 9g), the data used here is extracted from the Room System Performance Map Cell Data 956 (FIG. 9g). The precise number of Room System Performance Map Cell Data 956 (FIG. 9g) data points retrieved will be dependent on the spatial and temporal size of the Feature Extraction 974a (FIG. 9h) filter.

Once the data for the local region has been retrieved from the Room System Performance Map Cell Data 956 (FIG. 9g). the Feature Extraction Filter 974a (FIG. 9h) can be applied in step Apply Feature Extractor to Extracted Local Region S1336 to them. Examples of Feature Extraction 974a (FIG. 9h) filters than could be used are shown in Example Extraction Filters 1301 and include but are not limited to, smoothing filters, edge detectors, adaptive filters, statistical filters, shape detectors and so on.

The application of the Feature Extraction 974a (FIG. 9h) filter produces a value that represents the filters response to the underlying Room System Performance Map Cell Data 956 (FIG. 9g). This value is used to update in step Level 0 Extracted Features Map Cell Data S1337 the Level 0 Extracted Feature Cell Data 961 (FIG. 9g). Updating the Level 0 Extracted Feature Map Cell Data 961 (FIG. 9g), means that a value for the current Feature Extraction 974a (FIG. 9h) filter is added to the data point in step Initialize Level 0 Room System Extracted Features Map Cell Data S1338 for the current map cell.

At this point the loop starts again, and we continue to get the next map cell from the Level 0 Room System Performance Map Topology 957 (FIG. 9g) and repeat the process of moving and applying the Feature Extraction 974a (FIG. 9h) filter until all map cells have been processed. When all map cells have been processed in step Have we Processed all Map Cells S1331 we return to F2.1.2 (FIG. 13e) with an updated Level 0 Extracted Features Map Cell Data 961 (FIG. 9g) and continue the processing loop by determining if there are more feature extraction filters than should be applied—in step Get Next Feature Extraction Filter S1324 in FIG. 13e.

FIG. 13g illustrates the logic involved in the process of applying a Down Sampling Convolutional Filter 975a (FIG. 9h), to the Level 0 Room System Extracted Features Map 949 (FIG. 9g) in the process of creating multiple scaled versions of it in the production of the Multiscale Room System Performance Map 975 (FIG. 9g).

As can be seen by F2.2 (FIG. 12a), the input to the process of applying Down Sampling Convolutional Filter 975a (FIG. 9h) is the output from the Feature Extraction F2.2 (FIG. 12a) process. The output of the Feature Extraction F2.2 (FIG. 12a) process is the Multiscale Room System Performance Map 975 (FIG. 9g), details also in node F (FIG. 12b), which contains the Level 0 Room System Extracted Features Map 949 (FIG. 9g) and F4.0 (FIG. 12d). It is the highest resolution version of spatial and temporal features extracted from the Room System Performance Map 948 (FIG. 9g).

As is shown in FIG. 13g the process of applying Down Sampling Convolutional Filters F2.2 (FIG. 12a) is an iterative process that generates several reduced resolution versions (other Levels) of the Level 0 Room System Extracted Features Map 949 (FIG. 9g) from the Level 1 Room System Extracted Features Map 950 (FIG. 9g) to the Level N Room System Extracted Features Map 951 (FIG. 9g). The number of other Levels created depends on the original spatial and temporal resolution of the Level 0 Room System Extracted Features Map 950 (FIG. 9g), the properties of the Down Sampling Convolutional Filter 975a (FIG. 9h) used, and the minimum resolution required as defined in the Room and Measurement Configuration Data 904 (FIG. 9b).

The first steps, S1339 Get Level 0 Room System Extracted Features Map and in step S1340 Multiscale Room System Performance Map, involves retrieving the Level 0 Room System Extracted Features Map 949 (FIG. 9g) from the input Multiscale Room System Performance Map (FIG. 9g).

In the next step, Initialize Level Number: N=0 S1341, we initialize the Level Number to the number of the Level we are currently processing. As the process has just started with the Level 0 Room System Extracted Features Map 949 (FIG. 9g) Level Number is set to zero.

In step Current Level Resolution>Min Resolution S1342 we now check to see if the resolution of the current Level, identified by the Level Number is still greater than the minimum resolution we want in the Multiscale Room System Performance Map 975 (FIG. 9g). This minimum resolution is defined in the Room and Measurement Configuration Data 904 (FIG. 9b.) If the resolution of the current Level is smaller than or equal to the minimum required resolution, then the creation of the required multiscale versions of the Level 0 Room System Extracted Features Map 949 (FIG. 9g) is complete. This also means that a complete Multiscale Room System Performance Map 975 (FIG. 9g) is also complete and the data it contains, shown as node F (FIG. 12b), node F3 (FIG. 12c) and nodes F4.0, F4.1, F4.N (FIG. 12d) is now ready for External Downstream Data Consumption Processes 911 (FIG. 9f), for example 911 (FIG. 11a).

If the Current Level resolution is larger than the minimum resolution, we want in the Multiscale Room System Performance Map 975 (FIG. 9g) then we continue with the process of down sampling it to create a reduced resolution version.

The next step, Increment Level Number: N=N+1 S1344, involves increasing the current Level Number. This indicates the new Level that we will be generating. When we start the Level Number will be zero, indicating that we are starting with the Level 0 Room System Extracted Features Map 949 (FIG. 9g). In step Increment Level Number: N=N+1 S1344 increments the Level Number, indicating that in the first iteration of the down sampling process the next level we are creating will be the Level 1 Room System Extracted Features Map 950 (FIG. 9g).

The next step, Apply Convolution Down sample Filter to Current Level S1345, is where the Down Sampling Convolutional Filter 975a (FIG. 9h) is applied to the Current Level to produce the new level indicated by the Level Number. The details of this process are illustrated in detail in FIG. 13h.

The output of the Down Sampling Convolutional Filter 975a (FIG. 9h), see node F2.2.2 (FIG. 13h) is a reduced resolution version of the Current Level. Step Level N Room System Extracted Features Map S1346 next updates the Current Level to be this output. For example, if the Level Number is 1, then it produces the Level 1 Room System Extracted Features Map 950 (FIG. 9g) which becomes the new Current Level and it the Level Number is N, then it produces the Level N Room System Extracted Feature Map 951 (FIG. 9g) which would become the new Current Level. The new Level is finally added in step Add Down sampled Map to Multiscale Room System Performance Map S1347 to the Multiscale Room System Performance Map 975 (FIG. 9g) and we repeat the process going back to step Current Level Resolution>Min Resolution S1342 with the new Current Level.

FIG. 13h illustrates the steps involved in applying a Down Sampling Convolutional Filter 975a (FIG. 9h) to a higher resolution Level (for example the Level 0 Room System Extracted Features Map 949 (FIG. 9g) to produce a lower resolution Level of it (that is the Level 1 Room System Extracted Features Map 949 (FIG. 9g) in this example).

The input to the process is the Level Number (N) for the new Level that we are generating; for example, N would be one if the purpose is to generate the Level 1 Room System Extracted Features Map 950 (FIG. 9g). The process also has access to the Multiscale Room System Performance Map 975 (FIG. 9g) so that it can create, retrieve and update various Levels within it.

The output of the process is the newly created Level N extracted Features Map, for example the Level 1 Room System Extracted Features Map 949 (FIG. 9g), when N equals 1. This is added to the Multiscale Room System Performance Map 975 (FIG. 9g). When all Levels in the Multiscale Room System Performance Map 975 (FIG. 9g) have been generated, as illustrated in FIG. 13g, then a complete Multiscale Room System Performance Map 975 (FIG. 9g) has been created and the data it contains (node F (FIG. 12b), node F3 (FIG. 12c) and nodes F4.0, F4.1, F4.N (FIG. 12d)) are now ready for External Downstream Data Consumption Processes 911 (FIG. 9f), for example 911 (FIG. 11a).

For illustrative purposes, we will describe the logic flow of the Down Sampling Convolutional Filter 975a (FIG. 9h) process using a specific example. The example will be the generation of a Level 1 Room System Extracted Features Map 950 (FIG. 9g) from an already available Level 0 Room System Extracted Features Map 949 (FIG. 9g).

The overall process is iterative, and once the Level 1 Room System Extracted Feature Map 950 (FIG. 9g) is generated, this will become the new input to the Down Sampling Convolutional Filter process to generate the next lower resolution version of the data. The process repeats until a Level N Room System Extracted Feature Map 951 (FIG. 9g) is generated that meets defined minimum resolution requirements.

The first step in the process, in step Initialize Down sampling Convolution Filter Location (x,y,z,t) S1348, creates and initializes the Down Sampling Convolution Filter 975a (FIG. 9h) that will be used. There are several types of convolution filter that can be used (see Example Convolutional Filters 1302 for some common examples) each with their own configuration parameters which are initialized here. The selection of the specific Down Sampling Convolution Filter 975a (FIG. 9h) to use and how it should be configured is defined in the Room and Measurement Configuration Data 904 (FIG. 9b). One important parameter, common to all filters, is the size of the filter in both the spatial and temporal dimensions. This determines the bounding volume of the filter and therefore how many map cells will be analyzed when producing the down sampled representation of the data.

The next step, Initialize Level N Room System Extracted Feature Map S1349, creates and initializes the new Level N extracted features map. For example, if N equals 1, then this will create and initialize a new Level 1 Room System Extracted Features Map 950 (FIG. 9g). This step creates and initializes all the elements of this data structure. This includes the Level 1 Extracted Features Map Topology 962 (FIG. 9h), the Level 1 Extracted Features Map Geometry 963 (FIG. 9g), the Level 1 Extracted Features Map Data Points 964 (FIG. 9g), the Level 1 Extracted Features Map Cell Mapping 965 (FIG. 9g) and the Level 1 Extracted Features Map Cell Data 966 (FIG. 9g). All these components are derived from their counterparts in the Level 0 Room System Extracted Features Map 949 (FIG. 9g).

The overall process of applying a Down Sampling Convolution Filter 975a (FIG. 9h) is illustrated in FIG. 11d, which shows that the details of the Level 1 Room System Extracted Features Map 950 (FIG. 9g) are dependent on the specific properties of the Down Sampling Convolution Filter 975a (FIG. 9h). Of these the most important are the size and stride length of the filter in the spatial and temporal dimensions. The size of the filter indicates how many of the underlying map cells are used in the down sampling process. The stride length indicates how far along in each of the spatial and temporal dimensions the Down Sampling Convolution Filter 975a (FIG. 9h) will be moved each time it is applied. Therefore, the stride length indicates how much of reduction in resolution will be created by the Down Sampling Convolution Filter 975a (FIG. 9h). There is a critical relationship between the filter size and stride length. The filter size must be equal to or greater than the stride length. If not, then spatial and temporal holes will appear in the data produced by it.

Again, using a Level Number of 1 for illustration, in step Initialize Level N Room System Extracted Feature Map S1349 creates the Level 1 Extracted Features Map Topology 962 (FIG. 9g), from the underlying Level 0 Extracted Features Map Topology 957 (FIG. 9g). This involves the merging of neighboring cells in the underlying Level 0 Extracted Features Map Topology 957 (FIG. 9g) to create the corresponding cells in the Level 1 Extracted Features Map Topology 962 (FIG. 9g). The number of map cells merged will be determined by the filter size. The precise map cells merged will depend on the location (spatial and temporal) at which the Down Sampling Convolution Filter 975a (FIG. 9h) is applied. See FIG. 11d for an illustration. Note that the grid spacing in the Level 1 Extracted Features Map Topology 962 (FIG. 9g) will also be adjusted accordingly. As Level 1 Room System Extracted Features Map 950 (FIG. 9g) is a lower resolution version of the Level 0 Room System Extracted Features Map 949 (FIG. 9g) the grid spacing will be larger in each dimension. The change in grid spacing is determined by the stride length; again see FIG. 11d for an example.

Step Initialize Level N Room System Extracted Feature Map S1349 creates the Level 1 Extracted Features Map Geometry 963 (FIG. 9g) from the underlying Level 0 Extracted Features Map Geometry 958 (FIG. 9g). The new Level 1 Extracted Features Map Geometry 963 (FIG. 9g) is related to the new Level 1 Extracted Features Map Topology 962 (FIG. 9g) and is generated from it using the grid spacing specified by it.

Step Initialize Level N Room System Extracted Feature Map S1349 also creates the Level 1 Extracted Features Map Data Points 964 (FIG. 9g), simply by copying the Level 0 Extracted Features Map Data Points 959 (FIG. 9g.) These data points represent the Location Score Inference Engine 945 (FIG. 9e) and are the raw data from which everything is derived. We therefore don't down sample this data and simply copy the original data to the new Level.

Step Initialize Level N Room System Extracted Feature Map S1349 also creates the Level 1 Extracted Features Map Cell Mapping 965 (FIG. 9g) precisely how it was done when creating the initial Room System Performance Map Cell Mapping 955 (FIG. 9g). This is illustrated in FIG. 13b. The difference this time is that the input is the Level 1 Room System Extracted Features Map 950 (FIG. 9g).

Step Initialize Level N Room System Extracted Feature Map S1349 then creates the Level 1 Extracted Features Map Cell Data 966 (FIG. 9g) simply by initializing the values for each map cell (as defined by the new Level 1 Extracted Features Map Topology 962 (FIG. 9g)) to a null, or undefined value, to indicate that the cell data has not yet been computed. The cell data will eventually hold the output of the Down Sampling Convolutional Filter 975a (FIG. 9h) after it is applied in step Apply Convolution Filter to Local Region S1357.

The next step Get Next Level N Room System Extracted Feature Map Cell S1350 is the start of an iterative loop where we start to apply the Down Sampling Convolutional Filter 975a (FIG. 9h) to generate, in this example, the Level 1 Extracted Features Map Cell Data 966 (FIG. 9g). In step Get Next Level N Room System Extracted Feature Map Cell S1350 attempts to get the next, unprocessed, map cell from the Level 1 Extracted Features Map Topology 962 (FIG. 9g). It does this by getting it from the Multiscale Room System Performance Map 975 (FIG. 9g), as illustrated in step Multiscale Room System Performance Map S1351. If there are cells yet to be processed, in step Get Next Level N Room System Extracted Feature Map Cell S1350, will return a reference to this cell, which is referred to as the Current Cell.

In step Have we Processed all Map Cells S1352 we determine if there are any map cells, in the Level 1 Extracted Features Map Topology 962 (FIG. 9g), that remain to be processed. If step Get Next Level N Room System Extracted Feature Map Cell S1350 returns a reference to a map cell (i.e. it returns a new Current Cell) then there are map cells that haven't yet been processed and we continue with the convolutional down sampling in step Move Convolution Filter Location S1353. If in step Get Next Level N Room System Extracted Feature Map Cell S1350 does not provide a reference to a map cell, then we have completed the down sampling process. In this example, this means that a completed Level 1 Room System Extracted Features Map 950 (FIG. 9g) has been produced. The down sampling process now returns the newly created Level to step Apply Convolution Down sample Filter to Current Level S1345 in FIG. 13g as shown by node F2.2.2 in FIGS. 13h and 13g.

Now that we have a new Current Cell, from the Level 1 Extracted Features Map Topology 962 (FIG. 9g), in this example, the next step, Move Convolution Filter Location S1353 to the Next Cell Location (x,y,z,t), is to move the Down Sampling Convolutional Filter 975a (FIG. 9h) to the Current Cell location. From the Current Cell we determine its spatial and temporal location in the Level 1 Room System Extracted Features Map 950 (FIG. 9g). We do this by retrieving the Level 1 Room System Extracted Features Map 950 (FIG. 9g), in step Multiscale Room System Performance Map S1354, from the Multiscale Room System Performance Map 975 (FIG. 9h). The spatial and temporal location is then determined using the Current Cell reference, with the Level 1 Extracted Features Map Topology 962 (FIG. 9g) and the Level 1 Extracted Features Map Geometry 963 (FIG. 9g). The computed spatial and temporal location of the Current Cell is then used to move the Down Sampling Convolutional Filter 975a (FIG. 9h) to this point (in space and time) so that it can be applied to the Level 0 Extracted Features Map Cell Data 961 (FIG. 9g) in this region in step Extract Local Region using Current Filter Location (x,y,z,t) S1355.

With the Down Sampling Convolutional Filter 975a (FIG. 9h) in place, the next step Extract Local Region using Current Filter Location (x,y,z,t) S1355, in this example, extracts the Level 0 Extracted Features Map Cell Data 961 (FIG. 9g) that the filter will process. In step Extract Local Region using Current Filter Location (x,y,z,t) S1355 first retrieves, via step Multiscale Room System Performance Map S1356, the Level 0 Room System Extracted Features Map 949 (FIG. 9g) from the Multiscale Room System Performance Map 975 (FIG. 9g). Next it determines which Level 0 Extracted Features Cell Data 961 (FIG. 9g) need to be retrieved. This is done by, first determining the list of Level 1 Extracted Features Map Data Points 964 (FIG. 9g), are part of the Current Cell—this is simply the Level 1 Extracted Features Map Cell Mapping 965 (FIG. 9g) defined for the Current Cell reference. We will refer to these as the Current Cell Data Points. It then determines the list of Level 0 Extracted Feature Map Cell Data 961 (FIG. 9g) for all map cells in the Level 0 Extracted Feature Map Topology 957 (FIG. 9g) that contain one or more of the data points in the Current Cell Data Points list, the Current Cell. This is simply done by traversing the Level 0 Extracted Feature Map Cell Mapping 960 (FIG. 9g) and returning any map cell that contains any of Level 1 Extracted Features Map Data Points 964 (FIG. 9g) that are contained with the Current Cell (as defined by the Level 1 Extracted Feature Map Topology 962 (FIG. 9g).

Once the data for the local region has been extracted, from the Level 0 Room System Extracted Features Map 949 (FIG. 9g) in this example, the Down Sampling Convolution Filter 975a (FIG. 9h) can be applied to them in step Apply Convolution Filter S1357 to Local Region. The input to the Down Sampling Convolution Filter 975a (FIG. 9h) is the list of Level 0 Extracted Feature Map Cell Data 961 (FIG. 9g) as determined in the previous step Extract Local Region using Current Filter Location (x,y,z,t) S1355.

There are a range of Down Sampling Convolution Filter 975a (FIG. 9h) that could be used, as illustrated in Example Convolutional Filters 1302. Examples include, but are not limited to Bilinear or Bicubic Interpolation, Average Pooling, Max Pooling, Dilated Convolutions, Adaptive Down Sampling, Gaussian Blur, and Wavelet Transforms. The precise filter used will depend on what our analysis, visualization, or exploration goals might be. Details of which filter to use, and how it should be configured are specified by the Room and Measurement Configuration Data 904 (FIG. 9b).

The application of the Down Sampling Convolution Filter 975a (FIG. 9h) produces a value that represents the filters response to the input Level 0 Extracted Features Map Cell Data 961 (FIG. 9g) in this example. This value is used in step Multiscale Room System Performance Map S1358 to update the Level 1 Extracted Features Map Cell Data 966 (FIG. 9g), for the Current Cell (from the Level 1 Extracted Features Map Topology 962 (FIG. 9g).

At this point the loop starts again with step Get Next Level N Room System Extracted Feature Map Cell S1350 where we get the next map cell, from the Level 1 Extracted Features Map Topology 962 (FIG. 9g) that has not yet been processed. The process of moving and applying the Down Sampling Convolutional Filter 975a (FIG. 9h) continues until all the map cells in the Level Extracted Features Map Topology 962 (FIG. 9g) have been processed.

When all map cells have been processed, as determined in step Move Convolution Filter Location S1353, we return to node F2.2.1 (FIG. 13g) with a newly created Level 1 Room System Performance Map 950 (FIG. 9g).

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A system configured to measure and create at least one acoustic multiscale room system performance map of a 3D space, comprising:
one or more generators configured to emit acoustic signals into the 3D space;
one or more sensors configured to receive the acoustic signals in the 3D space and to produce output signals corresponding to the received acoustic signals; and
a room system score performance processor configured to manage acoustic signals from the one or more sensors and generators, wherein the room system score performance processor comprises room and measurement configuration data that includes a configuration of the 3D space, configurations of the sensors, configurations of the generators, and sensor outputs that include spatial and temporal information of the sensors, wherein the room system score performance processor is configured to perform operations comprising:
operating the sensors and/or operating the sensors and the generators to perform one or more acoustic measurements by using one or more acoustic measurement techniques, comprising receiving output signals from the sensors and computing acoustic measurements based on the output signals from the sensors and the room and measurement configuration data;
generating location scores for one or more room locations associated with measurement data structures of the sensors, based on the acoustic measurements and one or more selected from the group consisting of parameters of the 3D space, equipment parameters, and use case parameters, wherein the configuration of the 3D space comprises one or more of configurations of a conference system, use case data, and performance models, and occurs prior to generating the location scores to accurately infer the location scores for different locations in the 3D space, wherein the location scores are generated (i) by using sensor score inference engines to infer an impact that each specific measurement contained in the measurement data structure will have on the location score for each room location and (ii) by using a location score inference engine to infer the room location score for each room location as an aggregation of all inputs from the sensor score inference engines; and
generating the multiscale room system performance map based on the location scores.

2. The system of claim 1 further comprising a historical room database configured to store data obtained through the operations of the room system score performance processor, wherein the historical room database includes historical location score data and data in the historical room database is created, retrieved, updated, and deleted by the room system score performance processor.

3. The system of claim 2 wherein the multiscale room system performance map is generated based on the location scores and the historical location score data.

4. The system of claim 2 further comprising a historical sensor and generator data interface that supplies data to the room system score performance processor from the historical room database.

5. The system of claim 1 wherein the configuration of the 3D space includes room geometry, room material, and known sound source locations.

6. The system of claim 1 wherein the configuration of the sensors includes sensor positions, sensor directions, sensor rotations, and sensor time, and where in the configuration of the generators includes generator positions, generator direction, generator rotations, and generator time.

7. The system of claim 1 wherein the acoustic measurement techniques are indirect measurement techniques in which measurement software has no reference signal and/or direct measurement techniques in which measurement software generates known reference signal.

8. The system of claim 1 wherein the generators comprise one or more selected from the group consisting of balloons, starter pistols, hand claps, digital audio files, and speakers.

9. The system of claim 1 wherein the sensors comprise one or more selected from the group consisting of microphones, microphone arrays, microphone speaker bars, and cameras.

10. The system of claim 1 wherein the sensors and/or the generators are embedded in or external to the conference system.

11. The system of claim 1 wherein the one or more acoustic measurements comprise background noise, impulse measurements, spectrum measurements, and Speech Transmission Intelligence Public Address (STIPA) measurements.

12. The system of claim 1 wherein the parameters of the 3D space include a room dimension or a room size of the 3D space.

13. The system of claim 1 wherein the use case parameters include meeting rooms, conference rooms, presentation rooms, education spaces, lecture halls, hybrid spaces, hybrid rooms, and classrooms.

14. The system of claim 1 wherein the equipment parameters include audio conference and voice lift equipment.

15. A method for measuring and creating at least one acoustic multiscale room system performance map of a 3D space, comprising:
operating one or more sensors and/or operating the sensors and one or more generators to perform one or more acoustic measurements by using one or more acoustic measurement techniques via a room system score performance processor, wherein the room system score performance processor comprises room and measurement configuration data that includes a configuration of the 3D space, configurations of the sensors, configurations of the generators, and sensor outputs that include spatial and temporal information of the sensors, wherein the generators are configured to emit acoustic signals into the 3D space and the sensors are configured to receive the acoustic signals in the 3D space and to produce output signals corresponding to the received acoustic signals, wherein the operating one or more sensors and/or operating the sensors and the generators comprise receiving output signals from the sensors and computing acoustic measurements based on the output signals from the sensors and the room and measurement configuration data;
generating location scores for one or more room locations associated with measurement data structures of the sensors, based on the acoustic measurements and one or more selected from the group consisting of parameters of the 3D space, equipment parameters, and use case parameters, wherein the configuration of the 3D space comprises one or more of configurations of a conference system, use case data, and performance models, and occurs prior to generating the location scores to accurately infer the location scores for different locations in the 3D space, wherein the location scores are generated (i) by using sensor score inference engines to infer an impact that each specific measurement contained in the measurement data structure will have on the location score for each room location and (ii) by using a location score inference engine to infer the room location score for each room location as an aggregation of all inputs from the sensor score inference engines; and
generating the multiscale room system performance map based on the location scores.

16. The method of claim 15 further comprising storing, in a historical room database, data obtained through processes including the operating generators and sensors, wherein the historical room database includes historical location score data and data in the historical room database is created, retrieved, updated, and deleted by the room system score performance processor.

17. The method of claim 16 wherein the multiscale room system performance map is generated based on the location scores and the historical location score data.

18. The method of claim 16 supplying, via a historical sensor and generator data interface, data to the room system score performance processor from the historical room database.

19. The method of claim 15 wherein the configuration of the 3D space includes room geometry, room material, and known sound source locations.

20. The method of claim 15 wherein the configuration of the sensors includes sensor positions, sensor directions, sensor rotations, and sensor time, and where in the configuration of the generators includes generator positions, generator direction, generator rotations, and generator time.

21. The method of claim 15 wherein the acoustic measurement techniques are indirect measurement techniques in which measurement software has no reference signal and/or direct measurement techniques in which measurement software generates known reference signal.

22. The method of claim 15 wherein the generators comprise one or more selected from the group consisting of balloons, starter pistols, hand claps, digital audio files, and speakers, wherein the sensors comprise one or more selected from the group consisting of microphones, microphone arrays, microphone speaker bars, and cameras.

23. The method of claim 15 wherein the sensors and/or the generators are embedded in or external to the conference system.

24. The method of claim 15 wherein the one or more acoustic measurements comprise background noise, impulse measurements, spectrum measurements, and Speech Transmission Intelligence public address (STIPA) measurements.

25. The method of claim 15 wherein the parameters of the 3D space include a room dimension or a room size of the 3D space, wherein the use case parameters include meeting rooms, conference rooms, presentation rooms, education spaces, lecture halls, hybrid spaces, hybrid rooms, and classrooms, and wherein the equipment parameters include audio conference and voice lift equipment.

26. One or more non-transitory computer-readable media for measuring and creating at least one acoustic multiscale room system performance map of a 3D space, the computer-readable media comprising instructions configured to cause one or more processors to perform operations comprising:
operating one or more sensors and/or operating the sensors and one or more generators to perform one or more acoustic measurements by using one or more acoustic measurement techniques via a room system score performance processor, wherein the room system score performance processor comprises room and measurement configuration data that includes a configuration of the 3D space, configurations of the sensors, configurations of the generators, and sensor outputs that include spatial and temporal information of the sensors, wherein the generators are configured to emit acoustic signals into the 3D space and the sensors are configured to receive the acoustic signals in the 3D space and to produce output signals corresponding to the received acoustic signals, wherein the operating one or more sensors and/or operating the sensors and the generators comprise receiving output signals from the sensors and computing acoustic measurements based on the output signals from the sensors and the room and measurement configuration data;
generating location scores for one or more room locations associated with measurement data structures of the sensors, based on the acoustic measurements and one or more selected from the group consisting of parameters of the 3D space, equipment parameters, and use case parameters, wherein the configuration of the 3D space comprises one or more of configurations of a conference system, use case data, and performance models, and occurs prior to generating the location scores to accurately infer the location scores for different locations in the 3D space, wherein the location scores are generated (i) by using sensor score inference engines to infer an impact that each specific measurement contained in the measurement data structure will have on the location score for each room location and (ii) by using a location score inference engine to infer the room location score for each room location as an aggregation of all inputs from the sensor score inference engines; and
generating the multiscale room system performance map based on the location scores.
